(19) United States
(12) Patent Application Publication
(10) Pub. No.: US 2016/0122646 A1
(43) Pub. Date: May 5, 2016

(54) LIQUID CRYSTAL COMPOSITION AND LIQUID CRYSTAL DISPLAY ELEMENT USING SAME

(71) Applicant: DIC CORPORATION, Tokyo (JP)

(72) Inventors: Joji Kawamura, Kita-adachi-gun (JP); Makoto Negishi, Kita-adachi-gun (JP); Yoshinori Iwashita, Kita-adachi-gun (JP)

(73) Assignee: DIC CORPORATION, Tokyo (JP)

(21) Appl. No.: 14/779,505

(22) PCT Filed: Mar. 25, 2013
(86) PCT No.: PCT/JP2013/058507

§ 371 Date: Jan. 11, 2016

(51) Int. Cl. C09K 19/34; C09K 19/02; C09K 19/30

(52) U.S. Cl. CPC C09K 19/3402; C09K 19/3068; C09K 19/3066; C09K 19/0216; C09K 2019/3077; C09K 2019/3422

(57) ABSTRACT

An object of the present invention is to provide a liquid crystal composition which has a positive Δ∈, a liquid crystal phase in a wide temperature range, an good solubility at a low temperature, excellent ODE process compatibility, high specific resistance, and a high voltage holding ratio, and is stable with respect to heat and light, and in order to achieve the object, a liquid crystal composition containing compounds represented by the following Formulas (i) and (ii) is provided.

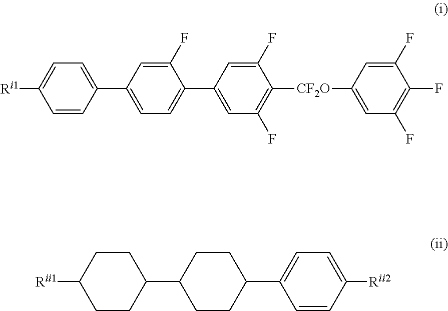

(In the formula, Rⁱ¹ represents an alkyl group having 2 to 5 carbon atoms, Rⁱⁱ¹ represents an alkenyl group having 2 to 5 carbon atoms, and Rⁱⁱ² represents an alkyl group having 1 to 5 carbon atoms or an alkoxy group having 1 to 4 carbon atoms.)

### TECHNICAL FIELD

The present invention relates to a nematic liquid crystal composition of which dielectric anisotropy (Δ∈) is a positive value useful as a liquid crystal display material and a liquid crystal display element using the same.

### BACKGROUND ART

The liquid crystal display element is used in various measuring equipment, a panel for an automobile, a word processor, an electronic organizer, a printer, a computer, a TV, a clock, an advertising display board and the like including a watch and a calculator. The representative examples of the liquid crystal display method includes a twisted nematic (TN) type, a super twisted nematic (STN) type, and a vertical alignment type and an in-plane switching (IPS) type using a thin film transistor (TFT). The liquid crystal composition used in these liquid crystal display elements is required to be stable with respect to external impetuses such as water, air, heat, and light, and to exhibit a liquid crystal phase in as wide a temperature range around room temperature as possible, and to have a low viscosity and a low driving voltage. Furthermore, the liquid crystal composition is constituted with several kinds of compounds to several dozens of compounds in order to make dielectric anisotropy (Δ∈) or refractive index anisotropy (Δn) optimal values in each display element.

In the vertical alignment (VA) type display, a liquid crystal composition having negative Δ∈ is used, and in horizontal alignment type displays such as the TN type, the STN type, and the in-plane switching (IPS) type, a liquid crystal composition having positive Δ∈ is used. A driving method in which a liquid crystal composition having positive Δ∈ is vertically aligned when no voltage is applied, and a horizontal electric field is applied to display has also been reported, and the need for the liquid crystal composition having positive Δ∈ is further increased. On the other hand, in all the driving methods, a low voltage driving, a high speed response, a wide operating temperature range are required. That is to say, it is required for Δ∈ to have a positive and high absolute value, for viscosity (η) to be low, and for a nematic phase-isotropic liquid phase transition temperature (Tni) to be high. In addition, it is necessary to adjust Δn of a liquid crystal composition to a suitable range in accordance with a cell gap in order to set Δn×d which is a product of Δn and the cell gap (d) to a predetermined value. Additionally, in a case where the liquid crystal display element is applied to a TV or the like, the liquid crystal composition is required to have low rotational viscosity (γ₁) since a high speed response property matters.

As a constitution of the liquid crystal composition for high speed response, for example, liquid crystal compositions using compounds represented by Formulas (A-1) to (A-3) which are liquid crystal compounds having positive Δ∈ and liquid crystal compounds (B) of which Δ∈ is neutral in combination are disclosed. As the characteristics of these liquid crystal compositions, it is widely known in the field of the liquid crystal composition that a liquid crystal compound having a positive Δ∈ has a —CF₂O— structure and a liquid crystal compound having a neutral Δ∈ has an alkenyl group (PTLs 1 to 4).

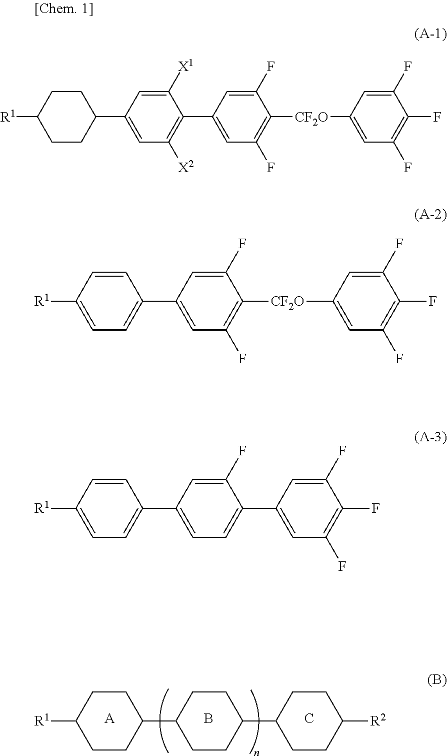

On the other hand, the application for the liquid crystal display element is expanded, and great changes are seen in the usage method and the manufacturing method thereof. In order to cope with these changes, optimization of characteristics other than fundamental physical property values known in the related art is demanded. That is to say, as the liquid crystal display element which uses the liquid crystal composition, the VA type and the IPS type are widely used, a display element of which the size is also an extra-large size of 50 inches or greater is put into practical use and is used. With the increase in a substrate size, an injection method of the liquid crystal composition into a substrate has been changed, and the mainstream type of the injection method has been changed from a vacuum injection method in the related art to a drop injection (ODF: One Drop Fill) method, but the problem in that dropping marks generated when the liquid crystal composition is dropped on a substrate leads to a decrease in display quality became an issue.

Furthermore, in the liquid crystal display element manufacturing step by the ODE method, the optimal amount needs to be dropped according to the size of the liquid crystal display element. If the amount dropped greatly deviates from the optimal value, the balance of the refractive index and the driving electric field of the liquid crystal display element which is designed in advance is lost, and display defects such as generation of spots and poor contrast occur. In particular, in a small-sized liquid crystal display element which is frequently used in smartphones in vogue recently, it is difficult to control deviation from the optimal value to be within a certain range since the optimal amount of liquid crystal dropped is small. Therefore, in order to maintain a high manufacturing yield of the liquid crystal display element, for example, it is required for the liquid crystal composition to be less affected by rapid pressure change or impact in the dropping device which occurs when the liquid crystal is dropped, and to be capable of performing dropping continuously stably over a long period of time.

In this manner, in the liquid crystal composition used in an active matrix driving liquid crystal display element driven by a TFT element or the like, while considering the manufacturing method of the liquid crystal display element, development in pursuit of improving high speed response performance, a high specific resistance value, a high voltage holding ratio, or stability with respect to external impetuses such as light and heat, required as a liquid crystal display element, has been demanded.

### CITATION LIST

### Patent Literature

[PTL 1] JP-A-2008-037918

[PTL 2] JP-A-2008-038018

[PTL 3] JP-A-2010-275390

[PTL 4] JP-A-2011-052120

### SUMMARY OF INVENTION

### Technical Problem

An object of the present invention is to provide a liquid crystal composition which has a positive Δ∈, a liquid crystal phase in a wide temperature range, a low viscosity, a good solubility at a low temperature, high specific resistance, and a high voltage holding ratio, and is stable with respect to heat and light, and another object of the present invention is to provide a liquid crystal display element which exhibits excellent display quality by suppression of display defects due to burn-in or dropping marks, with a high yield, by using the liquid crystal composition, and to provide a liquid crystal display element using the liquid crystal composition.

### Solution to Problem

The present invention includes the following aspects.

(1) A liquid crystal composition, containing at least one compound represented by General Formula (i) and at least one compound represented by General Formula (ii).

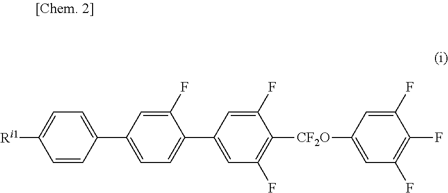

(In the formula, Rⁱ¹ represents an alkyl group having 2 to 5 carbon atoms.)

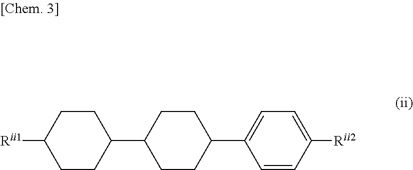

(Rⁱⁱ¹ represents an alkenyl group having 2 to 5 carbon atoms, and Rⁱⁱ² represents an alkyl group having 1 to 5 carbon atoms or an alkoxy group having 1 to 4 carbon atoms.)

(2) The liquid crystal composition according to (1), containing at least one compound represented by General formula (L).

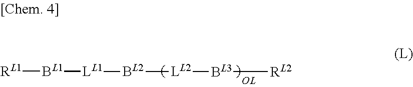

(In the formula, each of R^{L1} and R^{L2} independently represents an alkyl group having 1 to 8 carbon atoms, each of one —CH₂— group or two or more non-adjacent —CH₂— groups in the alkyl group may be independently substituted with —CH═CH—, —C≡C—, —O—, —CO—, —COO—, or —OCO—,

OL represents 0, 1, 2, or 3,

each of B^{L1}, B^{L2}, and B^{L3} independently represents a group selected from the group consisting of

(a) a 1,4-cyclohexylene group (one —CH₂— group or two or more non-adjacent —CH₂— groups present in the group may be substituted with —O—) and

(b) a 1,4-phenylene group (one —CH═ group or two or more non-adjacent —CH═ groups present in the group may be substituted with —N═), each of the groups (a) and (b) may be independently substituted with a cyano group, a fluorine atom, or a chlorine atom,

each of L^{L1} and L^{L2} independently represents a single bond, —CH₂CH₂—, —(CH₂)₄—, —OCH₂—, —CH₂O—, —COO—, —OCO—, —OCF₂—, —CF₂O—, CH═N—N═CH—, —CH═CH—, —CF═CF—, or —C≡C—,

in a case where a plurality of L^{L2}'s are present since OL is 2 or 3, L^{L2}'s may be the same as or different from each other, and in a case where a plurality of B^{L3}'s are present since OL is 2 or 3, B^{L3}'s may be the same as or different from each other, provided that a compound selected from the group represented by General Formula (ii) is excluded.)

(3) The liquid crystal composition according to (1) or (2), containing at least one compound represented by General Formula (M).

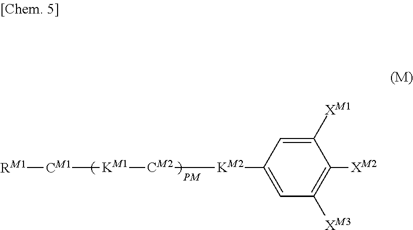

(In the formula, R^{M1} represents an alkyl group having 1 to 8 carbon atoms, each of one —CH₂— group or two or more non-adjacent —CH₂— groups in the alkyl group may be independently substituted with —CH═CH—, —C≡C—, —O—, —CO—, —COO—, or —OCO—,

PM represents 0, 1, 2, 3, or 4,

each of C^{M1} and C^{M2} independently represents a group selected from the group consisting of

(d) a 1,4-cyclohexylene group (one —CH₂— group or two or more non-adjacent —CH₂— groups present in the group may be substituted with —O— or —S—) and

(e) a 1,4-phenylene group (one —CH═ group or two or more non-adjacent —CH═ groups present in the group may be substituted with —N═), each of the groups (d) and (e) may be independently substituted with a cyano group, a fluorine atom, or a chlorine atom,

each of K^{M1} and K^{M2} independently represents a single bond, —CH₂CH₂—, —(CH₂)₄—, —OCH₂—, —CH₂O—, —OCF₂—, —CF₂O—, —COO—, —OCO—, or —C≡C—,

in a case where a plurality of K^{M1}'s are present since PM is 2, 3, or 4, K^{M1}'s may be the same as or different from each other, and in a case where a plurality of C^{m2}'s are present since PM is 2, 3, or 4, C^{M2}'s may be the same as or different from each other,

each of X^{M1} and X^{M3} independently represents a hydrogen atom, a chlorine atom, or a fluorine atom, and

X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group, provided that a compound represented by General Formula (i) is excluded.)

(4) The liquid crystal composition according to (3), containing at least one compound represented by General Formula (IX-2-2) as the compound represented by General Formula (M).

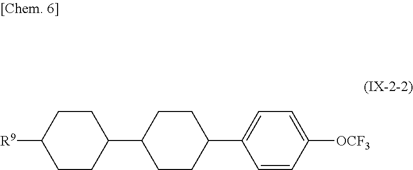

(In the formula, R⁹ represents an alkyl group having 1 to 5 carbon atoms or an alkenyl group having 2 to 5 carbon atoms.)

(5) The liquid crystal composition according to (4), containing a compound represented by Formula (31.2) and/or Formula (31.4) as the compound represented by General Formula (IX-2-2).

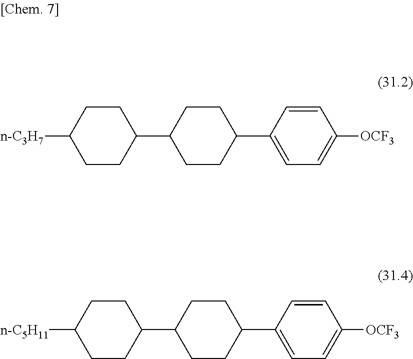

(6) The liquid crystal composition according to (3), containing at least one compound represented by General Formula (X-1-2) as the compound represented by General Formula (M).

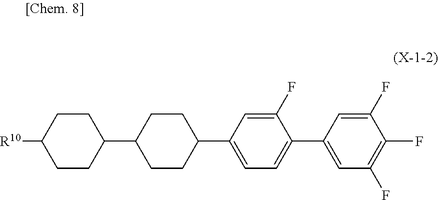

(In the formula, R¹⁰ represents an alkyl group having 1 to 5 carbon atoms, an alkenyl group having 2 to 5 carbon atoms, or an alkoxy group having 1 to 4 carbon atoms.)

(7) The liquid crystal composition according to (6), containing at least one compound represented by Formula (37.2) as the compound represented by General Formula (X-1-2).

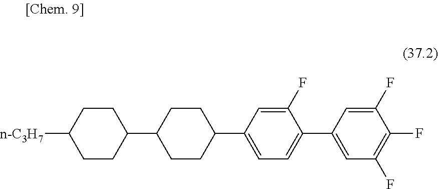

(8) The liquid crystal composition according to (3), containing at least one compound represented by General Formula (X-2-1) as the compound represented by General Formula (M).

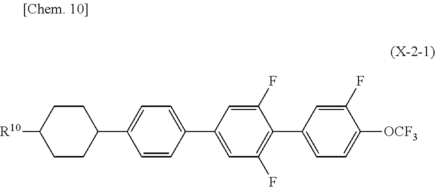

(In the formula, R¹⁰ represents an alkyl group having 1 to 5 carbon atoms, an alkenyl group having 2 to 5 carbon atoms, or an alkoxy group having 1 to 4 carbon atoms.)

(9) The liquid crystal composition according to (8), containing at least one compound represented by Formula (39.2) as the compound represented by General Formula (X-2-1).

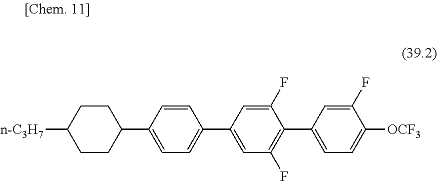

(10) The liquid crystal composition according to (2), containing at least one compound represented by General Formula (IV-2) as General Formula (L).

### [Chem. 12]

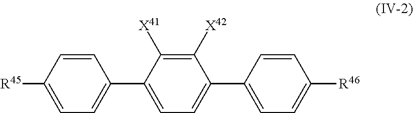

(In the formula, each of R⁴⁵ and R⁴⁶ independently represents an alkyl group having 1 to 5 carbon atoms or an alkenyl group having 2 to 5 carbon atoms, provided that at least one thereof represents an alkenyl group having 2 to 5 carbon atoms, and each of X⁴¹ and X⁴² independently represents a hydrogen atom or a fluorine atom.)

(11) The liquid crystal composition according to (10), containing at least one compound represented by Formula (19.1), (19.2), (19.3), or (19.4) as the compound represented by General Formula (IV-2).

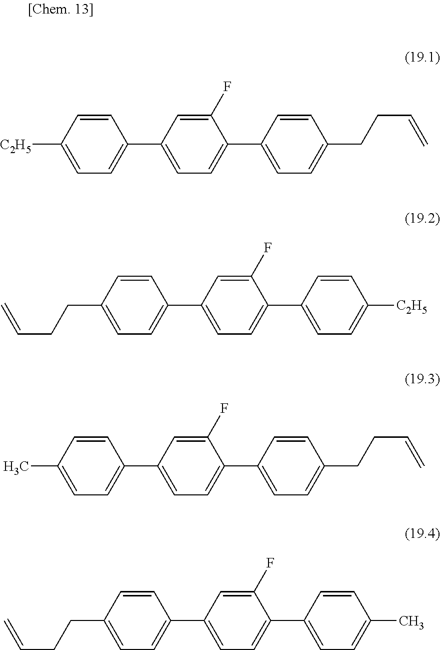

(12) The liquid crystal composition according to (3), containing at least one compound represented by General Formula (XI-1) as General Formula (M).

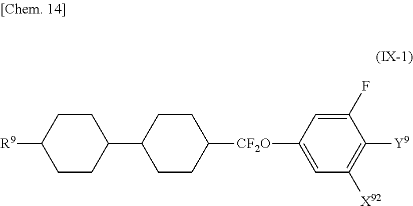

(In the formula, R⁹ represents an alkyl group having 1 to 5 carbon atoms, an alkenyl group having 2 to 5 carbon atoms, or an alkoxy having 1 to 4 carbon atoms, X⁹² represents a hydrogen atom or a fluorine atom, and Y⁹ represents a fluorine atom or —OCF₃.)

(13) The liquid crystal composition according to (12), containing a compound represented by Formula (28.5) as the compound represented by General Formula (XI-1).

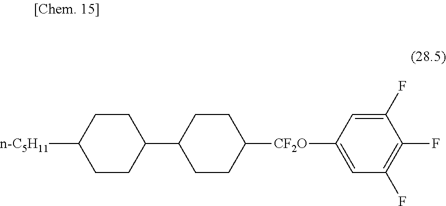

(14) The liquid crystal composition according to (12), containing 15% by mass or greater of a compound represented by Formula (28.3) as the compound represented by General Formula (XI-1).

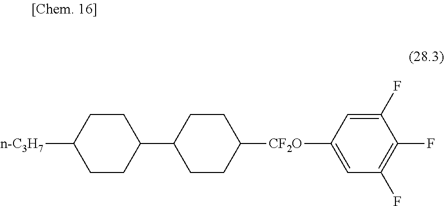

(15) The liquid crystal composition according to (2), containing at least one compound represented by General Formula (I-5) as General Formula (L).

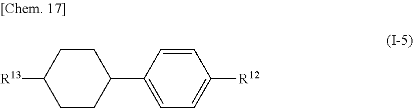

(In the formula, R¹³ represents an alkyl group having 1 to 5 carbon atoms, an alkenyl group having 2 to 5 carbon atoms, or an alkoxy group having 1 to 4 carbon atoms, and R¹² represents an alkyl group having 1 to 5 carbon atoms, an alkenyl group having 4 to 5 carbon atoms, or an alkoxy group having 1 to 4 carbon atoms.)

(16) The liquid crystal composition according to (15), containing a compound represented by Formula (6.3) and/or (6.6) as the compound represented by General Formula (I-5).

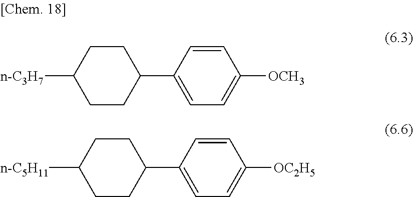

(17) The liquid crystal composition according to (2), containing at least one compound represented by General Formula (I-7) as General Formula (L).

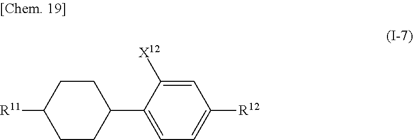

(In the formula, R¹¹ represents an alkyl group having 1 to 5 carbon atoms, an alkenyl group having 2 to 5 carbon atoms, or an alkoxy group having 1 to 4 carbon atoms, R¹² represents an alkyl group having 1 to 5 carbon atoms, an alkenyl group having 2 to 5 carbon atoms, or an alkoxy group having 1 to 4 carbon atoms, and X¹² represents a fluorine atom or a chlorine atom.)

(18) The liquid crystal composition according to (17), containing a compound represented by Formula (8.1) as the compound represented by General Formula (I-7).

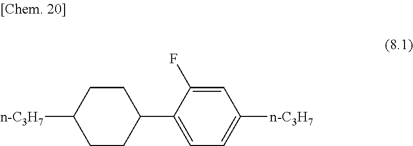

(19) The liquid crystal composition according to (2), containing at least one compound represented by General Formula (I-4) as General Formula (L).

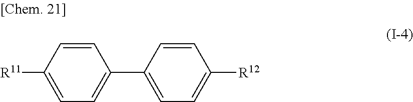

(In the formula, each of R¹¹ and R¹² independently represents an alkyl group having 1 to 5 carbon atoms, an alkenyl group having 4 to 5 carbon atoms, or an alkoxy group having 1 to 4 carbon atoms.)

(20) The liquid crystal composition according to (19), containing a compound represented by Formula (5.2) and/or Formula (5.3) as the compound represented by General Formula (I-4).

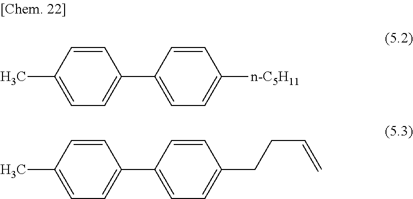

(21) The liquid crystal composition according to (3), containing at least one compound represented by General Formula (XIV-2-2) as General Formula (M).

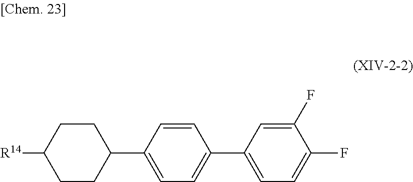

(In the formula, R¹⁴ represents an alkyl group having 1 to 5 carbon atoms, an alkenyl group having 2 to 5 carbon atoms, or an alkoxy group having 1 to 4 carbon atoms.)

(22) The liquid crystal composition according to (21), containing a compound represented by Formula (54.2) as the compound represented by General Formula (XIV-2-2).

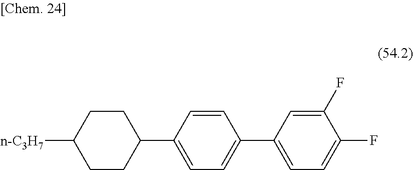

(23) The liquid crystal composition according to (22), containing 0.5% by mass or greater and less than 5% by mass of a compound represented by Formula (54.1) as the compound represented by General Formula (XIV-2-2).

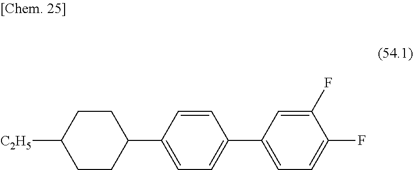

(24) The liquid crystal composition according to (3), containing at least one compound represented by General Formula (X-1-3) as General Formula (M).

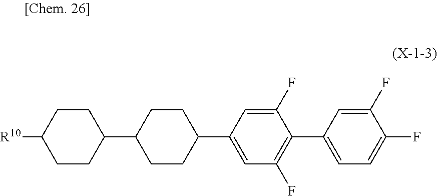

(In the formula, R¹⁰ represents an alkyl group having 1 to 5 carbon atoms, an alkenyl group having 2 to 5 carbon atoms, or an alkoxy group having 1 to 4 carbon atoms.)
(25) The liquid crystal composition according to (24), containing a compound represented by Formula (38.2) as the compound represented by General Formula (X-1-3).

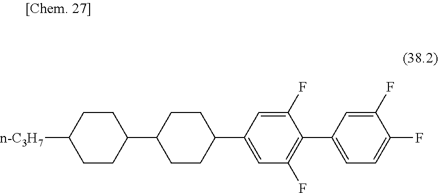

(26) The liquid crystal composition according to (2), containing 14% by mass or greater of at least one compound represented by General Formula (I-1-1) as General Formula (L).

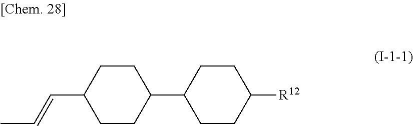

(In the formula, R¹² represents an alkyl group having 1 to 5 carbon atoms or an alkenyl group or an alkoxy group having 2 to 5 carbon atoms.)

(27) The liquid crystal composition according to (26), containing 14% by mass or greater of a compound represented by Formula (1.3) as the compound represented by General Formula (I-1-1).

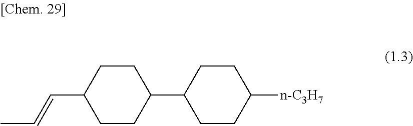

(28) The liquid crystal composition according to (2), containing 9% by mass or greater of at least one compound represented by General Formula (II-2) as General Formula (L).

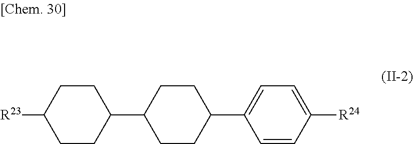

(R²³ represents an alkenyl group having 2 to 5 carbon atoms, and R²⁴ represents an alkyl group having 1 to 5 carbon atoms or an alkoxy group having 1 to 4 carbon atoms.)

(29) The liquid crystal composition according to (28), containing 9% by mass or greater of a compound represented by Formula (11.2) as the compound represented by General Formula (II-2).

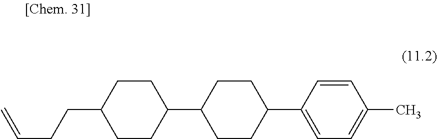

(30) The liquid crystal composition according to (2), containing 9% by mass or greater of at least one compound represented by General Formula (I-1-2) as General Formula (L).

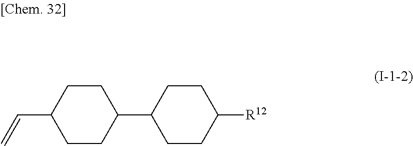

(In the formula, R¹² represents an alkyl group having 1 to 5 carbon atoms, an alkenyl group having 2 to 5 carbon atoms, or an alkoxy group having 2 to 5 carbon atoms.)

(31) The liquid crystal composition according to (30), containing 9% by mass or greater of at least one compound represented by Formula (2.4) as the compound represented by General Formula (I-1-2).

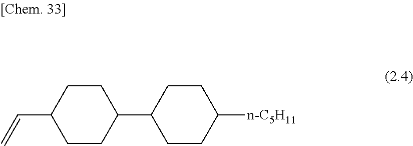

(32) The liquid crystal composition according to (3), containing 0.5% by mass or greater and less than 2% by mass of at least one compound represented by General Formula (X-3-1) as General Formula (M).

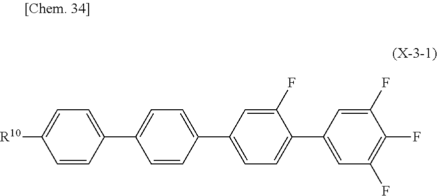

(In the formula, R¹⁰ represents an alkyl group having 1 to 5 carbon atoms, an alkenyl group having 2 to 5 carbon atoms, or an alkoxy group having 1 to 4 carbon atoms.)

(33) The liquid crystal composition according to (32), containing 0.5% by mass or greater and less than 2% by mass of a compound represented by Formula (41.2) as the compound represented by General Formula (X-3-1).

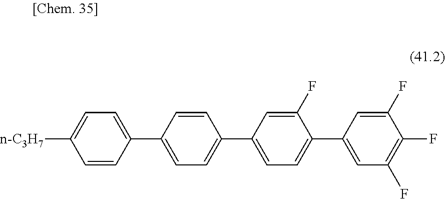

(34) The liquid crystal composition according to (3), containing 0.5% by mass or greater and less than 5% by mass of at least one compound represented by General Formula (VIII-1) as General Formula (M).

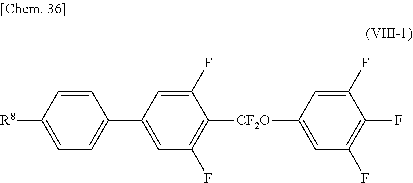

(In the formula, R⁸ represents an alkyl group having 1 to 5 carbon atoms, an alkenyl group having 2 to 5 carbon atoms, or an alkoxy group having 1 to 4 carbon atoms.)

(35) The liquid crystal composition according to (34), containing 0.5% by mass or greater and less than 5% by mass of a compound represented by Formula (26.1) as the compound represented by General Formula (VIII-1).

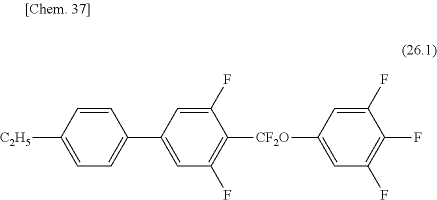

(36) The liquid crystal composition according to (2), containing 7% by mass or greater of at least one compound represented by General Formula (IV-1) as General Formula (L).

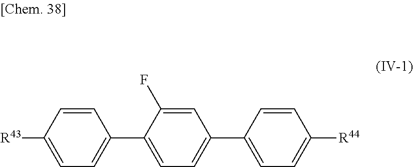

(In the formula, each of R⁴³ and R⁴⁴ independently represents an alkyl group having 1 to 5 carbon atoms.)

(37) The liquid crystal composition according to (36), containing 7% by mass or greater of a compound represented by Formula (18.4) and/or Formula (18.5) as the compound represented by General Formula (IV-1).

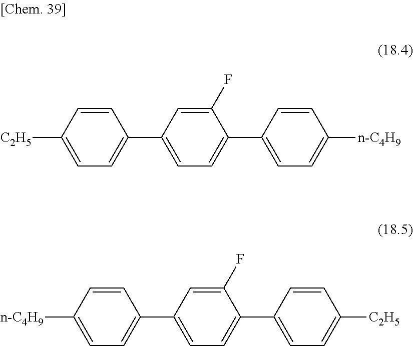

(38) The liquid crystal composition according to (36), containing 9% by mass or greater of a compound represented by Formula (18.6) and/or Formula (18.7) as the compound represented by General Formula (IV-1).

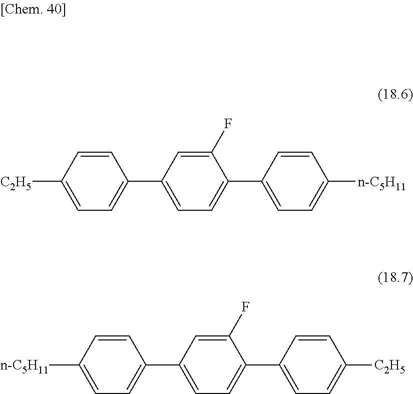

(39) A liquid crystal display element for driving active matrix using the liquid crystal composition according to any one of (1) to (38).

(40) The liquid crystal display element for driving active matrix according to (39), of which an operation mode is an IPS system.

(41) The liquid crystal display element for driving active matrix according to (39), of which the operation mode is a VA-IPS system.

(42) The liquid crystal display element for driving active matrix according to (39), of which the operation mode is an FFS system.

(43) The liquid crystal display element for driving active matrix according to (39), of which the operation mode is an ECB system.

(44) The liquid crystal display element for driving active matrix according to (39), of which the operation mode is an OCB system.

(45) The liquid crystal display element for driving active matrix according to (39), of which the operation mode is a VA system.

(46) A liquid crystal display using the liquid crystal display element for driving active matrix according to any one of (39) to (44).

### Advantageous Effects of Invention

The composition having positive dielectric anisotropy of the present invention is a composition in which the solubility at a low temperature is significantly improved compared to those in the related art, while maintaining a low viscosity, high specific resistance, and a high voltage holding ratio, and the composition can be continuously stably dropped over a long period of time in the liquid crystal display element manufacturing step by the ODE method. Therefore, using the composition of the present invention, a liquid crystal display element which exhibits excellent display quality by suppression of display defects generated in the manufacturing step can be manufactured with a high yield, and the composition has a high practicability (applicability) to liquid crystal products, and the liquid crystal display element of an in-plane switching (IPS) type or a fringe field switching (FFS) type using the composition can achieve high speed response.

### BRIEF DESCRIPTION OF DRAWINGS

FIG. 1 is a sectional view of a liquid crystal display element of the present invention. A substrate having 100 to 105 is referred to as “back plane”, and a substrate having 200 to 205 is referred to as “front plane”.

FIG. 2 is a diagram of an exposure processing step using a pattern for producing a post spacer to be formed on a black matrix as a photomask pattern.

### DESCRIPTION OF EMBODIMENTS

The liquid crystal composition of the present invention contains at least one compound represented by the following General Formula (i) and at least one compound represented by the following General Formula (ii). Hereinafter, the liquid crystal composition will be described, and, unless otherwise specified, “%” means “% by mass”.

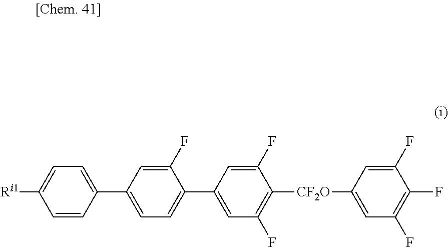

(In the formula, Rⁱ¹ represents an alkyl group having 2 to 5 carbon atoms.)

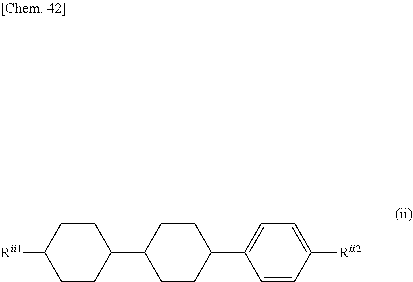

(Rⁱⁱ¹ represents an alkenyl group having 2 to 5 carbon atoms, and Rⁱⁱ² represents an alkyl group having 1 to 5 carbon atoms or an alkoxy group having 1 to 4 carbon atoms.)

<Compound Represented by General Formula (i)>

The liquid crystal composition of the present invention contains at least one compound represented by General Formula (i).

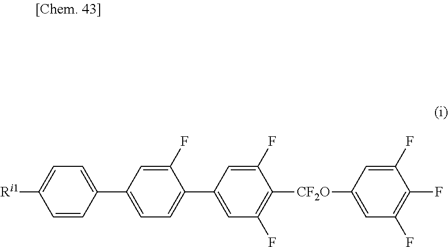

(In the formula, Rⁱ¹ represents an alkyl group having 2 to 5 carbon atoms.)

The content of the compound represented by General Formula (i) is preferably 1% by mass to 30% by mass, preferably 2% by mass to 25% by mass, and preferably 2% by mass to 22% by mass, with respect to the total mass of the liquid crystal composition of the present invention, in consideration of solubility at a low temperature, a transition temperature, and electrical reliability. Within the above-described content ranges, the content of the compound represented by General Formula (i) is preferably 2% to 20% by mass, preferably 2% to 12% by mass, preferably 2% to 8% by mass, preferably 2% to 5% by mass, preferably 2% to 4% by mass, preferably 4% to 22% by mass, preferably 5% to 22% by mass, preferably 10% to 22% by mass, preferably 14% to 22% by mass, preferably 20% to 22% by mass, preferably 4% to 5% by mass, preferably 5% to 8% by mass, preferably 10% to 12% by mass, and preferably 14% to 20% by mass, with respect to the total mass of the liquid crystal composition of the present invention.

Specifically, the compound represented by General Formula (i) used in the liquid crystal composition of the present invention is preferably at least one compound selected from the compound group represented by Formulas (45.1) to (45.4), preferably contains at least one compound selected from the compound group represented by Formulas (45.2) to (45.4) among Formulas (45.1) to (45.4), and more preferably contains the compound represented by Formula (45.2).

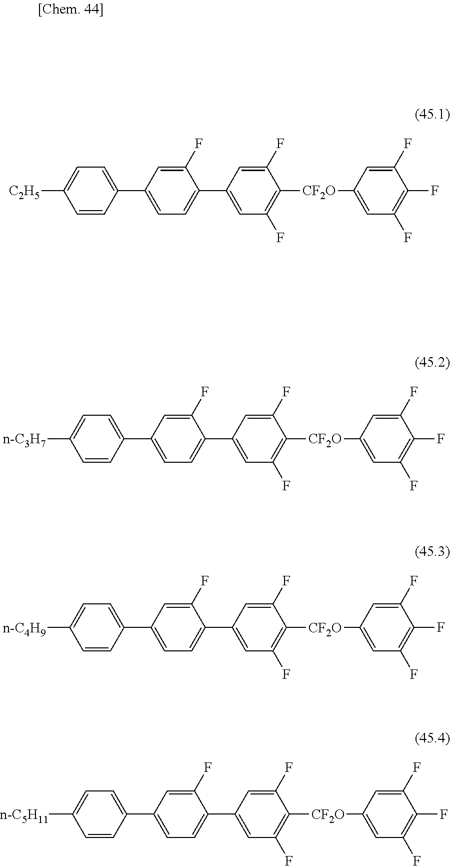

In the liquid crystal composition of the present invention, the content of the compound represented by Formula (45.2) is preferably 1% by mass to 25% by mass, preferably 2% by mass to 20% by mass, preferably 2% by mass to 15% by mass, and particularly preferably 2% by mass to 12% by mass, with respect to the total mass of the liquid crystal composition of the present invention, in consideration of solubility at a low temperature, a transition temperature, and electrical reliability.

Within the particularly preferable range, for example, 2% by mass to 10% by mass, 2% by mass to 6% by mass, 2% by mass to 5% by mass, 2% by mass to 4% by mass, 3% by mass to 11% by mass, 4% by mass to 11% by mass, and 4% by mass to 5% by mass are exemplified.

In the liquid crystal composition of the present invention, the content of the compound represented by Formula (45.3) is preferably 1% by mass to 20% by mass, preferably 1% by mass to 15% by mass, preferably 1% by mass to 10% by mass, and particularly preferably 2% by mass to 9% by mass, with respect to the total mass of the liquid crystal composition of the present invention, in consideration of solubility at a low temperature, a transition temperature, and electrical reliability. Within the particularly preferable range, for example, 4% by mass to 9% by mass, 5% by mass to 9% by mass, 2% by mass to 8% by mass, 2% by mass to 7% by mass, 2% by mass to 4% by mass, 4% by mass to 8% by mass, and 5% by mass to 7% by mass are exemplified.

In the liquid crystal composition of the present invention, the content of the compound represented by Formula (45.4) is preferably 1% by mass to 20% by mass, preferably 1% by mass to 15% by mass, preferably 1% by mass to 10% by mass, and particularly preferably 2% by mass to 10% by mass, with respect to the total mass of the liquid crystal composition of the present invention, in consideration of solubility at a low temperature, a transition temperature, and electrical reliability. Within the particularly preferable range, for example, 4% by mass to 10% by mass, 5% by mass to 10% by mass, 2% by mass to 7% by mass, 2% by mass to 6% by mass, and 5% by mass to 7% by mass are exemplified.

The compound with which the compound represented by General Formula (i) can be combined is not particularly limited, and in consideration of solubility at a low temperature, a transition temperature, electrical reliability, and birefringence, a compound is suitably combined with respect to each embodiment. For example, in an embodiment of the present invention, one type thereof is combined, in another embodiment, two types thereof are combined, and in still another embodiment, three or more types thereof are combined.

<Regarding Composition in Case of Containing at Least One Compound Represented by General Formula (i)>

In a case where the liquid crystal composition of the present invention contains at least one compound represented by General Formula (i), the content is preferably 0.5% by mass to 16% by mass in an embodiment, preferably 1% by mass to 13% by mass in an embodiment, and preferably 2% by mass to 10% by mass in an embodiment.

In a composition containing at least one compound represented by General Formula (i) and at least one compound represented by the following General Formula (ii), the total content of the compound represented by General Formula (i) and the compound represented by General Formula (ii) is preferably 5% by mass to 40% by mass, more preferably 8% by mass to 35% by mass, still more preferably 9% by mass to 33% by mass, and particularly preferably 15% by mass to 31% by mass, in an embodiment.

In the case of containing at least one compound represented by General Formula (i) and at least the compound represented by the following Formula (11.2) as the compound represented by General Formula (ii), the content of the compound represented by Formula (11.2) is preferably 3% by mass to 20% by mass in an embodiment, preferably 7% by mass to 20% by mass in an embodiment, preferably 9% by mass to 20% by mass in an embodiment, preferably 11% by mass to 20% by mass in an embodiment, preferably 12% by mass to 18% by mass in an embodiment, preferably 4% by mass to 17% by mass in an embodiment, and preferably 9% by mass to 17% by mass in an embodiment.

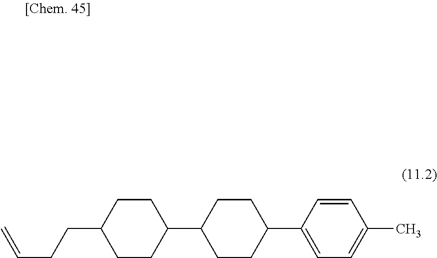 [SMILES: C=CCCC1CCC(C2CCC(c3ccc(C)cc3)CC2)CC1]

In a case where the liquid crystal composition of the present invention contains at least one compound represented by General Formula (i), the liquid crystal composition preferably further contains at least one of the compounds shown below.

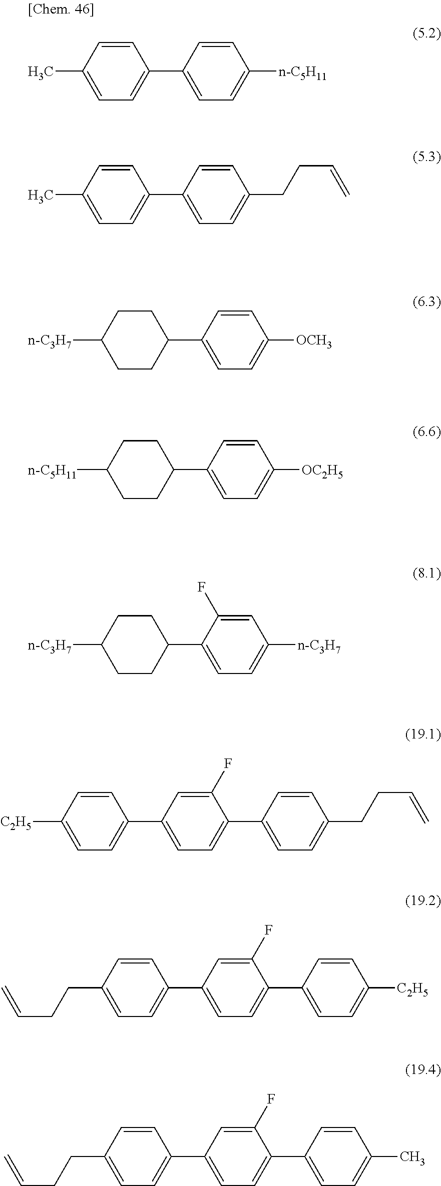

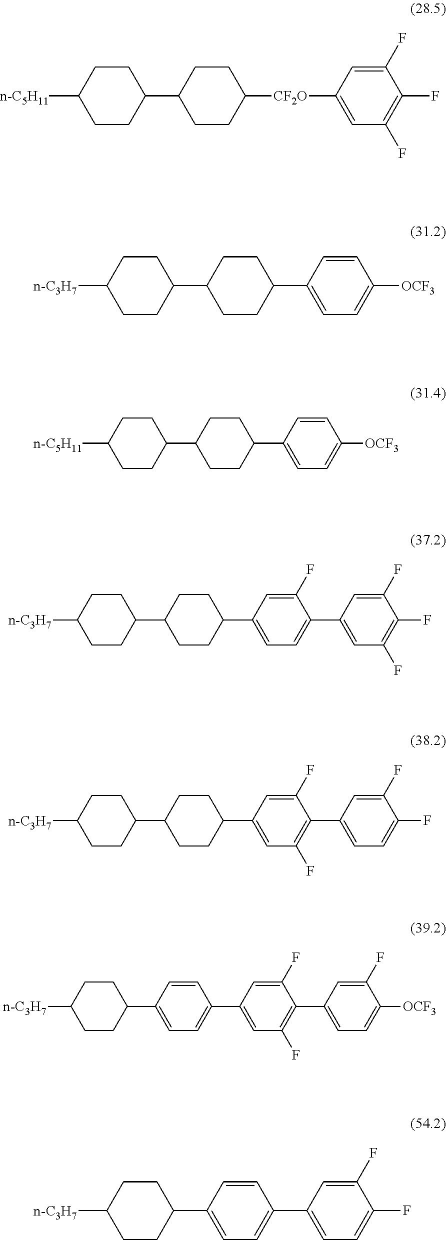

In a case where the liquid crystal composition of the present invention contains at least one compound represented by General Formula (i) and the compound represented by Formula (5.2), the content of the compound represented by Formula (5.2) is preferably 5% by mass to 18% by mass, preferably 8% by mass to 15% by mass, and more preferably within a range of 11% by mass to 12% by mass, with respect to 100% by mass of the liquid crystal composition, in an embodiment.

In a case where the liquid crystal composition of the present invention contains at least one compound represented by General Formula (i) and the compound represented by Formula (5.3), the content of the compound represented by Formula (5.3) is preferably 0.5% by mass to 11% by mass, preferably 1% by mass to 8% by mass, and more preferably within a range of 4% by mass to 5% by mass, with respect to 100% by mass of the liquid crystal composition, in an embodiment.

In a case where the liquid crystal composition of the present invention contains at least one compound represented by General Formula (i) and the compound represented by Formula (6.3), the content of the compound represented by Formula (6.3) is preferably 5% by mass to 17% by mass, more preferably within a range of 8% by mass to 14% by mass, and still more preferably 11% by mass, with respect to 100% by mass of the liquid crystal composition, in an embodiment.

In a case where the liquid crystal composition of the present invention contains at least one compound represented by General Formula (i) and the compound represented by Formula (6.6), the content of the compound represented by Formula (6.6) is preferably 0.5% by mass to 11% by mass, more preferably within a range of 2% by mass to 8% by mass, and still more preferably 5% by mass, with respect to 100% by mass of the liquid crystal composition, in an embodiment.

In a case where the liquid crystal composition of the present invention contains at least one compound represented by General Formula (i) and the compound represented by Formula (8.1), the content of the compound represented by Formula (8.1) is preferably 0.5% by mass to 7% by mass, more preferably within a range of 0.5% by mass to 4% by mass, and still more preferably 1% by mass, with respect to 100% by mass of the liquid crystal composition, in an embodiment.

In a case where the liquid crystal composition of the present invention contains at least one compound represented by General Formula (i) and the compound represented by Formula (19.1) and/or the compound represented by Formula (19.2), the content of the compound represented by Formula (19.1) and/or the compound represented by Formula (19.2) is preferably 0.5% by mass to 8% by mass, preferably 0.5% by mass to 5% by mass, and more preferably within a range of 0.5% by mass to 2% by mass, with respect to 100% by mass of the liquid crystal composition, in an embodiment.

In a case where the liquid crystal composition of the present invention contains at least one compound represented by General Formula (i) and the compound represented by Formula (19.4), the content of the compound represented by Formula (19.4) is preferably 5% by mass to 19% by mass, preferably 8% by mass to 16% by mass, and more preferably within a range of 11% by mass to 13% by mass, with respect to 100% by mass of the liquid crystal composition, in an embodiment.

In a case where the liquid crystal composition of the present invention contains at least one compound represented by General Formula (i) and the compound represented by Formula (28.5), the content of the compound represented by Formula (28.5) is preferably 1% by mass to 15% by mass, preferably 2% by mass to 12% by mass, and more preferably within a range of 3% by mass to 9% by mass, with respect to 100% by mass of the liquid crystal composition, in an embodiment.

In a case where the liquid crystal composition of the present invention contains at least one compound represented by General Formula (i) and the compound represented by Formula (31.2), the content of the compound represented by Formula (31.2) is preferably 3% by mass to 17% by mass, preferably 6% by mass to 14% by mass, and more preferably within a range of 3% by mass to 11% by mass, with respect to 100% by mass of the liquid crystal composition, in an embodiment.

In a case where the liquid crystal composition of the present invention contains at least one compound represented by General Formula (i) and the compound represented by Formula (31.4), the content of the compound represented by Formula (31.4) is preferably 0.5% by mass to 10% by mass, preferably 0.5% by mass to 7% by mass, and preferably 1% by mass to 4% by mass, with respect to 100% by mass of the liquid crystal composition, in an embodiment.

In a case where the liquid crystal composition of the present invention contains at least one compound represented by General Formula (i) and the compound represented by Formula (37.2), the content of the compound represented by Formula (37.2) is preferably 1% by mass to 13% by mass, preferably 1% by mass to 10% by mass, and more preferably within a range of 1% by mass to 7% by mass, with respect to 100% by mass of the liquid crystal composition, in an embodiment.

In a case where the liquid crystal composition of the present invention contains at least one compound represented by General Formula (i) and the compound represented by Formula (38.2), the content of the compound represented by Formula (38.2) is preferably 0.5% by mass to 12% by mass, preferably 1% by mass to 9% by mass, and more preferably within a range of 4% by mass to 6% by mass, with respect to 100% by mass of the liquid crystal composition, in an embodiment.

In a case where the liquid crystal composition of the present invention contains at least one compound represented by General Formula (i) and the compound represented by Formula (39.2), the content of the compound represented by Formula (39.2) is preferably 5% by mass to 13% by mass, preferably 8% by mass to 10% by mass, and more preferably within a range of 5% by mass to 7% by mass, with respect to 100% by mass of the liquid crystal composition, in an embodiment.

In a case where the liquid crystal composition of the present invention contains at least one compound represented by General Formula (i) and the compound represented by Formula (54.2), the content of the compound represented by Formula (54.2) is preferably 8% by mass to 21% by mass, preferably 11% by mass to 18% by mass, and more preferably within a range of 14% by mass to 15% by mass, with respect to 100% by mass of the liquid crystal composition, in an embodiment.

In the case of containing at least one compound represented by General Formula (i), the liquid crystal composition preferably further contains the following compound.

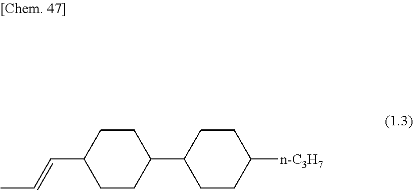

In the case of containing at least one compound represented by General Formula (i) and the compound represented by Formula (1.3), the content of the compound represented by Formula (1.3) is preferably 8% by mass to 20% by mass in an embodiment, preferably 6% by mass to 18% by mass in an embodiment, preferably 11% by mass to 17% by mass in an embodiment, preferably 14% by mass to 17% by mass in an embodiment, preferably 6% by mass to 17% by mass in an embodiment, and in addition, preferably 0.5% by mass or greater and less than 13% by mass in an embodiment.

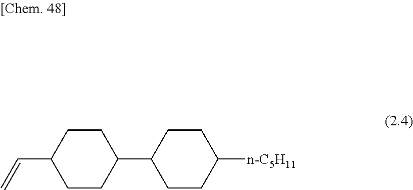

In the case of containing at least one compound represented by General Formula (i) and the compound represented by Formula (2.4), the content of the compound represented by Formula (2.4) is preferably 3% by mass to 15% by mass, more preferably 6% by mass to 15% by mass, still more preferably 9% by mass to 15% by mass, particularly preferably 10% by mass to 13% by mass, in an embodiment. In addition, in an embodiment, the content is preferably 6% by mass to 12% by mass.

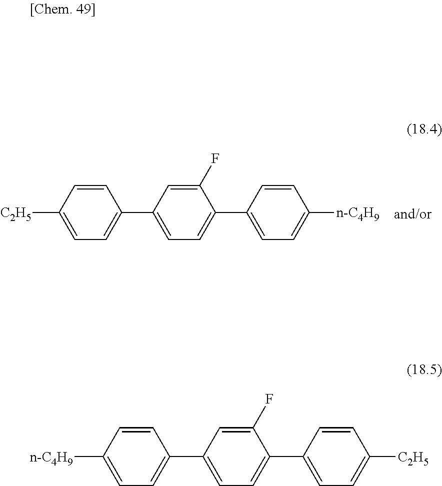

In the case of containing at least one compound represented by General Formula (i) and the compound represented by Formula (18.4) and/or the compound represented by Formula (18.5), the content of the compound represented by Formula (18.4) and/or the compound represented by Formula (18.5) is preferably 3% by mass to 16% by mass, preferably 6% by mass to 13% by mass, and preferably 9% by mass to 10% by mass, in an embodiment.

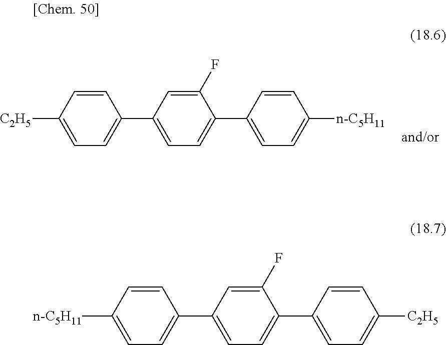

In the case of containing at least one compound represented by General Formula (i) and the compound represented by Formula (18.6) and/or the compound represented by Formula (18.7), the content of the compound represented by Formula (18.6) and/or the compound represented by Formula (18.7) is preferably 4% by mass to 17% by mass, preferably 7% by mass to 14% by mass, and preferably 10% by mass to 11% by mass, in an embodiment.

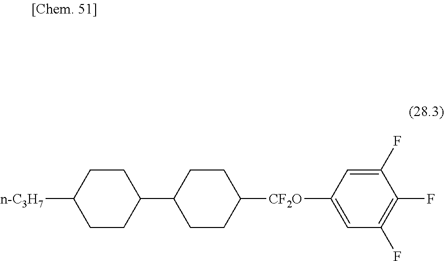

In the case of containing at least one compound represented by General Formula (i) and the compound represented by Formula (28.3), the content of the compound represented by Formula (28.3) is preferably 9% by mass to 21% by mass, preferably 12% by mass to 18% by mass, and preferably 15% by mass to 18% by mass, in an embodiment, and preferably 2% by mass to 18% by mass, in an embodiment.

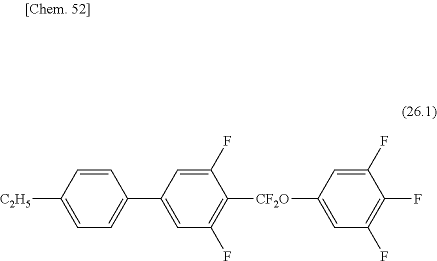

In the case of containing at least one compound represented by General Formula (i) and the compound represented by Formula (26.1), the content of the compound represented by Formula (26.1) is preferably 1% by mass to 11% by mass, preferably 1% by mass to 8% by mass, more preferably 1% to 5% by mass, and still more preferably 2% to 5% by mass, in an embodiment.

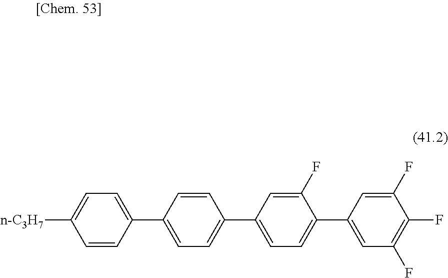

In the case of containing at least one compound represented by General Formula (i) and the compound represented by Formula (41.2), the content of the compound represented by Formula (41.2) is preferably 0.5% by mass or greater and less than 5% by mass, and preferably 0.5% by mass or greater and less than 2% by mass, in an embodiment.

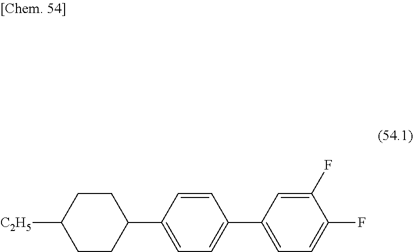

In the case of containing at least one compound represented by General Formula (i) and the compound represented by Formula (54.1), the content of the compound represented by Formula (54.1) is preferably 0.5% by mass or greater and less than 8% by mass, preferably 0.5% by mass or greater and less than 5% by mass, more preferably 1% by mass to 4% by mass, and still more preferably 2% by mass.

<Regarding Composition in Case of Containing at Least Two Compounds Represented by General Formula (i)>

In the case of containing at least two compounds represented by General Formula (i), the content thereof is preferably 2% by mass to 20% by mass in an embodiment, preferably 5% by mass to 20% by mass in an embodiment, and preferably 5% by mass to 15% by mass in an embodiment.

In the case of containing at least two compounds represented by General Formula (i) and one compound of the two compounds is the compound represented by Formula (45.2), the content of the compound represented by Formula (45.2) is preferably 0.5% by mass or greater and less than 5% by mass in an embodiment, preferably 0.5% by mass or greater and less than 3% by mass in an embodiment, and preferably 0.5% by mass or greater and less than 2% by mass in an embodiment.

In addition, in the case of containing at least two compounds represented by General Formula (i) and one compound of the two compounds is the compound represented by Formula (45.4), the content of the compound represented by Formula (45.4) is preferably 3% by mass to 15% by mass in an embodiment, preferably 5% by mass to 15% by mass in an embodiment, preferably 8% by mass to 15% by mass in an embodiment, preferably 9% by mass to 12% by mass in an embodiment, preferably 3% by mass to 10% by mass in an embodiment, and in addition, preferably 8% by mass to 11% by mass in an embodiment.

In the case of containing at least two compounds represented by General Formula (i) and at least the compound represented by Formula (11.2) as the compound represented by General Formula (ii), the content of the compound represented by Formula (11.2) is preferably 3% by mass to 20% by mass in an embodiment, preferably 6% by mass to 20% by mass in an embodiment, preferably 9% by mass to 20% by mass in an embodiment, preferably 11% by mass to 20% by mass in an embodiment, preferably 12% by mass to 18% by mass in an embodiment, preferably 4% by mass to 17% by mass in an embodiment, and preferably 6% by mass to 17% by mass in an embodiment.

In a case where the liquid crystal composition of the present invention contains at least two compounds represented by General Formula (i), the liquid crystal composition preferably further contains at least one selected from the compounds shown below.

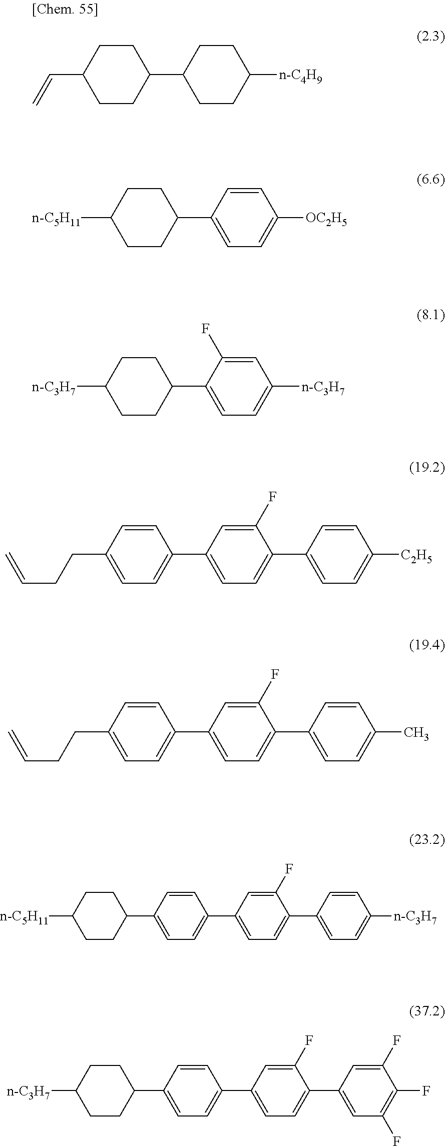

In the case of containing at least two compounds represented by General Formula (i) and the compound represented by Formula (2.3), the content of the compound represented by Formula (2.3) is preferably 9% by mass to 21% by mass, preferably 12% by mass to 18% by mass, and particularly preferably 15% by mass, in an embodiment.

In the case of containing at least two compounds represented by General Formula (i) and the compound represented by Formula (6.6), the content of the compound represented by Formula (6.6) is preferably 0.5% by mass to 11% by mass, preferably 2% by mass to 8% by mass, and preferably 5% by mass, in an embodiment.

In the case of containing at least two compounds represented by General Formula (i) and the compound represented by Formula (8.1), the content of the compound represented by Formula (8.1) is preferably 0.5% by mass to 5% by mass, preferably 0.5% by mass to 3% by mass, and preferably 1% by mass, in an embodiment.

In the case of containing at least two compounds represented by General Formula (i) and the compound represented by Formula (19.2), the content of the compound represented by Formula (19.2) is preferably 0.5% by mass to 5% by mass, preferably 0.5% by mass to 3% by mass, and preferably 1% by mass, in an embodiment.

In the case of containing at least two compounds represented by General Formula (i) and the compound represented by Formula (19.4), the content of the compound represented by Formula (19.4) is preferably 6% by mass to 18% by mass, preferably 9% by mass to 15% by mass, and preferably 12% by mass, in an embodiment.

In the case of containing at least two compounds represented by General Formula (i) and the compound represented by Formula (23.2), the content of the compound represented by Formula (23.2) is preferably 0.5% by mass to 11% by mass, preferably 2% by mass to 8% by mass, and preferably 5% by mass, in an embodiment.

In the case of containing at least two compounds represented by General Formula (i) and the compound represented by Formula (37.2), the content of the compound represented by Formula (37.2) is preferably 0.5% by mass to 8% by mass, preferably 0.5% by mass to 5% by mass, and preferably 2% by mass, in an embodiment.

In the case of containing at least two compounds represented by General Formula (i), the liquid crystal composition preferably further contains the following compound.

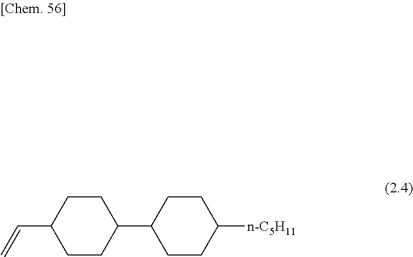

In the case of containing at least two compounds represented by General Formula (i) and the compound represented by Formula (2.4), the content of the compound represented by Formula (2.4) is preferably 3% by mass to 15% by mass, preferably 6% by mass to 14% by mass, more preferably 9% by mass to 13% by mass, and still more preferably 11% by mass to 13% by mass, in an embodiment. In addition, in an embodiment, the content is 12% by mass.

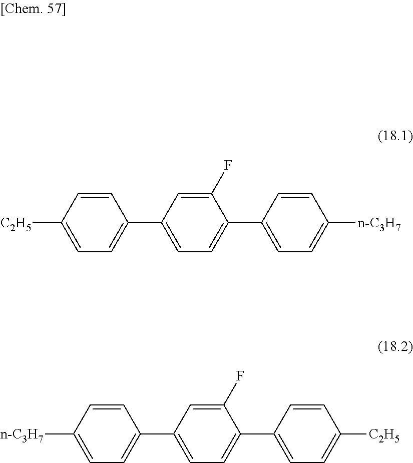

In the case of containing at least two compounds represented by General Formula (i) and the compound represented by Formula (18.1) and/or Formula (18.2), the content of the compound represented by Formula (18.1) and/or Formula (18.2) is preferably 0.5% by mass to 8% by mass, preferably 0.5% by mass to 5% by mass, and particularly preferably 1% by mass to 4% by mass, in an embodiment. In addition, in an embodiment, 0.5% by mass or greater and less than 3% by mass is preferable.

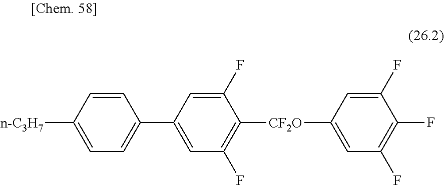

In the case of containing at least two compounds represented by General Formula (i) and the compound represented by Formula (26.2), the content of the compound represented by Formula (26.2) is preferably 1% by mass or greater and less than 13% by mass, preferably 1% by mass or greater and less than 10% by mass, and preferably 2% by mass to 9% by mass, in an embodiment, and in addition, preferably 2% by mass to 8% by mass, in an embodiment.

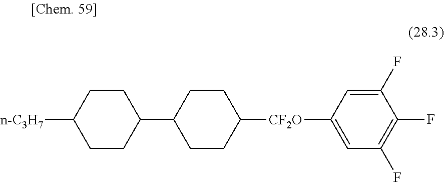

In the case of containing at least two compounds represented by General Formula (i) and the compound represented by Formula (28.3), the content of the compound represented by Formula (28.3) is preferably 1% to 21% by mass, more preferably 7% to 21% by mass, preferably 10% to 21% by mass, preferably 12% to 18% by mass, and particularly preferably 15% to 18% by mass, in an embodiment. In addition, in an embodiment, the content is preferably 2% by mass to 17% by mass.

<Regarding Composition in Case of Containing at Least Three Compounds Represented by General Formula (I)>

In the case of containing at least three compounds represented by General Formula (i), the content is preferably 7% by mass to 28% by mass, 10% by mass to 25% by mass, and preferably 13% by mass to 22% by mass.

In the case of containing at least three compounds represented by General Formula (i) and one compound of the three compounds is the compound represented by Formula (45.4), the content of the compound represented by Formula (45.4) is preferably 3% by mass to 15% by mass in an embodiment, preferably 4% by mass to 15% by mass in an embodiment, preferably 5% by mass to 15% by mass in an embodiment, preferably 7% by mass to 12% by mass in an embodiment, preferably greater than 3% by mass and 10% by mass or less in an embodiment, and preferably 6% by mass to 17% by mass in an embodiment. In an embodiment, the content is preferably 4% by mass to 11% by mass.

In the case of containing at least three compounds represented by General Formula (i) and the compound represented by Formula (11.1) as the compound represented by General Formula (ii), the content of the compound represented by Formula (11.1) is preferably 3% by mass to 20% by mass in an embodiment, preferably 6% by mass to 20% by mass in an embodiment, preferably 9% by mass to 20% by mass in an embodiment, preferably 11% by mass to 20% by mass in an embodiment, preferably 12% by mass to 18% by mass in an embodiment, preferably 7% by mass to 15% by mass in an embodiment, and preferably 6% by mass to 17% by mass in an embodiment.

In the case of containing at least three compounds represented by General Formula (i) and at least one compound represented by General Formula (ii), when containing the compound represented by Formula (11.2) as the compound represented by General Formula (ii), the content of the compound represented by Formula (11.2) is preferably 3% by mass to 20% by mass in an embodiment, and preferably 3% to 20% by mass, more preferably 5% to 20% by mass, and still more preferably 18% to 15% by mass, in an embodiment. In addition, in an embodiment, the content is preferably 4% to 11% by mass.

In a case where the liquid crystal composition of the present invention contains at least three compounds represented by General Formula (i), the liquid crystal composition preferably further contains at least one selected from the compounds shown below.

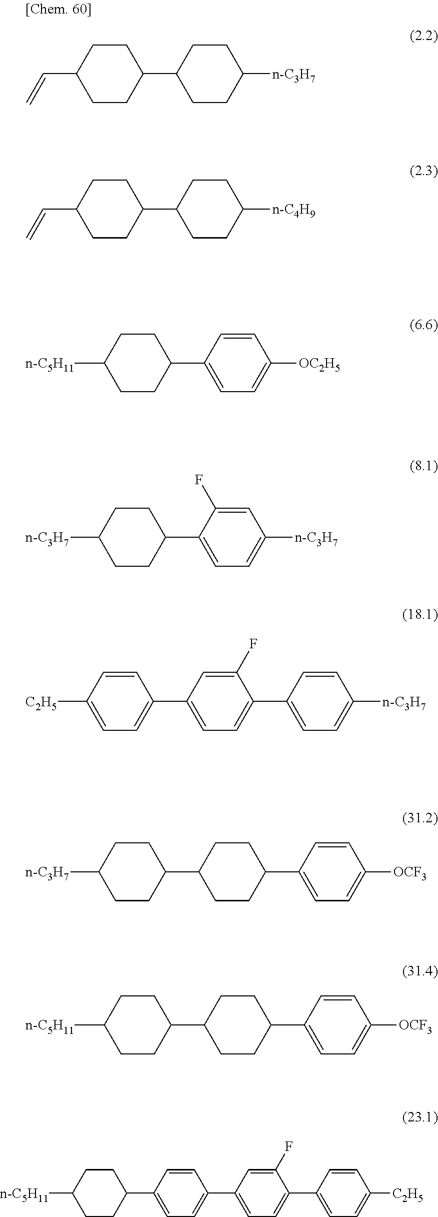

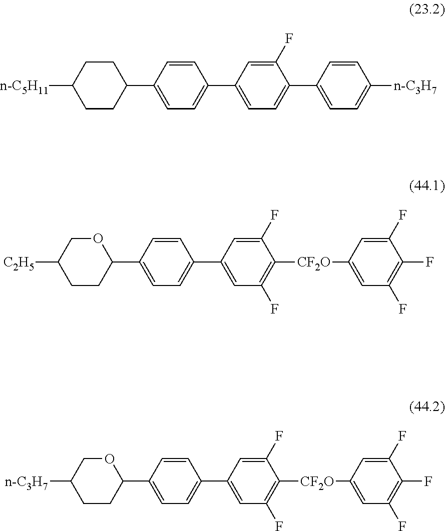

In the case of containing at least three compounds represented by General Formula (i) and the compound represented by Formula (2.2), the content of the compound represented by Formula (2.2) is preferably 17% by mass to 44% by mass, preferably 20% by mass to 41% by mass, and preferably 23% by mass to 38% by mass, in an embodiment.

In the case of containing at least three compounds represented by General Formula (i) and the compound represented by Formula (2.3), the content of the compound represented by Formula (2.3) is preferably 9% by mass to 21% by mass, preferably 12% by mass to 18% by mass, and preferably 15% by mass, in an embodiment.

In the case of containing at least three compounds represented by General Formula (i) and the compound represented by Formula (6.6), the content of the compound represented by Formula (6.6) is preferably 0.5% by mass to 11% by mass, preferably 2% by mass to 8% by mass, and preferably 5% by mass, in an embodiment.

In the case of containing at least three compounds represented by General Formula (i) and the compound represented by Formula (8.1), the content of the compound represented by Formula (8.1) is preferably 0.5% by mass to 5% by mass, preferably 0.5% by mass to 3% by mass, and preferably 1% by mass, in an embodiment.

In the case of containing at least three compounds represented by General Formula (i) and the compound represented by Formula (18.1), the content of the compound represented by Formula (18.1) is preferably 0.5% by mass to 9% by mass, preferably 0.5% by mass to 6% by mass, and preferably 3% by mass, in an embodiment.

In the case of containing at least three compounds represented by General Formula (i) and the compound represented by Formula (31.2), the content of the compound represented by Formula (31.2) is preferably 0.5% by mass to 12% by mass, preferably 3% by mass to 9% by mass, and preferably 6% by mass, in an embodiment.

In the case of containing at least three compounds represented by General Formula (i) and the compound represented by Formula (31.4), the content of the compound represented by Formula (31.4) is preferably 0.5% by mass to 9% by mass, preferably 0.5% by mass to 6% by mass, and preferably 3% by mass, in an embodiment.

In the case of containing at least three compounds represented by General Formula (i) and the compound represented by Formula (23.1), the content of the compound represented by Formula (23.1) is preferably 0.5% by mass to 11% by mass, preferably 2% by mass to 8% by mass, and preferably 5% by mass, in an embodiment.

In the case of containing at least three compounds represented by General Formula (i) and the compound represented by Formula (23.2), the content of the compound represented by Formula (23.2) is preferably 0.5% by mass to 11% by mass, preferably 2% by mass to 8% by mass, and preferably 5% by mass, in an embodiment.

In the case of containing at least three compounds represented by General Formula (i) and the compound represented by Formula (44.1), the content of the compound represented by Formula (44.1) is preferably 0.5% by mass to 11% by mass, preferably 2% by mass to 8% by mass, and preferably 5% by mass, in an embodiment.

In the case of containing at least three compounds represented by General Formula (i) and the compound represented by Formula (44.2), the content of the compound represented by Formula (44.2) is preferably 1% by mass to 13% by mass, preferably 4% by mass to 10% by mass, and preferably 7% by mass, in an embodiment.

In the case of containing at least three compounds represented by General Formula (i), the liquid crystal composition preferably further contains the following compound.

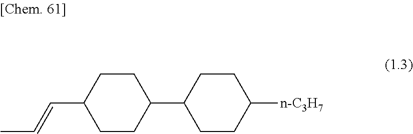

In the case of containing at least three compounds represented by General Formula (i) and the compound represented by Formula (1.3), the content of the compound represented by Formula (1.3) is preferably 3% by mass to 15% by mass, preferably 6% by mass to 15% by mass, more preferably 9% by mass to 15% by mass, still more preferably 10% by mass to 15% by mass, still more preferably 11% by mass to 15% by mass, and particularly preferably 12% by mass to 14% by mass, in an embodiment. In addition, in an embodiment, the content is preferably 11% by mass to 14% by mass.

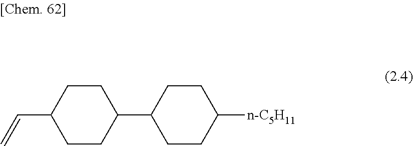

In the case of containing at least three compounds represented by General Formula (i) and the compound represented by Formula (2.4), the content of the compound represented by Formula (2.4) is preferably 9% by mass to 20% by mass, preferably 10% by mass to 15% by mass, and more preferably 11% by mass to 13% by mass, in an embodiment. In addition, in an embodiment, the content is 12% by mass.

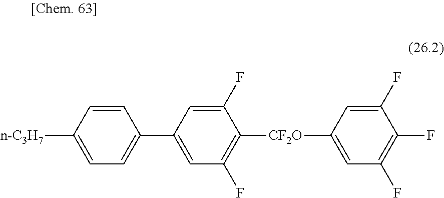

In the case of containing at least three compounds represented by General Formula (i) and the compound represented by Formula (26.2), the content of the compound represented by Formula (26.2) is preferably 1% by mass or greater and less than 10% by mass, more preferably 1% by mass to 9% by mass, still more preferably 1% by mass to 8% by mass, and even more preferably 2% by mass to 7% by mass, in an embodiment. In addition, in an embodiment, the content is preferably 2% by mass to 8% by mass.

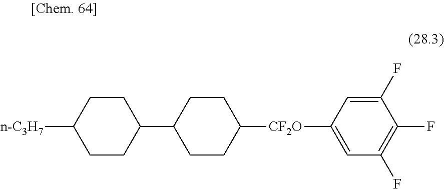

In the case of containing at least three compounds represented by General Formula (i) and the compound represented by Formula (28.3), the content of the compound represented by Formula (28.3) is preferably 1% by mass to 21% by mass, preferably 1% by mass to 17% by mass, more preferably 1% to 15% by mass, still more preferably 1% to 13% by mass, even more preferably 1% to 11% by mass, and particularly preferably 5% to 10% by mass, in an embodiment. In addition, in an embodiment, the content is 8% by mass to 17% by mass.

<Regarding Compound Represented by General Formula (ii)>

The liquid crystal composition of the present invention contains the compound represented by General Formula (ii).

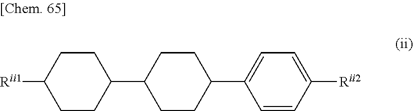

(Rⁱⁱ¹ represents an alkenyl group having 2 to 5 carbon atoms, and Rⁱⁱ² represents an alkyl group having 1 to 5 carbon atoms or an alkoxy group having 1 to 4 carbon atoms)

The types of compound with which the compound represented by General Formula (ii) can be combined are not particularly limited, and a suitable compound is combined depending on the required performance such as solubility at a low temperature, a transition temperature, electrical reliability, and birefringence. The type of compound used, for example, is one type in an embodiment of the present invention. Alternatively, in another embodiment of the present invention, two or more types are used.

In the liquid crystal composition of the present invention, the content of the compound represented by General Formula (ii) needs to be suitably adjusted depending on the required performance such as solubility at a low temperature, a transition temperature, electrical reliability, birefringence, process compatibility, dropping marks, burn-in, and dielectric anisotropy.

For example, the content of the compound represented by General Formula (ii) is 3% to 35% by mass with respect to the total mass of the liquid crystal composition of the present invention in an embodiment of the present invention. Alternatively, in another embodiment of the present invention, the content is 4% to 35% by mass. In still another embodiment of the present invention, the content is 5% to 35% by mass. In still another embodiment of the present invention, the content is 8% to 35% by mass. In still another embodiment of the present invention, the content is 9% to 35% by mass. In still another embodiment of the present invention, the content is 10% to 35% by mass. In still another embodiment of the present invention, the content is 11% to 35% by mass. In still another embodiment of the present invention, the content is 12% to 35% bymass. In still another embodiment of the present invention, the content is 13% to 35% by mass. In still another embodiment of the present invention, the content is 15% to 35% by mass. In addition, in still another embodiment of the present invention, the content is 20% to 35% by mass.

For example, the content of the compound represented by General Formula (ii) is 3% to 30% by mass with respect to the total mass of the liquid crystal composition of the present invention in an embodiment of the present invention. In another embodiment of the present invention, the content is 3% to 26% by mass. In still another embodiment of the present invention, the content is 3% to 20% by mass. In still another embodiment of the present invention, the content is 3% to 16% by mass. In still another embodiment of the present invention, the content is 3% to 15% by mass. In still another embodiment of the present invention, the content is 3% to 14% by mass. In still another embodiment of the present invention, the content is 3% to 13% by mass. In still another embodiment of the present invention, the content is 3% to 12% by mass. In still another embodiment of the present invention, the content is 3% to 10% by mass. In still another embodiment of the present invention, the content is 3% to 9% by mass. Further, in still another embodiment of the present invention, the content is 3% to 7% by mass.

Furthermore, the compound represented by General Formula (ii), for example, is preferably at least one compound selected from the compound group represented by Formulas (11.1) to (11.3).

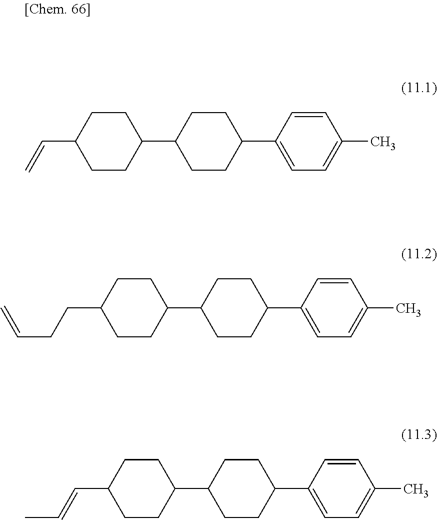

The liquid crystal composition of the present invention may contain the compound represented by Formula (11.1), the compound represented by Formula (11.2), both the compound represented by Formula (11.1) and the compound represented by Formula (11.2), or all the compounds represented by Formulas (11.1) to (11.3) depending on the required performance such as solubility at a low temperature, a transition temperature, electrical reliability, and birefringence.

The content of the compound represented by Formula (11.1) is preferably 1% to 30% by mass, preferably 2% to 25% by mass, and preferably 2% to 20% by mass, with respect to the total mass of the liquid crystal composition of the present invention. Within the above-described content ranges, for example, the content is preferably 2% to 10% by mass, 3% to 7% by mass, 3% to 5% by mass, 4% to 12% by mass, 5% to 15% by mass, 6% to 14% by mass, 6% to 13% by mass, 8% to 15% by mass, 12% to 20% by mass, or 13% to 16% by mass.

The content of the compound represented by Formula (11.2) is preferably 1% to 30% by mass, preferably 1% to 25% by mass, preferably 1% to 20% by mass, preferably 5% to 20% by mass, more preferably 9% to 20% by mass, still more preferably 10% to 20% by mass, and particularly preferably 11% to 18% by mass, with respect to the total mass of the liquid crystal composition of the present invention. Within the above-described content ranges, for example, the content is preferably 1% to 11% by mass, preferably 3% to 11% by mass, more preferably 5% to 11% by mass, more preferably 6% to 11% by mass, and still more preferably 9% to 11% by mass, in an embodiment, the content is preferably 2% to 15% by mass, preferably 2% to 9% by mass, still more preferably 4% to 5% by mass, in another embodiment, and preferably 5% to 17% by mass in still another embodiment. In addition, in still another embodiment, the content is preferably 3% to 17% by mass.

In the case of containing both the compound represented by Formula (11.1) and the compound represented by Formula (11.2), the total mass of both the compound represented by Formula (11.1) and the compound represented by Formula (11.2) is preferably 1% by mass to 45% by mass, preferably 1% by mass to 40% by mass, preferably 1% by mass to 35% by mass, preferably 1% by mass to 30% by mass, preferably 3% by mass to 30% by mass, preferably 3% by mass to 26% by mass, preferably 3% by mass to 20% by mass, preferably 3% by mass to 16% by mass, preferably 3% by mass to 15% by mass, preferably 3% by mass to 14% by mass, preferably 3% by mass to 13% by mass, preferably 3% by mass to 12% by mass, preferably 3% by mass to 10% by mass, preferably 3% by mass to 9% by mass, preferably 3% by mass to 7% by mass, preferably 4% by mass to 30% by mass, preferably 5% by mass to 30% by mass, preferably 8% by mass to 30% by mass, preferably 9% by mass to 30% by mass, preferably 10% by mass to 30% by mass, preferably 11% by mass to 30% by mass, preferably 12% by mass to 30% by mass, preferably 13% by mass to 30% by mass, and preferably 15% by mass to 30% by mass, with respect to the total amount of the liquid crystal composition of the present invention. Within the above-described content ranges, for example, the content is preferably 4% by mass to 12% by mass, 5% by mass to 9% by mass, 8% by mass to 13% by mass, 9% by mass to 14% by mass, 12% by mass to 16% by mass, 11% by mass to 26% by mass, or 11% by mass to 20%.

The total content of the compound represented by General Formula (i) and the compound represented by General Formula (ii) is preferably 10% by mass or greater, preferably 12% by mass or greater, preferably 17% by mass or greater, preferably 24% by mass or greater, preferably 25% by mass or greater, preferably 26% by mass or greater, preferably 30% by mass or greater, preferably 31% by mass or greater, preferably 40% by mass or greater, preferably 41% by mass or greater, and preferably 51% by mass or greater, with respect to the total mass of the liquid crystal composition.

<Regarding Composition in Case of Containing at Least One Compound Represented by General Formula (ii)>

In the case of containing at least one compound represented by General Formula (i) and at least one compound represented by General Formula (ii), when containing the compound represented by the following Formula (11.2) as the compound represented by General Formula (ii), the content of the compound represented by Formula (11.2) is preferably 4% by mass to 20% by mass, more preferably 6% by mass to 19% by mass, still more preferably 8% by mass to 17% by mass, and particularly preferably 9% by mass to 15% by mass, in an example.

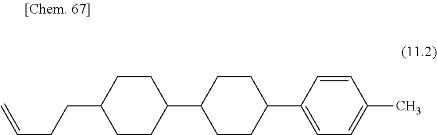

In the case of containing at least one compound represented by General Formula (ii), the liquid crystal composition preferably further contains at least one of the compounds shown below.

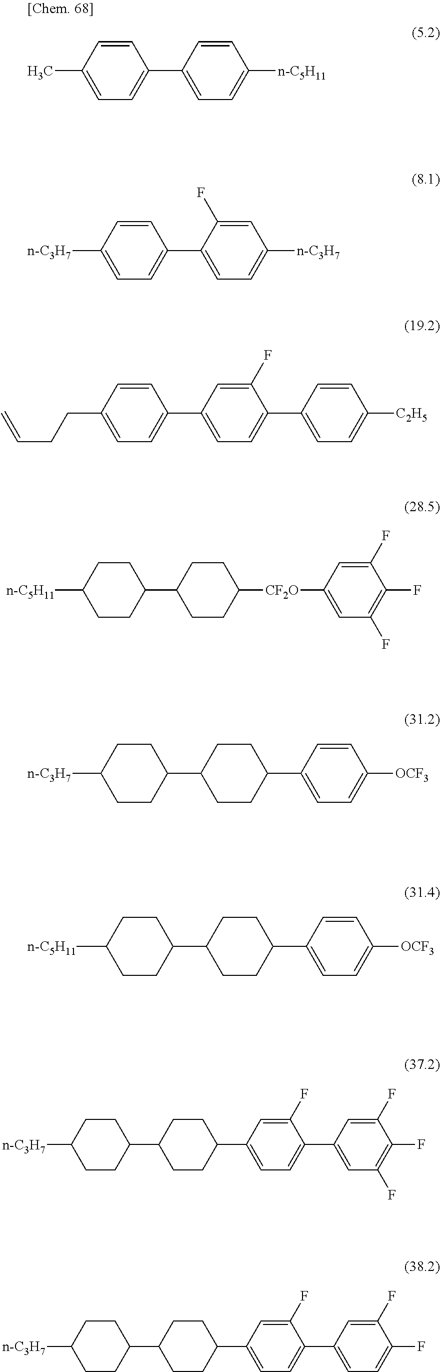

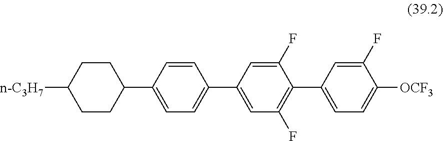

In the case of containing at least one compound represented by General Formula (ii) and the compound represented by Formula (5.2), the content of the compound represented by Formula (5.2) is preferably 6% by mass to 18% by mass, preferably 9% by mass to 15% by mass, and preferably 12% by mass, in an embodiment.

In the case of containing at least one compound represented by General Formula (ii) and the compound represented by Formula (8.1), the content of the compound represented by Formula (8.1) is preferably 0.5% by mass to 7% by mass, preferably 0.5% by mass to 4% by mass, and preferably 1% by mass, in an embodiment.

In the case of containing at least one compound represented by General Formula (ii) and the compound represented by Formula (19.2), the content of the compound represented by Formula (19.2) is preferably 0.5% by mass to 7% by mass, preferably 0.5% by mass to 4% by mass, and preferably 1% by mass, in an embodiment.

In the case of containing at least one compound represented by General Formula (ii) and the compound represented by Formula (28.5), the content of the compound represented by Formula (28.5) is preferably 0.5% by mass to 14% by mass, preferably 1% by mass to 11% by mass, and preferably 4% by mass to 8% by mass, in an embodiment.

In the case of containing at least one compound represented by General Formula (ii) and the compound represented by Formula (31.2), the content of the compound represented by Formula (31.2) is preferably 0.5% by mass to 17% by mass, preferably 0.5% by mass to 14% by mass, and preferably 3% by mass to 11% by mass, in an embodiment.

In the case of containing at least one compound represented by General Formula (ii) and the compound represented by Formula (31.4), the content of the compound represented by Formula (31.4) is preferably 0.5% by mass to 9% by mass, preferably 0.5% by mass to 6% by mass, and preferably 2% by mass to 3% by mass, in an embodiment.

In the case of containing at least one compound represented by General Formula (ii) and the compound represented by Formula (37.2), the content of the compound represented by Formula (37.2) is preferably 0.5% by mass to 13% by mass, preferably 0.5% by mass to 10% by mass, and preferably 2% by mass to 7% by mass.

In the case of containing at least one compound represented by General Formula (ii) and the compound represented by Formula (38.2), the content of the compound represented by Formula (38.2) is preferably 0.5% by mass to 21% by mass, preferably 2% by mass to 18% by mass, and preferably 5% by mass, in an embodiment.

In the case of containing at least one compound represented by General Formula (ii) and the compound represented by Formula (39.2), the content of the compound represented by Formula (39.2) is preferably 0.5% by mass to 12% by mass, preferably 3% by mass to 9% by mass, and preferably 6% by mass, in an embodiment.

In the case of containing at least one compound represented by General Formula (ii), the liquid crystal composition preferably further contains the following compound.

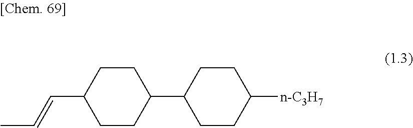

In the case of containing at least one compound represented by General Formula (ii) and the compound represented by Formula (1.3), the content of the compound represented by Formula (1.3) is preferably 5% to 20% by mass, preferably 10% to 20% by mass, preferably 14% to 20% by mass, and still more preferably 15% to 20% by mass, in an embodiment. In an embodiment, the content is preferably 7% by mass to 18% by mass. In addition, in an embodiment, the content is preferably greater than 13% by mass and 18% by mass or less.

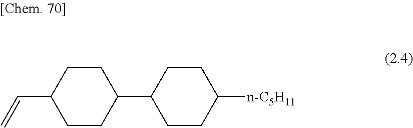

In the case of containing at least one compound represented by General Formula (ii) and the compound represented by Formula (2.4), the content of the compound represented by Formula (2.4) is preferably 5% by mass to 15% by mass, preferably 9% by mass to 15% by mass, and still more preferably 10% to 13% by mass, in an embodiment. In an embodiment, the content is preferably 6% by mass to 12% by mass. In addition, in an embodiment, the content is preferably greater than 8% by mass and 12% by mass or less.

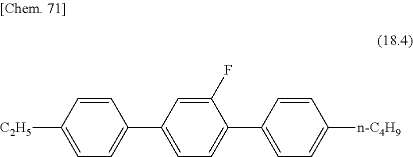

In the case of containing at least one compound represented by General Formula (ii) and the compound represented by Formula (18.4), the content of the compound represented by Formula (18.4) is preferably 5% to 15% by mass, preferably 7% to 12% by mass, and still more preferably 9% to 12% by mass.

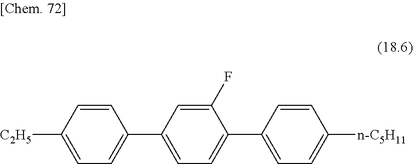

In the case of containing at least one compound represented by General Formula (ii) and the compound represented by Formula (18.6), the content of the compound represented by Formula (18.6) is preferably 5% to 15% by mass, preferably 8% to 13% by mass, and still more preferably 9% to 13% by mass.

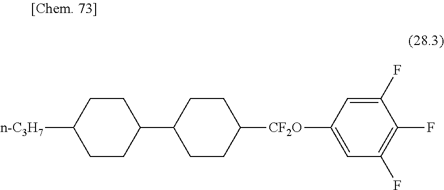

In the case of containing at least one compound represented by General Formula (ii) and the compound represented by Formula (28.3), the content of the compound represented by Formula (28.3) is preferably 2% to 20% by mass, more preferably 7% to 20% by mass, still more preferably 10% to 20% by mass, and particularly preferably 15% to 20% by mass, in an embodiment. In an embodiment, the content is preferably 2% by mass to 17% by mass. In addition, in an embodiment, the content is preferably 2% by mass or greater and less than 8% by mass, and preferably greater than 14% by mass and 17% by mass or less.

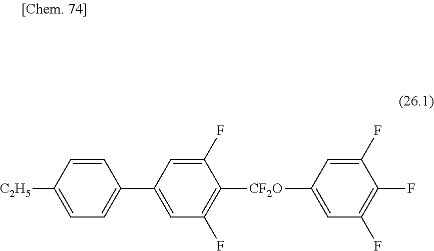

In the case of containing at least one compound represented by General Formula (ii) and the compound represented by Formula (26.1), the content of the compound represented by Formula (26.1) is preferably 1% to 5% by mass, preferably 1% to 4% by mass, and still more preferably 1% to 3% by mass.

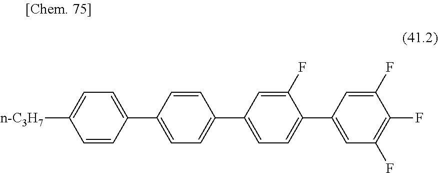

In the case of containing at least one compound represented by General Formula (ii) and the compound represented by Formula (41.2), the content of the compound represented by Formula (41.2) is preferably 0.5% by mass or greater and less than 5% by mass, and preferably 0.5% by mass or greater and less than 2% by mass, in an embodiment. In addition, in an embodiment, the content is 0.5% by mass to 1% by mass.

<Regarding Composition in Case of Containing at Least Two Compounds Represented by General Formula (ii)>

In a case where the liquid crystal composition of the present invention contains at least one compound represented by General Formula (i) and at least two compounds represented by General Formula (ii), when the liquid crystal composition of the present invention contains the compound represented by the following Formula (11.2) as the compound represented by General Formula (ii), the content of the compound represented by Formula (11.2) is preferably 4% to 20% by mass, more preferably 6% to 19% by mass, still more preferably 8% to 17% by mass, and particularly preferably 9% to 15% by mass.

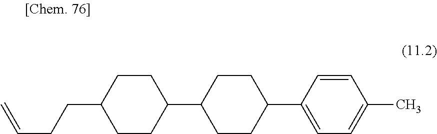

In a case where the liquid crystal composition of the present invention contains at least one compound represented by General Formula (i) and at least two compounds represented by General Formula (ii), when the liquid crystal composition of the present invention contains the compound represented by the following Formula (45.3) as the compound represented by General Formula (i), the content of the compound represented by Formula (45.3) is preferably 0.5% by mass or greater and less than 5% by mass, more preferably 1% by mass or greater and less than 5% by mass, and still more preferably 2% by mass or greater and less than 5% by mass.

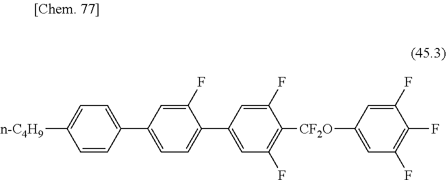

In a case where the liquid crystal composition of the present invention contains at least one compound represented by General Formula (i) and at least two compounds represented by General Formula (ii), when the liquid crystal composition of the present invention contains the compound represented by the following Formula (45.4) as the compound represented by General Formula (i), the content of Formula (45.4) is preferably 0.5% by mass or greater and less than 5% by mass, more preferably 1% by mass or greater and less than 5% by mass, and still more preferably 2% by mass or greater and less than 5% by mass.

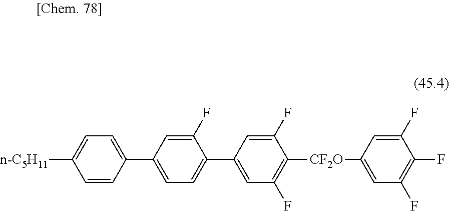

In a case where the liquid crystal composition of the present invention contains at least one compound represented by General Formula (i) and at least two compounds represented by General Formula (ii), the liquid crystal composition preferably further contains at least one of the compounds shown below.

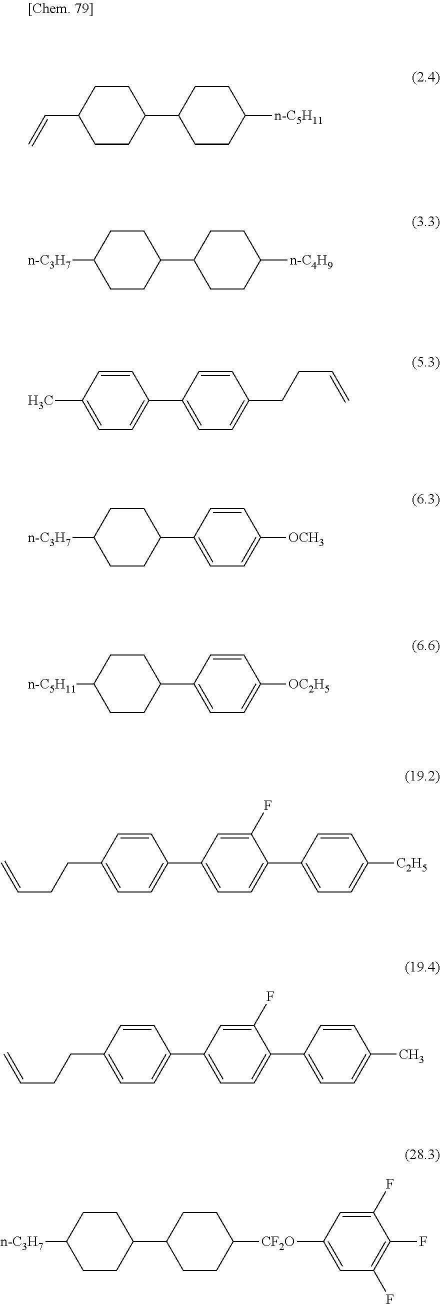

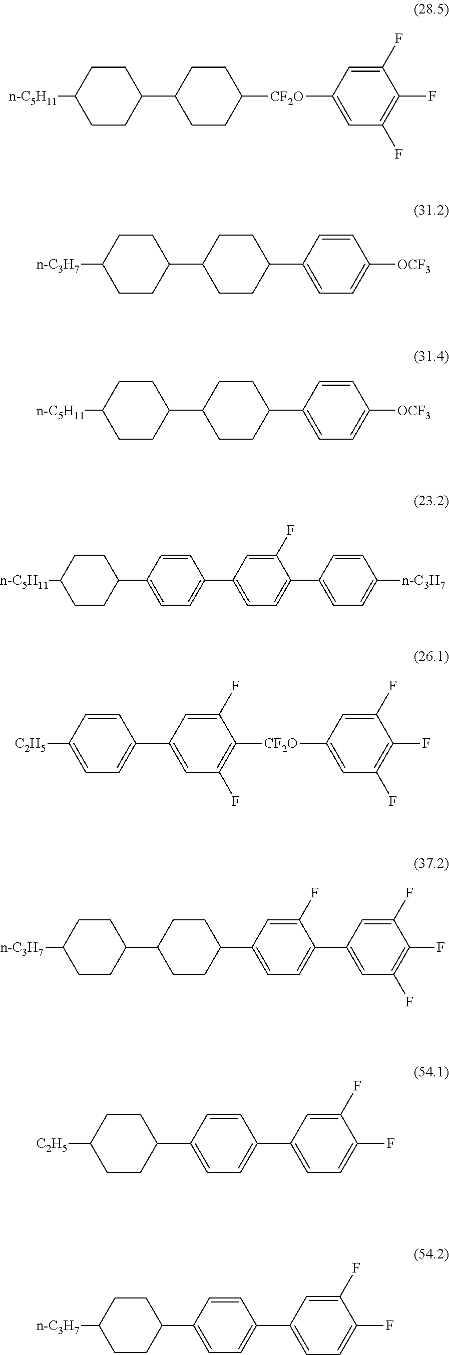

In a case where the liquid crystal composition of the present invention contains at least two compounds represented by General Formula (ii) and the compound represented by Formula (2.4), the content of the compound represented by Formula (2.4) is preferably 4% to 18% by mass, more preferably 7% to 15% by mass, and still more preferably 10% to 12% by mass, in 100% by mass of the liquid crystal composition of the present invention, in an embodiment.

In a case where the liquid crystal composition of the present invention contains at least two compounds represented by General Formula (ii) and the compound represented by Formula (3.3), the content of the compound represented by Formula (3.3) is preferably 0.5% to 10% by mass, more preferably 0.5% to 7% by mass, and still more preferably 2% to 4% by mass, in 100% by mass of the liquid crystal composition of the present invention, in an embodiment.

In a case where the liquid crystal composition of the present invention contains at least two compounds represented by General Formula (ii) and the compound represented by Formula (5.3), the content of the compound represented by Formula (5.3) is preferably 0.5% to 12% by mass, more preferably 1% to 9% by mass, and still more preferably 4% to 6% by mass, in 100% by mass of the liquid crystal composition of the present invention, in an embodiment.

In a case where the liquid crystal composition of the present invention contains at least two compounds represented by General Formula (ii) and the compound represented by Formula (6.3), the content of the compound represented by Formula (6.3) is preferably 4% to 18% by mass, more preferably 7% to 15% by mass, and still more preferably 10% to 12% by mass, in 100% by mass of the liquid crystal composition of the present invention, in an embodiment.

In a case where the liquid crystal composition of the present invention contains at least two compounds represented by General Formula (ii) and the compound represented by Formula (6.6), the content of the compound represented by Formula (6.6) is preferably 0.5% to 12% by mass, more preferably 1% to 9% by mass, and still more preferably 4% to 6% by mass, in 100% by mass of the liquid crystal composition of the present invention, in an embodiment.

In a case where the liquid crystal composition of the present invention contains at least two compounds represented by General Formula (ii) and the compound represented by Formula (19.2), the content of the compound represented by Formula (19.2) is preferably 0.5% to 7% by mass, more preferably 0.5% to 4% by mass, and still more preferably 1% by mass, in 100% by mass of the liquid crystal composition of the present invention, in an embodiment.

In a case where the liquid crystal composition of the present invention contains at least two compounds represented by General Formula (ii) and the compound represented by Formula (19.4), the content of the compound represented by Formula (19.4) is preferably 5% to 19% by mass, more preferably 8% to 16% by mass, and still more preferably 11% to 13% by mass, in 100% by mass of the liquid crystal composition of the present invention, in an embodiment.

In a case where the liquid crystal composition of the present invention contains at least two compounds represented by General Formula (ii) and the compound represented by Formula (28.3), the content of the compound represented by Formula (28.3) is preferably 0.5% to 13% by mass, more preferably 0.5% to 10% by mass, and still more preferably 2% to 7% by mass, in 100% by mass of the liquid crystal composition of the present invention, in an embodiment.

In a case where the liquid crystal composition of the present invention contains at least two compounds represented by General Formula (ii) and the compound represented by Formula (28.5), the content of the compound represented by Formula (28.5) is preferably 0.5% to 10% by mass, more preferably 0.5% to 7% by mass, and still more preferably 3% to 4% by mass, in 100% by mass of the liquid crystal composition of the present invention, in an embodiment.

In a case where the liquid crystal composition of the present invention contains at least two compounds represented by General Formula (ii) and the compound represented by Formula (31.2), the content of the compound represented by Formula (31.2) is preferably 0.5% to 14% by mass, more preferably 0.5% to 11% by mass, and still more preferably 3% to 8% by mass, in 100% by mass of the liquid crystal composition of the present invention, in an embodiment.

In a case where the liquid crystal composition of the present invention contains at least two compounds represented by General Formula (ii) and the compound represented by Formula (31.4), the content of the compound represented by Formula (31.4) is preferably 0.5% to 10% by mass, more preferably 0.5% to 7% by mass, and still more preferably 3% to 4% by mass, in 100% by mass of the liquid crystal composition of the present invention, in an embodiment.

In a case where the liquid crystal composition of the present invention contains at least two compounds represented by General Formula (ii) and the compound represented by Formula (23.2), the content of the compound represented by Formula (23.2) is preferably 0.5% to 12% by mass, more preferably 0.5% to 9% by mass, and still more preferably 3% to 6% by mass, in 100% by mass of the liquid crystal composition of the present invention, in an embodiment.

In a case where the liquid crystal composition of the present invention contains at least two compounds represented by General Formula (ii) and the compound represented by Formula (26.1), the content of the compound represented by Formula (26.1) is preferably 0.5% to 9% by mass, more preferably 0.5% to 6% by mass, and still more preferably 2% to 3% by mass, in 100% by mass of the liquid crystal composition of the present invention, in an embodiment.

In a case where the liquid crystal composition of the present invention contains at least two compounds represented by General Formula (ii) and the compound represented by Formula (37.2), the content of the compound represented by Formula (37.2) is preferably 0.5% to 13% by mass, more preferably 0.5% to 10% by mass, and still more preferably 1% to 7% by mass, in 100% by mass of the liquid crystal composition of the present invention, in an embodiment.

In a case where the liquid crystal composition of the present invention contains at least two compounds represented by General Formula (ii) and the compound represented by Formula (54.1), the content of the compound represented by Formula (54.1) is preferably 0.5% to 7% by mass, more preferably 0.5% to 4% by mass, and still more preferably 1% to 2% by mass, in 100% by mass of the liquid crystal composition of the present invention, in an embodiment.

In a case where the liquid crystal composition of the present invention contains at least two compounds represented by General Formula (ii) and the compound represented by Formula (54.2), the content of the compound represented by Formula (54.2) is preferably 8% to 22% by mass, more preferably 11% to 19% by mass, and still more preferably 14% to 16% by mass, in 100% by mass of the liquid crystal composition of the present invention, in an embodiment.

In the case of containing at least two compounds represented by General Formula (ii), the liquid crystal composition preferably further contains the following compound.

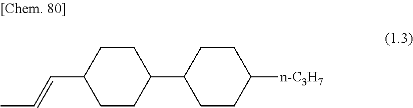

In the case of containing at least two compounds represented by General Formula (ii) and the compound represented by Formula (1.3), the content of the compound represented by Formula (1.3) is preferably 1% by mass to 15% by mass, preferably 1% by mass or greater and less than 10% by mass, preferably 1% to 9% by mass, and more preferably 1% to 8% by mass, in an embodiment. In addition, in an embodiment, the content is preferably 7% to 11% by mass.

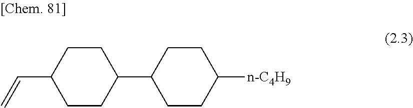

In the case of containing at least two compounds represented by General Formula (ii) and the compound represented by Formula (2.3), the content of the compound represented by Formula (2.3) is preferably 1% by mass or greater and less than 22% by mass, preferably 5% by mass to 20% by mass, preferably 8% by mass to 18% by mass, and preferably 10% by mass to 18% by mass.

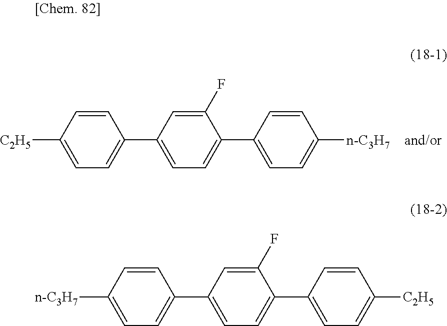

In the case of containing at least two compounds represented by General Formula (ii) and the compound represented by Formula (18.1) and/or Formula (18.2), the content of the compound represented by Formula (18.1) is preferably 0.5% by mass to 12% by mass, preferably 1% by mass or greater and less than 6% by mass, and more preferably 2% by mass to 4% by mass, in an embodiment. In addition, in an embodiment, the content is 3% by mass.

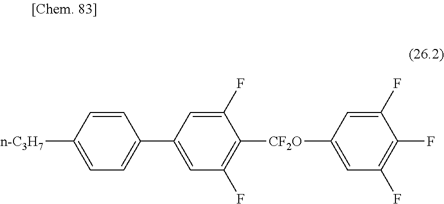

In the case of containing two compounds represented by General Formula (ii) and the compound represented by Formula (26.2), the content of the compound represented by Formula (26.2) is preferably 5% by mass to 20% by mass, preferably 8% by mass to 20% by mass, preferably 8% by mass to 18% by mass, and preferably 9% by mass to 16% by mass, in an embodiment. In addition, in an embodiment, the content is preferably 7% by mass to 15% by mass.

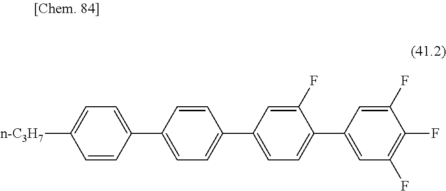

In the case of containing at least two compounds represented by General Formula (ii) and the compound represented by Formula (41.2), the content of the compound represented by Formula (41.2) is preferably 0.5% by mass or greater and less than 2% by mass, and preferably 0.5% by mass to 1% by mass, in an embodiment.

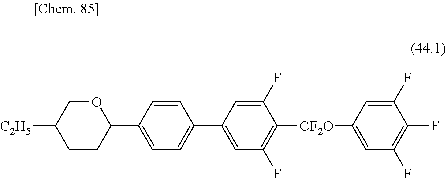

In the case of containing at least two compounds represented by General Formula (ii) and the compound represented by Formula (44.1), the content of the compound represented by Formula (44.1) is preferably 0.5% by mass or greater and less than 5% by mass, and preferably 2% by mass to 4% by mass, in an embodiment.

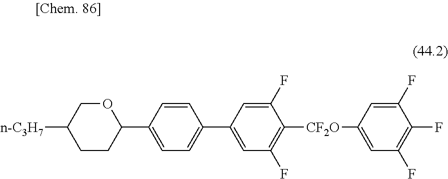

In the case of containing at least two compounds represented by General Formula (ii) and the compound represented by Formula (44.2), the content of the compound represented by Formula (44.2) is preferably 1% by mass or greater and less than 8% by mass, preferably 1% by mass to 7% by mass, preferably 3% by mass to 7% by mass, and preferably 3% by mass to 6% by mass, in an embodiment.

<Regarding Composition in Case of Containing at Least Two Compounds Represented by General Formula (i) and at Least Two Compounds Represented by General Formula (ii)>

In the case of containing at least two compounds represented by General Formula (i) and at least two compounds represented by General Formula (ii), when containing the compound represented by the following Formula (45.2) as the compound represented by General Formula (i), the content of the compound represented by Formula (45.2) is preferably 1% by mass to 4% by mass and more preferably 1% by mass to 3% by mass, in an embodiment. In addition, in an embodiment, the content is preferably 2% by mass.

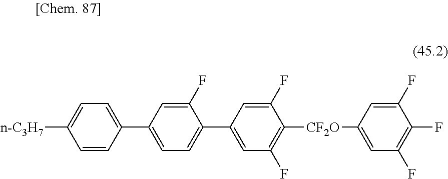

In the case of containing at least two compounds represented by General Formula (i) and at least two compounds represented by General Formula (ii), when containing the compound represented by the following Formula (45.3) as the compound represented by General Formula (i), the content of the compound represented by Formula (45.3) is preferably 1% to 5% by mass and more preferably 1% to 4% by mass, in an embodiment. In an embodiment, the content is preferably 2% to 5% by mass. In addition, in an embodiment, the content is preferably 2% by mass.

In the case of containing at least two compounds represented by General Formula (i) and at least two compounds represented by General Formula (ii), when containing the compound represented by the following Formula (45.4) as the compound represented by General Formula (i), the content of the compound represented by Formula (45.4) is preferably 1% to 4% by mass and more preferably 2% to 4% by mass, in an embodiment. In addition, in an embodiment, the content is preferably 3% by mass.

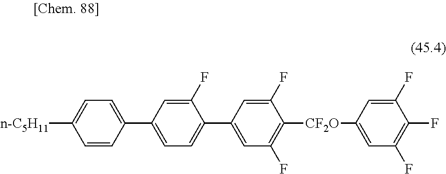

In the case of containing at least two compounds represented by General Formula (i) and at least two compounds represented by General Formula (ii), when containing the compound represented by the following Formula (11.1) as the compound represented by General Formula (ii), the content of the compound represented by Formula (11.1) is preferably 11% to 20% by mass, more preferably 13% to 20% by mass, and still more preferably 13% to 16% by mass, in an embodiment. In addition, in an embodiment, the content is preferably 13% to 15% by mass.

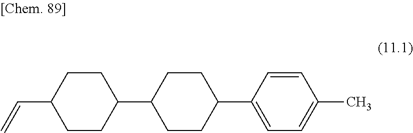

In the case of containing at least two compounds represented by General Formula (i) and at least two compounds represented by General Formula (ii), when containing the compound represented by the following Formula (11.2) as the compound represented by General Formula (ii), the content of the compound represented by Formula (11.2) is preferably 3% to 20% by mass, more preferably 5% to 20% by mass, and still more preferably 18% to 15% by mass, in an embodiment. In addition, in an embodiment, the content is preferably 4% to 11% by mass.

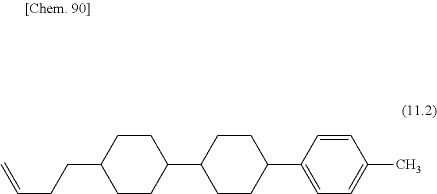

In the case of containing at least two compounds represented by General Formula (i) and at least two compounds represented by General Formula (ii), the liquid crystal composition preferably further contains the following compound.

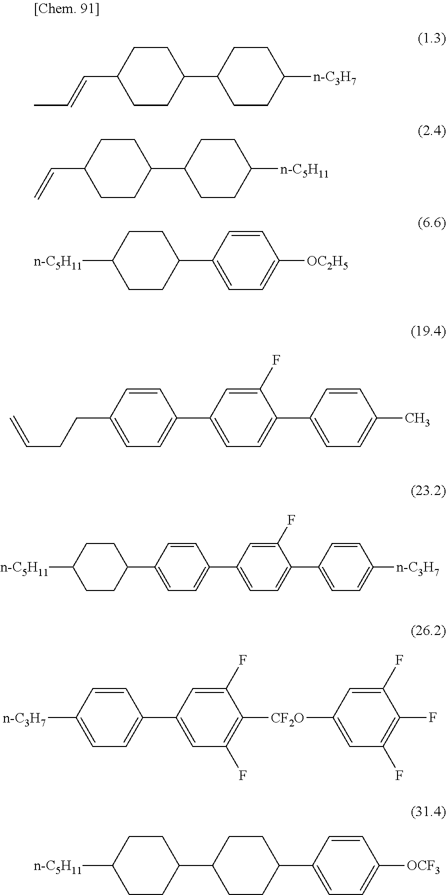

In the case of containing at least two compounds represented by General Formula (i), at least two compounds represented by General Formula (ii), and the compound represented by Formula (1.3), the content of the compound represented by Formula (1.3) is preferably 4% to 17% by mass, preferably 7% to 14% by mass, and preferably 10% to 11% by mass, in 100% by mass of the liquid crystal composition of the present invention, in an embodiment.

In the case of containing at least two compounds represented by General Formula (i), at least two compounds represented by General Formula (ii), and the compound represented by Formula (2.4), the content of the compound represented by Formula (2.4) is preferably 6% to 18% by mass, preferably 9% to 15% by mass, and preferably 12% by mass, in 100% by mass of the liquid crystal composition of the present invention, in an embodiment.

In the case of containing at least two compounds represented by General Formula (i), at least two compounds represented by General Formula (ii), and the compound represented by Formula (6.6), the content of the compound represented by Formula (6.6) is preferably 0.5% to 11% by mass, preferably 2% to 8% by mass, and preferably 5% by mass, in 100% by mass of the liquid crystal composition of the present invention, in an embodiment.

In the case of containing at least two compounds represented by General Formula (i), at least two compounds represented by General Formula (ii), and the compound represented by Formula (19.4), the content of the compound represented by Formula (19.4) is preferably 6% to 18% by mass, preferably 9% to 15% by mass, and preferably 12% by mass, in 100% by mass of the liquid crystal composition of the present invention, in an embodiment.

In the case of containing at least two compounds represented by General Formula (i), at least two compounds represented by General Formula (ii), and the compound represented by Formula (23.2), the content of the compound represented by Formula (23.2) is preferably 0.5% to 10% by mass, preferably 2% to 8% by mass, and preferably 5% by mass, in 100% by mass of the liquid crystal composition of the present invention, in an embodiment.

In the case of containing at least two compounds represented by General Formula (i), at least two compounds represented by General Formula (ii), and the compound represented by Formula (26.2), the content of the compound represented by Formula (26.2) is preferably 2% to 14% by mass, preferably 5% to 11% by mass, and preferably 8% by mass, in 100% by mass of the liquid crystal composition of the present invention, in an embodiment.

In the case of containing at least two compounds represented by General Formula (i), at least two compounds represented by General Formula (ii), and the compound represented by Formula (31.4), the content of the compound represented by Formula (31.4) is preferably 0.5% to 8% by mass, preferably 0.5% to 5% by mass, and preferably 2% by mass, in 100% by mass of the liquid crystal composition of the present invention, in an embodiment.

In the case of containing at least two compounds represented by General Formula (i) and at least two compounds represented by General Formula (ii), it is also preferable for the liquid crystal composition to further contain the following compound.

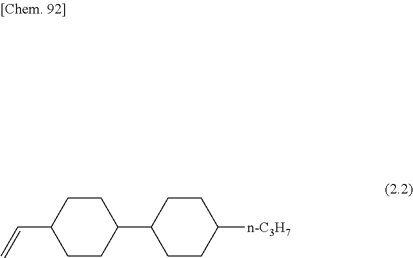

In the case of containing at least two compounds represented by General Formula (i), at least two compounds represented by General Formula (ii), and the compound represented by Formula (2.2), the content of the compound represented by Formula (2.2) is preferably 31% by mass to 50% by mass and preferably 35% by mass to 50% by mass, in an embodiment. In addition, in an embodiment, the content is 38% by mass.

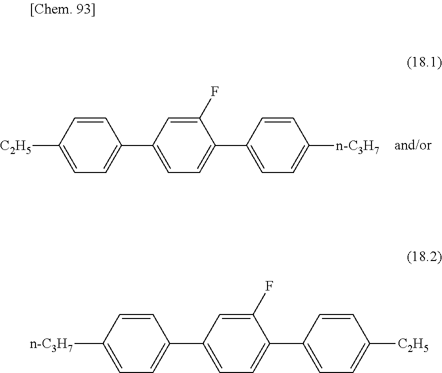

In the case of containing at least two compounds represented by General Formula (i), at least two compounds represented by General Formula (ii), and the compound represented by Formula (18.1) and/or the compound represented by Formula (18.2), the content of the compound represented by Formula (18.1) and/or the compound represented by Formula (18.2) is preferably 0.5% by mass to 10% by mass and preferably 0.5% by mass to 5% by mass, in an embodiment.

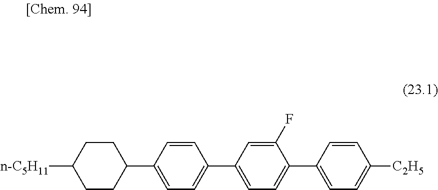

In the case of containing at least two compounds represented by General Formula (i), at least two compounds represented by General Formula (ii), and the compound represented by Formula (23.1), the content of the compound represented by Formula (23.1) is preferably 2% by mass to 10% by mass, preferably 3% by mass to 8% by mass, and preferably 4% by mass to 7% by mass, in an embodiment. In addition, in an embodiment, the content is 5% by mass.

<Regarding Other Preferable Composition>

In a composition containing at least one compound represented by General Formula (i), at least one compound represented by General Formula (ii), and the following General Formula (I-1-1), the total content of these compounds is preferably 15% to 50% by mass, more preferably 20% to 45% by mass, still more preferably 22% to 42% by mass, and particularly preferably 25% to 40% by mass, in an embodiment.

In a composition containing at least one compound represented by General Formula (i), at least one compound represented by General Formula (ii), and the compound represented by the following General Formula (I-1-2), the total content of these compounds is preferably 15% to 45% by mass, more preferably 15% to 25% by mass, and also more preferably 35% to 45% by mass, in an embodiment.

In a composition containing at least one compound represented by General Formula (i), at least one compound represented by General Formula (ii), and the compound represented by the following General Formula (I-4), the total content of these compounds is preferably 20% to 40% by mass, more preferably 20% to 28% by mass, and also more preferably 32% to 40% by mass, in an embodiment.

In a composition containing at least one compound represented by General Formula (i), at least one compound represented by General Formula (ii), and the compound represented by the following General Formula (I-5), the total content of these compounds is preferably 30% to 50% by mass and more preferably 35% to 45% by mass, in an embodiment.

In a composition containing at least one compound represented by General Formula (i), at least one compound represented by General Formula (ii), and the compound represented by the following General Formula (IV-1), the total content of these compounds is preferably 20% to 30% by mass and more preferably 22% to 26% by mass, in an embodiment.

In a composition containing at least one compound represented by General Formula (i), at least one compound represented by General Formula (ii), and the compound represented by the following General Formula (IV-2), the total content of these compounds is preferably 25% to 40% by mass and more preferably 30% to 35% by mass, in an embodiment.

In a composition containing at least one compound represented by General Formula (i), at least one compound represented by General Formula (ii), and the compound represented by the following General Formula (IX-1), the total content of these compounds is preferably 10% to 45% by mass, preferably 10% to 15% by mass, also preferably 25% to 45% by mass, and also more preferably 30% to 40% by mass, in an embodiment.

In a composition containing at least one compound represented by General Formula (i), at least one compound represented by General Formula (ii), and the compound represented by the following General Formula (IX-2-2), the total content of these compounds is preferably 25% to 45% by mass and preferably 30% to 40% by mass, in an embodiment.

In a composition containing at least one compound represented by General Formula (i), at least one compound represented by General Formula (ii), and the compound represented by the following General Formula (VIII-1), the total content of these compounds is preferably 15% to 40% by mass, more preferably 15% to 20% by mass, and also more preferably 30% to 40% by mass, in an embodiment.

In a composition containing at least one compound represented by General Formula (i), at least one compound represented by General Formula (ii), and the compound represented by the following General Formula (X-1-2), the total content of these compounds is preferably 15% to 40% by mass, more preferably 15% to 20% by mass, and also more preferably 30% to 40% by mass, in an embodiment.

In a composition containing at least one compound represented by General Formula (i), at least one compound represented by General Formula (ii), and the compound represented by the following General Formula (X-1-3), the total content of these compounds is preferably 10% to 20% by mass and more preferably 10% to 15% by mass, in an embodiment.

In a composition containing at least one compound represented by General Formula (i), at least one compound represented by General Formula (ii), and the compound represented by the following General Formula (X-2-1), the total content of these compounds is preferably 10% to 25% by mass and more preferably 15% to 25% by mass, in an embodiment.

In a composition containing at least one compound represented by General Formula (i), at least one compound represented by General Formula (ii), and the compound represented by the following General Formula (X-3-1), the total content of these compounds is preferably 10% to 35% by mass and more preferably 15% to 35% by mass, in an embodiment.

In a composition containing at least one compound represented by General Formula (i), at least one compound represented by General Formula (ii), and the compound represented by the following General Formula (XIV-2-2), the total content of these compounds is preferably 40% to 50% by mass in an embodiment.

In a composition containing at least one compound represented by General Formula (i), at least one compound represented by General Formula (ii), the compound represented by the following General Formula (I-1-1), and the compound represented by the following General Formula (IX-1), the total content of these compounds is preferably 22% to 55% by mass, preferably 25% to 52% by mass, and preferably 28% to 49% by mass, in an embodiment.

In a composition containing at least one compound represented by General Formula (i), at least one compound represented by General Formula (ii), the compound represented by the following General Formula (I-1-1), and the compound represented by the following General Formula (X-1-2), the total content of these compounds is preferably 34% to 52% by mass, preferably 37% to 49% by mass, and preferably 40% to 46% by mass, in an embodiment.

In a composition containing at least one compound represented by General Formula (i), at least one compound represented by General Formula (ii), the compound represented by the following General Formula (I-1-1), and the compound represented by the following General Formula (X-2-1), the total content of these compounds is preferably 26% to 38% by mass, preferably 29% to 35% by mass, and preferably 32% by mass, in an embodiment.

In a composition containing at least one compound represented by General Formula (i), at least one compound represented by General Formula (ii), the compound represented by the following General Formula (I-1-1), and the compound represented by the following General Formula (X-3-1), the total content of these compounds is preferably 29% to 46% by mass, preferably 32% to 43% by mass, and preferably 35% to 40% by mass, in an embodiment.

In a composition containing at least one compound represented by General Formula (i), at least one compound represented by General Formula (ii), the compound represented by the following General Formula (I-1-1), and the compound represented by the following General Formula (I-1-2), the total content of these compounds is preferably 43% to 55% by mass, preferably 46% to 52% by mass, and preferably 49% by mass, in an embodiment.

In a composition containing at least one compound represented by General Formula (i), at least one compound represented by General Formula (ii), the compound represented by the following General Formula (I-1-1), and the compound represented by the following General Formula (I-4), the total content of these compounds is preferably 32% to 50% by mass, preferably 35% to 47% by mass, and preferably 38% to 44% by mass, in an embodiment.

In a composition containing at least one compound represented by General Formula (i), at least one compound represented by General Formula (ii), the compound represented by the following General Formula (I-1-1), and the compound represented by the following General Formula (IV-1), the total content of these compounds is preferably 28% to 42% by mass, preferably 31% to 39% by mass, and preferably 33% to 36% by mass, in an embodiment.

In a composition containing at least one compound represented by General Formula (i), at least one compound represented by General Formula (ii), the compound represented by the following General Formula (I-1-1), and the compound represented by the following General Formula (VIII-1), the total content of these compounds is preferably 26% to 50% by mass, preferably 29% to 47% by mass, and preferably 32% to 44% by mass, in an embodiment.

In a composition containing at least one compound represented by General Formula (i), at least one compound represented by General Formula (ii), the compound represented by the following General Formula (I-1-1), and the compound represented by the following General Formula (I-5), the total content of these compounds is preferably 44% to 56% by mass, preferably 47% to 53% by mass, and preferably 50% by mass, in an embodiment.

In a composition containing at least one compound represented by General Formula (i), at least one compound represented by General Formula (ii), the compound represented by the following General Formula (I-1-1), and the compound represented by the following General Formula (IV-2), the total content of these compounds is preferably 34% to 46% by mass, preferably 37% to 43% by mass, and preferably 40% by mass, in an embodiment.

In a composition containing at least one compound represented by General Formula (i), at least one compound represented by General Formula (ii), the compound represented by the following General Formula (I-1-1), and the compound represented by the following General Formula (IX-2-2), the total content of these compounds is preferably 36% to 48% by mass, preferably 39% to 45% by mass, and preferably 42% by mass, in an embodiment.

In a composition containing at least one compound represented by General Formula (i), at least one compound represented by General Formula (ii), the compound represented by the following General Formula (I-1-1), and the compound represented by the following General Formula (X-1-3), the total content of these compounds is preferably 25% to 37% by mass, preferably 28% to 34% by mass, and preferably 31% by mass, in an embodiment.

In a composition containing at least one compound represented by General Formula (i), at least one compound represented by General Formula (ii), the compound represented by the following General Formula (I-1-1), and the compound represented by the following General Formula (XIV-2-2), the total content of these compounds is preferably 46% to 58% by mass, preferably 49% to 55% by mass, and preferably 52% by mass, in an embodiment.

In a composition containing at least one compound represented by General Formula (i), at least one compound represented by General Formula (ii), the compound represented by the following General Formula (IX-1), and the compound represented by the following General Formula (X-1-2), the total content of these compounds is preferably 26% to 38% by mass, preferably 29% to 35% by mass, and preferably 32% by mass, in an embodiment.

In a composition containing at least one compound represented by General Formula (i), at least one compound represented by General Formula (ii), the compound represented by the following General Formula (IX-1), and the compound represented by the following General Formula (X-2-1), the total content of these compounds is preferably 11% to 42% by mass, preferably 14% to 39% by mass, and preferably 17% to 36% by mass, in an embodiment.

In a composition containing at least one compound represented by General Formula (i), at least one compound represented by General Formula (ii), the compound represented by the following General Formula (IX-1), and the compound represented by the following General Formula (X-3-1), the total content of these compounds is preferably 24% to 38% by mass, preferably 27% to 35% by mass, and preferably 30% to 32% by mass, in an embodiment.

In a composition containing at least one compound represented by General Formula (i), at least one compound represented by General Formula (ii), the compound represented by the following General Formula (IX-1), and the compound represented by the following General Formula (VIII-1), the total content of these compounds is preferably 36% to 48% by mass, preferably 39% to 45% by mass, and preferably 42% by mass, in an embodiment.

In a composition containing at least one compound represented by General Formula (i), at least one compound represented by General Formula (ii), the compound represented by the following General Formula (IX-1), and the compound represented by the following General Formula (XIV-2-2), the total content of these compounds is preferably 43% to 55% by mass, preferably 46% to 52% by mass, and preferably 49% by mass, in an embodiment.

In a composition containing at least one compound represented by General Formula (i), at least one compound represented by General Formula (ii), the compound represented by the following General Formula (I-1-1), the compound represented by the following General Formula (X-1-2), the compound represented by the following General Formula (X-3-1), the compound represented by the following General Formula (I-1-2), the compound represented by the following General Formula (I-5), the compound represented by the following General Formula (IV-2), and the compound represented by the following General Formula (IX-2-2), the total content of these compounds is preferably 66% to 78% by mass, preferably 69% to 75% by mass, and preferably 72% by mass, in an embodiment.

In a composition containing at least one compound represented by General Formula (i), at least one compound represented by General Formula (ii), the compound represented by the following General Formula (I-1-1), the compound represented by the following General Formula (IX-1), and the compound represented by the following General Formula (VIII-1), the total content of these compounds is preferably 45% to 57% by mass, preferably 48% to 54% by mass, and preferably 51% by mass, in an embodiment.

In a composition containing at least one compound represented by General Formula (i), at least one compound represented by General Formula (ii), the compound represented by the following General Formula (I-1-1), the compound represented by the following General Formula (X-1-2), and the compound represented by the following General Formula (I-4), the total content of these compounds is preferably 39% to 51% by mass, preferably 42% to 48% by mass, and preferably 45% by mass, in an embodiment.

In a composition containing at least one compound represented by General Formula (i), at least one compound represented by General Formula (ii), the compound represented by the following General Formula (I-1-1), the compound represented by the following General Formula (IX-1), the compound represented by the following General Formula (X-3-1), and the compound represented by the following General Formula (XIV-2-2), the total content of these compounds is preferably 50% to 62% by mass, preferably 53% to 59% by mass, and preferably 56% by mass, in an embodiment.

In a composition containing at least one compound represented by General Formula (i), at least one compound represented by General Formula (ii), the compound represented by the following General Formula (IX-1), the compound represented by the following General Formula (X-1-2), the compound represented by the following General Formula (X-2-1), the compound represented by the following General Formula (X-3-1), and the compound represented by the following General Formula (I-1-2), the total content of these compounds is preferably 39% to 51% by mass, preferably 42% to 48% by mass, and preferably 45% by mass, in an embodiment.

In a composition containing at least one compound represented by General Formula (i), at least one compound represented by General Formula (ii), the compound represented by the following General Formula (I-1-1), the compound represented by the following General Formula (X-2-1), the compound represented by the following General Formula (I-4), the compound represented by the following General Formula (IV-1), and the compound represented by the following General Formula (VIII-1), the total content of these compounds is preferably 53% to 64% by mass, preferably 56% to 61% by mass, and preferably 59% by mass, in an embodiment.

In a composition containing at least one compound represented by General Formula (i), at least one compound represented by General Formula (ii), the compound represented by the following General Formula (I-1-1), the compound represented by the following General Formula (IX-1), the compound represented by the following General Formula (X-2-1), and the compound represented by the following General Formula (X-1-3), the total content of these compounds is preferably 40% to 52% by mass, preferably 43% to 49% by mass, and preferably 46% by mass, in an embodiment.

In a composition containing at least two compounds represented by General Formula (i) and at least one compound represented by General Formula (ii), the total content of the two compounds represented by General Formula (i) and the compound represented by General Formula (ii) is preferably 15% to 37% by mass, preferably 18% to 34% by mass, and preferably 21% to 31% by mass, in an embodiment.

In a composition containing at least two compounds represented by General Formula (i), at least one compound represented by General Formula (ii), the compound represented by the following General Formula (I-1-1), the compound represented by the following General Formula (I-1-2), the compound represented by the following General Formula (IX-2-2), and the compound represented by the following General Formula (X-6), the total content of these compounds is preferably 78% to 100% by mass, preferably 81% to 98% by mass, and preferably 84% to 95% by mass, in an embodiment.

In a composition containing at least two compounds represented by General Formula (i), at least one compound represented by General Formula (ii), the compound represented by the following General Formula (I-1-1), the compound represented by the following General Formula (I-1-2), the compound represented by the following General Formula (Ix-2-2), the compound represented by the following General Formula (x-6), the compound represented by the following General Formula (IV-2), and the compound represented by the following General Formula (XI-1), the total content of these compounds is preferably 92% to 100% by mass, preferably 95% to 100% by mass, and preferably 98% to 100% by mass, in an embodiment.

In a composition containing at least two compounds represented by General Formula (i), at least one compound represented by General Formula (ii), the compound represented by the following General Formula (I-1-1), the compound represented by the following General Formula (I-1-2), the compound represented by the following General Formula (Ix-2-2), the compound represented by the following General Formula (x-6), the compound represented by the following General Formula (VIII-1), the compound represented by the following General Formula (X-1-2), and the compound represented by the following General Formula (XI-1), the total content of these compounds is preferably 91% to 100% by mass, preferably 94% to 100% by mass, and preferably 97% to 100% by mass, in an embodiment.

In a composition containing at least two compounds represented by General Formula (i), at least one compound represented by General Formula (ii), the compound represented by the following General Formula (I-1-1), the compound represented by the following General Formula (I-1-2), the compound represented by the following General Formula (Ix-2-2), the compound represented by the following General Formula (x-6), the compound represented by the following General Formula (IV-2), and the compound represented by the following General Formula (VIII-1), the total content of these compounds is preferably 92% to 100% by mass, preferably 95% to 100% by mass, and preferably 98% to 100% by mass, in an embodiment.

In a composition containing at least three compounds represented by General Formula (i) and at least one compound represented by General Formula (ii), the total content of these compounds is preferably 13% to 42% by mass, preferably 16% to 39% by mass, and preferably 19% to 36% by mass, in an embodiment.

In a composition containing at least three compounds represented by General Formula (i), at least one compound represented by General Formula (ii), the compound represented by the following General Formula (VIII-1), the compound represented by the following General Formula (I-1-1), and the compound represented by the following General Formula (I-1-2), the total content of these compounds is preferably 65% to 90% by mass, preferably 68% to 93% by mass, and preferably 71% to 90% by mass, in an embodiment.

In a composition containing at least three compounds represented by General Formula (i), at least one compound represented by General Formula (ii), the compound represented by the following General Formula (VIII-1), the compound represented by the following General Formula (I-1-1), the compound represented by the following General Formula (I-1-2), and the compound represented by the following General Formula (XI-1), the total content of these compounds is preferably 82% to 100% by mass, preferably 85% to 100% by mass, and preferably 88% to 100% by mass, in an embodiment.

In a composition containing at least three compounds represented by General Formula (i), at least one compound represented by General Formula (ii), the compound represented by the following General Formula (VIII-1), the compound represented by the following General Formula (I-1-1), the compound represented by the following General Formula (I-1-2), the compound represented by the following General Formula (I-5), the compound represented by the following General Formula (IV-1), and the compound represented by the following General Formula (V-2-1), the total content of these compounds is preferably 92% to 100% by mass, preferably 95% to 100% by mass, and preferably 98% to 100% by mass, in an embodiment.

In a composition containing at least three compounds represented by General Formula (i), at least one compound represented by General Formula (ii), the compound represented by the following General Formula (VIII-1), the compound represented by the following General Formula (I-1-1), the compound represented by the following General Formula (I-1-2), the compound represented by the following General Formula (XI-1), and the compound represented by the following General Formula (I-7), the total content of these compounds is preferably 83% to 94% by mass, preferably 86% to 91% by mass, and preferably 89% by mass, in an embodiment.

In a composition containing at least three compounds represented by General Formula (i), at least one compound represented by General Formula (ii), the compound represented by the following General Formula (VIII-1), the compound represented by the following General Formula (I-1-1), the compound represented by the following General Formula (I-1-2), the compound represented by the following General Formula (IX-2-2), and the compound represented by the following General Formula (X-6), the total content of these compounds is preferably 86% to 98% by mass, preferably 89% to 95% by mass, and preferably 92% by mass, in an embodiment.

In a composition containing at least one compound represented by General Formula (i) and at least one compound represented by General Formula (ii), the total content of these compounds is preferably 3% to 40% by mass, preferably 6% to 37% by mass, and preferably 9% to 34% by mass, in an embodiment.

In a composition containing at least one compound represented by General Formula (i), at least one compound represented by General Formula (ii), and the compound represented by the following General Formula (I-1-1), the total content of these compounds is preferably 16% to 56% by mass, preferably 19% to 53% by mass, and preferably 22% to 48% by mass, in an embodiment.

In a composition containing at least one compound represented by General Formula (i), at least one compound represented by General Formula (ii), the compound represented by the following General Formula (I-1-1), and the compound represented by the following General Formula (IX-1), the total content of these compounds is preferably 22% to 70% by mass, preferably 25% to 67% by mass, and preferably 28% to 64% by mass, in an embodiment.

In a composition containing at least one compound represented by General Formula (i), at least one compound represented by General Formula (ii), the compound represented by the following General Formula (I-1-2), the compound represented by the following General Formula (IX-1), the compound represented by the following General Formula (X-1-2), the compound represented by the following General Formula (X-2-1), and the compound represented by the following General Formula (X-3-1), the total content of these compounds is preferably 39% to 51% by mass, preferably 42% to 48% by mass, and preferably 45% by mass, in an embodiment.

In a composition containing at least one compound represented by General Formula (i), at least one compound represented by General Formula (ii), the compound represented by the following General Formula (I-1-1), the compound represented by the following General Formula (IX-1), and the compound represented by the following General Formula (I-7), the total content of these compounds is preferably 44% to 56% by mass, preferably 47% to 53% by mass, and preferably 50% by mass, in an embodiment.

In a composition containing at least one compound represented by General Formula (i), at least one compound represented by General Formula (ii), the compound represented by the following General Formula (I-1-1), and the compound represented by the following General Formula (IX-2-2), the total content of these compounds is preferably 36% to 48% by mass, preferably 39% to 45% by mass, and preferably 42% by mass, in an embodiment.

In a composition containing at least one compound represented by General Formula (i), at least one compound represented by General Formula (ii), the compound represented by the following General Formula (I-1-1), the compound represented by the following General Formula (IX-1), the compound represented by the following General Formula (IX-2-2), and the compound represented by the following General Formula (X-1-2), the total content of these compounds is preferably 51% to 63% by mass, preferably 54% to 60% by mass, and preferably 57% by mass, in an embodiment.

In a composition containing at least one compound represented by General Formula (i), at least one compound represented by General Formula (ii), the compound represented by the following General Formula (I-1-1), the compound represented by the following General Formula (IV-2), and the compound represented by the following General Formula (IX-2-2), the total content of these compounds is preferably 46% to 58% by mass, preferably 49% to 55% by mass, and preferably 52% by mass, in an embodiment.

In a composition containing at least one compound represented by General Formula (i), at least one compound represented by General Formula (ii), the compound represented by the following General Formula (I-1-1), and the compound represented by the following General Formula (IV-1), the total content of these compounds is preferably 27% to 39% by mass, preferably 30% to 36% by mass, and preferably 33% by mass, in an embodiment.

In a composition containing at least one compound represented by General Formula (i), at least one compound represented by General Formula (ii), the compound represented by the following General Formula (I-1-1), the compound represented by the following General Formula (I-4), the compound represented by the following General Formula (IV-1), the compound represented by the following General Formula (VIII-1), and the compound represented by the following General Formula (X-2-1), the total content of these compounds is preferably 53% to 65% by mass, preferably 56% to 62% by mass, and preferably 59% by mass, in an embodiment.

In a composition containing at least one compound represented by General Formula (i), at least one compound represented by General Formula (ii), the compound represented by the following General Formula (I-1-1), the compound represented by the following General Formula (IX-1), the compound represented by the following General Formula (Ix-2-2), the compound represented by the following General Formula (x-1-3), and the compound represented by the following General Formula (X-2-1), the total content of these compounds is preferably 40% to 52% by mass, preferably 43% to 49% by mass, and preferably 46% by mass, in an embodiment.

In a composition containing at least one compound represented by General Formula (i) and at least two compounds represented by General Formula (ii), the total content of these compounds is preferably 15% to 42% by mass, preferably 18% to 39% by mass, and preferably 21% to 36% by mass, in an embodiment.

In a composition containing at least one compound represented by General Formula (i), at least two compounds represented by General Formula (ii), and the compound represented by the following General Formula (I-1-1), the total content of these compounds is preferably 25% to 52% by mass, preferably 28% to 49% by mass, and preferably 31% to 46% by mass, in an embodiment.

In a composition containing at least one compound represented by General Formula (i), at least two compounds represented by General Formula (ii), the compound represented by the following General Formula (I-1-1), and the compound represented by the following General Formula (VIII-1), the total content of these compounds is preferably 40% to 62% by mass, preferably 43% to 59% by mass, and preferably 46% to 56% by mass, in an embodiment.

In a composition containing at least one compound represented by General Formula (i), at least two compounds represented by General Formula (ii), the compound represented by the following General Formula (I-1-1), and the compound represented by the following General Formula (X-6), the total content of these compounds is preferably 33% to 57% by mass, preferably 36% to 54% by mass, and preferably 39% to 51% by mass, in an embodiment.

In a composition containing at least one compound represented by General Formula (i), at least two compounds represented by General Formula (ii), the compound represented by the following General Formula (I-1-1), the compound represented by the following General Formula (VIII-1), and the compound represented by the following General Formula (X-6), the total content of these compounds is preferably 46% to 71% by mass, preferably 49% to 68% by mass, and preferably 52% to 65% by mass, in an embodiment.

In a composition containing at least one compound represented by General Formula (i), at least two compounds represented by General Formula (ii), the compound represented by the following General Formula (I-1-1), the compound represented by the following General Formula (VIII-1), the compound represented by the following General Formula (I-1-2), the compound represented by the following General Formula (I-5), the compound represented by the following General Formula (IV-1), and the compound represented by the following General Formula (V-2-1), the total content of these compounds is preferably 89% to 100% by mass, preferably 92% to 98% by mass, and preferably 95% by mass, in an embodiment.

In a composition containing at least one compound represented by General Formula (i), at least two compounds represented by General Formula (ii), the compound represented by the following General Formula (I-1-1), the compound represented by the following General Formula (X-6), the compound represented by the following General Formula (IV-2), the compound represented by the following General Formula (IX-1), and the compound represented by the following General Formula (IX-2-2), the total content of these compounds is preferably 56% to 68% by mass, preferably 59% to 65% by mass, and preferably 62% by mass, in an embodiment.

In a composition containing at least one compound represented by General Formula (i), at least two compounds represented by General Formula (ii), the compound represented by the following General Formula (I-1-1), the compound represented by the following General Formula (VIII-1), the compound represented by the following General Formula (I-1-2), the compound represented by the following General Formula (I-2), the compound represented by the following General Formula (I-5), the compound represented by the following General Formula (IV-2), the compound represented by the following General Formula (IX-2-2), the compound represented by the following General Formula (X-1-2), the compound represented by the following General Formula (X-3-1), and the compound represented by the following General Formula (X-6), the total content of these compounds is preferably 90% to 100% by mass, preferably 93% to 100% by mass, and preferably 96% to 100% by mass, in an embodiment.

In a composition containing at least one compound represented by General Formula (i), at least two compounds represented by General Formula (ii), the compound represented by the following General Formula (I-1-1), the compound represented by the following General Formula (VIII-1), the compound represented by the following General Formula (I-1-2), the compound represented by the following General Formula (I-4), the compound represented by the following General Formula (V-2-1), the compound represented by the following General Formula (X-1-2), and the compound represented by the following General Formula (X-6), the total content of these compounds is preferably 83% to 95% by mass, preferably 86% to 92% by mass, and preferably 89% by mass, in an embodiment.

In a composition containing at least one compound represented by General Formula (i), at least two compounds represented by General Formula (ii), the compound represented by the following General Formula (I-1-1), the compound represented by the following General Formula (VIII-1), the compound represented by the following General Formula (IX-1), the compound represented by the following General Formula (X-3-1), the compound represented by the following General Formula (x-6), and the compound represented by the following General Formula (XIV-2-2), the total content of these compounds is preferably 60% to 90% by mass, preferably 70% to 80% by mass, and preferably 73% to 77% by mass, in an embodiment.

In a composition containing at least two compounds represented by General Formula (i) and at least two compounds represented by General Formula (ii), the total content of these compounds is preferably 16% to 42% by mass, preferably 19% to 39% by mass, and preferably 21% to 36% by mass, in an embodiment.

In a composition containing at least two compounds represented by General Formula (i), at least two compounds represented by General Formula (ii), and the compound represented by the following General Formula (I-1-2), the total content of these compounds is preferably 42% to 65% by mass, preferably 45% to 62% by mass, and preferably 48% to 59% by mass, in an embodiment.

In a composition containing at least two compounds represented by General Formula (i), at least two compounds represented by General Formula (ii), the compound represented by the following General Formula (I-1-2), the compound represented by the following General Formula (IV-2), and the compound represented by the following General Formula (IX-2-2), the total content of these compounds is preferably 67% to 79% bymass, preferably 70% to 76% bymass, and preferably 73% by mass, in an embodiment.

In a composition containing at least three compounds represented by General Formula (i), at least two compounds represented by General Formula (ii), the compound represented by the following General Formula (I-1-2), the compound represented by the following General Formula (I-5), the compound represented by the following General Formula (IV-1), the compound represented by the following General Formula (V-2-1), and the compound represented by the following General Formula (VIII-1), the total content of these compounds is preferably 68% to 80% by mass, preferably 71% to 77% by mass, and preferably 74% by mass, in an embodiment.

The liquid crystal composition of the present invention can further contain at least one compound represented by General Formula (L).

[Chem. 95]

R^{L1}—B^{L1}-L^{L1}-B^{L2}-(L^{L2}-B^{L3})_{OL}—R^{L2} (L)

In General Formula (L), each of R^{L1} and R^{L2} independently represents an alkyl group having 1 to 8 carbon atoms, and each of one —CH₂— group or at least two non-adjacent —CH₂— groups in the alkyl group may be independently substituted with —CH═CH—, —C≡C—, —O—, —CO—, —COO—, or —OCO—.

OL represents 0, 1, 2, or 3.

Each of B^{L1}, B^{L2}, and B^{L3} independently represents a group selected from the group consisting of

(a) a 1,4-cyclohexylene group (one —CH₂— group or at least two non-adjacent —CH₂— groups present in the group may be substituted with —O—) and

(b) a 1,4-phenylene group (one —CH═ group or at least two non-adjacent —CH═ groups present in the group may be substituted with —N═). At least one hydrogen atom in the group (a) or (b) may be independently substituted with a cyano group, a fluorine atom, or a chlorine atom.

Each of L^{L1} and L^{L2} independently represents a single bond, —CH₂CH₂—, (CH₂)₄—, —OCH₂—, —CH₂O—, —COO—, —OCO—, —OCF₂—, —CF₂O—, CH═N—N═CH, —CH═CH—, —CF═CF—, or —C≡C—.

In a case where OL is 2 or 3, and thus, a plurality of L^{L2}'s are present, L^{L2}'s may be the same as or different from each other.

In a case where OL is 2 or 3, and thus, a plurality of B^{L3}'s are present, B^{L3}'s may be the same as or different from each other.

Here, the compound represented by Formula (ii) is excluded.

The types of compound capable of being combined are not particularly limited, and a compound is suitably combined and used depending on the desired performance such as solubility at a low temperature, a transition temperature, electrical reliability, and birefringence (refractive index anisotropy). The type of compound used, for example, is one type in an embodiment of the present invention. In another embodiment of the present invention, two types are used. Instill another embodiment of the present invention, three types are used. In still another embodiment of the present invention, four types are used. In still another embodiment of the present invention, five types are used. In still another embodiment of the present invention, six types are used. Instill another embodiment of the present invention, seven types are used. In still another embodiment of the present invention, eight types are used. In still another embodiment of the present invention, nine types are used. Furthermore, in still another embodiment of the present invention, ten or more types are used.

In the liquid crystal composition of the present invention, the content of the compound represented by General Formula (L) needs to be suitably adjusted depending on the required performance such as solubility at a low temperature, a transition temperature, electrical reliability, birefringence, process compatibility, dropping marks, burn-in, and dielectric anisotropy.

The content of the compound is 1% by mass to 95% by mass with respect to the total mass of the liquid crystal composition of the present invention, for example, in an embodiment of the present invention. In another embodiment of the present invention, the content is 10% to 95% by mass. In still another embodiment of the present invention, the content is 20% to 95% by mass. In still another embodiment of the present invention, the content is 30% to 95% by mass. In still another embodiment of the present invention, the content is 40% to 95% by mass. In still another embodiment of the present invention, the content is 50% to 95% by mass. In still another embodiment of the present invention, the content is 55% to 95% by mass. In still another embodiment of the present invention, the content is 60% to 95% by mass. In still another embodiment of the present invention, the content is 65% to 95% by mass. In still another embodiment of the present invention, the content is 70% to 95% by mass. In still another embodiment of the present invention, the content is 75% to 95% by mass. Furthermore, in still another embodiment of the present invention, the content is 80% to 95% by mass.

The content of the compound is 1% to 95% by mass with respect to the total mass of the liquid crystal composition of the present invention, for example, in an embodiment of the present invention. In another embodiment of the present invention, the content is 1% to 85% by mass. In still another embodiment of the present invention, the content is 1% to 75% by mass. Instill another embodiment of the present invention, the content is 1% to 65% by mass. In still another embodiment of the present invention, the content is 1% to 55% by mass. In still another embodiment of the present invention, the content is 1% to 45% by mass. In still another embodiment of the present invention, the content is 1% to 35% by mass. Furthermore, in still another embodiment of the present invention, the content is 1% to 25% by mass.

In a case where it is required that the viscosity of the liquid crystal composition of the present invention be kept low and the liquid crystal composition have a high response speed, it is preferable that the above-described lower limit value is large and the above-described upper limit value is large. In a case where it is required that Tni of the liquid crystal composition of the present invention be kept high and the liquid crystal composition have good temperature stability, it is preferable that the above-described lower limit value is large and the above-described upper limit value is large. In addition, when it is desired to increase the dielectric anisotropy in order to keep the driving voltage low, it is preferable that the above-described lower limit value is small and the above-described upper limit value is small.

In a case where the ring structure to which R^{L1} or R^{L2} is bonded is a phenyl group (aromatic group), each of R^{L1} and R^{L2} is preferably a linear alkyl group having 1 to 5 carbon atoms, a linear alkoxy group having 1 to 4 carbon atoms (or more), or an alkenyl group having 4 or 5 carbon atoms, and in a case where the ring structure to which R^{L1} or R^{L2} is bonded is a saturated ring structure such as cyclohexane, pyran, or dioxane, each of R^{L1} and R^{L2} is preferably a linear alkyl group having 1 to 5 carbon atoms, a linear alkoxy group having 1 to 4 carbon atoms (or more), or a linear alkenyl group having 2 to 5 carbon atoms.

In a case where chemical stability of the liquid crystal composition is required, the compound represented by General Formula (L) is preferably has no chlorine atom in the molecule.

The compound represented by General Formula (L), for example, is preferably a compound selected from the compound group represented by General Formula (I).

[Chem. 96]

R¹¹—A¹¹—A¹²—R¹² (I)

In General Formula (I), each of R¹¹ and R¹² independently represents an alkyl group having 1 to 5 carbon atoms, an alkoxy group having 1 to 5 carbon atoms, or an alkenyl group having 2 to 5 carbon atoms, and each of A¹¹ and A¹² independently represents a 1,4-cyclohexylene group, a 1,4-phenylene group, a 2-fluoro-1,4-phenylene group, or a 3-fluoro-1,4-phenylene group. Provided that, the compound represented by Formula (ii) is excluded.

The types of compound capable of being combined are not particularly limited, and a compound is suitably combined and used depending on the required performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three types are used. In still another embodiment of the present invention, four types are used. In still another embodiment of the present invention, five types are used. Furthermore, in still another embodiment of the present invention, six or more types are used.

In the liquid crystal composition of the present invention, the content of the compound represented by General Formula (I) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I) is 3% to 75% by mass with respect to the total mass of the liquid crystal composition of the present invention, for example, in an embodiment of the present invention. In another embodiment of the present invention, the content is 15% to 75% by mass. In still another embodiment of the present invention, the content is 18% to 75% by mass. In still another embodiment of the present invention, the content is 20% to 75% by mass. In still another embodiment of the present invention, the content is 29% to 75% bymass. In still another embodiment of the present invention, the content is 35% to 75% by mass. In still another embodiment of the present invention, the content is 42% to 75% by mass. In still another embodiment of the present invention, the content is 47% to 75% by mass. In still another embodiment of the present invention, the content is 53% to 75% by mass. In still another embodiment of the present invention, the content is 56% to 75% by mass. In still another embodiment of the present invention, the content is 60% to 75% by mass. Furthermore, in still another embodiment of the present invention, the content is 65% to 75% by mass.

The content of the compound represented by General Formula (I) is 3% to 65% by mass with respect to the total mass of the liquid crystal composition of the present invention, for example, in an embodiment of the present invention. In another embodiment of the present invention, the content is 3% to 55% by mass. In still another embodiment of the present invention, the content is 3% to 50% by mass. In still another embodiment of the present invention, the content is 3% to 45% by mass. Instill another embodiment of the present invention, the content is 3% to 40% by mass. In still another embodiment of the present invention, the content is 3% to 35% by mass. Furthermore, in still another embodiment of the present invention, the content is 3% to 30% by mass.

In a case where it is required that the viscosity of the liquid crystal composition of the present invention be kept low and the liquid crystal composition have a high response speed, it is preferable that the above-described lower limit value is large and the above-described upper limit value is large. In a case where it is required that Tni of the liquid crystal composition of the present invention be kept high and the liquid crystal composition have good temperature stability, it is preferable that the above-described lower limit value is within a moderate range and the above-described upper limit value is within a moderate range. In addition, when it is desired to increase the dielectric anisotropy in order to keep the driving voltage low, it is preferable that the above-described lower limit value is small and the above-described upper limit value is small.

In a case where the ring structure to which R¹¹ or R¹² is bonded is a phenyl group (aromatic group), each of R¹¹ and R¹² is preferably a linear alkyl group having 1 to 5 carbon atoms, a linear alkoxy group having 1 to 4 carbon atoms, or an alkenyl group having 4 or 5 carbon atoms, and in a case where the ring structure to which R¹¹ or R¹² is bonded is a saturated ring structure such as cyclohexane, pyran, or dioxane, each of R¹¹ and R¹² is preferably a linear alkyl group having 1 to 5 carbon atoms, a linear alkoxy group having 1 to 4 carbon atoms, or a linear alkenyl group having 2 to 5 carbon atoms.

The compound represented by General Formula (I) is preferably at least one compound selected from the compound group represented by General Formula (I-1).

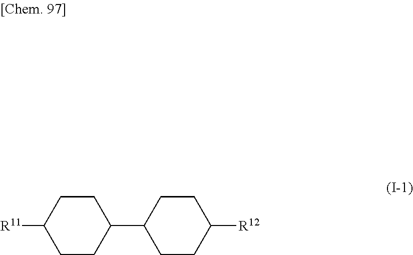

In General Formula (I-1), each of R¹¹ and R¹² independently represents an alkyl group having 1 to 5 carbon atoms, an alkoxy group having 1 to 5 carbon atoms, or an alkenyl group having 2 to 5 carbon atoms.

The types of compound capable of being combined are not particularly limited, and a compound is suitably combined and used depending on the required performance such as solubility at a low temperature, a transition temperature, electrical reliability, and birefringence. The type of compound used, for example, is one type in an embodiment of the present invention. In another embodiment of the present invention, the types of compound used are two types. In still another embodiment of the present invention, the types of compound used are three types. In still another embodiment of the present invention, the types of compound used are four types. Furthermore, in still another embodiment of the present invention, the types of compound used are five or more types.

In the liquid crystal composition of the present invention, in a case where the compound represented by General Formula (I-1) is mixed, the content of the compound needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I-1) is 3% to 70% by mass with respect to the total mass of the liquid crystal composition of the present invention, for example, in an embodiment of the present invention. In another embodiment of the present invention, the content is 15% to 70% bymass. In still another embodiment of the present invention, the content is 18% to 70% by mass. In still another embodiment of the present invention, the content is 25% to 70% by mass. In still another embodiment of the present invention, the content is 29% to 70% by mass.

In still another embodiment of the present invention, the content is 31% to 70% by mass. In still another embodiment of the present invention, the content is 35% to 70% by mass. In still another embodiment of the present invention, the content is 43% to 70% by mass. In still another embodiment of the present invention, the content is 47% to 70% by mass. In still another embodiment of the present invention, the content is 50% to 70% by mass. In still another embodiment of the present invention, the content is 53% to 70% by mass. Furthermore, in still another embodiment of the present invention, the content is 56% to 70% by mass.

The content of the compound represented by General Formula (I-1) is 2% to 60% by mass with respect to the total mass of the liquid crystal composition of the present invention, for example, in an embodiment of the present invention. In another embodiment of the present invention, the content is 2% to 50% by mass. In still another embodiment of the present invention, the content is 2% to 45% by mass. In still another embodiment of the present invention, the content is 2% to 40% by mass. In still another embodiment of the present invention, the content is 2% to 35% by mass. In still another embodiment of the present invention, the content is 2% to 30% by mass. Furthermore, instill another embodiment of the present invention, the content is 2% to 26% by mass.

In a case where it is required that the viscosity of the liquid crystal composition of the present invention be kept low and the liquid crystal composition have a high response speed, it is preferable that the above-described lower limit value is large and the above-described upper limit value is large. In a case where it is required that Tni of the liquid crystal composition of the present invention be kept high and the liquid crystal composition have good temperature stability, it is preferable that the above-described lower limit value is within a moderate range and the above-described upper limit value is within a moderate range. In addition, when it is desired to increase the dielectric anisotropy in order to keep the driving voltage low, it is preferable that the above-described lower limit value is small and the above-described upper limit value is small.

Alternatively/in addition, the compound represented by General Formula (I-1) is preferably at least one compound selected from the compound group represented by General Formula (I-1-1).

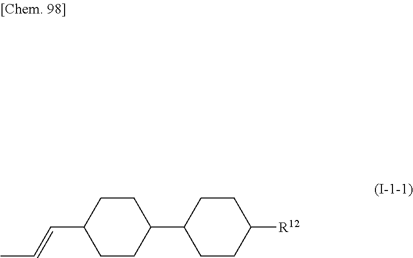

In General Formula (I-1-1), R¹² represents an alkyl group having 1 to 5 carbon atoms, an alkenyl group having 2 to 5 carbon atoms, or an alkoxy group having 1 to 5 carbon atoms.

In the liquid crystal composition of the present invention, the content of the compound represented by General Formula (I-1-1) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I-1-1) is 1% to 35% by mass with respect to the total mass of the liquid crystal composition of the present invention, for example, in an embodiment of the present invention. In another embodiment of the present invention, the content is 2% to 30% by mass. In still another embodiment of the present invention, the content is 4% to 30% by mass. In still another embodiment of the present invention, the content is 6% to 30% by mass. In still another embodiment of the present invention, the content is 8% to 30% by mass. In still another embodiment of the present invention, the content is 9% to 30% by mass. Furthermore, in still another embodiment of the present invention, the content is 10% to 30% by mass.

The content of the compound represented by General Formula (I-1-1) is 2% to 26% by mass with respect to the total mass of the liquid crystal composition of the present invention, for example, in an embodiment of the present invention. In another embodiment of the present invention, the content is 2% to 22% by mass. In still another embodiment of the present invention, the content is 2% to 17% by mass. In still another embodiment of the present invention, the content is 2% to 16% by mass. In still another embodiment of the present invention, the content is 2% to 14% by mass. In still another embodiment of the present invention, the content is 2% to 13% by mass. In still another embodiment of the present invention, the content is 2% to 12% by mass. Furthermore, in still another embodiment of the present invention, the content is 2% to 5% by mass.

The compound represented by General Formula (I-1-1) is preferably a compound selected from the compound group represented by Formulas (1.1) to (1.3), preferably the compound represented by Formula (1.2) or (1.3), and particularly preferably the compound represented by Formula (1.3). The content of the compound represented by Formula (1.3) is preferably 14% by mass or greater in 100% by mass of the liquid crystal composition of the present invention.

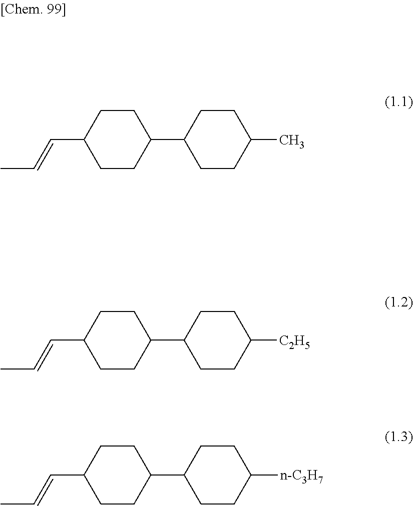

In a case where the compound represented by Formula (1.2) or (1.3) is used alone, respectively, when the content of the compound represented by Formula (1.2) is large, there are effects in the improvement in the response speed, and the content of the compound represented by Formula (1.3) is preferably in the range shown below since a liquid crystal composition having a high response speed and high electrical and optical reliability can be obtained.

The content of the compound represented by Formula (1.3) is 1% to 25% by mass with respect to the total mass of the liquid crystal composition of the present invention, for example, in an embodiment of the present invention. In another embodiment of the present invention, the content is 2% to 25% by mass. In still another embodiment of the present invention, the content is 4% to 25% by mass. In still another embodiment of the present invention, the content is 6% to 25% by mass. In still another embodiment of the present invention, the content is 7% to 25% by mass. In still another embodiment of the present invention, the content is 8% to 25% by mass. In still another embodiment of the present invention, the content is 9% to 25% by mass. Furthermore, in still another embodiment of the present invention, the content is 10% to 25% by mass.

The content of the compound represented by General Formula (1.3) is 2% to 22% by mass with respect to the total mass of the liquid crystal composition of the present invention, for example, in an embodiment of the present invention. In another embodiment of the present invention, the content is 2% to 18% by mass. In still another embodiment of the present invention, the content is 2% to 17% by mass. In still another embodiment of the present invention, the content is 2% to 16% by mass. In still another embodiment of the present invention, the content is 2% to 14% by mass. In still another embodiment of the present invention, the content is 2% to 13% by mass. Furthermore, in still another embodiment of the present invention, the content is 2% to 5% by mass.

Alternatively/in addition, the compound represented by General Formula (I-1) is preferably at least one compound selected from the compound group represented by General Formula (I-1-2).

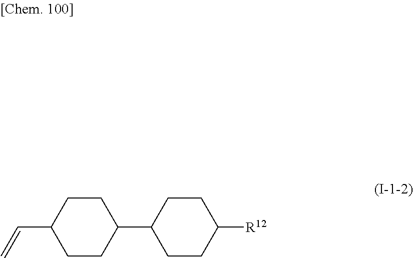

In General Formula (I-1-2), R¹² represents an alkyl group having 1 to 5 carbon atoms, an alkoxy group having 1 to 5 carbon atoms, or an alkenyl group having 2 to 5 carbon atoms.

The types of compound capable of being combined are not particularly limited, and a compound is suitably combined and used depending on the required performance such as solubility at a low temperature, a transition temperature, electrical reliability, and birefringence. The type of compound used, for example, is one type in an embodiment of the present invention. In another embodiment of the present invention, the types of compound used are two types. In addition, in still another embodiment of the present invention, three types are used.

In the liquid crystal composition of the present invention, the content of the compound represented by General Formula (I-1-2) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I-1-2) is 1% to 25% by mass with respect to the total mass of the liquid crystal composition of the present invention, for example, in an embodiment of the present invention. In another embodiment of the present invention, the content is 2% to 25% by mass. In still another embodiment of the present invention, the content is 4% to 25% by mass. In still another embodiment of the present invention, the content is 6% to 25% by mass. In still another embodiment of the present invention, the content is 7% to 25% by mass. In still another embodiment of the present invention, the content is 8% to 25% by mass. In still another embodiment of the present invention, the content is 9% to 25% by mass. Furthermore, in still another embodiment of the present invention, the content is 10% to 25% by mass.

The content of the compound represented by General Formula (I-1-2) is 2% to 22% by mass with respect to the total mass of the liquid crystal composition of the present invention, for example, in an embodiment of the present invention. In another embodiment of the present invention, the content is 2% to 18% by mass. In still another embodiment of the present invention, the content is 2% to 17% by mass. In still another embodiment of the present invention, the content is 2% to 16% by mass. In still another embodiment of the present invention, the content is 2% to 14% by mass. Furthermore, in still another embodiment of the present invention, the content is 2% to 13% by mass.

Furthermore, the compound represented by General Formula (I-1-2) is preferably at least one compound selected from the compound group represented by Formulas (2.1) to (2.4), and preferably the compound represented by Formulas (2.3) and/or (2.4). The content of the compound represented by Formula (2.3) or (2.4) is not preferably 30% by mass or greater in order to improve the solubility at a low temperature.

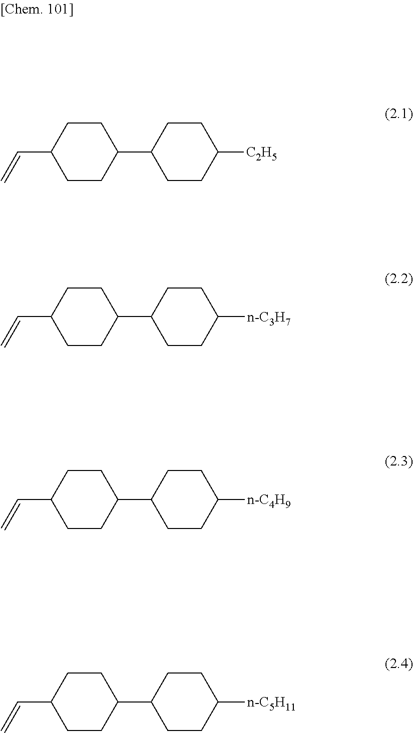

The content of the compound represented by Formula (2.2) in the liquid crystal composition is preferably 3% by mass or greater, preferably 10% by mass or greater, preferably 12% by mass or greater, preferably 15% by mass or greater, preferably 20% by mass or greater, preferably 22% by mass or greater, preferably 23% by mass or greater, preferably 24% by mass or greater, preferably 30% by mass or greater, and preferably 37% by mass or greater, with respect to the total mass of the liquid crystal composition of the present invention, from the viewpoint of a response speed, electrical and optical reliability.

On the other hand, the content of the compound represented by Formula (2.2) in the liquid crystal composition is preferably 60% by mass or less, preferably 50% by mass or less, preferably 46% by mass or less, preferably 45% by mass or less, preferably 44% by mass or less, preferably 42% by mass or less, preferably 40% by mass or less, preferably 38% by mass or less, preferably 36% by mass or less, preferably 32% by mass or less, preferably 26% by mass or less, and preferably 17% by mass or less, with respect to the total mass of the liquid crystal composition of the present invention.

Within the above-described content ranges, the content of the compound represented by Formula (2.2) in the liquid crystal composition is preferably 1% to 60% by mass, preferably 1% to 50% by mass, preferably 10% to 50% by mass, preferably 10% to 45% by mass, preferably 10% to 26% by mass, preferably 12% to 17% by mass, preferably 3% to 15% by mass, preferably 5% to 12% by mass, preferably 15% to 38% by mass, preferably 15% to 32% by mass, preferably 20% to 45% by mass, preferably 20% to 42% by mass, preferably 22% to 44% by mass, preferably 24% to 40% by mass, preferably 23% to 36% by mass, preferably 29% to 42% by mass, preferably 30% to 50% by mass, preferably 35% to 50% by mass, preferably 37% to 46% by mass, and preferably 30% to 38% by mass, with respect to the total mass of the liquid crystal composition of the present invention.

In the liquid crystal composition of the present invention, the content of the compound represented by Formula (2.3) is preferably 1% by mass to 25% by mass, preferably 5% by mass to 20% by mass, preferably 10% by mass to 15% by mass, and preferably 6% by mass to 15% by mass, with respect to the total mass of the liquid crystal composition of the present invention.

In the liquid crystal composition of the present invention, the content of the compound represented by Formula (2.4) is preferably 1% by mass to 25% by mass, more preferably 5% by mass to 20% by mass, preferably 10% by mass to 15% by mass, and preferably 6% by mass to 15% by mass, with respect to the total mass of the liquid crystal composition of the present invention.

The liquid crystal composition of the present invention can also further contain the compound represented by Formula (2.5) having a similar structure to that of the compound represented by General Formula (I-1-2).

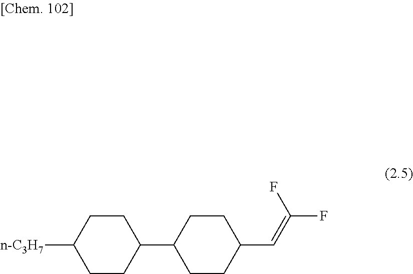

The content of the compound represented by Formula (2.5) is preferably adjusted depending on the required performance such as solubility at a low temperature, a transition temperature, electrical reliability, and birefringence, and the compound is preferably contained in an amount of 0% by mass to 40% by mass, preferably 10% by mass to 40% by mass, and preferably 15% by mass to 35% by mass, with respect to the total amount of the liquid crystal composition of the present invention.

Alternatively/in addition, the compound represented by General Formula (I) is preferably at least one compound selected from the compound group represented by General Formula (I-2).

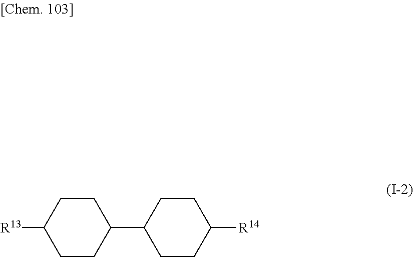

In General Formula (I-2), each of R¹³ and R¹⁴ independently represents an alkyl group having 1 to 5 carbon atoms.

The types of compound capable of being combined are not particularly limited, and a compound is combined depending on the required performance such as solubility at a low temperature, a transition temperature, electrical reliability, and birefringence. The type of compound used, for example, is one type in an embodiment of the present invention. In another embodiment of the present invention, two types are used. In addition, in still another embodiment of the present invention, three types are used.

In the liquid crystal composition of the present invention, the content of the compound represented by General Formula (I-2) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I-2) is 1% to 30% by mass with respect to the total mass of the liquid crystal composition of the present invention, for example, in an embodiment of the present invention. In another embodiment of the present invention, the content is 2% to 30% by mass. In still another embodiment of the present invention, the content is 4% to 30% by mass. In still another embodiment of the present invention, the content is 6% to 30% by mass. In still another embodiment of the present invention, the content is 10% to 30% by mass. In still another embodiment of the present invention, the content is 15% to 30% by mass. Furthermore, in still another embodiment of the present invention, the content is 20% to 30% by mass.

The content of the compound represented by General Formula (I-2) is 1% to 25% by mass with respect to the total mass of the liquid crystal composition of the present invention, for example, in an embodiment of the present invention. In another embodiment of the present invention, the content is 1% to 23% by mass. In still another embodiment of the present invention, the content is 1% to 18% by mass. In still another embodiment of the present invention, the content is 1% to 15% by mass. In still another embodiment of the present invention, the content is 1% to 12% by mass. In still another embodiment of the present invention, the content is 1% to 10% by mass. Furthermore, in still another embodiment of the present invention, the content is 1% to 5% by mass.

Furthermore, the compound represented by General Formula (I-2) is preferably at least one compound selected from the compound group represented by Formulas (3.1) to (3.4), and preferably the compound represented by Formulas (3.1), (3.3), and/or (3.4). In particular, the compound represented by Formula (3.2) is preferable since the compound particularly improves the response speed of the liquid crystal composition of the present invention. When a high Tni is required rather than the response speed, the compound represented by Formulas (3.3) and/or (3.4) is preferably used. The content of the compound represented by Formulas (3.3) and (3.4) is not preferably 20% by mass or greater in order to improve the solubility at a low temperature.

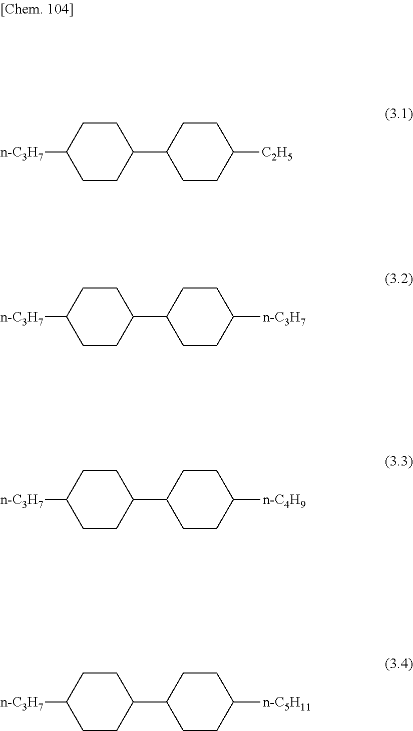

In the liquid crystal composition of the present invention, the content of the compound represented by Formula (3.3) is preferably 2% by mass to 40% by mass with respect to the total mass of the liquid crystal composition of the present invention. As a more preferable content, for example, 3% by mass to 40% by mass, 4% by mass to 40% by mass, 10% by mass to 40% by mass, 12% by mass to 40% by mass, 14% by mass to 40% by mass, 16% by mass to 40% by mass, 20% by mass to 40% by mass, 23% by mass to 40% by mass, 26% by mass to 40% by mass, 30% by mass to 40% by mass, 34% by mass to 40% by mass, 37% by mass to 40% by mass, 3% by mass to 4% by mass, 3% by mass to 10% by mass, 3% by mass to 12% by mass, 3% by mass to 14% by mass, 3% by mass to 16% by mass, 3% by mass to 20% by mass, 3% by mass to 23% by mass, 3% by mass to 26% by mass, 3% by mass to 30% by mass, 3% by mass to 34% by mass, and 3% by mass to 37% by mass are exemplified.

Alternatively/in addition, the compound represented by General Formula (I) is preferably at least one compound selected from the compound group represented by General Formula (I-3).

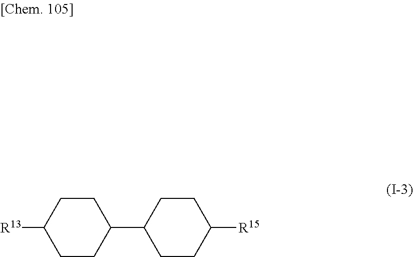

In General Formula (I-3), R¹³ represents an alkyl group having 1 to 5 carbon atoms, and R¹⁵ represents an alkoxy group having 1 to 4 carbon atoms.

The types of compound capable of being combined are not particularly limited, and a compound is combined depending on the required performance such as solubility at a low temperature, a transition temperature, electrical reliability, and birefringence. The type of compound used, for example, is one type in an embodiment of the present invention. In another embodiment of the present invention, two types are used. In addition, in still another embodiment of the present invention, three types are used.

In the liquid crystal composition of the present invention, the content of the compound represented by General Formula (I-3) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I-3) is 3% to 60% by mass with respect to the total mass of the liquid crystal composition of the present invention, for example, in an embodiment of the present invention. In another embodiment of the present invention, the content is 4% to 60% by mass. In still another embodiment of the present invention, the content is 15% to 60% by mass. In still another embodiment of the present invention, the content is 25% to 60% by mass. In still another embodiment of the present invention, the content is 30% to 60% by mass. In still another embodiment of the present invention, the content is 35% to 60% by mass. In still another embodiment of the present invention, the content is 38% to 60% by mass. In still another embodiment of the present invention, the content is 40% to 60% by mass. In still another embodiment of the present invention, the content is 42% to 60% by mass. In still another embodiment of the present invention, the content is 45% to 60% by mass. In still another embodiment of the present invention, the content is 47% to 60% by mass. Furthermore, in still another embodiment of the present invention, the content is 50% to 60% by mass.

The content of the compound is 3% to 55% by mass with respect to the total mass of the liquid crystal composition of the present invention, for example, in an embodiment of the present invention. In another embodiment of the present invention, the content is 3% to 45% by mass. In still another embodiment of the present invention, the content is 3% to 40% by mass. Instill another embodiment of the present invention, the content is 3% to 30% by mass. In still another embodiment of the present invention, the content is 3% to 20% by mass. In still another embodiment of the present invention, the content is 3% to 15% by mass. Furthermore, in still another embodiment of the present invention, the content is 3% to 5% by mass.

In a case where the solubility at a low temperature matters, when the content is set to be large, effects are higher, and in contrast, in a case where the response speed matters, when the content is set to be small, effects are higher. Furthermore, in the case of improving dropping marks or burn-in characteristics, the range of the content is preferably set to an intermediate value.

Furthermore, the compound represented by General Formula (1-3) is preferably at least one compound selected from the compound group represented by Formulas (4.1) to (4.3), and preferably the compound represented by Formula (4.3).

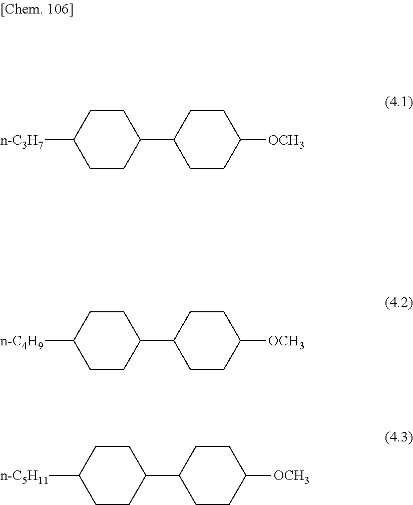

The content of the compound represented by General Formula (4.3) is preferably 2% by mass to 30% by mass, preferably 4% by mass to 30% by mass, preferably 6% by mass to 30% by mass, preferably 8% by mass to 30% by mass, preferably 10% by mass to 30% by mass, preferably 12% by mass to 30% by mass, preferably 14% by mass to 30% by mass, preferably 16% by mass to 30% by mass, preferably 18% by mass to 25% by mass, preferably 20% by mass to 24% by mass, and particularly preferably 22% by mass to 23% by mass, with respect to the total mass of the liquid crystal composition of the present invention.

Alternatively/in addition, the compound represented by General Formula (I) is preferably at least one compound selected from the compound group represented by General Formula (I-4).

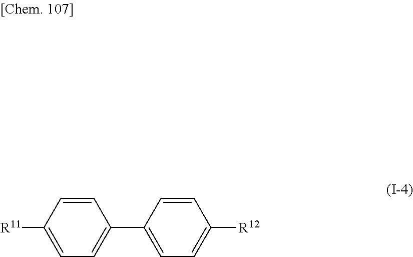

In General Formula (I-4), each of R¹¹ and R¹² independently represents an alkyl group having 1 to 5 carbon atoms, an alkenyl group having 4 or 5 carbon atoms, or an alkoxy group having 1 to 4 carbon atoms.

The types of compound capable of being combined are not particularly limited, and a compound is combined depending on the required performance such as solubility at a low temperature, a transition temperature, electrical reliability, and birefringence. The type of compound used, for example, is one type in an embodiment of the present invention. In another embodiment of the present invention, two types are used.

In the liquid crystal composition of the present invention, the content of the compound represented by General Formula (I-4) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (I-4) is 2% to 50% by mass with respect to the total mass of the liquid crystal composition of the present invention, for example, in an embodiment of the present invention. In another embodiment of the present invention, the content is 5% to 50% by mass. In still another embodiment of the present invention, the content is 6% to 50% by mass. In still another embodiment of the present invention, the content is 8% to 50% by mass. In still another embodiment of the present invention, the content is 10% to 50% by mass. In still another embodiment of the present invention, the content is 12% to 50% by mass. In still another embodiment of the present invention, the content is 15% to 50% by mass. In still another embodiment of the present invention, the content is 20% to 50% bymass. In still another embodiment of the present invention, the content is 25% to 50% by mass. In still another embodiment of the present invention, the content is 30% to 50% by mass. Instill another embodiment of the present invention, the content is 35% to 50% by mass. Furthermore, in still another embodiment of the present invention, the content is 40% to 50% by mass.

The content of the compound is 2% to 40% by mass with respect to the total mass of the liquid crystal composition of the present invention, for example, in an embodiment of the present invention. In another embodiment of the present invention, the content is 2% to 35% by mass. In still another embodiment of the present invention, the content is 2% to 30% by mass. In still another embodiment of the present invention, the content is 2% to 20% by mass. In still another embodiment of the present invention, the content is 2% to 15% by mass. Furthermore, in still another embodiment of the present invention, the content is 2% to 10% by mass.

In the case of obtaining a high birefringence, when the content is set to be large, effects are higher, and in contrast, in a case where a high Tni matters, when the content is set to be small, effects are higher. Furthermore, in the case of improving dropping marks or burn-in characteristics, the range of the content is preferably set to an intermediate value.

Furthermore, the compound represented by General Formula (I-4) is preferably at least one compound selected from the compound group represented by Formulas (5.1) to (5.4), and preferably at least one compound selected from the compound group represented by Formulas (5.2) to (5.4).

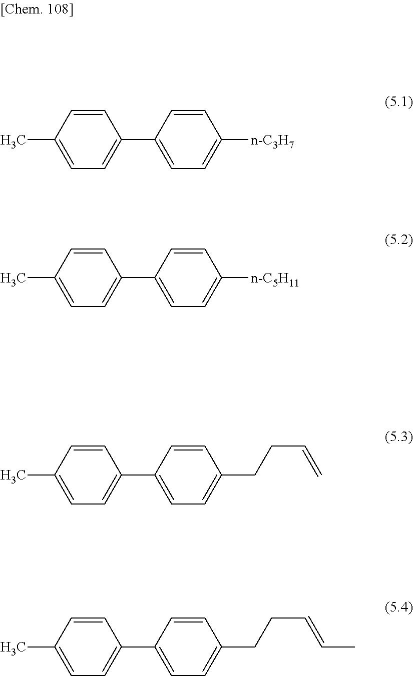

The content of the compound represented by Formula (5.4) is preferably 2% by mass to 30% by mass with respect to the total mass of the liquid crystal composition of the present invention. Within the above-described content ranges, for example, 4% by mass to 30% by mass, 6% by mass to 30% by mass, 8% by mass to 30% by mass, 10% by mass to 30% by mass, 12% by mass to 30% by mass, 14% by mass to 30% by mass, 16% by mass to 30% by mass, 18% by mass to 30% by mass, 20% by mass to 30% by mass, 22% by mass to 30% by mass, 23% by mass to 30% by mass, 24% by mass to 30% by mass, 25% by mass to 30% by mass, 4% by mass to 6% by mass, 4% by mass to 8% by mass, 4% by mass to 10% by mass, 4% by mass to 12% by mass, 4% by mass to 14% by mass, 4% by mass to 16% by mass, 4% by mass to 18% by mass, 4% by mass to 20% by mass, 4% by mass to 22% by mass, 4% by mass to 23% by mass, 4% by mass to 24% by mass, or 4% by mass to 25% by mass is preferable.

Alternatively/in addition, the compound represented by General Formula (I) is preferably at least one compound selected from the compound group represented by General Formula (I-5).

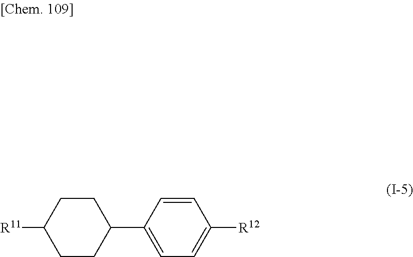

In General Formula (I-5), R¹¹ represents an alkyl group having 1 to 5 carbon atoms, an alkenyl group having 2 to 5 carbon atoms, or an alkoxy group having 1 to 4 carbon atoms, and R¹² represents an alkyl group having 1 to 5 carbon atoms, an alkenyl group having 4 to 5 carbon atoms, or an alkoxy group having 1 to 4 carbon atoms.

The types of compound capable of being combined are not particularly limited, and a compound is combined depending on the required performance such as solubility at a low temperature, a transition temperature, electrical reliability, and birefringence. The type of compound used, for example, is one type in an embodiment of the present invention. In another embodiment of the present invention, two types are used.

In the liquid crystal composition of the present invention, the content of the compound represented by General Formula (I-5) needs to be suitably adjusted depending on the required performance such as solubility at a low temperature, a transition temperature, electrical reliability, birefringence, process compatibility, dropping marks, burn-in, and dielectric anisotropy.

The content of the compound is 1% to 50% by mass with respect to the total mass of the liquid crystal composition of the present invention, for example, in an embodiment of the present invention. In another embodiment of the present invention, the content is 5% to 50% by mass. In still another embodiment of the present invention, the content is 8% to 50% by mass. Instill another embodiment of the present invention, the content is 11% to 50% bymass. In still another embodiment of the present invention, the content is 13% to 50% by mass. In still another embodiment of the present invention, the content is 15% to 50% by mass. In still another embodiment of the present invention, the content is 17% to 50% by mass. In still another embodiment of the present invention, the content is 20% to 50% by mass. In still another embodiment of the present invention, the content is 25% to 50% by mass. In still another embodiment of the present invention, the content is 30% to 50% by mass. In still another embodiment of the present invention, the content is 35% to 50% by mass. Furthermore, in still another embodiment of the present invention, the content is 40% to 50% by mass.

The content of the compound is 1% to 40% by mass with respect to the total mass of the liquid crystal composition of the present invention, for example, in an embodiment of the present invention. In another embodiment of the present invention, the content is 1% to 35% by mass. In still another embodiment of the present invention, the content is 1% to 30% by mass. Instill another embodiment of the present invention, the content is 1% to 20% by mass. In still another embodiment of the present invention, the content is 1% to 15% by mass. In still another embodiment of the present invention, the content is 1% to 10% by mass. Furthermore, in still another embodiment of the present invention, the content is 1% to 5% by mass.

In a case where the solubility at a low temperature matters, when the content is set to be large, effects are higher, and in contrast, in a case where the response speed matters, when the content is set to be small, effects are higher. Furthermore, in the case of improving dropping marks or burn-in characteristics, the range of the content is preferably set to an intermediate value.

Furthermore, the compound represented by General Formula (1-5) is preferably at least one compound selected from the compound group represented by Formulas (6.1) to (6.6), and preferably the compound represented by Formulas (6.3), (6.4), and/or (6.6).

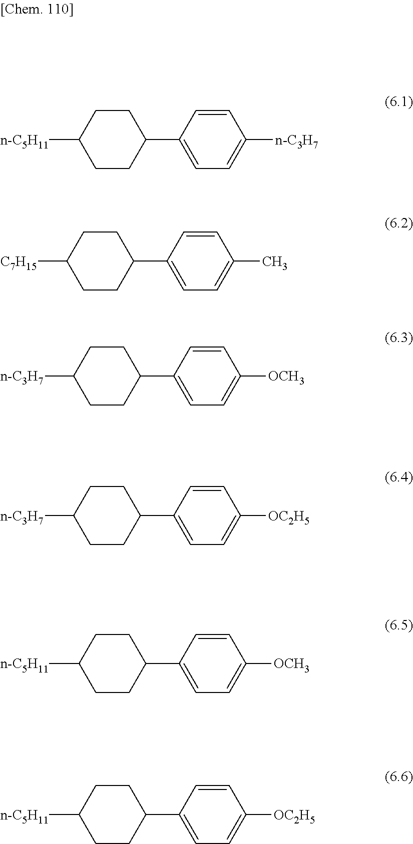

For example, the content of the compound represented by General Formula (6-6) is preferably 2% by mass to 30% by mass, preferably 4% by mass to 30% by mass, preferably 5% by mass to 30% by mass, preferably 6% by mass to 30% by mass, preferably 9% by mass to 30% by mass, preferably 12% by mass to 30% by mass, preferably 14% by mass to 30% by mass, preferably 16% by mass to 30% by mass, preferably 18% by mass to 25% by mass, preferably 20% by mass to 24% by mass, and preferably 22% by mass to 23% by mass, with respect to the total mass of the liquid crystal composition of the present invention.

The liquid crystal composition of the present invention can also further contain the compound represented by Formula (6.7) and/or Formula (6.8) as the compound represented by General Formula (I-5).

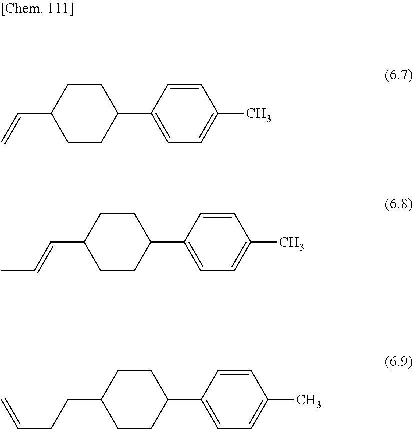

The content of the compound represented by Formula (6.7) is preferably adjusted depending on the required performance such as solubility at a low temperature, a transition temperature, electrical reliability, and birefringence, and the compound is preferably contained in an amount of 2% by mass or greater, preferably 3% by mass or greater, preferably 5% by mass or greater, and preferably 7% by mass or greater, with respect to the total mass of the liquid crystal composition of the present invention. In addition, a range of 4% by mass to 16% by mass is preferable.

Alternatively/in addition, the compound represented by General Formula (I) is preferably at least one compound selected from the compound group represented by General Formula (I-6).

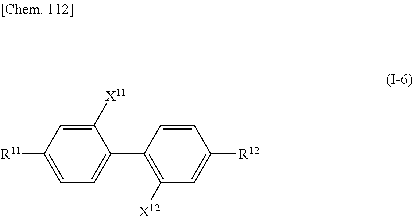

In Formula (I-6), each of R¹¹ and R¹² independently represents an alkyl group having 1 to 5 carbon atoms, an alkenyl group having 4 or 5 carbon atoms, or an alkoxy group having 1 to 4 carbon atoms, each of X¹¹ and X¹² independently represents a fluorine atom or a hydrogen atom, and any one of X¹¹ and X¹² is a fluorine atom.

The content of the compound represented by General Formula (I-6) is preferably 2% by mass to 30% by mass, preferably 4% by mass to 30% by mass, preferably 5% by mass to 30% by mass, preferably 6% by mass to 30% by mass, preferably 9% by mass to 30% by mass, preferably 12% by mass to 30% by mass, preferably 14% by mass to 30% by mass, preferably 16% by mass to 30% by mass, preferably 18% by mass to 25% by mass, preferably 20% by mass to 24% by mass, and preferably 22% by mass to 23% by mass, with respect to the total mass of the liquid crystal composition of the present invention.

Furthermore, the compound represented by General Formula (I-6) is preferably the compound represented by Formula (7.1).

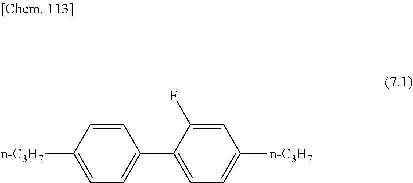

Alternatively/in addition, the compound represented by General Formula (I) is preferably a compound selected from the compound group represented by General Formula (I-7).

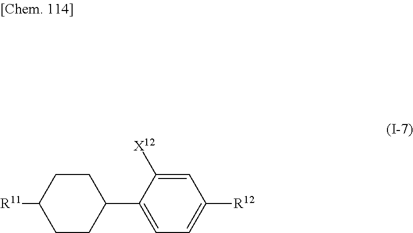

In General Formula (I-7), each of R¹¹ and R¹² independently represents an alkyl group having 1 to 5 carbon atoms, an alkenyl group having 2 to 5 carbon atoms, or an alkoxy group having 1 to 4 carbon atoms, and X¹² represents a fluorine atom or a chlorine atom.

The content of the compound represented by General Formula (I-7) is preferably 1% by mass to 20% by mass, preferably 1% by mass to 15% by mass, preferably 1% by mass to 10% by mass, and preferably 1% by mass to 5% by mass, with respect to the total mass of the liquid crystal composition of the present invention.

Furthermore, the compound represented by General Formula (I-7) is preferably the compound represented by Formula (8.1).

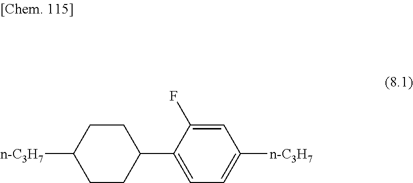

Alternatively/in addition, the compound represented by General Formula (I) is preferably at least one compound selected from the compound group represented by General Formula (I-8).

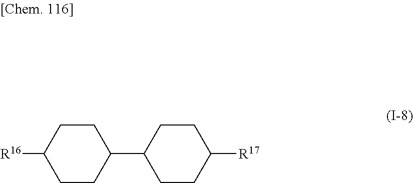

In General Formula (I-8), each of R¹⁶ and R¹⁷ independently represents an alkenyl group having 2 to 5 carbon atoms.

The types of compound capable of being combined are not particularly limited, and one to three types are preferably combined depending on the required performance such as solubility at a low temperature, a transition temperature, electrical reliability, and birefringence.

The content of the compound represented by General Formula (I-8) is preferably 1% to 30% by mass, preferably 1% to 25% by mass, preferably 1% to 20% by mass, preferably 1% to 18% by mass, and preferably 3% to 18% by mass, with respect to the total mass of the liquid crystal composition of the present invention, depending on the required performance such as solubility at a low temperature, a transition temperature, electrical reliability, birefringence, process compatibility, dropping marks, burn-in, and dielectric anisotropy.

Furthermore, the compound represented by General Formula (1-8) is preferably at least one compound selected from the compound group represented by Formulas (9.1) to (9.10), and preferably the compound represented by Formulas (9.2), (9.4), and/or (9.7).

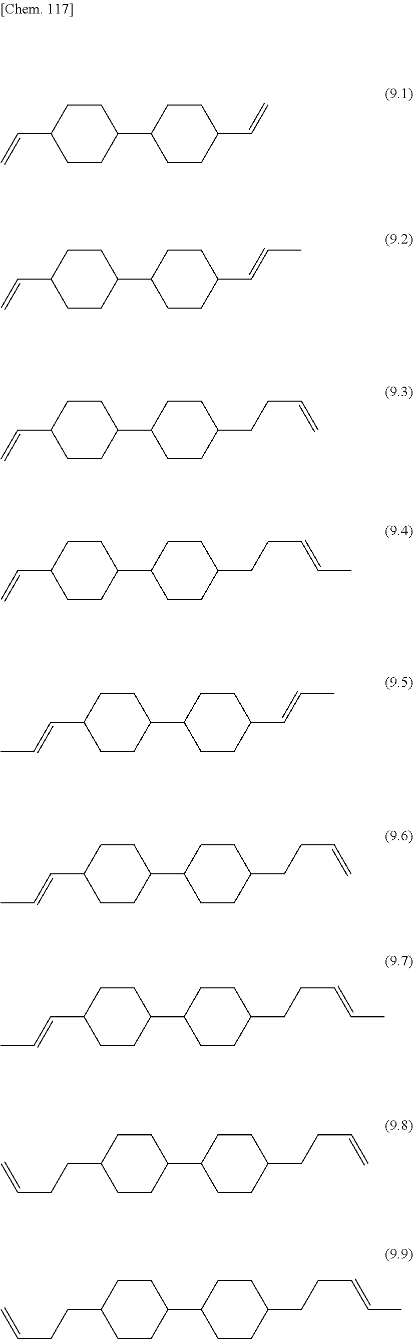

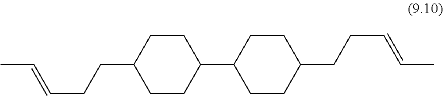

Alternatively/in addition, the compound represented by General Formula (L), for example, is preferably at least one compound selected from the compound represented by General Formula (II).

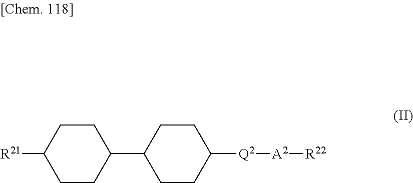

In General Formula (II), each of R²¹ and R²² independently represents an alkenyl group having 2 to 5 carbon atoms, an alkyl group having 1 to 5 carbon atoms, or an alkoxy group having 1 to 4 carbon atoms, A² represents a 1,4-cyclohexylene group or a 1,4-phenylene group, and Q² represents a single bond, —COO—, —CH₂—CH₂—, or CF₂O—.

The types of compound capable of being combined are not particularly limited, and a compound is combined depending on the required performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three types are used. Furthermore, in still another embodiment of the present invention, four or more types are used.

In the liquid crystal composition of the present invention, the content of the compound represented by General Formula (II) needs to be suitably adjusted depending on the required performance such as solubility at a low temperature, a transition temperature, electrical reliability, birefringence, process compatibility, dropping marks, burn-in, and dielectric anisotropy.

For example, the content of the compound represented by General Formula (II) is 3% to 50% by mass with respect to the total mass of the liquid crystal composition of the present invention in an embodiment of the present invention. In another embodiment of the present invention, the content is 5% to 50% by mass. In still another embodiment of the present invention, the content is 7% to 50% by mass. In still another embodiment of the present invention, the content is 10% to 50% by mass. Instill another embodiment of the present invention, the content is 14% to 50% bymass. In still another embodiment of the present invention, the content is 16% to 50% by mass. In still another embodiment of the present invention, the content is 20% to 50% by mass. In still another embodiment of the present invention, the content is 23% to 50% by mass. In still another embodiment of the present invention, the content is 26% to 50% by mass. In still another embodiment of the present invention, the content is 30% to 50% by mass. In still another embodiment of the present invention, the content is 35% to 50% by mass. Furthermore, in still another embodiment of the present invention, the content is 40% to 50% by mass.

For example, the content of the compound represented by General Formula (II) is 3% to 40% by mass with respect to the total mass of the liquid crystal composition of the present invention in an embodiment of the present invention. In another embodiment of the present invention, the content is 3% to 35% by mass. In still another embodiment of the present invention, the content is 3% to 30% by mass. In still another embodiment of the present invention, the content is 3% to 20% by mass. In still another embodiment of the present invention, the content is 3% to 15% by mass. In still another embodiment of the present invention, the content is 3% to 10% by mass. Furthermore, in still another embodiment of the present invention, the content is 3% to 5% by mass.

Furthermore, the compound represented by General Formula (II), for example, is preferably at least one compound selected from the compound group represented by General Formula (II-1).

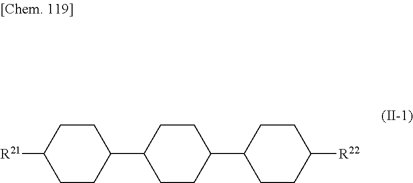

In General Formula (II-1), each of R²¹ and R²² independently represents an alkenyl group having 2 to 5 carbon atoms, an alkyl group having 1 to 5 carbon atoms, or an alkoxy group having 1 to 4 carbon atoms.

The content of the compound represented by General Formula (II-1) is preferably adjusted depending on the required performance such as solubility at a low temperature, a transition temperature, electrical reliability, and birefringence, and the content is preferably 4% by mass to 24% by mass, preferably 8% by mass to 18% by mass, and more preferably 12% by mass to 14% by mass.

Furthermore, the compound represented by General Formula (II-1), for example, is preferably the compound represented by Formulas (10.1) and/or (10.2).

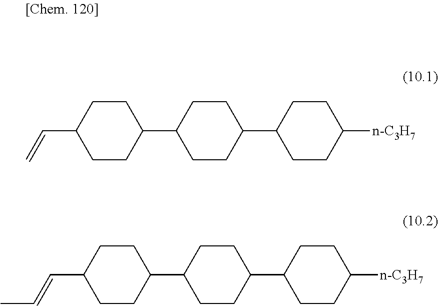

Alternatively/in addition, the compound represented by General Formula (II), for example, is preferably at least one compound selected from the compound group represented by General Formula (II-3).

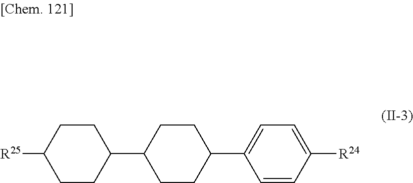

In General Formula (II-3), R²⁵ represents an alkyl group having 1 to 5 carbon atoms, and R²⁴ represents an alkyl group having 1 to 5 carbon atoms or an alkoxy group having 1 to 4 carbon atoms.

The types of compound capable of being combined are not particularly limited, and one to three types of these compounds are preferably contained depending on the required performance such as solubility at a low temperature, a transition temperature, electrical reliability, and birefringence.

The content of the compound represented by General Formula (II-3) needs to be suitably adjusted depending on the required performance such as solubility at a low temperature, a transition temperature, electrical reliability, birefringence, process compatibility, dropping marks, burn-in, and dielectric anisotropy.

The preferable content of the compound represented by General Formula (II-3), for example, is 2% to 45% by mass with respect to the total mass of the liquid crystal composition of the present invention. Within the above content ranges, for examples, 5% to 45% by mass, 8% to 45% by mass, 11% to 45% by mass, 14% to 45% by mass, 17% to 45% by mass, 20% to 45% by mass, 23% to 45% by mass, 26% to 45% by mass, 29% to 45% by mass, 2% to 45% by mass, 2% to 40% by mass, 2% to 35% by mass, 2% to 30% by mass, 2% to 25% by mass, 2% to 20% by mass, 2% to 15% by mass, or 2% to 10% by mass is preferable.

Furthermore, the compound represented by General Formula (II-3), for example, is preferably at least one compound selected from the compound group represented by Formulas (12.1) to (12.3).

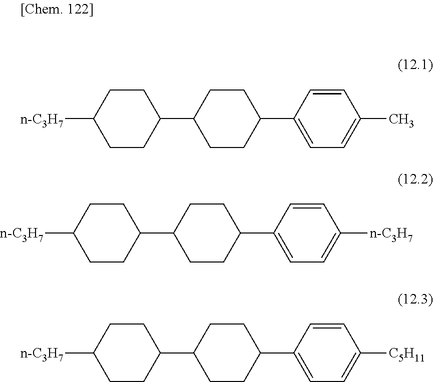

The liquid crystal composition of the present invention may contain the compound represented by Formula (12.1), the compound represented by Formula (12.2), or both the compound represented by Formula (12.1) and the compound represented by Formula (12.2) depending on the required performance such as solubility at a low temperature, a transition temperature, electrical reliability, and birefringence.

The content of the compound represented by Formula (12.1) is preferably 3% by mass to 40% by mass, preferably 5% by mass to 40% by mass, preferably 7% by mass to 40% by mass, preferably 9% by mass to 40% by mass, preferably 11% by mass to 40% by mass, preferably 12% by mass to 40% by mass, preferably 13% by mass to 40% by mass, preferably 18% by mass to 30% by mass, and preferably 21% by mass to 25% by mass, with respect to the total mass of the liquid crystal composition of the present invention.

The content of the compound represented by Formula (12.2) is preferably 3% by mass to 40% by mass, preferably 5% by mass to 40% by mass, preferably 8% by mass to 40% by mass, preferably 10% by mass to 40% by mass, preferably 12% by mass to 40% by mass, preferably 15% by mass to 40% by mass, preferably 17% by mass to 30% by mass, and preferably 19% by mass to 25% by mass, with respect to the total mass of the liquid crystal composition of the present invention.

In the case of containing both the compound represented by Formula (12.1) and the compound represented by Formula (12.2), the total mass of both the compounds is preferably 15% by mass to 45% by mass, preferably 19% by mass to 45% by mass, preferably 24% by mass to 40% by mass, and preferably 30% by mass to 35% by mass, with respect to the total mass of the liquid crystal composition of the present invention.

In addition, the content of the compound represented by Formula (12.3) is preferably 0.05% by mass to 2% by mass, preferably 0.1% by mass to 1% by mass, and preferably 0.2% by mass to 0.5% by mass, with respect to the total mass of the liquid crystal composition of the present invention. The compound represented by Formula (12.3) may be an optically active compound.

Furthermore, the compound represented by General Formula (II-3), for example, is preferably at least one compound selected from the compound group represented by General Formula (II-3-1).

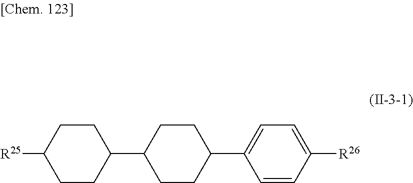

In General Formula (II-3-1), R²⁵ represents an alkyl group having 1 to 5 carbon atoms, and R²⁶ represents an alkoxy group having 1 to 4 carbon atoms.

The types of compound capable of being combined are not particularly limited, and one to three types of these compounds are preferably contained depending on the required performance such as solubility at a low temperature, a transition temperature, electrical reliability, and birefringence.

The content of the compound represented by General Formula (II-3-1) is preferably adjusted depending on the required performance such as solubility at a low temperature, a transition temperature, electrical reliability, and birefringence, and the content is preferably 1% by mass to 24% by mass, preferably 4% by mass to 18% by mass, and preferably 6% by mass to 14% by mass.

Furthermore, the compound represented by General Formula (II-3-1), for example, is preferably at least one compound selected from the compound group represented by Formulas (13.1) to (13.4), and, particularly preferably the compound represented by Formula (13.3).

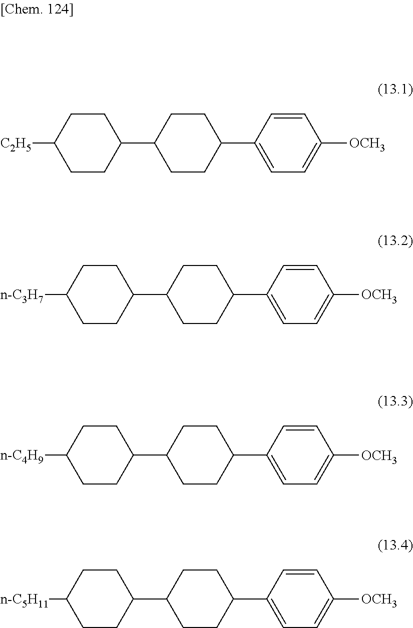

Alternatively/in addition, the compound represented by General Formula (II), for example, is preferably at least one compound selected from the compound group represented by General Formula (II-4).

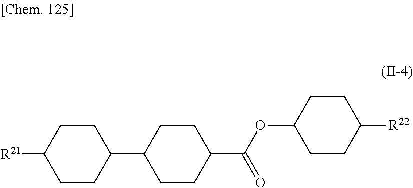

In General Formula (II-4), each of R²¹ and R²² independently represents an alkenyl group having 2 to 5 carbon atoms, an alkyl group having 1 to 5 carbon atoms, or an alkoxy group having 1 to 4 carbon atoms.

Only one type of these compounds may be contained or two or more types thereof may be contained, and these compounds are preferably suitably combined depending on the required performance. The types of compound capable of being combined are not particularly limited, and one or two types of these compounds are preferably contained, and one to three types are more preferably contained, depending on the required performance such as solubility at a low temperature, a transition temperature, electrical reliability, and birefringence.

The content of the compound represented by General Formula (II-4) is preferably 1% by mass to 15% by mass, preferably 2% by mass to 15% by mass, preferably 3% by mass to 15% by mass, preferably 4% by mass to 12% by mass, and preferably 5% by mass to 7% by mass, with respect to the total mass of the liquid crystal composition of the present invention.

Furthermore, the compound represented by General Formula (II-4), for example, is preferably at least one compound selected from the compound group represented by Formulas (14.1) to (14.5), and, particularly preferably the compound represented by Formulas (14.2) and/or (14.5).

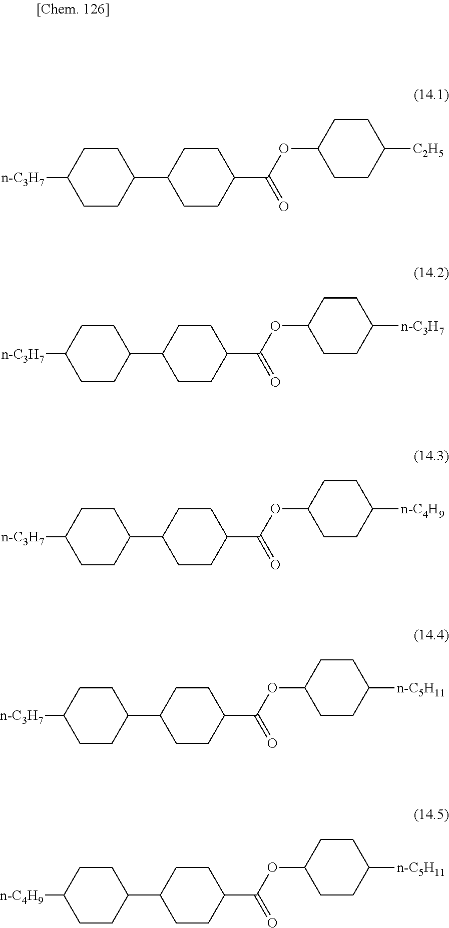

Alternatively/in addition, the compound represented by General Formula (L) is preferably at least one compound selected from the compound group represented by General Formula (III).

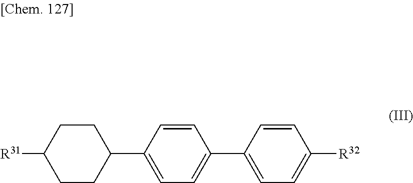

In General Formula (III), each of R³¹ and R³² independently represents an alkenyl group having 2 to 5 carbon atoms, an alkyl group having 1 to 5 carbon atoms, or an alkoxy group having 1 to 4 carbon atoms.

The content of the compound represented by General Formula (III) is preferably 1% by mass to 25% by mass, preferably 2% by mass to 20% by mass, and preferably 2% by mass to 15% by mass, with respect to the total mass of the liquid crystal composition of the present invention, in consideration of the required solubility and birefringence.

Furthermore, the compound represented by General Formula (III), for example, is preferably the compound represented by Formulas (15.1) and/or (15.2), and, particularly preferably the compound represented by Formula (15.1). In addition, the content of the compound represented by Formula (15.1) is preferably within a range of 5% by mass to 10% by mass, and preferably within a range of 7% by mass to 9% by mass.

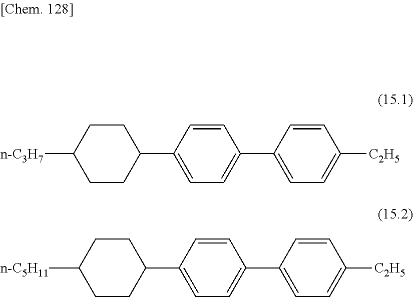

Furthermore, the compound represented by General Formula (III) is preferably at least one compound selected from the compound group represented by General Formula (III-1).

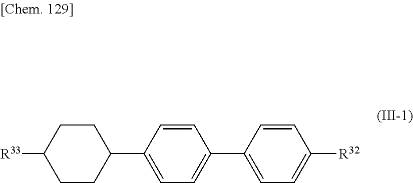

In General Formula (III-1), R³³ represents an alkenyl group having 2 to 5 carbon atoms, and R³² represents an alkyl group having 1 to 5 carbon atoms or an alkoxy group having 1 to 4 carbon atoms.

The content of the compound represented by General Formula (III-1) is preferably adjusted depending on the required performance such as solubility at a low temperature, a transition temperature, electrical reliability, and birefringence, and the content is preferably 4% by mass to 23% by mass, preferably 6% by mass to 18% by mass, and preferably 10% by mass to 13% by mass, with respect to the total mass of the liquid crystal composition of the present invention.

The compound represented by General Formula (III-1), for example, is preferably the compound represented by Formulas (16.1) and/or (16.2).

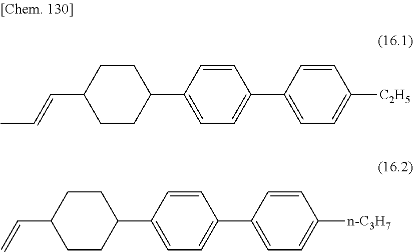

Alternatively/in addition, the compound represented by General Formula (III) is preferably at least one compound selected from the compound group represented by General Formula (III-2).

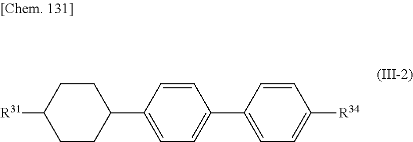

In General Formula (III-2), R³¹ represents an alkyl group having 1 to 5 carbon atoms, and R³⁴ represents an alkoxy group having 1 to 4 carbon atoms.

The content of the compound represented by General Formula (III-2) is preferably adjusted depending on the required performance such as solubility at a low temperature, a transition temperature, electrical reliability, and birefringence, and the content is preferably 4% by mass to 23% by mass, preferably 6% by mass to 18% by mass, and preferably 10% by mass to 13% by mass, with respect to the total mass of the liquid crystal composition of the present invention.

Furthermore, the compound represented by General Formula (III-2), for example, is preferably at least one compound selected from the compound group represented by Formulas (17.1) to (17.3), and, particularly preferably the compound represented by Formula (17.3).

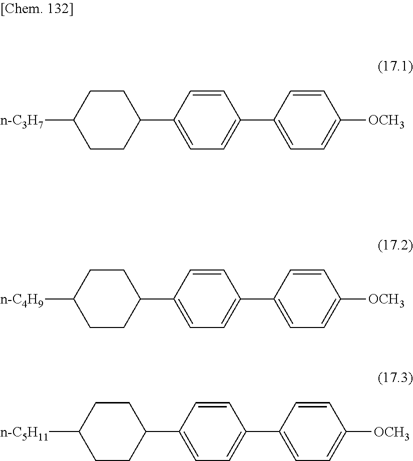

Alternatively/in addition, the compound represented by General Formula (L) is preferably at least one compound selected from the compound group represented by General Formula (IV).

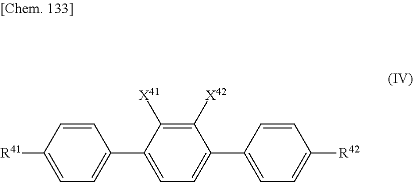

In General Formula (IV), each of R⁴¹ and R⁴² independently represents an alkyl group having 1 to 5 carbon atoms or an alkenyl group having 2 to 5 carbon atoms, and each of X⁴¹ and X⁴² independently represents a hydrogen atom or a fluorine atom.

The types of compound capable of being combined are not particularly limited, and a compound is suitably combined depending on the required performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three types are used. In still another embodiment of the present invention, four types are used. In still another embodiment of the present invention, five types are used. Furthermore, in still another embodiment of the present invention, six or more types are used.

Furthermore, the compound represented by General Formula (IV), for example, is preferably at least one compound selected from the compound group represented by General Formula (IV-1).

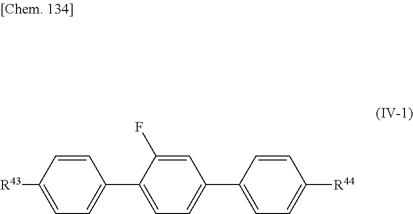

In General Formula (IV-1), each of R⁴³ and R⁴⁴ independently represents an alkyl group having 1 to 5 carbon atoms.

The content of the compound represented by General Formula (IV-1) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (IV-1) is 1% by mass to 30% by mass with respect to the total mass of the liquid crystal composition of the present invention, for example, in an embodiment. In another embodiment of the present invention, the content is 3% by mass to 30% by mass. In still another embodiment of the present invention, the content is 4% by mass to 30% by mass. In still another embodiment of the present invention, the content is 6% by mass to 30% by mass. In still another embodiment of the present invention, the content is 11% by mass to 30% by mass. Furthermore, in still another embodiment of the present invention, the content is 20% by mass to 30% by mass.

For example, in an embodiment of the present invention, the content of the compound represented by General Formula (IV-1) is 1% to 26% by mass with respect to the total mass of the liquid crystal composition of the present invention. In another embodiment of the present invention, the content is 1% to 20% by mass. In still another embodiment of the present invention, the content is 1% to 16% by mass. In still another embodiment of the present invention, the content is 1% to 6% by mass. Furthermore, in still another embodiment of the present invention, the content is 1% to 5% by mass.

Furthermore, the compound represented by General Formula (IV-1), for example, is preferably at least one compound selected from the compound group represented by Formulas (18.1) to (18.9).

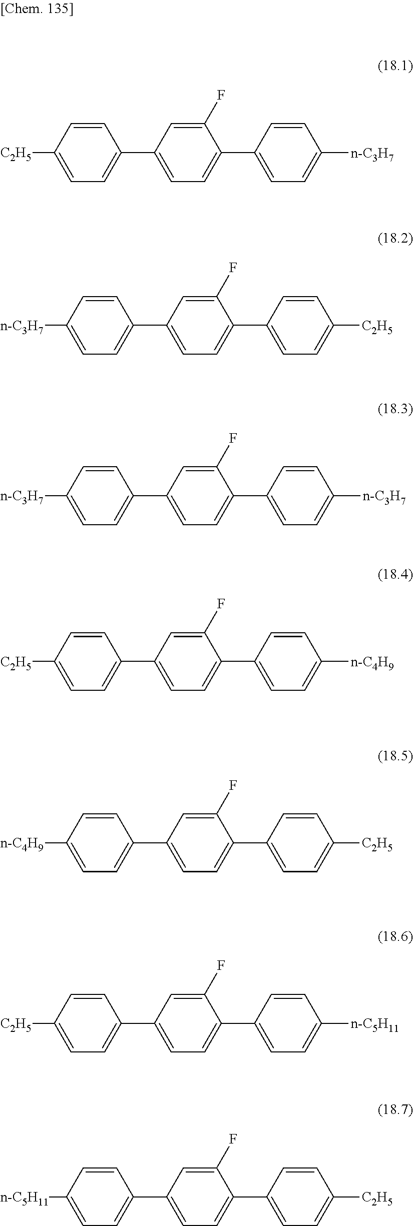

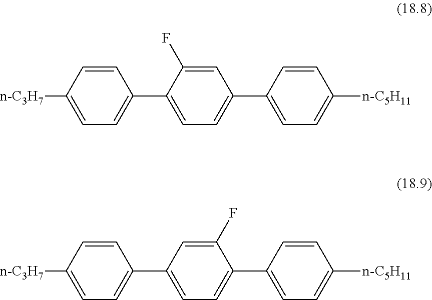

The types of compounds capable of being combined are not particularly limited, and one to three types of these compounds are preferably contained, and one to four types of these compounds are more preferably contained. In addition, since it is also effective for solubility that the molecular weight distribution of the selected compound is wide, for example, one compound represented by Formula (18.1) or (18.2), one compound represented by Formula (18.4) or (18.5), and one compound represented by Formula (18.6) or (18.7) are selected, and these compounds are preferably suitably combined. Among these, the compounds represented by Formulas (18.1), (18.3), (18.4), (18.6), and (18.9) are preferably included.

In the case of containing only one type, the compound represented by Formula (18.4) is preferably selected, in the case of containing two types, the compounds represented by Formulas (18.1) and (18.6) are preferably selected, and in the case of containing three types, the compounds represented by Formulas (18.1), (18.4), and (18.6) are preferably selected.

Alternatively/in addition, the compound represented by General Formula (IV), for example, is preferably at least one compound selected from the compound group represented by General Formula (IV-2).

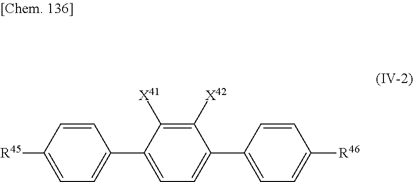

In General Formula (IV-2), each of R⁴⁵ and R⁴⁶ independently represents an alkyl group having 1 to 5 carbon atoms or an alkenyl group having 2 to 5 carbon atoms, at least one thereof represents an alkenyl group having 2 to 5 carbon atoms, and each of X⁴¹ and X⁴² independently represents a hydrogen atom or a fluorine atom.

The types of compound capable of being combined are not particularly limited, and a compound is suitably combined depending on the required performance such as solubility at a low temperature, a transition temperature, electrical reliability, and birefringence.

The content of the compound represented by General Formula (IV-2) needs to be suitably adjusted depending on the required performance such as solubility at a low temperature, a transition temperature, electrical reliability, birefringence, process compatibility, dropping marks, burn-in, and dielectric anisotropy. For example, the content of the compound represented by General Formula (IV-2) is preferably 1% by mass to 20% by mass with respect to the total mass of the liquid crystal composition of the present invention. Examples of a more preferable content include 1% to 15% by mass, 2% to 15% by mass, 5% to 15% by mass, 8% to 15% by mass, 2% to 15% by mass, 5% to 15% by mass, 8% to 15% by mass, 1% to 4% by mass, 3% to 7% by mass, and 7% to 13% by mass.

Furthermore, the compound represented by General Formula (IV-2), for example, is preferably at least one compound selected from the compound group represented by the following Formulas (19.1) to (19.8), and, among these, preferably the compound represented by Formula (19.2).

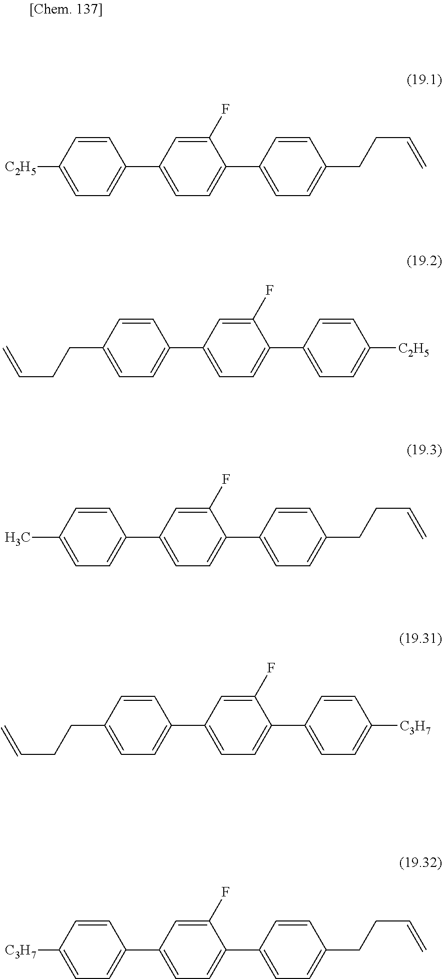

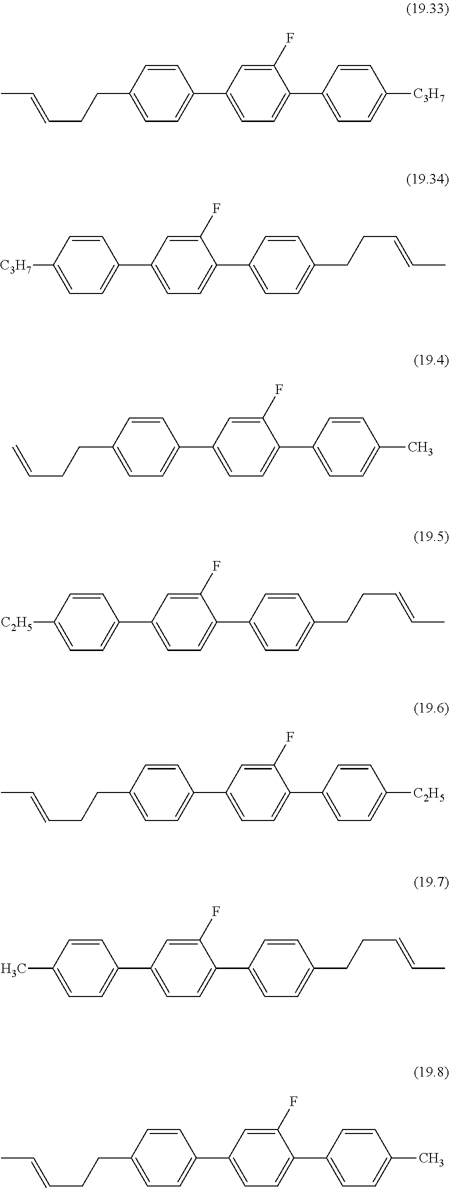

Since it is also effective for solubility that the molecular weight distribution of the compound selected as the component of the liquid crystal composition is wide, from the viewpoint of improving solubility of the liquid crystal composition, for example, one compound represented by Formula (19.1) or (19.2), one compound represented by Formula (19.3) or (19.4), one compound represented by Formula (19.5) or (19.6), and one compound represented by Formula (19.7) or (19.8) are selected respectively, and these compounds are preferably suitably combined.

In the liquid crystal composition of the present invention, the content of the compound represented by Formula (19.4) is preferably 3% by mass to 25% by mass, preferably 5% by mass to 20% by mass, preferably 5% by mass to 15% by mass, and preferably 7% by mass to 10% by mass, with respect to the total mass of the liquid crystal composition of the present invention, in consideration of solubility at a low temperature, a transition temperature, and electrical reliability.

Furthermore, the compound represented by General Formula (L) is preferably at least one compound selected from the compound group represented by General Formula (V).

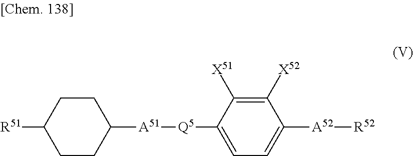

In General Formula (V), each of R⁵¹ and R⁵² independently represents an alkyl group having 1 to 5 carbon atoms, an alkenyl group having 2 to 5 carbon atoms, or an alkoxy group having 1 to 4 carbon atoms, each of A⁵¹ and A⁵² independently represents a 1,4-cyclohexylene group or a 1,4-phenylene group, Q⁵ represents a single bond or —COO—, and each of X⁵¹ and X⁵² independently represents a fluorine atom or a hydrogen atom.

The types of compound capable of being combined are not particularly limited, and a compound is suitably combined depending on the required performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three types are used. Furthermore, in still another embodiment of the present invention, four types are used.

The content of the compound represented by General Formula (V) is 2% to 40% by mass with respect to the total mass of the liquid crystal composition of the present invention, for example, in an embodiment. In another embodiment of the present invention, the content is 4% to 40% by mass. In still another embodiment of the present invention, the content is 7% to 40% by mass. In still another embodiment of the present invention, the content is 10% to 40% by mass. In still another embodiment of the present invention, the content is 12% to 40% by mass. Instill another embodiment of the present invention, the content is 15% to 40% bymass. In still another embodiment of the present invention, the content is 17% to 40% by mass. In still another embodiment of the present invention, the content is 18% to 40% by mass. In still another embodiment of the present invention, the content is 20% to 40% by mass. Furthermore, in still another embodiment of the present invention, the content is 22% to 40% by mass.

For example, in an embodiment of the present invention, the content of the compound is 2% to 30% by mass with respect to the total mass of the liquid crystal composition of the present invention. In another embodiment of the present invention, the content of the compound is 2% to 25% by mass. In still another embodiment of the present invention, the content of the compound is 2% to 20% by mass. In still another embodiment of the present invention, the content of the compound is 2% to 15% by mass. In still another embodiment of the present invention, the content of the compound is 2% to 10% by mass. In still another embodiment of the present invention, the content of the compound is 2% to 5% by mass. Furthermore, in still another embodiment of the present invention, the content of the compound is 2% to 4% by mass.

Furthermore, the compound represented by General Formula (V) is preferably the compound represented by General Formula (V-1).

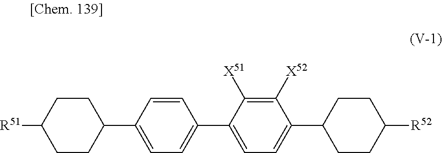

In General Formula (V-1), each of R⁵¹ and R⁵² independently represents an alkyl group having 1 to 5 carbon atoms, an alkenyl group having 2 or 5 carbon atoms, or an alkoxy having 1 to 4 carbon atoms, and each of X⁵¹ and X⁵² independently represents a fluorine atom or a hydrogen atom.

Furthermore, the compound represented by General Formula (V-1) is preferably the compound represented by General Formula (V-1-1).

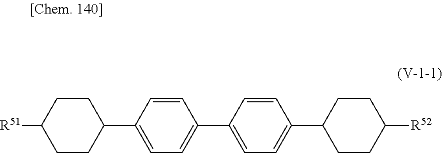

In General Formula (V-1-1), each of R⁵¹ and R⁵² independently represents an alkyl group having 1 to 5 carbon atoms, an alkenyl group having 2 to 5 carbon atoms, or an alkoxy group having 1 to 4 carbon atoms.

The compound represented by General Formula (V-1-1) is contained in an amount of preferably 1% by mass to 15% by mass, more preferably 2% by mass to 10% by mass, more preferably 3% by mass to 10% by mass, and particularly preferably 3% by mass to 7% by mass, with respect to the total mass of the liquid crystal composition of the present invention.

Furthermore, the compound represented by General Formula (V-1-1) is preferably at least one compound selected from the compound group represented by Formulas (20.1) to (20.4), and preferably the compound represented by Formula (20.2).

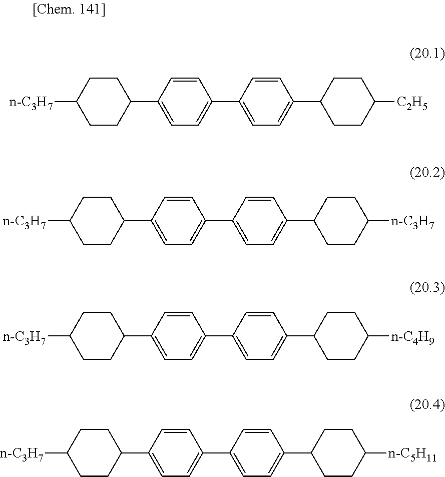

Alternatively/in addition, the compound represented by General Formula (V-1) is preferably the compound represented by General Formula (V-1-2).

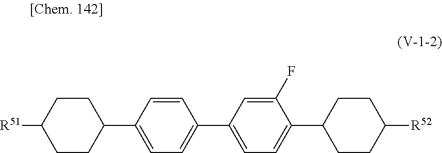

In General Formula (V-1-2), each of R⁵¹ and R⁵² independently represents an alkyl group having 1 to 5 carbon atoms, an alkenyl group having 2 to 5 carbon atoms, or an alkoxy group having 1 to 4 carbon atoms.

The compound represented by General Formula (V-1-2) is contained in an amount of preferably 1% by mass to 15% by mass, preferably 1% by mass to 10% by mass, preferably 1% by mass to 7% by mass, and preferably 1% by mass to 5% by mass, with respect to the total mass of the liquid crystal composition of the present invention.

Furthermore, the compound represented by General Formula (V-1-2) is preferably at least one compound selected from the compound group represented by Formulas (21.1) to (21.3), and preferably the compound represented by Formula (21.1).

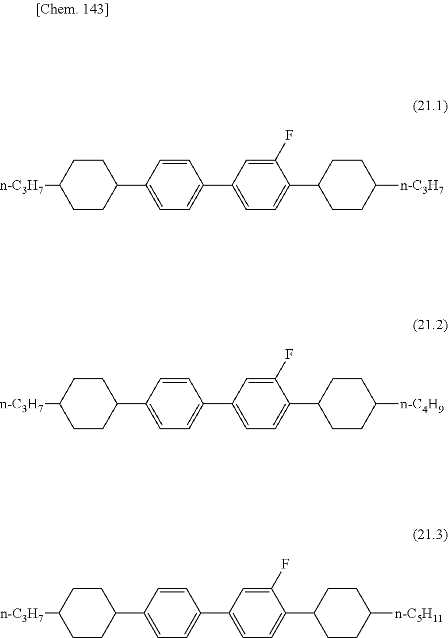

Alternatively/in addition, the compound represented by General Formula (V-1) is preferably the compound represented by General Formula (V-1-3).

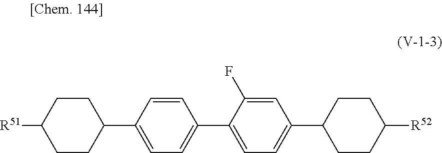

In General Formula (V-1-3), each of R⁵¹ and R⁵² independently represents an alkyl group having 1 to 5 carbon atoms, an alkenyl group having 2 to 5 carbon atoms, or an alkoxy group having 1 to 4 carbon atoms.

The compound represented by General Formula (V-1-3) is contained in an amount of preferably 1% by mass to 15% by mass, preferably 2% by mass to 15% by mass, preferably 3% by mass to 10% by mass, and preferably 4% by mass to 8% by mass, with respect to the total mass of the liquid crystal composition of the present invention.

Furthermore, the compound represented by General Formula (V-1-3) is preferably at least one compound selected from the compound group represented by Formulas (22.1) to (22.3), and more preferably the compound represented by Formula (22.1).

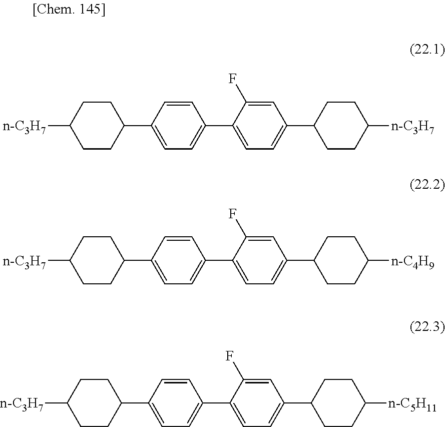

Alternatively/in addition, the compound represented by General Formula (V) is preferably the compound represented by General Formula (V-2).

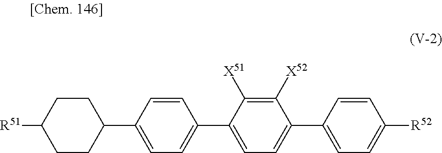

In General Formula (V-2), each of R⁵¹ and R⁵² independently represents an alkyl group having 1 to 5 carbon atoms, an alkenyl group having 2 to 5 carbon atoms, or an alkoxy group having 1 to 4 carbon atoms, and each of X⁵¹ and X⁵² independently represents a fluorine atom or a hydrogen atom.

The types of compound capable of being combined are not particularly limited, and a compound is suitably combined depending on the required performance such as solubility at a low temperature, a transition temperature, electrical reliability, and birefringence. The type of compound used, for example, is one type in an embodiment of the present invention. Alternatively, in another embodiment of the present invention, two or more types are used.

The content of the compound represented by General Formula (V-2) is 2% to 40% by mass with respect to the total mass of the liquid crystal composition of the present invention, for example, in an embodiment. In another embodiment of the present invention, the content of the compound is 4% to 40% by mass. In still another embodiment of the present invention, the content of the compound is 7% to 40% by mass. In still another embodiment of the present invention, the content of the compound is 10% to 40% by mass.

In still another embodiment of the present invention, the content of the compound is 12% to 40% by mass. Instill another embodiment of the present invention, the content of the compound is 15% to 40% by mass. In still another embodiment of the present invention, the content of the compound is 17% to 40% by mass. In still another embodiment of the present invention, the content of the compound is 18% to 40% by mass. In still another embodiment of the present invention, the content of the compound is 20% to 40% by mass. Furthermore, in still another embodiment of the present invention, the content of the compound is 22% to 40% by mass.

For example, in an embodiment of the present invention, the content of the compound represented by General Formula (V-2) is 2% to 30% by mass with respect to the total mass of the liquid crystal composition of the present invention. In another embodiment of the present invention, the content of the compound is 2% to 25% bymass. In still another embodiment of the present invention, the content of the compound is 2% to 20% by mass. In still another embodiment of the present invention, the content of the compound is 2% to 15% by mass. In still another embodiment of the present invention, the content of the compound is 2% to 10% by mass. In still another embodiment of the present invention, the content of the compound is 2% to 5% by mass. Furthermore, in still another embodiment of the present invention, the content of the compound is 2% to 4% by mass.

In the case of desiring an embodiment in which the liquid crystal composition of the present invention has a high Tni, it is preferable to increase the content of the compound represented by Formula (V-2), and in the case of desiring an embodiment having a low viscosity, it is preferable to decrease the content.

Furthermore, the compound represented by General Formula (V-2) is preferably the compound represented by General Formula (V-2-1).

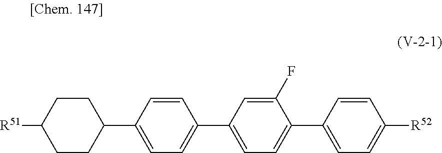

In General Formula (V-2-1), each of R⁵¹ and R⁵² independently represents an alkyl group having 1 to 5 carbon atoms, an alkenyl group having 2 to 5 carbon atoms, or an alkoxy group having 1 to 4 carbon atoms.

Furthermore, the compound represented by General Formula (V-2-1) is preferably at least one compound selected from the compound group represented by Formulas (23.1) to (23.4), and preferably the compound represented by Formulas (23.1) and/or (23.2).

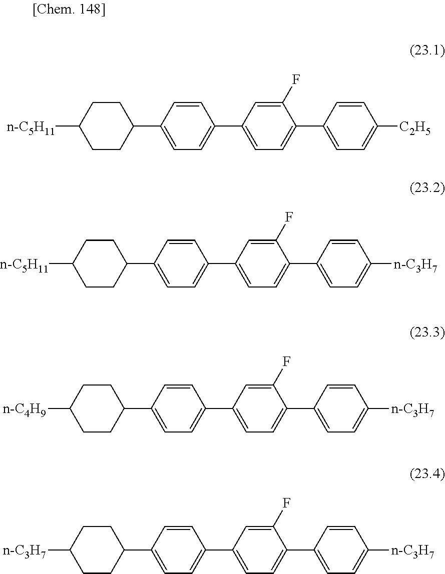

Alternatively/in addition, the compound represented by General Formula (V-2) is preferably the compound represented by General Formula (V-2-2).

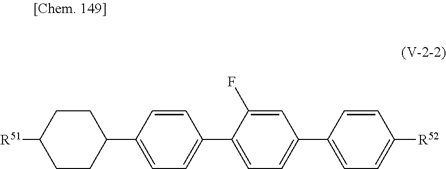

In General Formula (V-2-2), each of R⁵¹ and R⁵² independently represents an alkyl group having 1 to 5 carbon atoms, an alkenyl group having 2 to 5 carbon atoms, or an alkoxy group having 1 to 4 carbon atoms.

The compound represented by General Formula (V-2-2) is contained in an amount of preferably 2% by mass to 16% by mass, preferably 3% by mass to 13% by mass, and preferably 4% by mass to 10% by mass, with respect to the total mass of the liquid crystal composition of the present invention.

Furthermore, the compound represented by General Formula (V-2-2) is preferably at least one compound selected from the compound group represented by Formulas (24.1) to (24.4), and preferably the compound represented by Formulas (24.1) and/or (24.2).

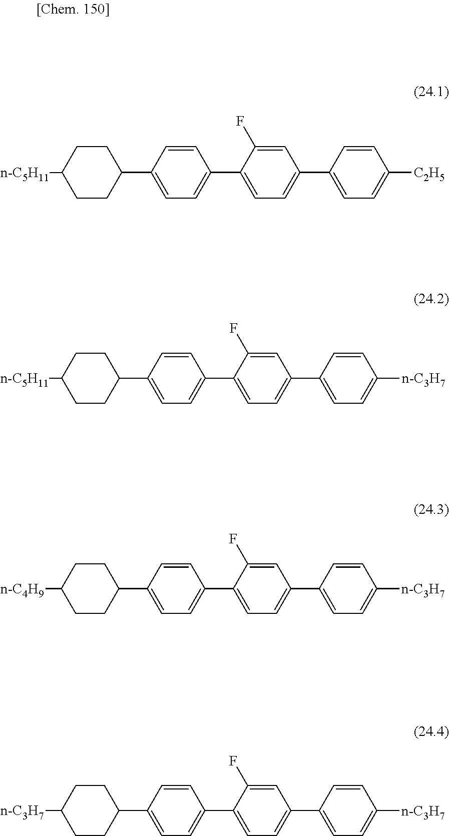

Alternatively/in addition, the compound represented by General Formula (V) is preferably the compound represented by General Formula (V-3).

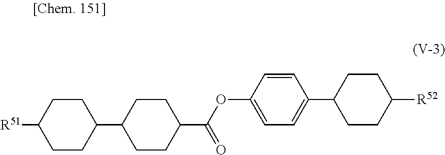

In General Formula (V-3), each of R⁵¹ and R⁵² independently represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined depending on the required performance such as solubility at a low temperature, a transition temperature, electrical reliability, and birefringence. The type of compound used, for example, is one type in an embodiment of the present invention. In another embodiment of the present invention, two types are used. Furthermore, in still another embodiment of the present invention, three or more types are used.

The compound represented by General Formula (V-3) is contained in an amount of preferably 2% by mass to 16% by mass, preferably 4% by mass to 16% by mass, preferably 7% by mass to 13% by mass, and preferably 8% by mass to 11% by mass, with respect to the total mass of the liquid crystal composition of the present invention.

Furthermore, the compound represented by General Formula (V-3) is preferably at least one compound selected from the compound group represented by Formulas (25.1) to (25.3).

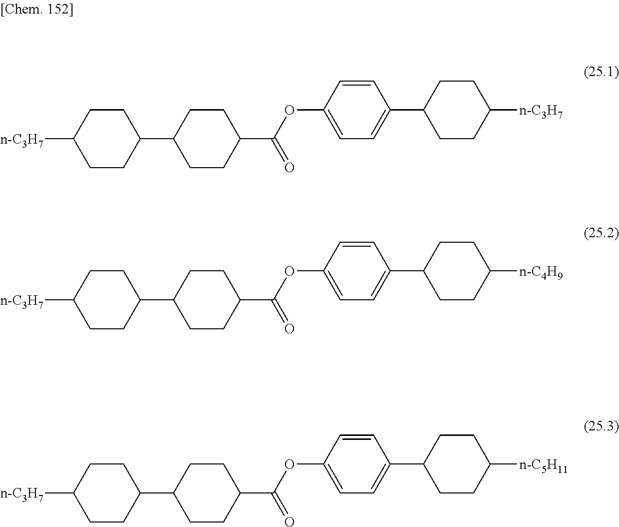

Alternatively/in addition, the compound represented by General Formula (V) is preferably the compound represented by General Formula (V′-3).

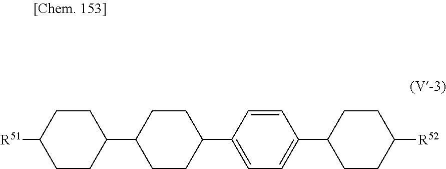

In General Formula (V′-3), each of R⁵¹ and R⁵² independently represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined depending on the required performance such as solubility at a low temperature, a transition temperature, electrical reliability, and birefringence. The type of compound used, for example, is one type in an embodiment of the present invention. In another embodiment of the present invention, two types are used. Furthermore, in still another embodiment of the present invention, three or more types are used.

The compound represented by General Formula (V′-3) is contained in an amount of preferably 2% by mass to 16% by mass, preferably 4% by mass to 16% by mass, preferably 7% by mass to 13% by mass, and preferably 8% by mass to 11% by mass, with respect to the total mass of the liquid crystal composition of the present invention.

Furthermore, the compound represented by General Formula (V′-3) is preferably at least one compound selected from the compound group represented by Formulas (25.31) to (25.33).

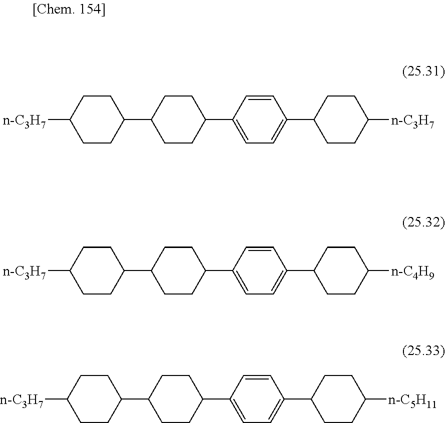

Alternatively/in addition, the compound represented by General Formula (V) used in the liquid crystal composition of the present invention is preferably the compound represented by General Formula (V-4).

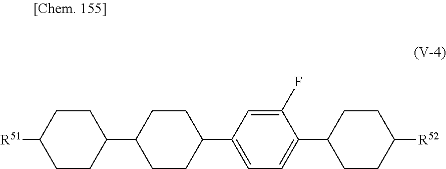

In General Formula (V-4), each of R⁵¹ and R⁵² independently represents an alkyl group having 1 to 5 carbon atoms, an alkenyl group having 2 to 5 carbon atoms, or an alkoxy group having 1 to 4 carbon atoms.

The compound represented by General Formula (V-4) is contained in an amount of preferably 1% by mass to 15% by mass, preferably 2% by mass to 15% by mass, preferably 3% by mass to 10% by mass, and preferably 4% by mass to 8% by mass, with respect to the total mass of the liquid crystal composition of the present invention.

Furthermore, the compound represented by General Formula (V-4) is preferably at least one compound selected from the compound group represented by Formulas (25.11) to (25.13), and more preferably the compound represented by Formula (25.13).

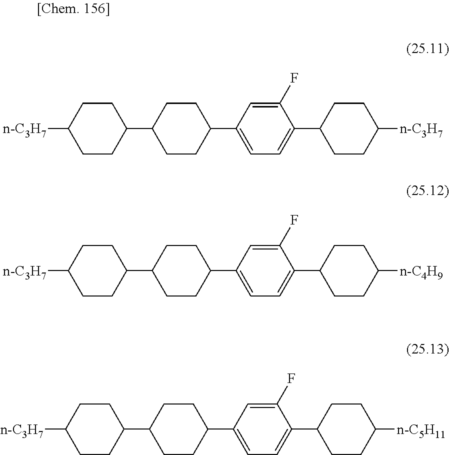

Alternatively/in addition, the compound represented by General Formula (L) used in the liquid crystal composition of the present invention is preferably the compound represented by General Formula (V′-5).

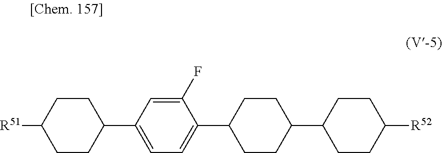

In General Formula (V′-5), each of R⁵¹ and R⁵² independently represents an alkyl group having 1 to 5 carbon atoms, an alkenyl group having 2 to 5 carbon atoms, or an alkoxy group having 1 to 4 carbon atoms.

The compound represented by General Formula (V′-5) is contained in an amount of preferably 1% by mass to 15% by mass, preferably 2% by mass to 15% by mass, and preferably 2% by mass to 13% by mass, with respect to the total mass of the liquid crystal composition of the present invention.

Furthermore, the compound represented by General Formula (V′-5) is preferably at least one compound selected from the compound group represented by Formulas (25.21) to (25.25), and more preferably the compound represented by Formulas (25.21) and/or (25.23).

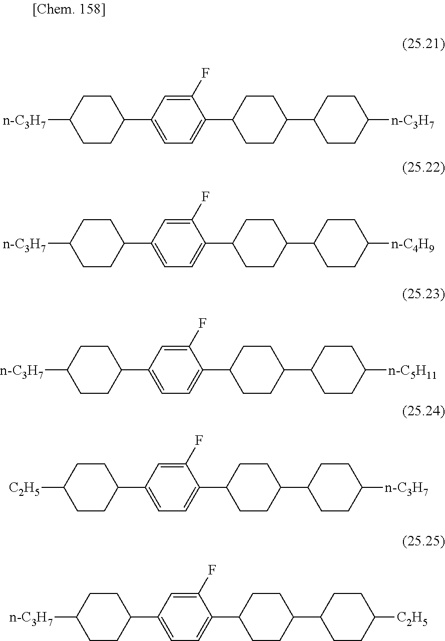

The liquid crystal composition of the present invention can also further contain at least one compound represented by General Formula (VI).

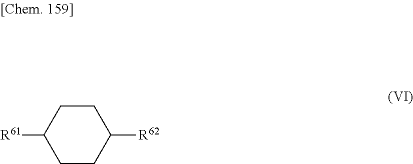

In General Formula (VI), each of R⁶¹ and R⁶² independently represents a linear alkyl group having 1 to 10 carbon atoms, a linear alkoxy group having 1 to 10 carbon atoms, or a linear alkenyl group having 2 to 10 carbon atoms.

The types of compounds capable of being combined are not particularly limited, and one to three types of these compounds are preferably mixed, one to four types thereof are more preferably contained, and one to five or more types thereof are particularly preferably contained, depending on the required performance such as solubility at a low temperature, a transition temperature, electrical reliability, and birefringence.

The content of the compound represented by General Formula (VI) is preferably 0% to 35% by mass, preferably 0% to 25% by mass, and preferably 0% to 15% by mass, with respect to the total mass of the liquid crystal composition of the present invention.

As the compound represented by General Formula (VI), specifically, the following compounds can be suitably used.

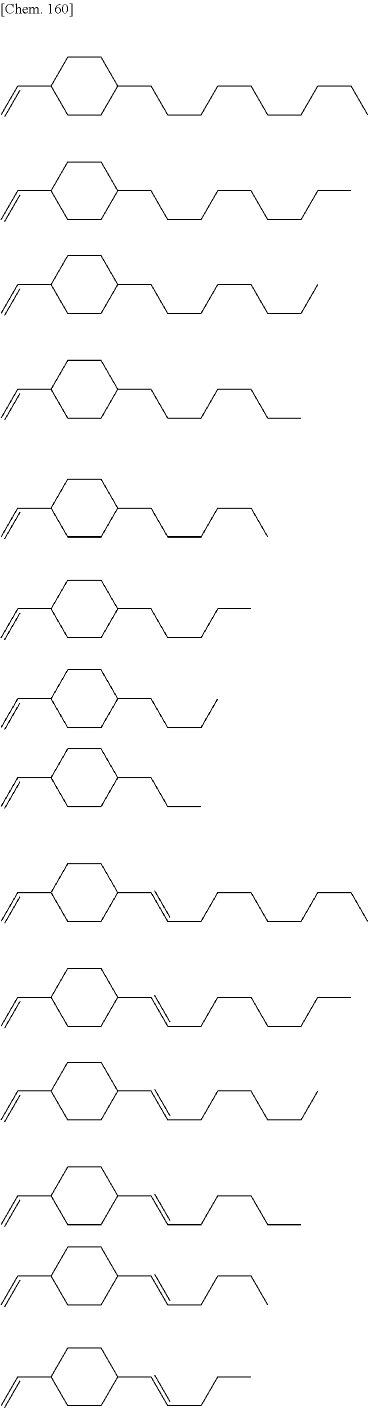

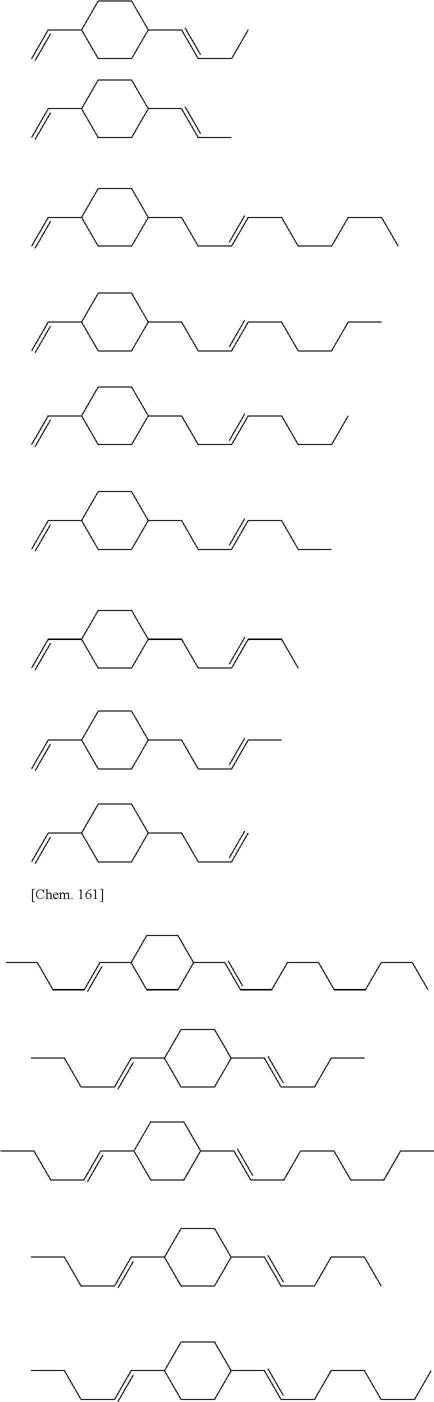

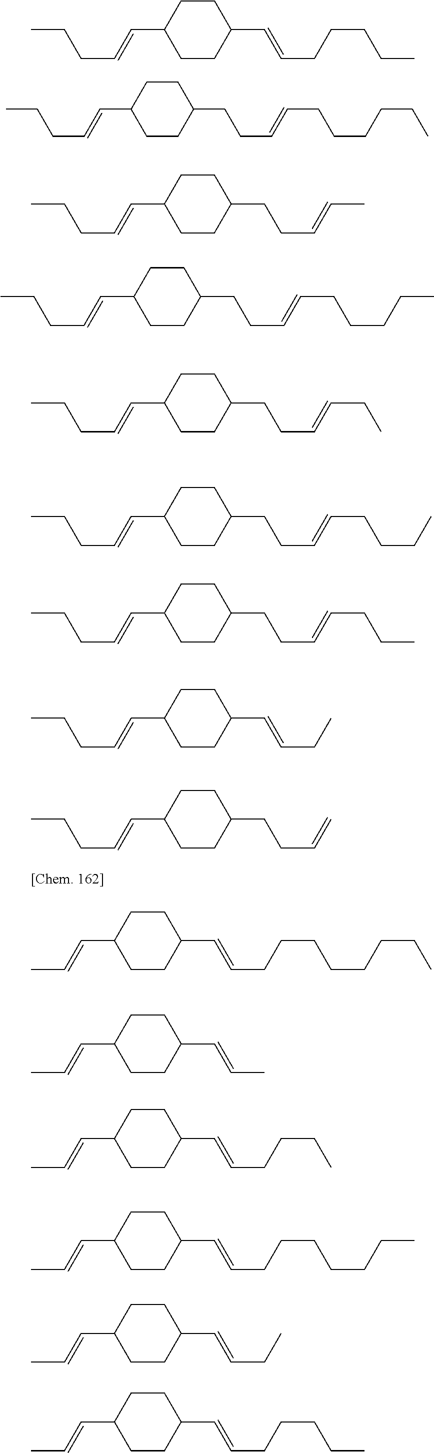

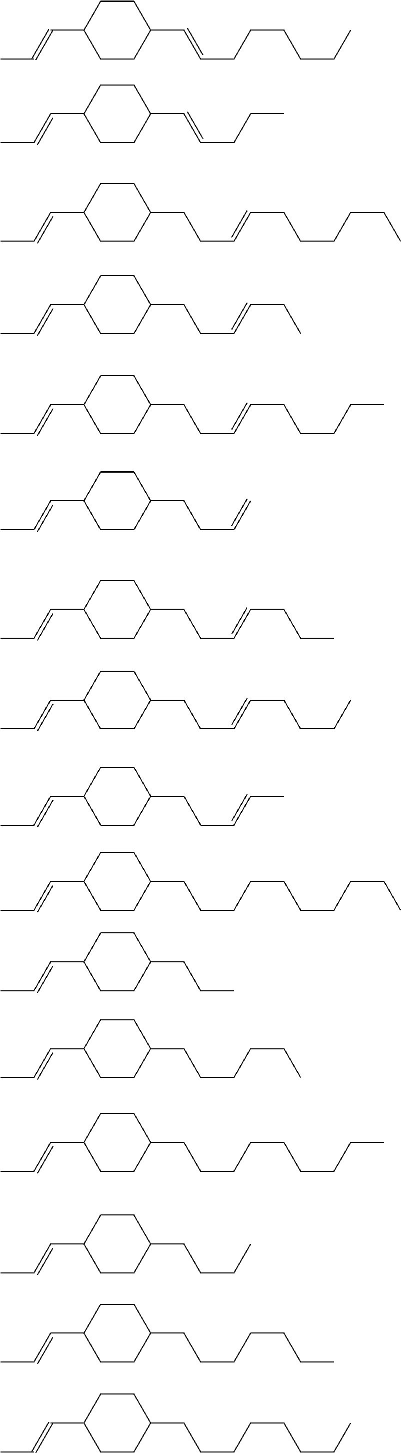

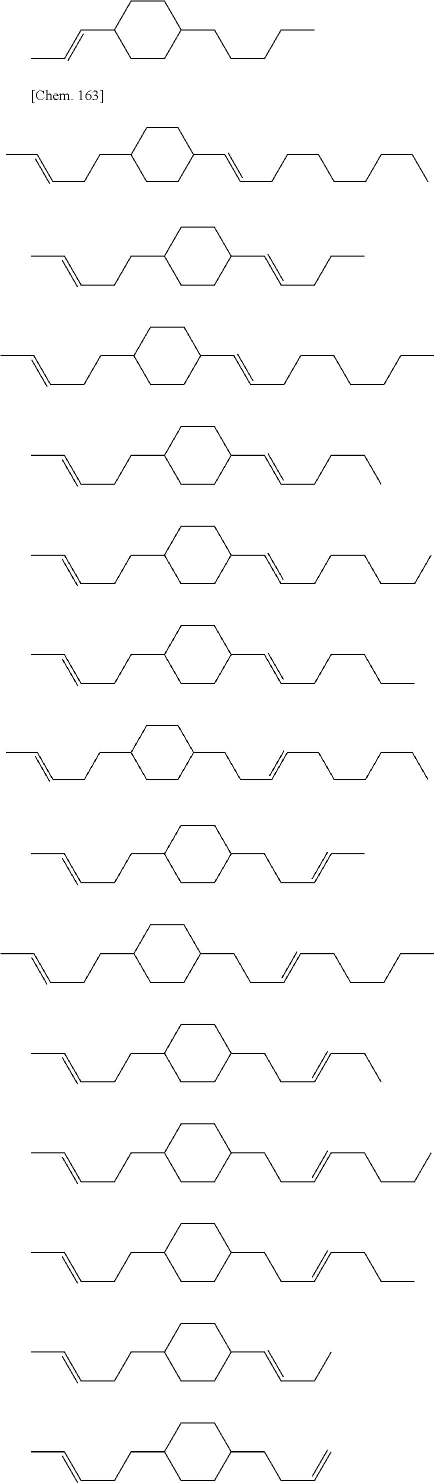

The liquid crystal composition of the present invention can further contain at least one compound represented by General Formula (VII).

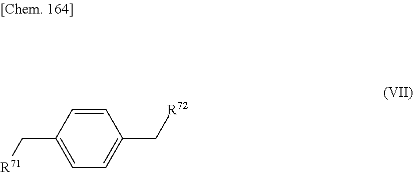

In General Formula (VII), each of R⁷¹ and R⁷² independently represents a linear alkyl group having 1 to 10 carbon atoms, a linear alkoxy group having 1 to 10 carbon atoms, or a linear alkenyl group having 4 to 10 carbon atoms.

The types of compounds capable of being combined are not particularly limited, and one to three types suitably selected among these compounds are preferably mixed, one to four types are more preferably mixed, and one to five or more types are particularly preferably contained, depending on the required performance such as solubility at a low temperature, a transition temperature, electrical reliability, and birefringence.

The content of the compound represented by General Formula (VII) is preferably 0% to 35% by mass, more preferably 0% to 25% by mass, and preferably 0% to 15% by mass, with respect to the total mass of the liquid crystal composition of the present invention.

As the compound represented by General Formula (VII), specifically, the following compounds can be suitably used.

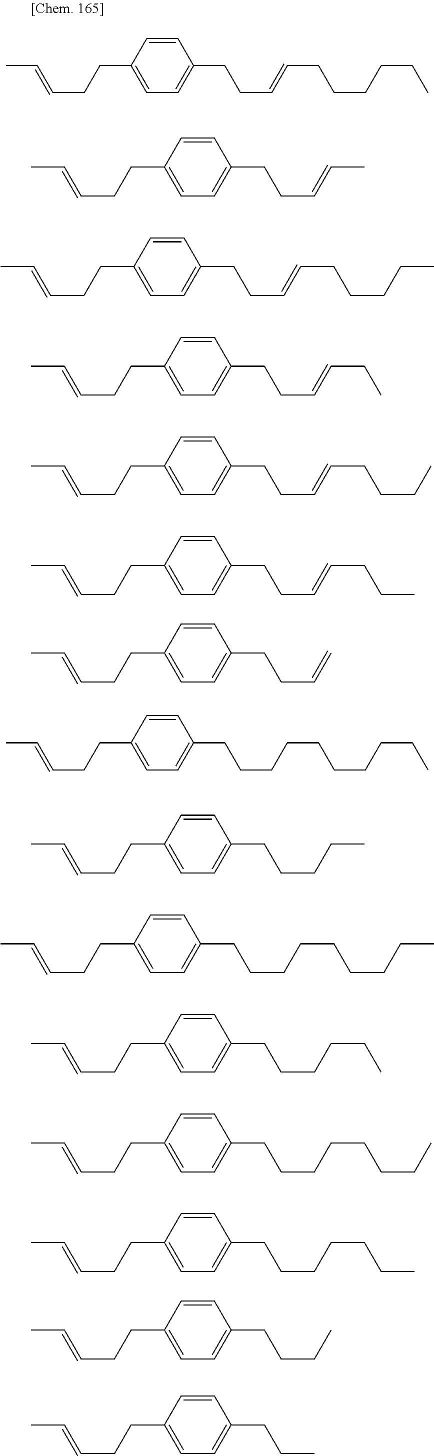

The liquid crystal composition of the present invention also preferably further contains at least one compound represented by the following General Formula (M).

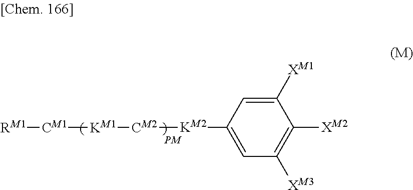

In General Formula (M), R^{M1} represents an alkyl group having 1 to 8 carbon atoms, each of one —CH₂— group or two or more non-adjacent —CH₂— groups in the alkyl group may be independently substituted with —CH═CH—, —C≡C—, —O—, —CO—, —COO—, or —OCO—,

PM represents 0, 1, 2, 3, or 4,

each of C^{M1} and C^{M2} independently represents a group selected from the group consisting of

(d) 1,4-cyclohexylene group (one —CH₂— group or two or more non-adjacent —CH₂— groups present in the group may be substituted with —O— or —S—) and

(e) 1,4-phenylene group (one —CH═ group or two or more non-adjacent —CH═ groups present in the group may be substituted with —N═), each of the groups (d) and (e) may be independently substituted with a cyano group, a fluorine atom, or a chlorine atom,

each of K^{M1} and K^{M2} independently represents a single bond, —CH₂CH₂—, (CH₂)₄—, —OCH₂—, —CH₂O—, —OCF₂—, —CF₂O—, —COO—, —OCO—, or —C≡C—,

in a case where a plurality of K^{M1}'s are present since PM is 2, 3, or 4, K^{M1}'s may be the same as or different from each other, in a case where a plurality of C^{M2}'s are present since PM is 2, 3, or 4, C^{M2}'s may be the same as or different from each other,

each X^{M1} and X^{M3} independently represents a hydrogen atom, a chlorine atom, or a fluorine atom, and

X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group, provided that the compound represented by General Formula (i) is excluded.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. In another embodiment of the present invention, two types are used. Instill another embodiment of the present invention, three types are used. In still another embodiment of the present invention, four types are used. In still another embodiment of the present invention, five types are used. In still another embodiment of the present invention, six types are used. Furthermore, in still another embodiment of the present invention, seven or more types are used.

In the liquid crystal composition of the present invention, the content of the compound represented by General Formula (M) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (M) is 1% to 95% by mass with respect to the total mass of the liquid crystal composition of the present invention in an embodiment of the present invention. For example, in another embodiment of the present invention, the content of the compound is 10% to 95% by mass. For example, in still another embodiment of the present invention, the content of the compound is 20% to 95% by mass. For example, in still another embodiment of the present invention, the content of the compound is 30% to 95% by mass. For example, in still another embodiment of the present invention, the content of the compound is 40% to 95% by mass. For example, in still another embodiment of the present invention, the content of the compound is 45% to 95% by mass. For example, in still another embodiment of the present invention, the content of the compound is 50% to 95% by mass. For example, in still another embodiment of the present invention, the content of the compound is 55% to 95% by mass. For example, in still another embodiment of the present invention, the content of the compound is 60% to 95% by mass. For example, in still another embodiment of the present invention, the content of the compound is 65% to 95% by mass. For example, in still another embodiment of the present invention, the content of the compound is 70% to 95% by mass. For example, in still another embodiment of the present invention, the content of the compound is 75% to 95% by mass. For example, in still another embodiment of the present invention, the content of the compound is 80% to 95% by mass.

The content of the compound represented by General Formula (M) is 1% to 85% by mass with respect to the total mass of the liquid crystal composition of the present invention, for example, in an embodiment of the present invention. In another embodiment of the present invention, the content of the compound is 1% to 75% bymass. In still another embodiment of the present invention, the content of the compound is 1% to 65% by mass. In still another embodiment of the present invention, the content of the compound is 1% to 55% by mass. In still another embodiment of the present invention, the content of the compound is 1% to 45% by mass. In still another embodiment of the present invention, the content of the compound is 1% to 35% by mass. In still another embodiment of the present invention, the content of the compound is 1% to 25% by mass.

In a case where it is required that the viscosity of the liquid crystal composition of the present invention be kept low and the liquid crystal composition have a high response speed, it is preferable that the above-described lower limit value is small and the above-described upper limit value is small. In a case where it is required that Tni of the liquid crystal composition of the present invention be kept high and the liquid crystal composition have good temperature stability, it is preferable that the above-described lower limit value is small and the above-described upper limit value is small. In addition, when it is desired to increase the dielectric anisotropy in order to keep the driving voltage low, it is preferable that the above-described lower limit value is large and the above-described upper limit value is large.

In a case where the ring structure to which R^{M1} is bonded is a phenyl group (aromatic group), R^{M1} is preferably a linear alkyl group having 1 to 5 carbon atoms, a linear alkoxy group having 1 to 4 carbon atoms, or an alkenyl group having 4 or 5 carbon atoms, and in a case where the ring structure to which R^{M1} is bonded is a saturated ring structure such as cyclohexane, pyran, or dioxane, R^{M1} is preferably a linear alkyl group having 1 to 5 carbon atoms, a linear alkoxy group having 1 to 4 carbon atoms, or a linear alkenyl group having 2 to 5 carbon atoms.

In a case where chemical stability of the liquid crystal composition is required, the compound represented by General Formula (M) is preferably has no chlorine atom in the molecule thereof. The content of the compound having a chlorine atom in the liquid crystal composition is preferably 0% to 5% by mass, preferably 0% to 3% by mass, preferably 0% to 1% by mass, and preferably 0% to 0.5% by mass, with respect to the total mass of the liquid crystal composition of the present invention, and the compound having a chlorine atom is preferably substantially not contained. Here, the “substantially does not contain” means that only the compound which unintentionally includes a chlorine atom, such as a compound produced as an impurity at the time of manufacturing a compound is mixed in the liquid crystal composition.

The compound represented by General Formula (M), for example, is preferably at least one compound selected from the compound group represented by General Formula (VIII).

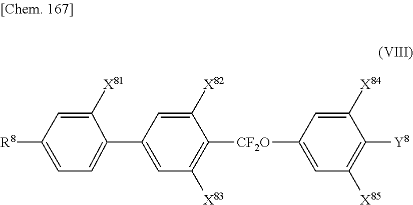

In General Formula (VIII), R⁸ represents an alkyl group having 1 to 5 carbon atoms, an alkenyl group having 2 to 5 carbon atoms, or an alkoxy group having 1 to 4 carbon atoms, each of X⁸¹ to X⁸⁵ independently represents a hydrogen atom or a fluorine atom, and Y⁸ represents a fluorine atom or —OCF₃.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. In another embodiment of the present invention, two types are used. Furthermore, in still another embodiment of the present invention, three or more types are used.

In the liquid crystal composition of the present invention, the content of the compound represented by General Formula (VIII) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (VIII) is 2% to 40% by mass with respect to the total mass of the liquid crystal composition of the present invention, for example, in an embodiment of the present invention. For example, in another embodiment of the present invention, the content of the compound is 4% to 40% by mass. For example, in still another embodiment of the present invention, the content of the compound is 5% to 40% by mass. For example, in still another embodiment of the present invention, the content of the compound is 6% to 40% by mass. For example, in still another embodiment of the present invention, the content of the compound is 7% to 40% by mass. For example, in still another embodiment of the present invention, the content of the compound is 8% to 40% by mass. For example, in still another embodiment of the present invention, the content of the compound is 9% to 40% by mass. For example, in still another embodiment of the present invention, the content of the compound is 10% to 40% by mass. For example, in still another embodiment of the present invention, the content of the compound is 11% to 40% by mass. For example, in still another embodiment of the present invention, the content of the compound is 12% to 40% by mass. For example, in still another embodiment of the present invention, the content of the compound is 14% to 40% by mass. For example, in still another embodiment of the present invention, the content of the compound is 15% to 40% by mass. For example, in still another embodiment of the present invention, the content of the compound is 21% to 40% by mass. For example, in still another embodiment of the present invention, the content of the compound is 23% to 40% by mass.

The content of the compound is 2% to 30% by mass with respect to the total mass of the liquid crystal composition of the present invention, for example, in an embodiment of the present invention. In another embodiment of the present invention, the content of the compound is 2% to 25% by mass. In still another embodiment of the present invention, the content of the compound is 2% to 21% by mass. In still another embodiment of the present invention, the content of the compound is 2% to 16% by mass. In still another embodiment of the present invention, the content of the compound is 2% to 12% by mass. In still another embodiment of the present invention, the content of the compound is 2% to 8% by mass. In still another embodiment of the present invention, the content of the compound is 2% to 5% by mass.

In a case where it is required that the viscosity of the liquid crystal composition of the present invention be kept low and the liquid crystal composition have a high response speed, it is preferable that the above-described lower limit value is small and the above-described upper limit value is small. In a case where it is required that Tni of the liquid crystal composition of the present invention be kept high and the liquid crystal composition have good temperature stability, it is preferable that the above-described lower limit value is small and the above-described upper limit value is small. In addition, when it is desired to increase the dielectric anisotropy in order to keep the driving voltage low, it is preferable that the above-described lower limit value is large and the above-described upper limit value is large.

Furthermore, the compound represented by General Formula (VIII) is preferably the compound represented by General Formula (VIII-1).

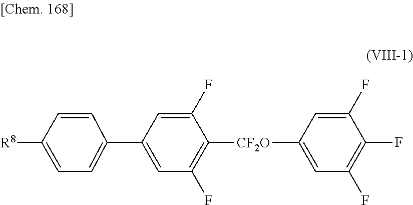

In General Formula (VIII-1), R⁸ represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. Alternatively, in another embodiment of the present invention, two or more types are used.

Furthermore, the compound represented by General Formula (VIII-1), specifically, is preferably at least one compound selected from the compound group represented by Formulas (26.1) to (26.4), preferably the compound represented by Formulas (26.1) and/or (26.2), and more preferably the compound represented by Formula (26.2).

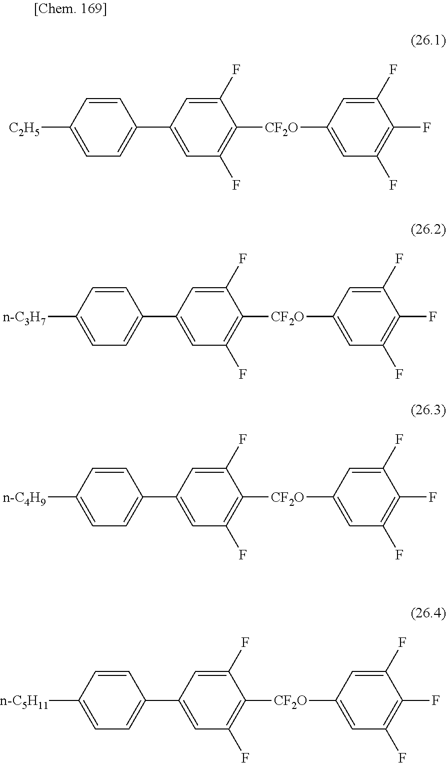

The content of the compound represented by Formula (26.1) is preferably 1% by mass to 20% by mass, more preferably 1% by mass to 15% by mass, still more preferably 1% by mass to 10% by mass, and particularly preferably 1% by mass to 7% by mass, with respect to the total mass of the liquid crystal composition of the present invention, in consideration of solubility at a low temperature, a transition temperature, electrical reliability, and birefringence. Within the particularly preferable range, 1% by mass to 6% by mass, 1% by mass to 5% by mass, 1% by mass to 3% by mass, 3% by mass to 7% by mass, and 3% by mass to 6% by mass are exemplified.

The content of the compound represented by Formula (26.2) is preferably 1% by mass to 30% by mass, more preferably 1% by mass to 25% by mass, still more preferably 1% by mass to 20% by mass, and particularly preferably 1% by mass to 18% by mass, with respect to the total mass of the liquid crystal composition of the present invention, in consideration of solubility at a low temperature, a transition temperature, electrical reliability, and birefringence. Within the particularly preferable range, for example, 1% by mass to 2% by mass, 3% by mass to 12% by mass, 4% by mass to 12% by mass, 4% by mass to 10% by mass, 6% by mass to 12% by mass, 6% by mass to 9% by mass, 6% by mass to 8% by mass, 7% by mass to 12% by mass, 8% by mass to 11% by mass, 3% by mass to 7% by mass, 5% by mass to 10% by mass, or 12% by mass to 18% by mass is preferable.

The total content of the compound represented by Formula (26.1) and the compound represented by Formula (26.2) is preferably 1% by mass to 30% by mass, more preferably 1% by mass to 25% by mass, and still more preferably 1% by mass to 20% by mass, with respect to the total mass of the liquid crystal composition of the present invention. Within the still more preferable range, 1% by mass to 18% by mass, 1% by mass to 14% by mass, 1% by mass to 10% by mass, 1% by mass to 9% by mass, 1% by mass to 8% by mass, 1% by mass to 2% by mass, 5% by mass to 10% by mass, 6% by mass to 10% by mass, 6% by mass to 9% by mass, 6% by mass to 8% by mass, 8% by mass to 12% by mass, 7% by mass to 12% by mass, 9% by mass to 14% by mass, and 12% by mass to 18% by mass are exemplified.

Alternatively/in addition, the compound represented by General Formula (VIII) is preferably the compound represented by General Formula (VIII-2).

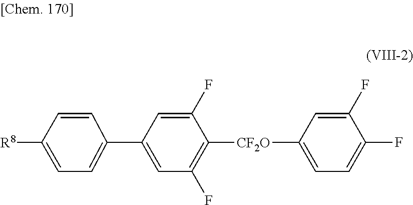

In General Formula (VIII-2), R⁸ represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three or more types are used.

The content of the compound represented by General Formula (VIII-2) is preferably 2.5% by mass to 25% by mass, preferably 8% by mass to 25% by mass, preferably 10% by mass to 20% by mass, and preferably 12% by mass to 15% by mass, with respect to the total mass of the liquid crystal composition of the present invention, in consideration of solubility at a low temperature, a transition temperature, electrical reliability, and birefringence.

Furthermore, the compound represented by General Formula (VIII-2) is preferably at least one compound selected from the compound group represented by Formulas (27.1) to (27.4), and preferably the compound represented by Formula (27.2).

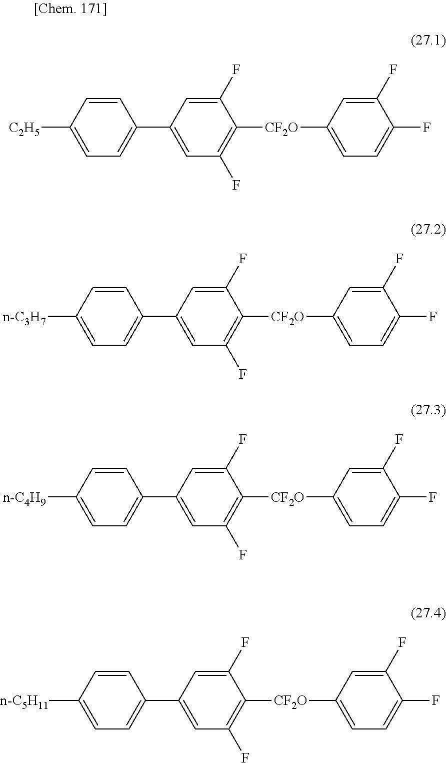

Alternatively/in addition, the compound represented by General Formula (VIII) is preferably the compound represented by General Formula (VIII-3).

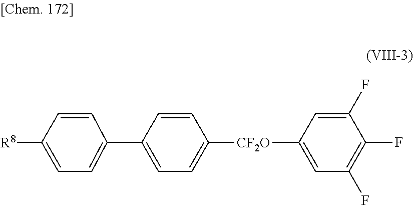

In General Formula (VIII-3), R⁸ represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. Alternatively, in another embodiment of the present invention, two or more types are used.

Furthermore, the compound represented by General Formula (VIII-3), specifically, is preferably at least one compound selected from the compound group represented by Formulas (26.11) to (26.14), preferably the compound represented by Formulas (26.11) and/or (26.12), and more preferably the compound represented by Formula (26.12).

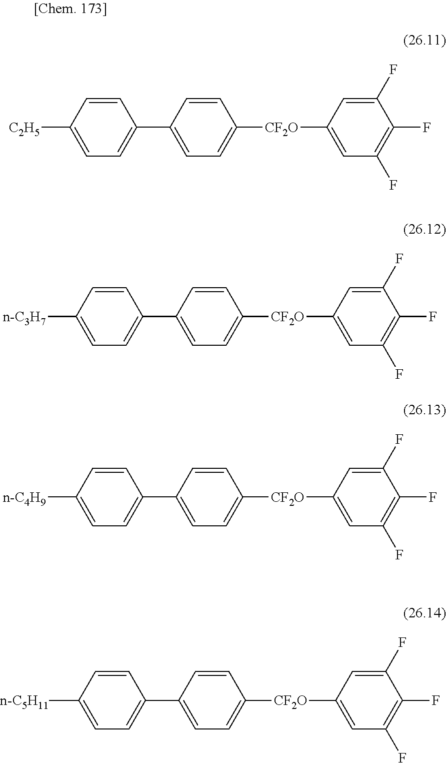

Alternatively/in addition, the compound represented by General Formula (VIII) is preferably the compound represented by General Formula (VIII-4).

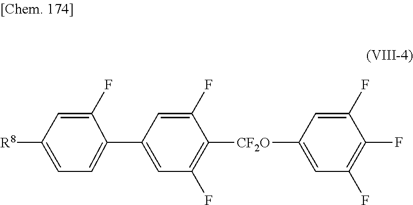

In General Formula (VIII-4), R⁸ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (VIII-4) is suitably adjusted in consideration of characteristics such as solubility at a low temperature, a transition temperature, electrical reliability, and birefringence.

For example, the content of the compound represented by General Formula (VIII-4) is 1% to 25% by mass in an embodiment of the present invention, 2% to 25% by mass in another embodiment, 3% to 20% by mass in still another embodiment, and the content of the compound is 3% to 13% by mass in still another embodiment, the content of the compound is 3% to 10% by mass in still another embodiment, and the content of the compound is 1% to 5% by mass in still another embodiment, with respect to the total mass of the liquid crystal composition of the present invention.

Furthermore, the compound represented by General Formula (VIII-4) used in the liquid crystal composition of the present invention, specifically, is preferably at least one compound selected from the compound group represented by Formulas (26.21) to (26.24), and more preferably contains the compound represented by Formula (26.24) among Formulas (26.21) to (26.24).

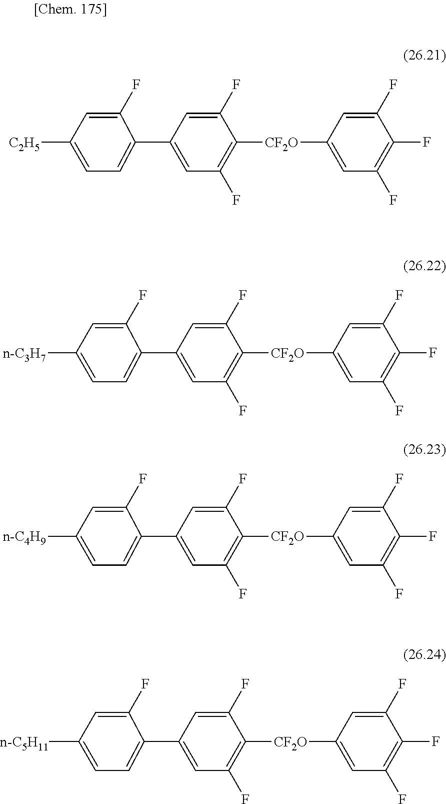

Furthermore, the compound represented by General Formula (M), for example, is preferably at least one compound selected from the compound group represented by General Formula (IX).

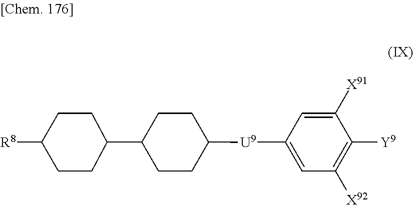

In General Formula (IX), R⁹ represents an alkyl group having 1 to 5 carbon atoms, an alkenyl group having 2 to 5 carbon atoms, or an alkoxy group having 1 to 4 carbon atoms, each of X⁹¹ and X⁹² independently represents a hydrogen atom or a fluorine atom, Y⁹ represents a fluorine atom, a chlorine atom, or —OCF₃, and U⁹ represents a single bond, —COO—, or —CF₂O—.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three types are used. In still another embodiment of the present invention, four types are used. In still another embodiment of the present invention, five types are used. Furthermore, in still another embodiment of the present invention, six or more types are used.

In the liquid crystal composition of the present invention, the content of the compound represented by General Formula (Ix) needs to be suitably adjusted depending on the required performance such as solubility at a low temperature, a transition temperature, electrical reliability, birefringence, process compatibility, dropping marks, burn-in, and dielectric anisotropy.

The content of the compound represented by General Formula (Ix) is 2% to 70% by mass with respect to the total mass of the liquid crystal composition of the present invention, for example, in an embodiment of the present invention. For example, in another embodiment of the present invention, the content of the compound is 5% to 70% by mass. For example, in still another embodiment of the present invention, the content of the compound is 8% to 70% by mass. For example, in still another embodiment of the present invention, the content of the compound is 10% to 70% by mass. For example, in still another embodiment of the present invention, the content of the compound is 12% to 70% by mass. For example, in still another embodiment of the present invention, the content of the compound is 15% to 70% by mass. For example, in still another embodiment of the present invention, the content of the compound is 17% to 70% by mass. For example, in still another embodiment of the present invention, the content of the compound is 20% to 70% by mass. For example, in still another embodiment of the present invention, the content of the compound is 24% to 70% by mass. For example, in still another embodiment of the present invention, the content of the compound is 28% to 70% by mass. For example, in still another embodiment of the present invention, the content of the compound is 30% to 70% by mass. For example, in still another embodiment of the present invention, the content of the compound is 34% to 70% by mass. For example, in still another embodiment of the present invention, the content of the compound is 39% to 70% by mass. For example, in still another embodiment of the present invention, the content of the compound is 40% to 70% by mass. For example, in still another embodiment of the present invention, the content of the compound is 42% to 70% by mass. For example, in still another embodiment of the present invention, the content of the compound is 45% to 70% by mass.

The content of the compound is 3% to 60% by mass with respect to the total mass of the liquid crystal composition of the present invention, for example, in an embodiment of the present invention. In another embodiment of the present invention, the content of the compound is 3% to 55% by mass. In still another embodiment of the present invention, the content of the compound is 3% to 50% by mass. In still another embodiment of the present invention, the content of the compound is 3% to 45% by mass. In still another embodiment of the present invention, the content of the compound is 3% to 40% by mass. In still another embodiment of the present invention, the content of the compound is 3% to 35% by mass. In still another embodiment of the present invention, the content of the compound is 3% to 30% by mass. In still another embodiment of the present invention, it is 25% by mass. In still another embodiment of the present invention, the content of the compound is 3% to 20% by mass. In still another embodiment of the present invention, the content of the compound is 3% to 15% by mass. In still another embodiment of the present invention, the content of the compound is 3% to 10% by mass.

In a case where it is required that the viscosity of the liquid crystal composition of the present invention be kept low and the liquid crystal composition have a high response speed, it is preferable that the above-described lower limit value is small and the above-described upper limit value is small. In a case where it is required that Tni of the liquid crystal composition of the present invention be kept high and the liquid crystal composition be less likely to generate burn-in, it is preferable that the above-described lower limit value is small and the above-described upper limit value is small. In addition, when it is desired to increase the dielectric anisotropy in order to keep the driving voltage low, it is preferable that the above-described lower limit value is large and the above-described upper limit value is large.

Furthermore, the compound represented by General Formula (Ix) is preferably the compound represented by General Formula (IX-1).

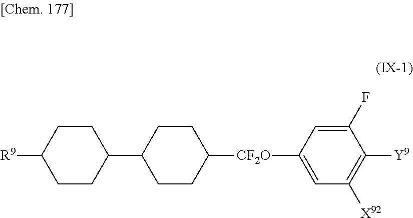

In Formula (IX-1), R⁹ represents an alkyl group having 1 to 5 carbon atoms, an alkenyl group having 2 to 5 carbon atoms, or an alkoxy group having 1 to 4 carbon atoms, X⁹² represents a hydrogen atom or a fluorine atom, and Y⁹ represents a fluorine atom or —OCF₃.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. In another embodiment of the present invention, two types are used. In still another embodiment of the present invention, three types are used. In addition, in still another embodiment of the present invention, four or more types are used.

Furthermore, the compound represented by General Formula (IX-1) is preferably the compound represented by General Formula (IX-1-1).

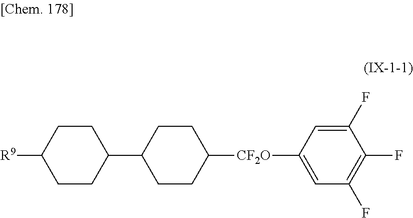

In General Formula (IX-1-1), R⁹ represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. In another embodiment of the present invention, two types are used. Furthermore, in still another embodiment of the present invention, three or more types are used.

The content of the compound represented by General Formula (IX-1-1) is suitably adjusted depending on an embodiment in consideration of solubility at a low temperature, a transition temperature, electrical reliability, and birefringence.

The content of the compound represented by General Formula (IX-1-1) is 1% to 15% by mass with respect to the total mass of the liquid crystal composition of the present invention, for example, in an embodiment of the present invention. For example, in another embodiment of the present invention, the content of the compound is 1% to 10% by mass. For example, in still another embodiment of the present invention, the content of the compound is 1% to 9% by mass. For example, in still another embodiment of the present invention, the content of the compound is 1% to 8% by mass. For example, in still another embodiment of the present invention, the content of the compound is 1% to 3% by mass.

The content of the compound represented by General Formula (IX-1-1) is 2% to 17% by mass with respect to the total mass of the liquid crystal composition of the present invention, for example, in an embodiment of the present invention. In another embodiment of the present invention, the content of the compound is 3% to 10% by mass. In still another embodiment of the present invention, the content of the compound is 5% to 10% bymass. In still another embodiment of the present invention, the content of the compound is 6% to 10% by mass. In still another embodiment of the present invention, the content of the compound is 7% to 10% by mass. In still another embodiment of the present invention, the content of the compound is 3% to 8% by mass. In still another embodiment of the present invention, the content of the compound is 5% to 8% by mass. In still another embodiment of the present invention, the content of the compound is 6% to 9% by mass.

Furthermore, the compound represented by General Formula (Ix-1-1) is preferably at least one compound selected from the compound group represented by Formulas (28.1) to (28.5), and preferably the compound represented by Formula (28.5).

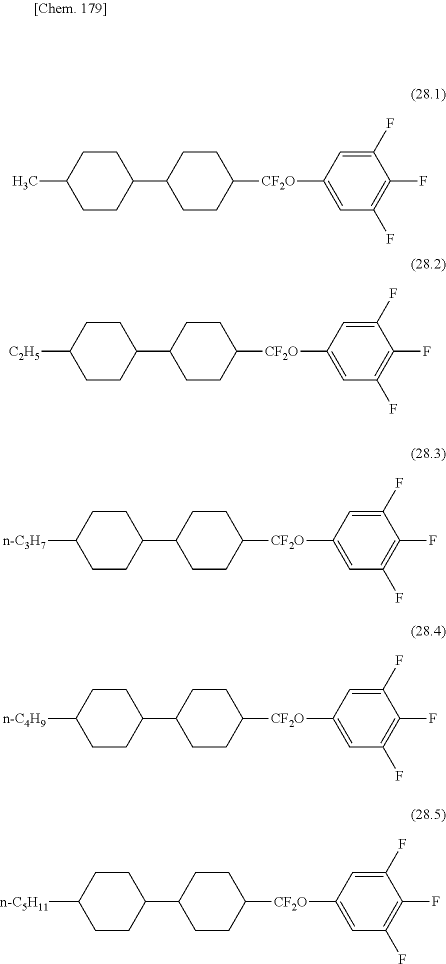

In the liquid crystal composition, the content of the compound represented by the formula (28.3) is not particularly limited, and the content thereof is preferably 1% by mass or greater, preferably 3% by mass or greater, preferably 5% by mass or greater, preferably 7% by mass or greater, preferably 10% by mass or greater, preferably 14% by mass or greater, and preferably 16% by mass or greater, with respect to the total mass of the liquid crystal composition. On the other hand, the content of the compound represented by Formula (i) in the liquid crystal composition is preferably 30% by mass or less, preferably 25% by mass or less, preferably 22% by mass or less, preferably 20% by mass or less, preferably 19% by mass or less, preferably 15% by mass or less, preferably 12% by mass or less, preferably 10% by mass or less, preferably 8% by mass or less, and preferably less than 5% by mass, with respect to the total mass of the liquid crystal composition, in consideration of solubility at a low temperature, a nematic phase-isotropic liquid phase transition temperature, and electrical reliability.

Within the above-described content ranges, the content of the compound represented by Formula (28.3) in the liquid crystal composition is preferably 1% to 30% by mass, preferably 1% to 25% by mass, preferably 1% to 19% by mass, preferably 1% to 8% by mass, preferably 2% to 6% by mass, preferably 3% to 8% by mass, preferably 5% to 15% by mass, preferably 5% to 11% by mass, preferably 7% to 12% by mass, preferably 7% to 20% by mass, preferably 7% to 18% by mass, and preferably 11% to 16% by mass, with respect to the total mass of the liquid crystal composition of the present invention.

In the liquid crystal composition of the present invention, the content of the compound represented by Formula (28.5) is preferably 1% by mass to 25% by mass, more preferably 1% by mass to 20% by mass, still more preferably 1% by mass to 15% by mass, and particularly preferably 1% by mass to 10% by mass, with respect to the total mass of the liquid crystal composition of the present invention, in consideration of solubility at a low temperature, a transition temperature, and electrical reliability. Within the above ranges, 2% by mass to 10% by mass, 3% by mass to 10% by mass, 5% by mass to 10% by mass, 6% by mass to 10% by mass, 7% by mass to 10% by mass, 1% by mass to 10% by mass, 1% by mass to 10% by mass, 1% by mass to 9% by mass, 1% by mass to 8% by mass, 1% by mass to 3% by mass, 3% by mass to 8% by mass, 5% by mass to 8% by mass, or 6% by mass to 9% by mass is preferable.

Alternatively/in addition, the compound represented by General Formula (IX-1) is preferably the compound represented by General Formula (IX-1-2).

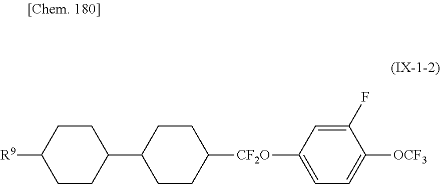

In General Formula (IX-1-2), R⁹ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, one to three types are preferably combined, and one to four types are more preferably combined.

The content of the compound represented by General Formula (IX-1-2) is preferably 1% by mass to 30% by mass, preferably 5% by mass to 30% by mass, preferably 8% by mass to 30% by mass, preferably 10% by mass to 25% by mass, preferably 14% by mass to 22% by mass, and preferably 16% by mass to 20% by mass, with respect to the total mass of the liquid crystal composition of the present invention, in consideration of solubility at a low temperature, a transition temperature, and electrical reliability.

Furthermore, the compound represented by General Formula (Ix-1-2) is preferably at least one compound selected from the compound group represented by Formulas (29.1) to (29.4), and preferably the compound represented by Formulas (29.2) and/or (29.4).

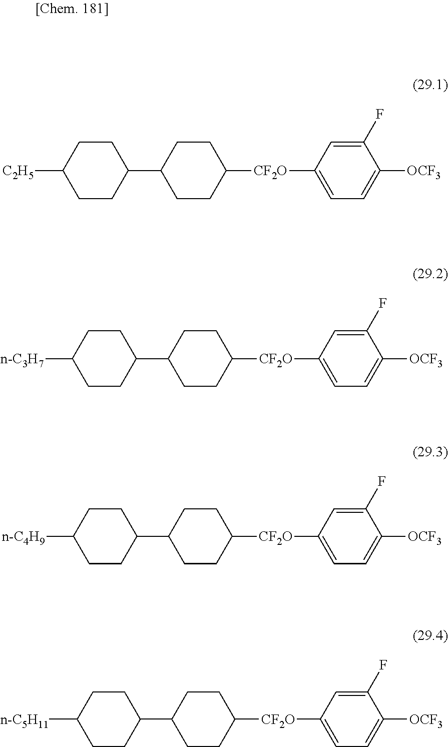

Alternatively/in addition, the compound represented by General Formula (IX) is preferably the compound represented by General Formula (IX-2).

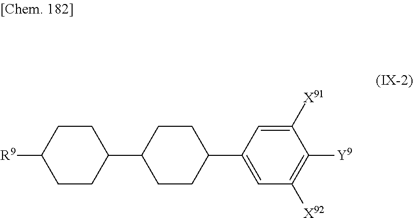

In General Formula (IX-2), R⁹ represents an alkyl group having 1 to 5 carbon atoms, an alkenyl group having 2 to 5 carbon atoms, or an alkoxy group having 1 to 4 carbon atoms, each of X⁹¹ and X⁹² independently represents a hydrogen atom or a fluorine atom, and Y⁹ represents a fluorine atom, a chlorine atom, or —OCF₃.

The types of compound capable of being combined are not limited, and in consideration of solubility at a low temperature, a transition temperature, electrical reliability, and birefringence, a compound is suitably combined and used with respect to each embodiment. For example, in an embodiment of the present invention, one type thereof is combined, in another embodiment, two types thereof are combined, in still another embodiment, three types thereof are combined, in still another embodiment, four types thereof are combined, in still another embodiment, five types thereof are combined, and in still another embodiment, six or more types thereof are combined.

Furthermore, the compound represented by General Formula (IX-2) is preferably the compound represented by General Formula (IX-2-1).

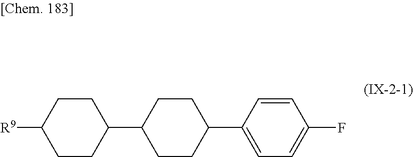

In General Formula (IX-2-1), R⁹ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, one to three types are preferably combined.

The content of the compound represented by General Formula (IX-2-1) is suitably adjusted in consideration of characteristics such as solubility at a low temperature, a transition temperature, electrical reliability, and birefringence.

For example, in an embodiment of the present invention, the content of the compound represented by General Formula (IX-2-1) is 1% to 40% by mass with respect to the total mass of the liquid crystal composition of the present invention. In another embodiment, the content of the compound is 2% to 40% by mass. In still another embodiment, the content of the compound is 4% to 40% by mass. In still another embodiment, the content of the compound is 10% to 40% by mass. In still another embodiment, the content of the compound is 14% to 40% by mass. In still another embodiment, the content of the compound is 16% to 40% by mass. In addition, in still another embodiment, the content of the compound is 21% to 40% by mass.

For example, the content of the compound represented by General Formula (IX-2-1) is 1% to 30% by mass in an embodiment of the present invention, 1% to 25% by mass in another embodiment, 1% to 22% by mass in still another embodiment, 1% to 20% by mass in still another embodiment, 1% to 10% by mass in still another embodiment, 1% to 7% by mass in still another embodiment, and 1% to 5% by mass in still another embodiment, with respect to the total mass of the liquid crystal composition of the present invention.

Furthermore, the compound represented by General Formula (Ix-2-1) is preferably at least one compound selected from the compound group represented by Formulas (30.1) to (30.4), and preferably the compound represented by Formulas (30.1) and/or (30.2).

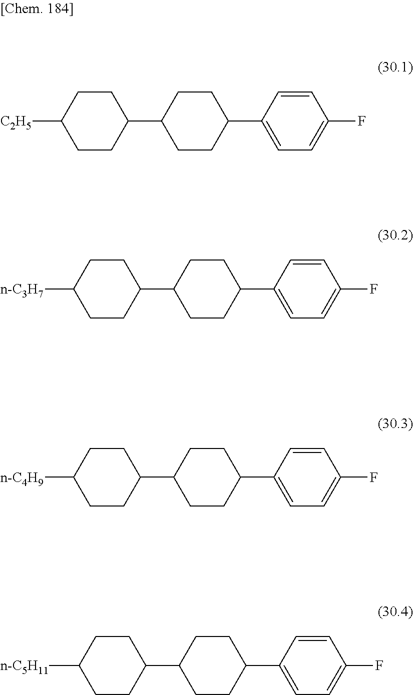

Alternatively/in addition, the compound represented by General Formula (IX-2) is preferably the compound represented by General Formula (IX-2-2).

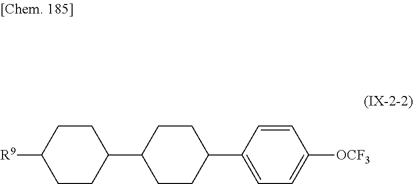

In General Formula (IX-2-2), R⁹ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, one to three types are preferably combined, and one to four types are more preferably combined.

The content of the compound represented by General Formula (IX-2-2) is suitably adjusted with respect to each embodiment in consideration of characteristics such as solubility at a low temperature, a transition temperature, electrical reliability, and birefringence.

For example, the content of the compound represented by General Formula (IX-2-2) is 1% to 30% by mass in an embodiment of the present invention, 1% to 25% by mass in another embodiment, 1% to 20% by mass in still another embodiment, 1% to 15% by mass in still another embodiment, 1% to 11% by mass in still another embodiment, 1% to 10% by mass in still another embodiment, and 1% to 9% by mass in still another embodiment, 1% to 8% by mass in still another embodiment, 2% to 9% by mass in still another embodiment, 7% to 10% by mass in still another embodiment, 5% to 8% by mass in still another embodiment, and 8% to 11% by mass in still another embodiment, with respect to the total mass of the liquid crystal composition of the present invention.

Furthermore, the compound represented by General Formula (Ix-2-2) is preferably at least one compound selected from the compound group represented by Formulas (31.1) to (31.4), preferably at least one compound selected from the compound group represented by Formulas (31.2) to (31.4), and preferably the compound represented by Formula (31.2).

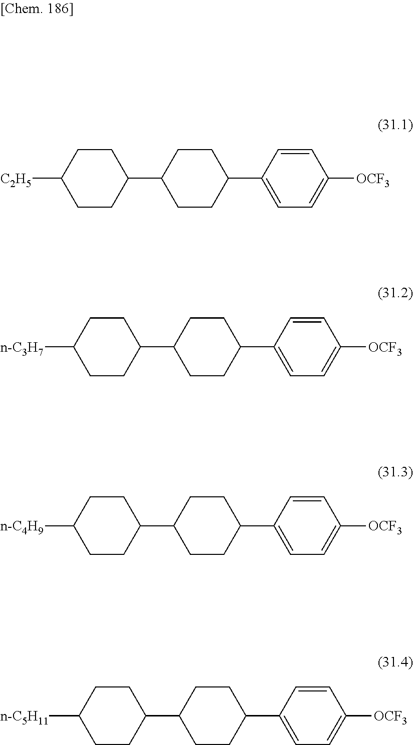

In the liquid crystal composition of the present invention, the content of the compound represented by Formula (31.2) is preferably 1% by mass to 30% by mass, preferably 1% by mass to 25% by mass, preferably 1% by mass to 20% by mass, and preferably 1% by mass to 15% by mass, with respect to the total mass of the liquid crystal composition of the present invention. Within the above ranges, for example, 1% by mass to 14% by mass, 2% by mass to 9% by mass, 4% by mass to 10% by mass, 5% by mass to 8% by mass, or 8% by mass to 11% by mass is preferable.

In the liquid crystal composition of the present invention, the content of the compound represented by Formula (31.4) is preferably 1% by mass to 20% by mass, preferably 1% by mass to 15% by mass, preferably 1% by mass to 5% by mass, and preferably 2% by mass to 5% by mass, with respect to the total mass of the liquid crystal composition of the present invention.

Alternatively/in addition, the compound represented by General Formula (IX-2) is preferably the compound represented by General Formula (IX-2-3).

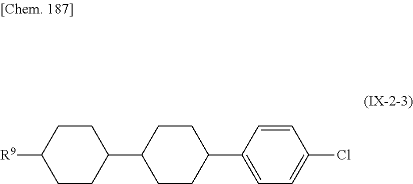

In General Formula (IX-2-3), R⁹ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, one type or two types are preferably combined.

The content of the compound represented by General Formula (IX-2-3) is preferably 1% by mass to 30% by mass, more preferably 3% by mass to 20% by mass, still more preferably 6% by mass to 15% by mass, and even more preferably 8% by mass to 10% by mass, with respect to the total mass of the liquid crystal composition of the present invention, in consideration of solubility at a low temperature, a transition temperature, and electrical reliability.

Furthermore, the compound represented by General Formula (Ix-2-3) is preferably at least one compound selected from the compound group represented by Formulas (32.1) to (32.4), and preferably the compound represented by Formulas (32.2) and/or (32.4).

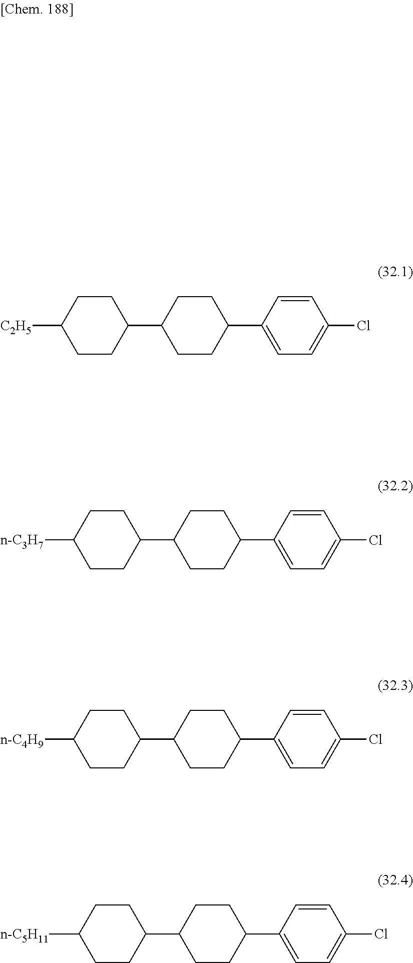

Alternatively/in addition, the compound represented by General Formula (IX-2) is preferably the compound represented by General Formula (IX-2-4).

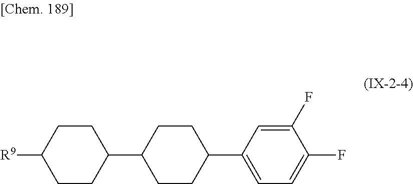

In General Formula (IX-2-4), R⁹ represents an alkyl group having 1 to 5 carbon atoms, an alkenyl group having 2 to 5 carbon atoms, or an alkoxy group having 1 to 4 carbon atoms.

The content of the compound represented by General Formula (IX-2-4) is preferably 1% by mass to 30% by mass, more preferably 3% by mass to 20% by mass, still more preferably 6% by mass to 15% by mass, and particularly preferably 8% by mass to 10% by mass, with respect to the total mass of the liquid crystal composition of the present invention, in consideration of solubility at a low temperature, a transition temperature, and electrical reliability.

Furthermore, the compound represented by General Formula (Ix-2-4) is preferably at least one compound selected from the compound group represented by Formulas (33.1) to (33.6), and preferably the compound represented by Formulas (33.1) and/or (33.3).

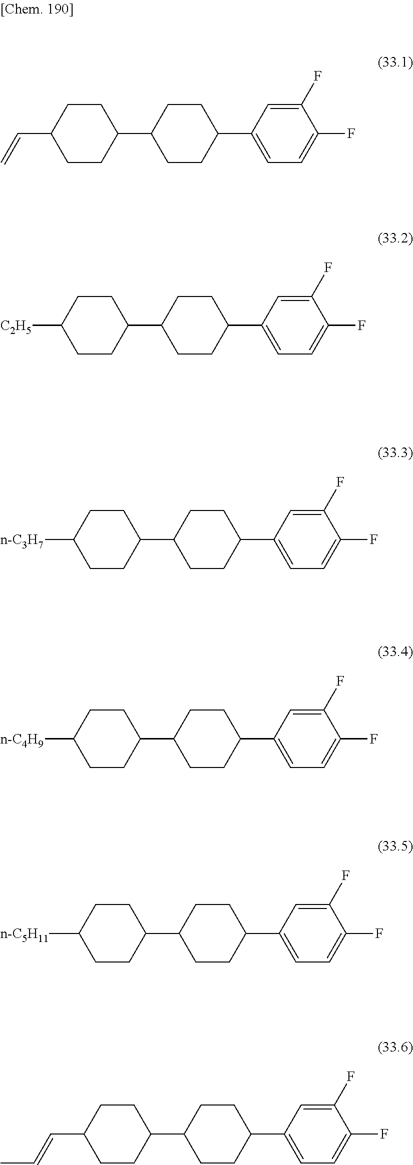

Alternatively/in addition, the compound represented by General Formula (IX-2) is preferably the compound represented by General Formula (IX-2-5).

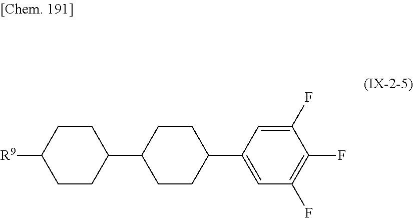

In General Formula (IX-2-5), R⁹ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, a compound is suitably combined and used with respect to each embodiment. For example, in an embodiment of the present invention, one type thereof is combined, in another embodiment, two types thereof are combined, in still another embodiment, three types thereof are combined, and in still another embodiment, four or more types thereof are combined.

The content of the compound represented by General Formula (IX-2-5) is suitably adjusted with respect to each embodiment in consideration of characteristics such as solubility at a low temperature, a transition temperature, electrical reliability, and birefringence.

For example, the content of the compound represented by General Formula (IX-2-5) is 1% to 30% by mass in an embodiment of the present invention, 2% to 25% by mass in another embodiment, 5% to 25% by mass in still another embodiment, 5% to 20% by mass in still another embodiment, 5% to 8% by mass in still another embodiment, 8% to 20% by mass in still another embodiment, and 1% to 10% by mass in still another embodiment, and 1% to 4% by mass in still another embodiment, with respect to the total mass of the liquid crystal composition of the present invention.

In a case where it is required that the viscosity of the liquid crystal composition of the present invention be kept low and the liquid crystal composition have a high response speed, it is preferable that the above-described lower limit value is small and the above-described upper limit value is small. In a case where it is required that Tni of the liquid crystal composition of the present invention be kept high and the liquid crystal composition be less likely to generate burn-in, it is preferable that the above-described lower limit value is small and the above-described upper limit value is small. In addition, when it is desired to increase the dielectric anisotropy in order to keep the driving voltage low, it is preferable that the above-described lower limit value is large and the above-described upper limit value is large.

Furthermore, the compound represented by General Formula (Ix-2-5) is preferably at least one compound selected from the compound group represented by Formulas (34.1) to (34.7), and more preferably the compound represented by Formulas (34.1), (34.2), (34.3), and/or (34.5).

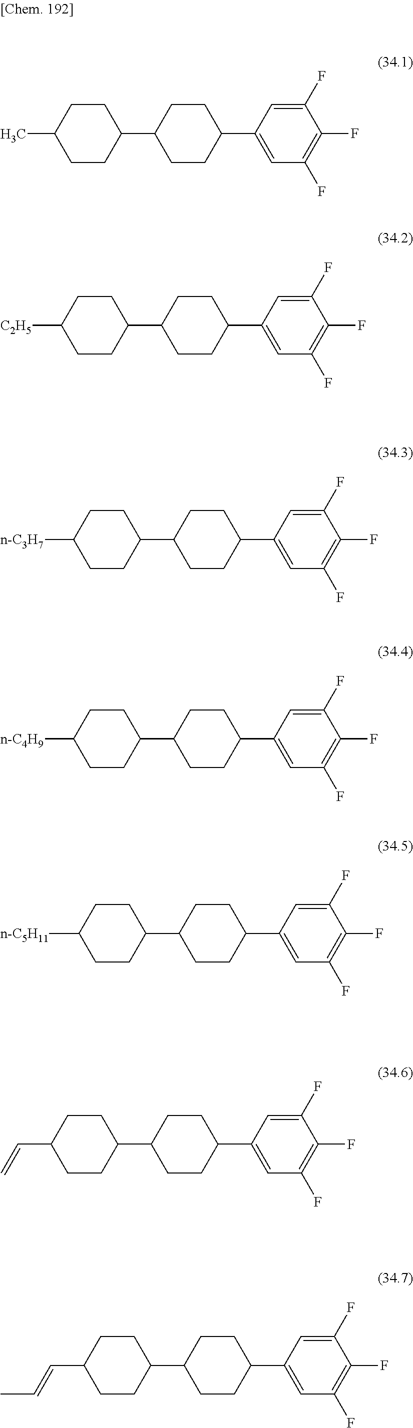

Alternatively/in addition, the compound represented by General Formula (IX) is preferably the compound represented by General Formula (IX-3).

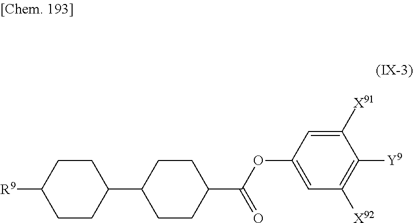

In General Formula (IX-3), R⁹ represents an alkyl group having 1 to 5 carbon atoms, an alkenyl group having 2 to 5 carbon atoms, or an alkoxy group having 1 to 4 carbon atoms, each of X⁹¹ and X⁹² independently represents a hydrogen atom or a fluorine atom, and Y⁹ represents a fluorine atom, a chlorine atom, or —OCF₃.

Furthermore, the compound represented by General Formula (IX-3) is preferably the compound represented by General Formula (IX-3-1).

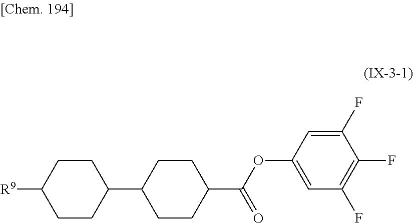

In General Formula (IX-3-1), R⁹ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, one type or two types are preferably combined.

The content of the compound represented by General Formula (IX-3-1) is preferably 3% by mass to 30% by mass, preferably 7% by mass to 30% by mass, preferably 13% by mass to 20% by mass, and preferably 15% by mass to 18% by mass, with respect to the total mass of the liquid crystal composition of the present invention, in consideration of solubility at a low temperature, a transition temperature, and electrical reliability.

Furthermore, the compound represented by General Formula (Ix-3-1) is preferably at least one compound selected from the compound group represented by Formulas (35.1) to (35.4), and preferably the compound represented by Formulas (35.1) and/or (35.2).

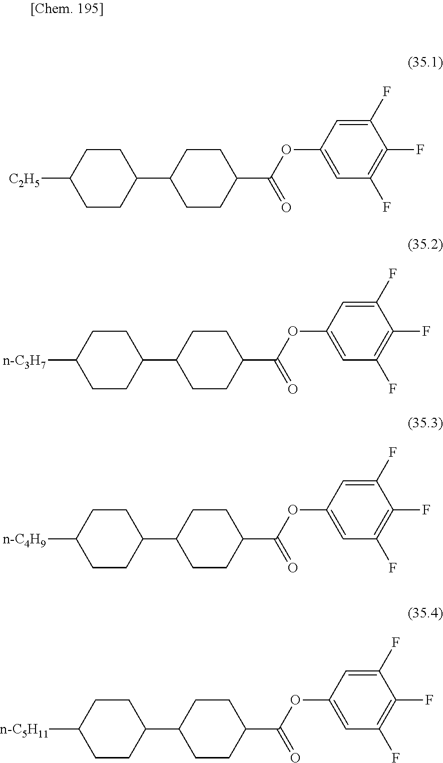

Alternatively/in addition, the compound represented by General Formula (M) is preferably the compound represented by General Formula (X).

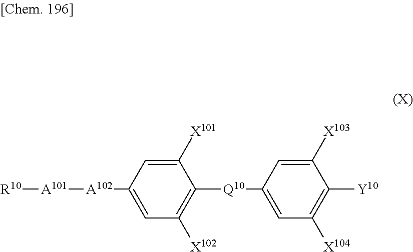

In General Formula (X), each of X¹⁰¹ to X¹⁰⁴ independently represents a fluorine atom or a hydrogen atom, Y¹⁰ represents a fluorine atom, a chlorine atom, or —OCF₃, Q¹⁰ represents a single bond or —CF₂O—, R¹⁰ represents an alkyl group having 1 to 5 carbon atoms, an alkenyl group having 2 to 5 carbon atoms, or an alkoxy group having 1 to 4 carbon atoms, each of A¹⁰¹ and A¹⁰² independently represents a 1,4-cyclohexylene group, a 1,4-phenylene group, or any one of groups represented by the following formulas, and here, a hydrogen atom of the 1,4-phenylene group may be substituted with a fluorine atom.

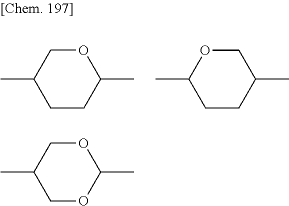

The compounds capable of being combined are not particularly limited, and in consideration of solubility at a low temperature, a transition temperature, electrical reliability, and birefringence, a compound is suitably combined. For example, in an embodiment of the present invention, one type is used. In addition, in another embodiment of the present invention, two types are used. In still another embodiment, three types are used. In still another embodiment, four types are used. In still another embodiment, five or more types are used.

The content of the compound represented by General Formula (X) is suitably adjusted with respect to each embodiment in consideration of characteristics such as solubility at a low temperature, a transition temperature, electrical reliability, and birefringence. For example, the content of the compound represented by General Formula (X) is 2% to 45% by mass in an embodiment of the present invention, 3% to 45% by mass in another embodiment, 6% to 45% by mass in still another embodiment, 8% to 45% by mass in still another embodiment, 9% to 45% by mass in still another embodiment, 11% to 45% by mass in still another embodiment, and 12% to 45% by mass in still another embodiment, 18% to 45% by mass in still another embodiment, 19% to 45% by mass in still another embodiment, 23% to 45% by mass in still another embodiment, and 25% to 45% by mass instill another embodiment, with respect to the total mass of the liquid crystal composition of the present invention.

In addition, for example, the content of the compound represented by General Formula (X) is 2% to 35% by mass in an embodiment of the present invention, 2% to 30% by mass in another embodiment, 2% to 25% by mass in still another embodiment, 2% to 20% by mass in still another embodiment, 2% to 13% by mass in still another embodiment, 2% to 9% by mass in still another embodiment, 2% to 6% by mass in still another embodiment, and 2% to 3% by mass in still another embodiment, with respect to the total mass of the liquid crystal composition of the present invention.

In a case where it is required that the viscosity of the liquid crystal composition of the present invention be kept low and the liquid crystal composition have a high response speed, it is preferable that the above-described lower limit value is small and the above-described upper limit value is small. In a case where it is required that the liquid crystal composition be less likely to generate burn-in, it is preferable that the above-described lower limit value is small and the above-described upper limit value is small. In addition, when it is desired to increase the dielectric anisotropy in order to keep the driving voltage low, it is preferable that the above-described lower limit value is large and the above-described upper limit value is large.

The compound represented by General Formula (X) used in the liquid crystal composition of the present invention is preferably the compound represented by General Formula (X-1).

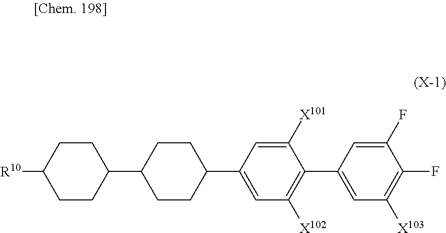

In General Formula (X-1), each of X¹⁰¹ to X¹⁰³ independently represents a fluorine atom or a hydrogen atom, and R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, a compound is suitably combined with respect to each embodiment. For example, in an embodiment of the present invention, one type is used. In addition, in another embodiment of the present invention, two types are used. In still another embodiment, three types are used. In still another embodiment, four types are used. In still another embodiment, five or more types are used.

The content of the compound represented by General Formula (x-1) is suitably adjusted in consideration of characteristics such as solubility at a low temperature, a transition temperature, electrical reliability, and birefringence.

For example, the content of the compound represented by General Formula (X-1) is 2% to 40% by mass in an embodiment of the present invention, 3% to 40% by mass in another embodiment, 5% to 40% by mass in still another embodiment, 6% to 40% by mass in still another embodiment, 7% to 40% by mass in still another embodiment, 8% to 40% by mass in still another embodiment, and 9% to 40% by mass in still another embodiment, 13% to 40% by mass in still another embodiment, 18% to 40% by mass in still another embodiment, and 23% to 40% by mass in still another embodiment, with respect to the total mass of the liquid crystal composition of the present invention.

In addition, for example, the content of the compound represented by General Formula (X-1) is 2% to 30% by mass in an embodiment of the present invention, 2% to 25% by mass in another embodiment, 2% to 20% by mass in still another embodiment, 2% to 15% by mass in still another embodiment, 2% to 10% by mass in still another embodiment, 2% to 6% by mass in still another embodiment, and 2% to 4% by mass in still another embodiment, with respect to the total mass of the liquid crystal composition of the present invention.

The compound represented by General Formula (X-1) used in the liquid crystal composition of the present invention is preferably the compound represented by General Formula (X-1-1).

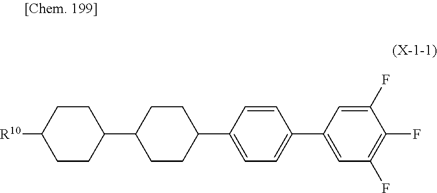

In General Formula (X-1-1), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, a compound is suitably combined. For example, in an embodiment of the present invention, one type is used. In addition, in another embodiment of the present invention, two types are used. In still another embodiment, three types are used. In still another embodiment, four or more types are used.

The content of the compound represented by General Formula (X-1-1) is suitably adjusted in consideration of characteristics such as solubility at a low temperature, a transition temperature, electrical reliability, and birefringence.

For example, the content of the compound represented by General Formula (X-1-1) is 3% to 30% by mass in an embodiment of the present invention, 4% to 30% by mass in another embodiment, 6% to 30% by mass in still another embodiment, 9% to 30% by mass in still another embodiment, 12% to 30% by mass in still another embodiment, 15% to 30% by mass in still another embodiment, 18% to 30% by mass in still another embodiment, and 21% to 30% by mass in still another embodiment, with respect to the total mass of the liquid crystal composition of the present invention.

In addition, for example, the content of the compound represented by General Formula (X-1-1) is 3% to 20% by mass in an embodiment of the present invention, 3% to 13% by mass in another embodiment, 3% to 10% by mass in still another embodiment, and 3% to 7% by mass in still another embodiment, with respect to the total mass of the liquid crystal composition of the present invention.

Furthermore, the compound represented by General Formula (X-1-1) used in the liquid crystal composition of the present invention, specifically, is preferably at least one compound selected from the compound group represented by Formulas (36.1) to (36.4), and preferably contains the compound represented by Formulas (36.1) and/or (36.2) among Formulas (36.1) to (36.4).

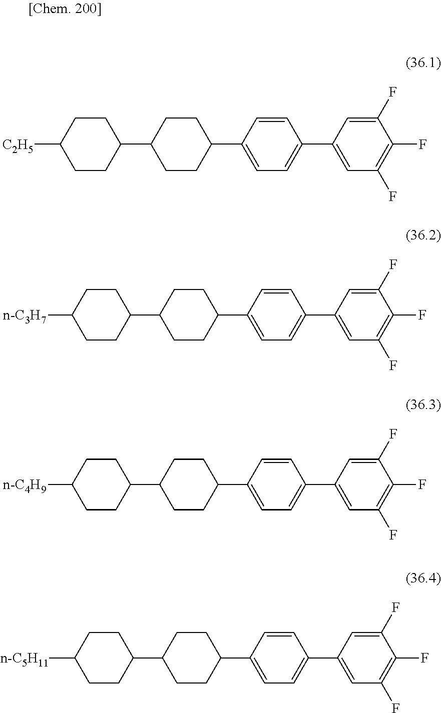

Alternatively/in addition, the compound represented by General Formula (X-1) used in the liquid crystal composition of the present invention is preferably the compound represented by General Formula (X-1-2).

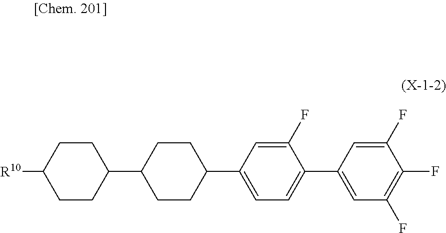

In General Formula (X-1-2), R¹⁰ represents an alkyl group having 1 to 5 carbon atoms, an alkenyl group having 2 to 5 carbon atoms, or an alkoxy group having 1 to 4 carbon atoms.

The content of the compound represented by General Formula (X-1-2) is suitably adjusted in consideration of solubility at a low temperature, a transition temperature, and electrical reliability.

For example, the content of the compound represented by General Formula (X-1-2) is 1% to 20% by mass in an embodiment of the present invention, 1% to 15% by mass in another embodiment, 1% to 10% by mass in still another embodiment, 1% to 6% by mass in still another embodiment, 1% to 4% by mass in still another embodiment, and 1% to 3% by mass in still another embodiment, with respect to the total mass of the liquid crystal composition of the present invention.

In addition, for example, the content of the compound represented by General Formula (X-1-2) is 3% to 10% by mass in an embodiment of the present invention, 4% to 10% by mass in another embodiment, and 6% to 10% by mass in still another embodiment, with respect to the total mass of the liquid crystal composition of the present invention.

Furthermore, the compound represented by General Formula (X-1-2) used in the liquid crystal composition of the present invention, specifically, is preferably at least one compound selected from the compound group represented by Formulas (37.1) to (37.4), and preferably contains the compound represented by Formula (37.2) among Formulas (37.1) to (37.4).

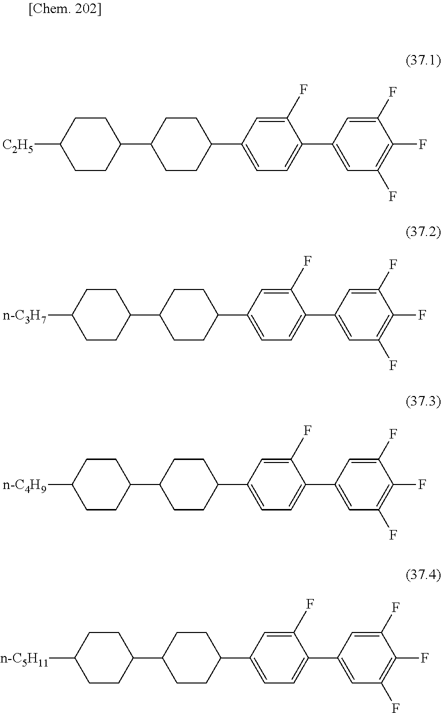

Alternatively/in addition, the compound represented by General Formula (X-1) used in the liquid crystal composition of the present invention is preferably the compound represented by General Formula (X-1-3).

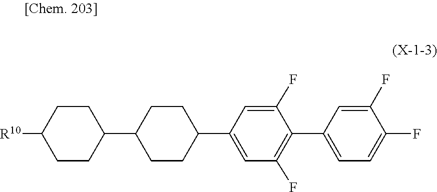

In General Formula (X-1-3), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (X-1-3) is suitably adjusted in consideration of solubility at a low temperature, a transition temperature, and electrical reliability.

For example, the content of the compound represented by General Formula (X-1-3) is 1% to 20% by mass in an embodiment of the present invention, 1% to 15% by mass in another embodiment, 1% to 10% by mass in still another embodiment, 1% to 8% by mass in still another embodiment, and 1% to 5% by mass in still another embodiment, with respect to the total mass of the liquid crystal composition of the present invention.

In addition, for example, the content of the compound represented by General Formula (X-1-3) is 3% to 20% by mass in an embodiment of the present invention, 5% to 20% by mass in another embodiment, and 5% to 15% by mass in still another embodiment, with respect to the total mass of the liquid crystal composition of the present invention.

Furthermore, the compound represented by General Formula (X-1-3) used in the liquid crystal composition of the present invention, specifically, is preferably at least one compound selected from the compound group represented by Formulas (38.1) to (38.4), and preferably contains the compound represented by Formula (38.2) among Formulas (38.1) to (38.4).

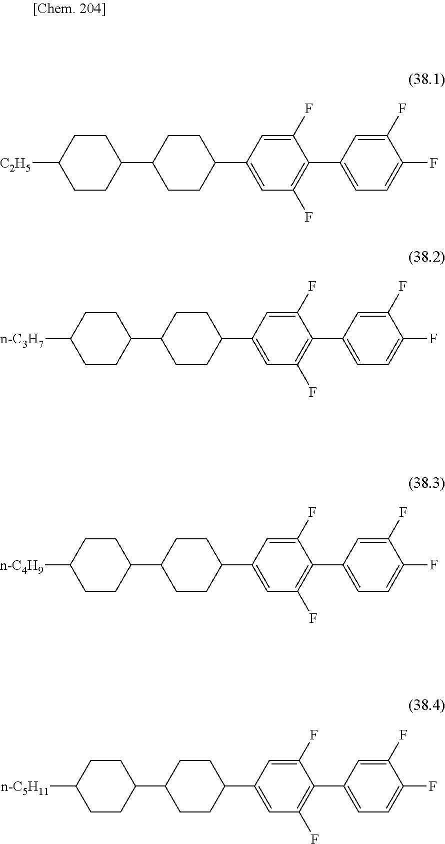

In the liquid crystal composition of the present invention, the content of the compound represented by Formula (38.2) is preferably 1% by mass to 20% by mass, preferably 1% by mass to 15% by mass, preferably 1% by mass to 10% by mass, preferably 1% by mass to 8% by mass, preferably 3% by mass to 5% by mass, and preferably 4% by mass to 5% by mass, with respect to the total mass of the liquid crystal composition of the present invention.

Alternatively/in addition, the compound represented by General Formula (X) used in the liquid crystal composition of the present invention is preferably the compound represented by General Formula (X-2).

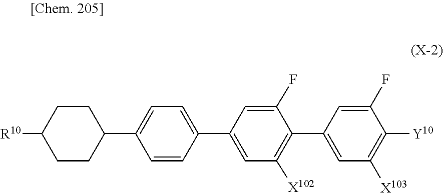

In General Formula (X-2), each of X¹⁰² and X¹⁰³ independently represents a fluorine atom or a hydrogen atom, Y¹⁰ represents a fluorine atom, a chlorine atom, or —OCF₃, R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or more types are preferably combined.

The compound represented by General Formula (X-2) used in the liquid crystal composition of the present invention is preferably the compound represented by General Formula (X-2-1).

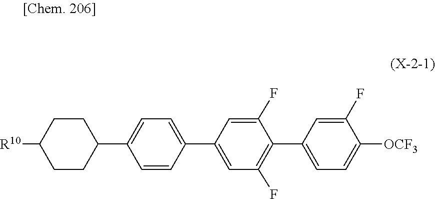

In General Formula (X-2-1), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited. In consideration of solubility at a low temperature, a transition temperature, electrical reliability, and birefringence, one type or more types are preferably combined, and three or more types are more preferably combined.

The content of the compound represented by General Formula (X-2-1) is preferably 1% by mass to 20% by mass, preferably 1% by mass to 16% by mass, preferably 1% by mass to 12% by mass, and preferably 1% by mass to 10% by mass, with respect to the total mass of the liquid crystal composition of the present invention, in consideration of solubility at a low temperature, a transition temperature, and electrical reliability. Within the above ranges, the content of the compound represented by General Formula (X-2-1) is preferably 1% to 5% by mass, preferably 1% to 3% by mass, preferably 5% to 10% by mass, and preferably 6% to 9% by mass, with respect to the total mass of the liquid crystal composition of the present invention.

Furthermore, the compound represented by General Formula (X-2-1) used in the liquid crystal composition of the present invention, specifically, is preferably at least one compound selected from the compound group represented by Formulas (39.1) to (39.4), and preferably contains the compound represented by Formula (39.2) among Formulas (39.1) to (39.4).

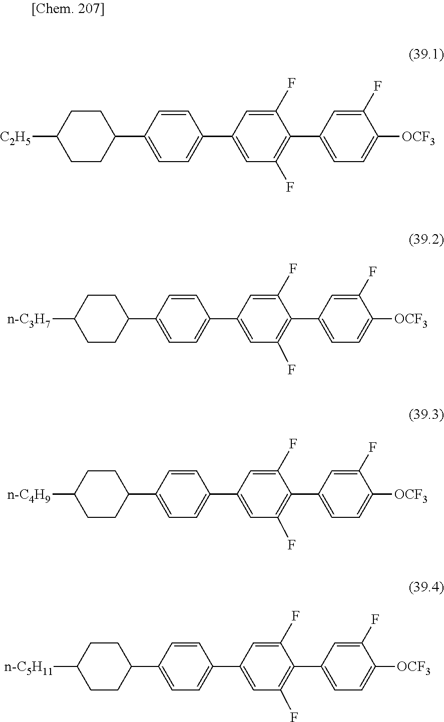

In the liquid crystal composition of the present invention, the content of the compound represented by Formula (39.2) is preferably 1% by mass to 20% by mass, preferably 1% by mass to 16% by mass, preferably 1% by mass to 12% by mass, and preferably 3% by mass to 10% by mass, with respect to the total mass of the liquid crystal composition of the present invention. Within the above ranges, the content of the compound represented by General Formula (39.2) is preferably 1% to 5% by mass, preferably 1% to 3% by mass, preferably 5% to 10% by mass, and preferably 6% to 9% by mass, with respect to the total mass of the liquid crystal composition of the present invention.

Alternatively/in addition, the compound represented by General Formula (X-2) used in the liquid crystal composition of the present invention is preferably the compound represented by General Formula (X-2-2).

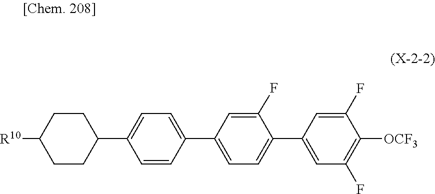

In General Formula (X-2-2), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or more types are preferably combined.

The content of the compound represented by General Formula (X-2-2) is preferably 3% by mass to 20% by mass, preferably 6% by mass to 16% by mass, preferably 9% by mass to 12% by mass, and preferably 9% by mass to 10% by mass, with respect to the total mass of the liquid crystal composition of the present invention, in consideration of solubility at a low temperature, a transition temperature, and electrical reliability.

Furthermore, the compound represented by General Formula (X-2-2) used in the liquid crystal composition of the present invention, specifically, is preferably at least one compound selected from the compound group represented by Formulas (40.1) to (40.4), and preferably contains the compound represented by Formula (40.2) among Formulas (40.1) to (40.4).

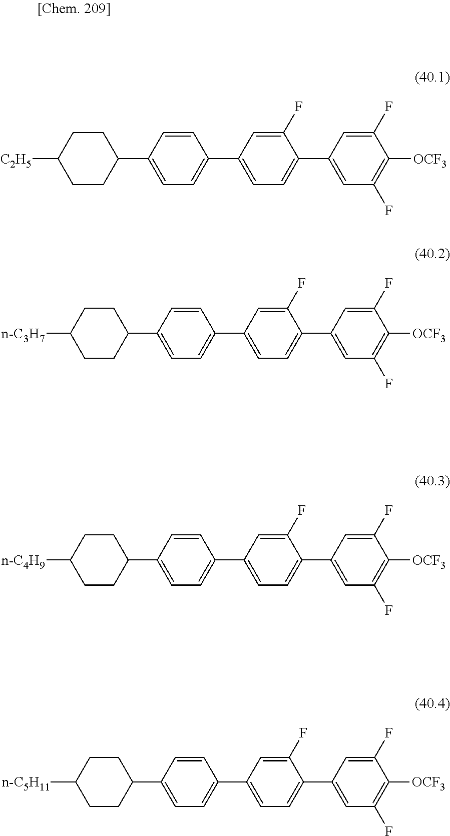

Alternatively/in addition, the compound represented by General Formula (X) is preferably the compound represented by General Formula (X-3).

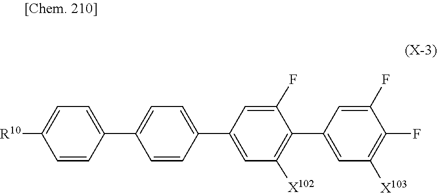

In General Formula (X-3), each of X¹⁰² and X¹⁰³ independently represents a fluorine atom or a hydrogen atom, and R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited. In consideration of solubility at a low temperature, a transition temperature, electrical reliability, and birefringence, one type or two or more types are preferably combined.

The compound represented by General Formula (X-3) used in the liquid crystal composition of the present invention is preferably the compound represented by General Formula (X-3-1).

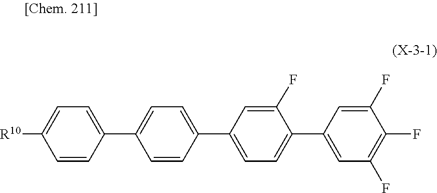

In General Formula (X-3-1), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (X-3-1) is suitably adjusted in consideration of solubility at a low temperature, a transition temperature, and electrical reliability.

For example, the content of the compound represented by General Formula (X-3-1) is 1% to 10% by mass in an embodiment of the present invention, 1% to 8% by mass in another embodiment, 1% to 6% by mass in still another embodiment, 1% to 4% by mass in still another embodiment, and 1% to 2% by mass in still another embodiment, with respect to the total mass of the liquid crystal composition of the present invention.

Furthermore, the compound represented by General Formula (X-3-1) used in the liquid crystal composition of the present invention, specifically, is preferably at least one compound selected from the compound group represented by Formulas (41.1) to (41.4), and preferably contains the compound represented by Formula (41.2) among Formulas (41.1) to (41.4).

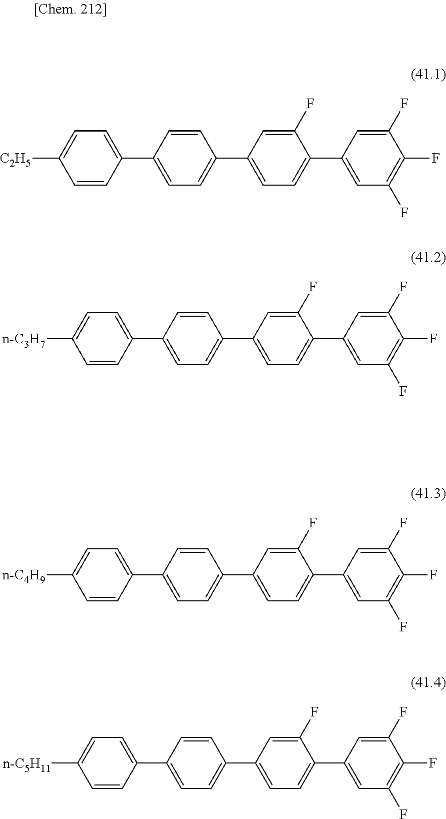

Alternatively/in addition, the compound represented by General Formula (X) is preferably the compound represented by General Formula (X-4).

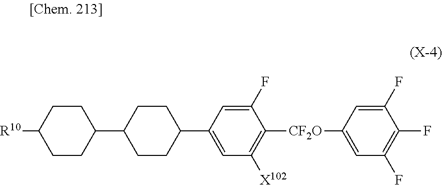

In General Formula (X-4), X¹⁰² represents a fluorine atom or a hydrogen atom, and R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

The compound represented by General Formula (X-4) used in the liquid crystal composition of the present invention is preferably the compound represented by General Formula (X-4-1).

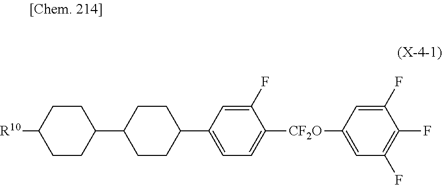

In General Formula (X-4-1), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

The content of the compound represented by General Formula (X-4-1) is suitably adjusted in consideration of solubility at a low temperature, a transition temperature, and electrical reliability.

The content of the compound represented by General Formula (X-4-1) is preferably 2% by mass to 20% by mass, preferably 5% by mass to 17% by mass, preferably 10% by mass to 15% by mass, and preferably 10% by mass to 13% by mass, with respect to the total mass of the liquid crystal composition of the present invention.

Furthermore, the compound represented by General Formula (X-4-1) used in the liquid crystal composition of the present invention, specifically, is preferably at least one compound selected from the compound group represented by Formulas (42.1) to (42.4), and preferably contains the compound represented by Formula (42.3) among Formulas (42.1) to (42.4).

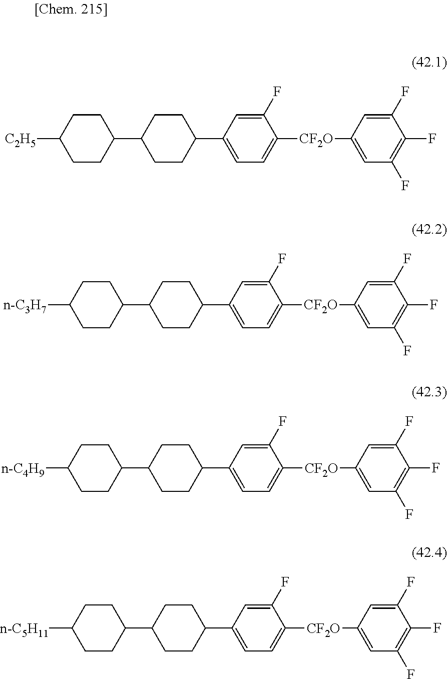

The compound represented by General Formula (X-4) used in the liquid crystal composition of the present invention is preferably the compound represented by General Formula (X-4-4).

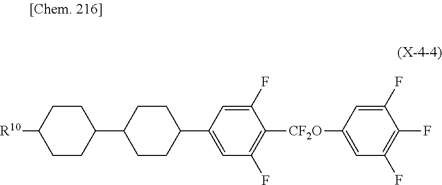

In General Formula (X-4-4), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

The content of the compound represented by General Formula (X-4-4) is suitably adjusted in consideration of solubility at a low temperature, a transition temperature, and electrical reliability.

The content of the compound represented by General Formula (X-4-4) is preferably 2% by mass to 20% by mass, preferably 5% by mass to 17% by mass, preferably 10% by mass to 15% by mass, and preferably 10% by mass to 13% by mass, with respect to the total mass of the liquid crystal composition of the present invention.

Furthermore, the compound represented by General Formula (X-4-4) used in the liquid crystal composition of the present invention, specifically, is preferably at least one compound selected from the compound group represented by Formulas (42.31) to (42.34), and preferably contains the compound represented by Formula (42.33) among Formulas (42.31) to (42.34).

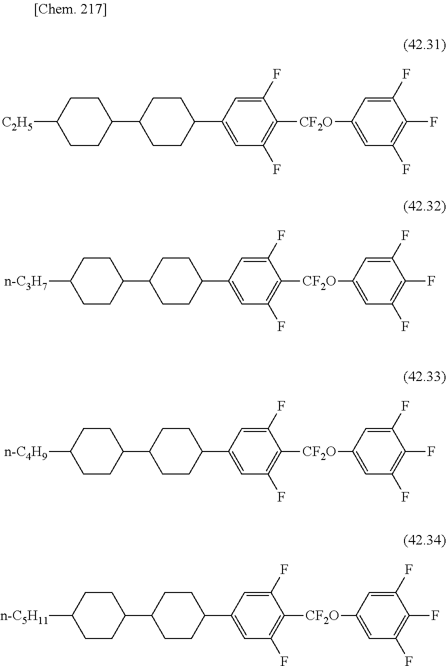

Alternatively/in addition, the compound represented by General Formula (X) used in the liquid crystal composition of the present invention is preferably the compound represented by General Formula (X-4-2).

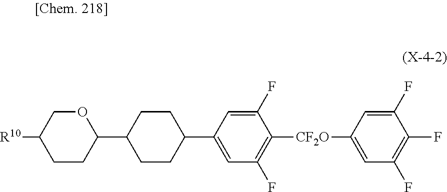

In General Formula (X-4-2), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

The content of the compound represented by General Formula (X-4-2) is preferably 2% by mass to 20% by mass, preferably 5% by mass to 17% by mass, preferably 10% by mass to 15% by mass, and preferably 10% by mass to 13% by mass, with respect to the total mass of the liquid crystal composition of the present invention, in consideration of solubility at a low temperature, a transition temperature, and electrical reliability.

Furthermore, the compound represented by General Formula (X-4-2) used in the liquid crystal composition of the present invention, specifically, is preferably at least one compound selected from the compound group represented by Formulas (42.11) to (42.14), and more preferably contains the compound represented by Formulas (42.13) and/or (42.14) among Formulas (42.11) to (42.14).

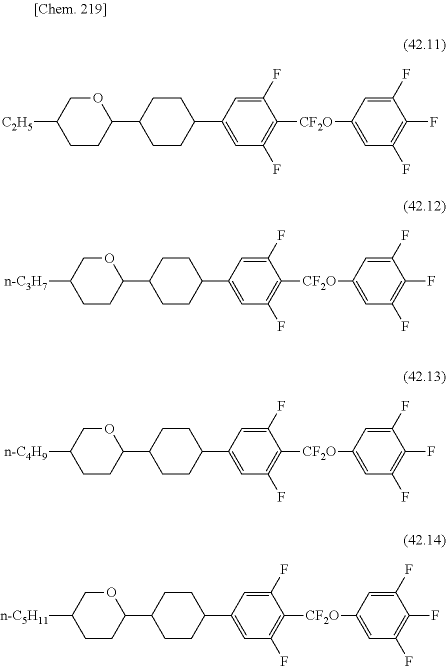

Alternatively/in addition, the compound represented by General Formula (X) used in the liquid crystal composition of the present invention is preferably the compound represented by General Formula (X-4-3).

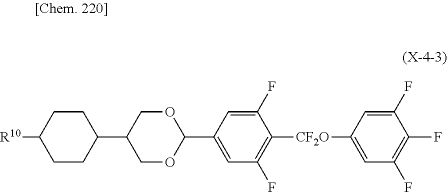

In General Formula (X-4-3), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

The content of the compound represented by General Formula (X-4-3) is preferably 2% by mass to 20% by mass, preferably 5% by mass to 17% by mass, preferably 10% by mass to 15% by mass, and preferably 10% by mass to 13% by mass, with respect to the total mass of the liquid crystal composition of the present invention, in consideration of solubility at a low temperature, a transition temperature, and electrical reliability.

Furthermore, the compound represented by General Formula (X-4-3) used in the liquid crystal composition of the present invention, specifically, is preferably at least one compound selected from the compound group represented by Formulas (42.21) to (42.24), and more preferably contains the compound represented by Formula (42.22) among Formulas (42.21) to (42.24).

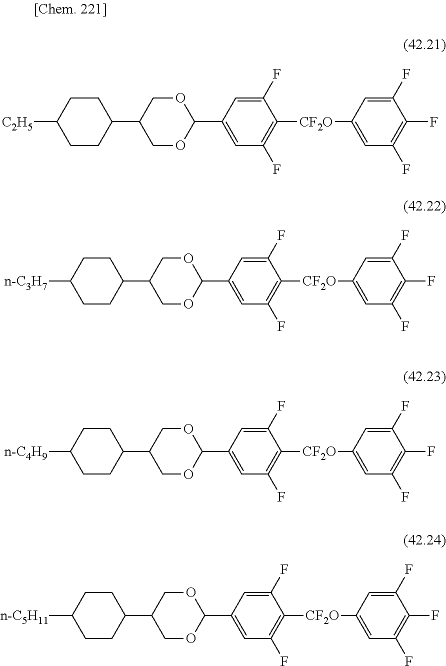

Alternatively/in addition, the compound represented by General Formula (X) is preferably the compound represented by General Formula (X-5).

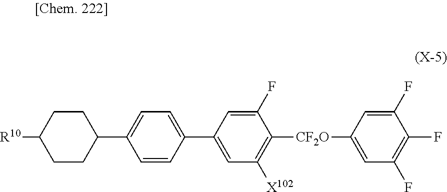

In General Formula (X-5), X¹⁰² represents a fluorine atom or a hydrogen atom, and R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

Furthermore, the compound represented by General Formula (X-5) is preferably the compound represented by General Formula (X-5-1).

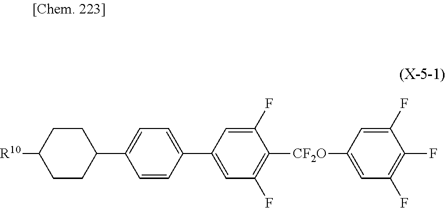

In General Formula (X-5-1), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined, and three or more types are more preferably combined.

Furthermore, the compound represented by General Formula (X-5-1), specifically, is preferably at least one compound selected from the compound group represented by Formulas (43.1) to (43.4), and preferably contains the compound represented by Formula (43.2) among Formulas (43.1) to (43.4).

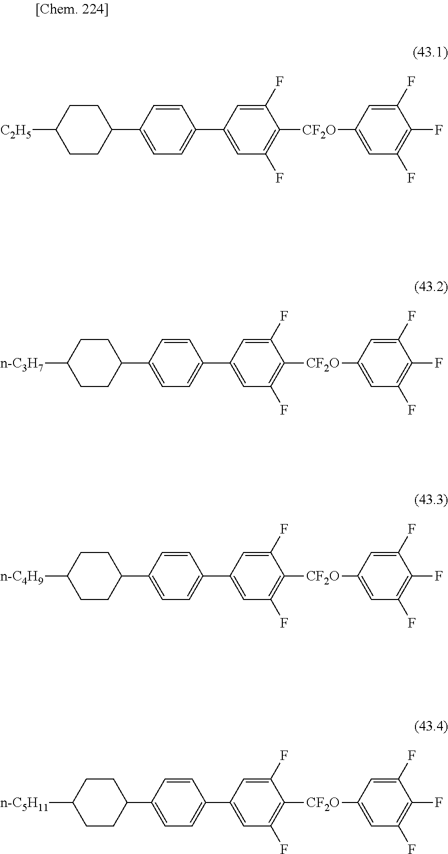

Alternatively/in addition, the compound represented by General Formula (X) is preferably the compound represented by General Formula (X-6).

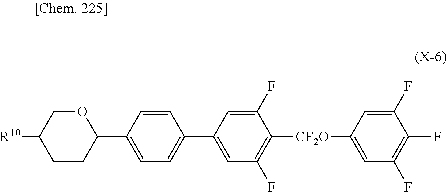

In General Formula (X-6), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (x-6) is suitably adjusted in consideration of characteristics such as solubility at a low temperature, a transition temperature, electrical reliability, and birefringence.

For example, the content of the compound represented by General Formula (X-6) is 1% to 30% by mass in an embodiment of the present invention, 1% to 25% by mass in another embodiment, 1% to 20% by mass in still another embodiment, 1% to 15% by mass in still another embodiment, 2% to 14% by mass in still another embodiment, 2% to 12% by mass in still another embodiment, 2% to 9% by mass in still another embodiment, 2% to 8% by mass in still another embodiment, 2% to 6% by mass in still another embodiment, 2% to 5% by mass in still another embodiment, 3% to 14% by mass in still another embodiment, 5% to 14% by mass in still another embodiment, 7% to 14% by mass in still another embodiment, 8% to 14% by mass in still another embodiment, 9% to 14% by mass in still another embodiment, 9% to 12% by mass in still another embodiment, 3% to 8% by mass in still another embodiment, 3% to 6% by mass in still another embodiment, 4% to 7% by mass in still another embodiment, 4% to 5% by mass in still another embodiment, 5% to 8% by mass in still another embodiment, 5% to 6% by mass in still another embodiment, 7% to 8% by mass in still another embodiment, and 8% to 9% by mass in still another embodiment, with respect to the total mass of the liquid crystal composition of the present invention.

Furthermore, the compound represented by General Formula (X-6), specifically, is preferably at least one compound selected from the compound group represented by Formulas (44.1) to (44.4), and preferably contains the compound represented by Formulas (44.1) and/or (44.2) among Formulas (44.1) to (44.4).

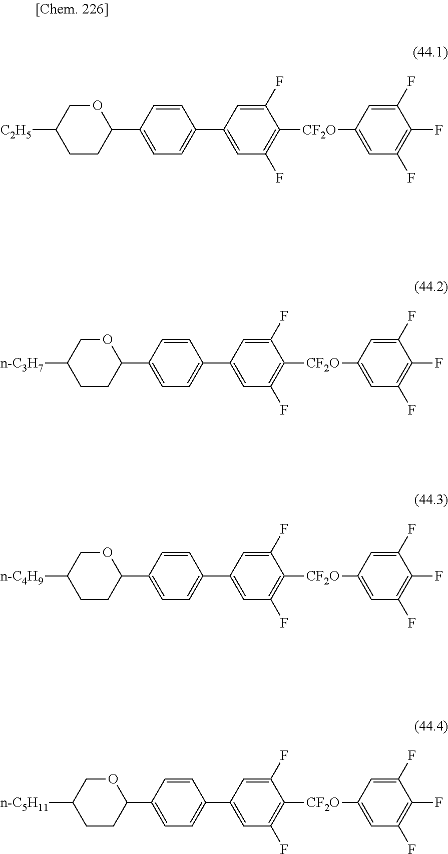

As the compound represented by General Formula (M), the compound represented by General Formula (X′-7) which is similar to the compound represented by General Formula (X) may be contained in the liquid crystal compound of the present invention.

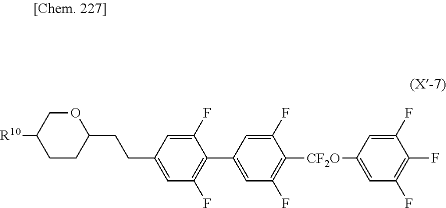

In General Formula (X′-7), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (X′-7) is suitably adjusted in consideration of characteristics such as solubility at a low temperature, a transition temperature, electrical reliability, and birefringence.

For example, the content of the compound represented by General Formula (X′-7) is 4% to 30% by mass in an embodiment of the present invention, 5% to 30% by mass in another embodiment, 6% to 30% by mass in still another embodiment, 8% to 30% by mass in still another embodiment, 9% to 30% by mass in still another embodiment, 11% to 30% by mass in still another embodiment, 14% to 30% by mass in still another embodiment, and 18% to 30% by mass in still another embodiment, with respect to the total mass of the liquid crystal composition of the present invention.

In addition, for example, the content of the compound represented by General Formula (X′-7) is 4% to 20% by mass in an embodiment of the present invention, the content of the compound is 4% to 13% by mass in another embodiment, the content of the compound is 4% to 10% by mass in still another embodiment, and the content of the compound is 4% to 7% by mass in still another embodiment, with respect to the total mass of the liquid crystal composition of the present invention.

Furthermore, the compound represented by General Formula (X′-7) used in the liquid crystal composition of the present invention, specifically, is preferably at least one compound selected from the compound group represented by Formulas (44.11) to (44.14), and more preferably contains the compound represented by Formula (44.13) among Formulas (44.11) to (44.14).

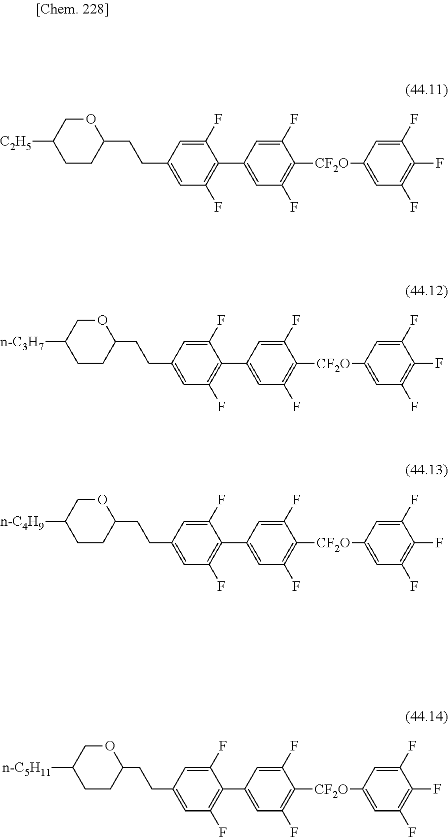

Alternatively/in addition, the compound represented by General Formula (X) is preferably the compound represented by General Formula (X-8).

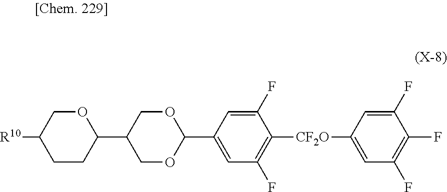

In General Formula (X-8), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (x-8) is suitably adjusted in consideration of characteristics such as solubility at a low temperature, a transition temperature, electrical reliability, and birefringence.

For example, the content of the compound represented by General Formula (X-8) is 1% to 25% by mass in an embodiment of the present invention, 1% to 20% by mass in another embodiment, 1% to 15% by mass in still another embodiment, 1% to 10% by mass in still another embodiment, 1% to 5% by mass in still another embodiment, and 1% to 3% by mass in still another embodiment, with respect to the total mass of the liquid crystal composition of the present invention.

Furthermore, the compound represented by General Formula (X-8), specifically, is preferably at least one compound selected from the compound group represented by Formulas (44.21) to (44.24), and preferably contains the compound represented by Formula (44.22) among Formulas (44.21) to (44.24).

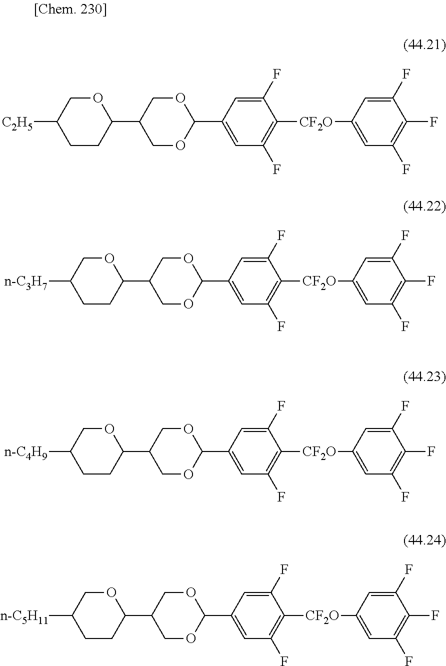

Alternatively/in addition, the compound represented by General Formula (X) is preferably the compound represented by General Formula (X-9).

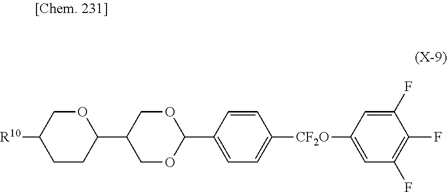

In General Formula (X-9), R¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (x-9) is suitably adjusted in consideration of characteristics such as solubility at a low temperature, a transition temperature, electrical reliability, and birefringence.

For example, the content of the compound represented by General Formula (X-9) is 1% to 25% by mass in an embodiment of the present invention, 1% to 20% by mass in another embodiment, 1% to 15% by mass in still another embodiment, 1% to 10% by mass in still another embodiment, 1% to 5% by mass in still another embodiment, and 1% to 3% by mass in still another embodiment, with respect to the total mass of the liquid crystal composition of the present invention.

Furthermore, the compound represented by General Formula (X-9), specifically, is preferably at least one compound selected from the compound group represented by Formulas (44.31) to (44.34), and preferably contains the compound represented by Formula (44.33) or (44.34) among Formulas (44.31) to (44.34).

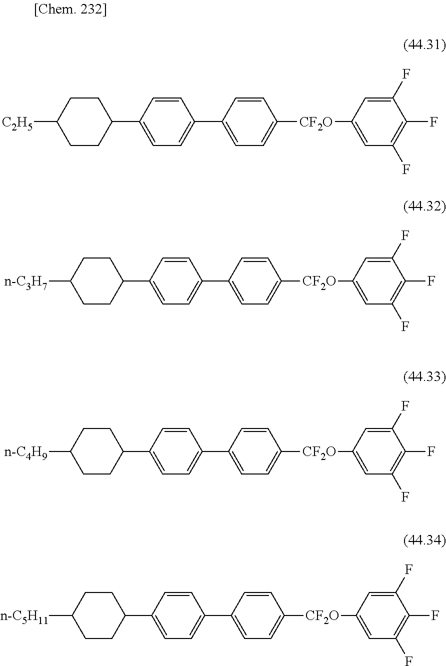

Alternatively/in addition, the compound represented by General Formula (X) is preferably at least one compound selected from the group represented by General Formula (XI).

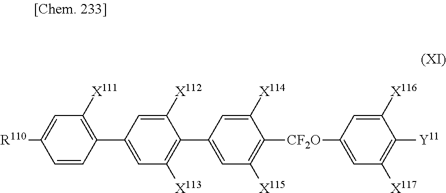

In General Formula (XI), each of X¹¹¹ to X¹¹⁷ independently represents a fluorine atom or a hydrogen atom, at least one of X¹¹¹ to X¹¹⁷ represents a fluorine atom, R¹¹⁰ represents an alkyl group having 1 to 5 carbon atoms, an alkenyl group having 2 to 5 carbon atoms, or an alkoxy group having 1 to 4 carbon atoms, and Y¹¹ represents a fluorine atom or —OCF₃.

The compounds capable of being combined are not particularly limited, and in consideration of solubility at a low temperature, a transition temperature, electrical reliability, and birefringence, for example, in an embodiment of the present invention, one type thereof is preferably combined, in another embodiment, two types thereof are preferably combined, and in still another embodiment, three or more types thereof are preferably combined.

The content of the compound represented by General Formula (XI) is suitably adjusted in consideration of characteristics such as solubility at a low temperature, a transition temperature, electrical reliability, and birefringence.

For example, the content of the compound represented by General Formula (XI) is 2% to 30% by mass in an embodiment of the present invention, 4% to 30% by mass in another embodiment, 5% to 30% by mass in still another embodiment, 7% to 30% by mass in still another embodiment, 9% to 30% by mass in still another embodiment, 10% to 30% by mass in still another embodiment, and 12% to 30% by mass in still another embodiment, 13% to 30% by mass in still another embodiment, 15% to 30% by mass in still another embodiment, and 18% to 30% by mass in still another embodiment, with respect to the total mass of the liquid crystal composition of the present invention.

For example, the content of the compound represented by General Formula (XI) is 2% to 25% by mass in an embodiment of the present invention, 2% to 20% by mass in another embodiment, 2% to 15% by mass in still another embodiment, 2% to 10% by mass in still another embodiment, and 2% to 5% by mass in still another embodiment, with respect to the total mass of the liquid crystal composition of the present invention.

In a case where the liquid crystal composition of the present invention is used in a liquid crystal display element having a small cell gap, it is suitable that the content of the compound represented by General Formula (XI) is large. In a case where the liquid crystal composition of the present invention is used in a liquid crystal display element having a low driving voltage, it is suitable that the content of the compound represented by General Formula (XI) is large. In a case where the liquid crystal composition of the present invention is used in a liquid crystal display element which is used in a low temperature environment, it is suitable that the content of the compound represented by General Formula (XI) is small. In a case where the liquid crystal composition of the present invention is used in a liquid crystal display element having a high response speed, it is suitable that the content of the compound represented by General Formula (XI) is small.

Alternatively/in addition, the compound represented by General Formula (XI) used in the liquid crystal composition of the present invention is preferably the compound represented by General Formula (XI-2).

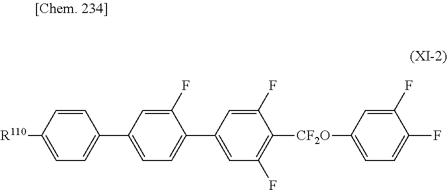

In General Formula (XI-2), R¹¹⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, a compound is suitably combined with respect to each embodiment. For example, in an embodiment of the present invention, one type thereof is combined, in another embodiment, two types thereof are combined, and in still another embodiment, three or more types thereof are combined.

The content of the compound represented by General Formula (XI-2) is preferably 1% by mass to 20% by mass, preferably 3% by mass to 20% by mass, preferably 4% by mass to 20% by mass, preferably 6% by mass to 15% by mass, and preferably 9% by mass to 12% by mass, with respect to the total mass of the liquid crystal composition of the present invention, in consideration of solubility at a low temperature, a transition temperature, and electrical reliability.

Specifically, the compound represented by General Formula (XI-2) used in the liquid crystal composition of the present invention is preferably at least one compound selected from the compound group represented by Formulas (45.11) to (45.14), preferably contains at least one compound selected from the compound group represented by Formulas (45.12) to (45.14) among Formulas (45.11) to (45.14), and more preferably contains the compound represented by Formula (45.12).

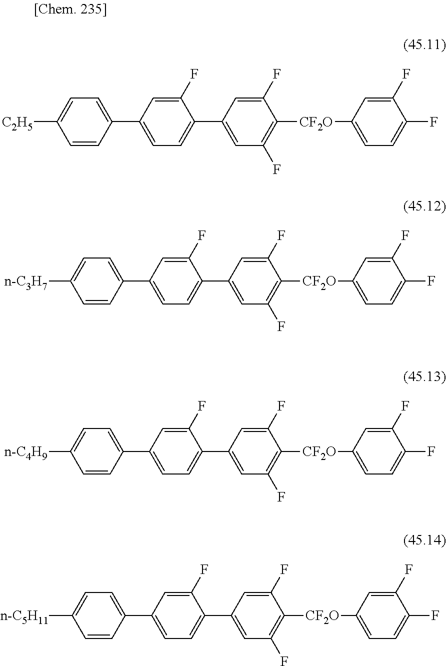

Alternatively/in addition, the compound represented by General Formula (X) is preferably at least one compound selected from the group represented by General Formula (XII).

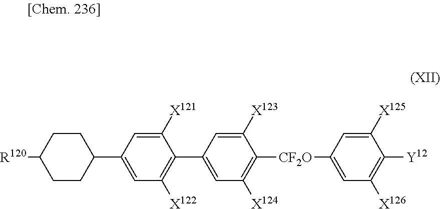

In General Formula (XII), each of X¹²¹ and X¹²⁶ independently represents a fluorine atom or a hydrogen atom, R¹²⁰ represents an alkyl group having 1 to 5 carbon atoms, an alkenyl group having 2 to 5 carbon atoms, or an alkoxy group having 1 to 4 carbon atoms, and Y¹² represents a fluorine atom or —OCF₃.

The compounds capable of being combined are not particularly limited, and in consideration of solubility at a low temperature, a transition temperature, electrical reliability, and birefringence, one to three or more types are preferably suitably combined, and one to four or more types are more preferably suitably combined.

The compound represented by General Formula (XII) used in the liquid crystal composition of the present invention is preferably the compound represented by General Formula (XII-1).

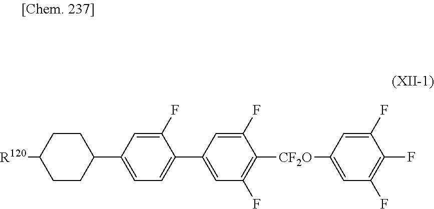

In General Formula (XII-1), R¹²⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably suitably combined, and one to three or more types are more preferably suitably combined.

The content of the compound represented by General Formula (XII-1) is preferably 1% by mass to 15% by mass, preferably 2% by mass to 10% by mass, preferably 3% by mass to 8% by mass, and preferably 4% by mass to 6% by mass, with respect to the total mass of the liquid crystal composition of the present invention, in consideration of solubility at a low temperature, a transition temperature, and electrical reliability.

Specifically, the compound represented by General Formula (XII-1) used in the liquid crystal composition of the present invention is preferably at least one compound selected from the compound group represented by Formulas (46.1) to (46.4), and preferably contains at least one compound selected from the compound group represented by Formulas (46.2) to (46.4) among Formulas (46.1) to (46.4).

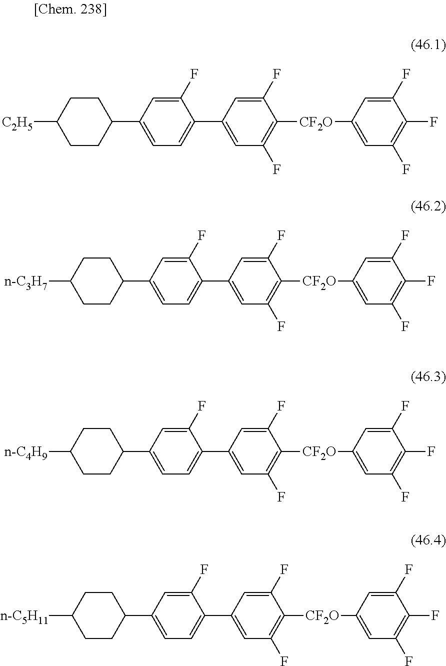

Alternatively/in addition, the compound represented by General Formula (XII) is preferably the compound represented by General Formula (XII-2).

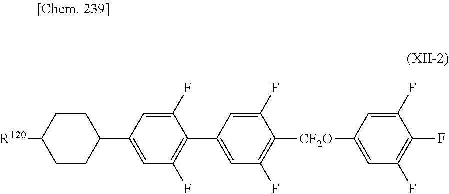

In General Formula (XII-2), R¹²⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably suitably combined, and one to three or more types are more preferably suitably combined.

The content of the compound represented by General Formula (XII-2) is preferably 1% by mass to 20% by mass, preferably 3% by mass to 20% by mass, preferably 4% by mass to 17% by mass, preferably 6% by mass to 15% by mass, and preferably 9% by mass to 13% by mass, with respect to the total mass of the liquid crystal composition of the present invention, in consideration of solubility at a low temperature, a transition temperature, and electrical reliability.

Specifically, the compound represented by General Formula (XII-2) used in the liquid crystal composition of the present invention is preferably at least one compound selected from the compound group represented by Formulas (47.1) to (47.4), and preferably contains at least one compound selected from the compound group represented by Formulas (47.2) to (47.4) among Formulas (47.1) to (47.4).

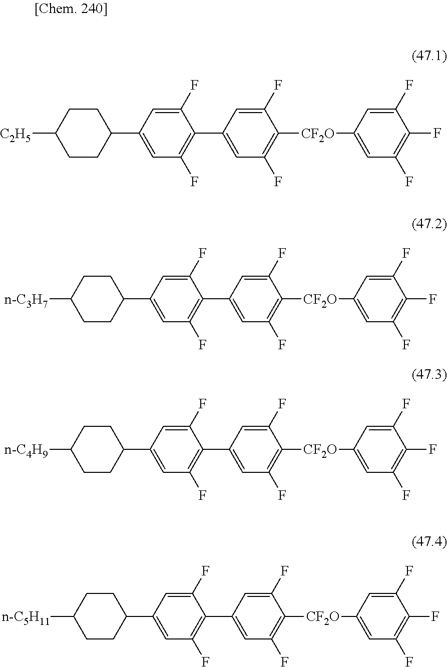

Alternatively/in addition, the compound represented by General Formula (M) is preferably at least one compound selected from the compound group represented by General Formula

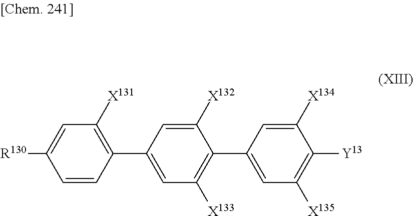

In General Formula (XIII), each of X¹³¹ to X¹³⁵ independently represents a fluorine atom or a hydrogen atom, R¹³⁰ represents an alkyl group having 1 to 5 carbon atoms, an alkenyl group having 4 to 5 carbon atoms, or an alkoxy group having 1 to 4 carbon atoms, and Y¹³ represents a fluorine atom or —OCF₃.

The types of compounds capable of being combined are not particularly limited, and one type or two types of these compounds are preferably contained, one to three types are more preferably contained, and one to four types are still more preferably contained.

The content of the compound represented by General Formula (XIII) is suitably adjusted in consideration of characteristics such as solubility at a low temperature, a transition temperature, electrical reliability, and birefringence.

For example, the content of the compound represented by General Formula (XIII) is 2% to 30% by mass in an embodiment of the present invention, 4% to 30% by mass in another embodiment, 5% to 30% by mass in still another embodiment, 7% to 30% by mass in still another embodiment, 9% to 30% by mass in still another embodiment, 11% to 30% by mass in still another embodiment, and 13% to 30% by mass in still another embodiment, 14% to 30% by mass in still another embodiment, 16% to 30% by mass in still another embodiment, and 20% to 30% by mass in still another embodiment, with respect to the total mass of the liquid crystal composition of the present invention.

In addition, for example, the content of the compound represented by General Formula (XIII) is 2% to 25% by mass in an embodiment of the present invention, the content of the compound is 2% to 20% by mass in another embodiment, the content of the compound is 2% to 15% by mass in still another embodiment, the content of the compound is 2% to 10% by mass in still another embodiment, and the content of the compound is 2% to 5% by mass in still another embodiment, with respect to the total mass of the liquid crystal composition of the present invention.

In a case where the liquid crystal composition of the present invention is used in a liquid crystal display element having a small cell gap, it is suitable that the content of the compound represented by General Formula (XIII) is large. In a case where the liquid crystal composition of the present invention is used in a liquid crystal display element having a low driving voltage, it is suitable that the content of the compound represented by General Formula (XIII) is large. In a case where the liquid crystal composition of the present invention is used in a liquid crystal display element which is used in a low temperature environment, it is suitable that the content of the compound represented by General Formula (XIII) is small. In a case where the liquid crystal composition of the present invention is used in a liquid crystal display element having a high response speed, it is suitable that the content of the compound represented by General Formula (XIII) is small.

Furthermore, the compound represented by General Formula (XIII) is preferably the compound represented by General Formula (XIII-1).

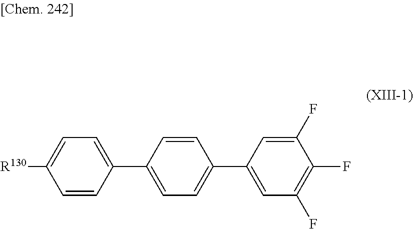

In General Formula (XIII-1), R¹³⁰ represents an alkyl group having 1 to 5 carbon atoms, an alkenyl group having 4 to 5 carbon atoms, or an alkoxy group having 1 to 4 carbon atoms.

The compound represented by General Formula (XIII-1) is contained in an amount of preferably 1% by mass to 25% by mass, preferably 3% by mass to 25% by mass, preferably 5% by mass to 20% by mass, and preferably 10% by mass to 15% by mass, with respect to the total mass of the liquid crystal composition of the present invention.

Furthermore, the compound represented by General Formula (XIII-1) is preferably at least one compound selected from the compound group represented by Formulas (48.1) to (48.4), and preferably the compound represented by Formula (48.2).

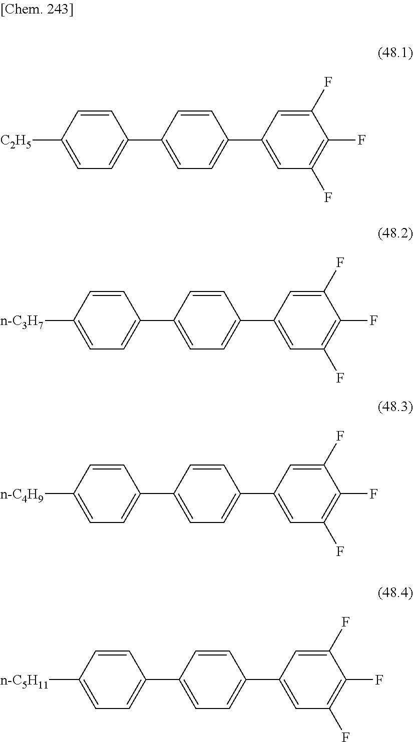

Alternatively/in addition, the compound represented by General Formula (XIII) is preferably the compound represented by General Formula (XIII-2).

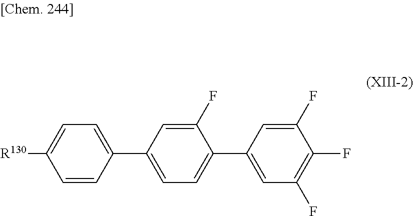

In General Formula (XIII-2), R¹³⁰ represents an alkyl group having 1 to 5 carbon atoms, an alkenyl group having 4 to 5 carbon atoms, or an alkoxy group having 1 to 4 carbon atoms.

The types of compounds capable of being combined are not particularly limited, and one type or two or more types of these compounds are preferably contained.

The compound represented by General Formula (XIII-2) is contained in an amount of preferably 1% by mass to 25% by mass, preferably 1% by mass to 20% by mass, preferably 1% by mass to 15% by mass, and preferably 3% by mass to 14% by mass, with respect to the total mass of the liquid crystal composition of the present invention. Within the above ranges, the compound represented by General Formula (XIII-2) is contained in an amount of preferably 3% by mass to 10% by mass, preferably 3% by mass to 6% by mass, preferably 6% by mass to 14% by mass, and preferably 10% by mass to 14% by mass, with respect to the total mass of the liquid crystal composition of the present invention.

Furthermore, the compound represented by General Formula (XIII-2) is preferably at least one compound selected from the compound group represented by Formulas (49.1) to (49.4), and preferably the compound represented by Formulas (49.1) and/or (49.2).

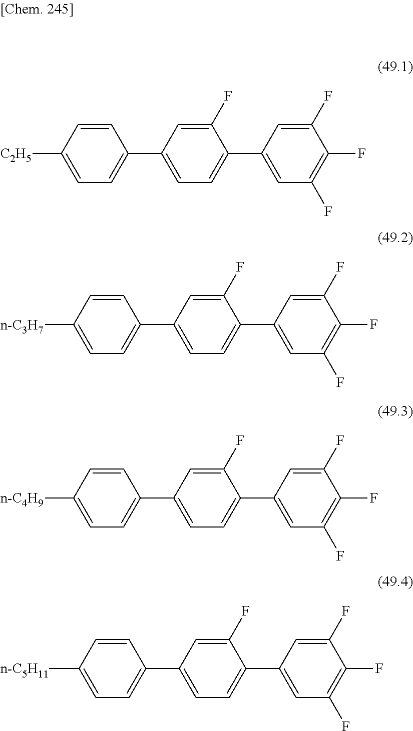

Alternatively/in addition, the compound represented by General Formula (XIII) is preferably the compound represented by General Formula (XIII-3).

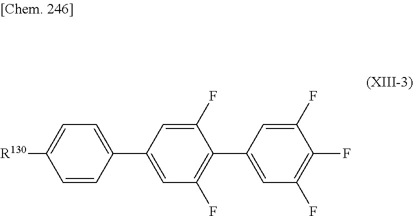

In General Formula (XIII-3), R¹³⁰ represents an alkyl group having 1 to 5 carbon atoms, an alkenyl group having 4 to 5 carbon atoms, or an alkoxy group having 1 to 4 carbon atoms.

The types of compounds capable of being combined are not particularly limited, and one type or two types of these compounds are preferably contained.

The compound represented by General Formula (XIII-3) is contained in an amount of preferably 2% by mass to 20% by mass, preferably 4% by mass to 20% by mass, preferably 9% by mass to 17% by mass, and preferably 11% by mass to 14% by mass, with respect to the total mass of the liquid crystal composition of the present invention.

Furthermore, the compound represented by General Formula (XIII-3) is preferably at least one compound selected from the compound group represented by Formulas (50.1) to (50.4), and preferably the compound represented by Formulas (50.1) and/or (50.2).

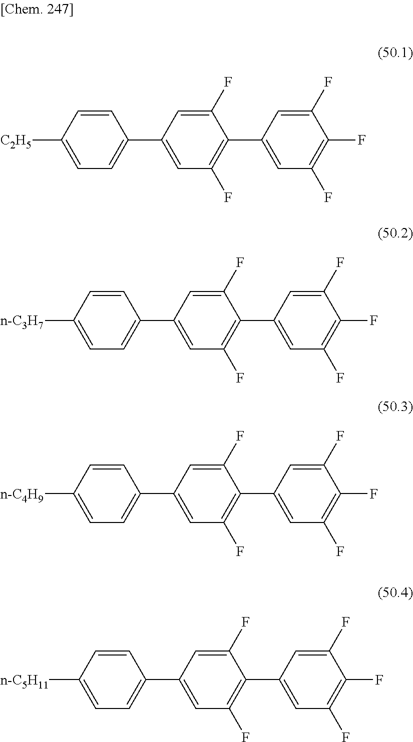

Alternatively/in addition, the compound represented by General Formula (M) is preferably at least one compound selected from the compound group represented by General Formula (XIV).

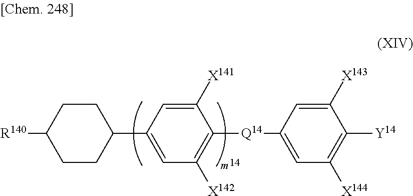

In General Formula (XIV), R¹⁴⁰ represents an alkyl group having 1 to 7 carbon atoms, an alkenyl group having 2 to 7 carbon atoms, or an alkoxy group having 1 to 7 carbon atoms, each of X¹⁴¹ to X¹⁴⁴ independently represents a fluorine atom or a hydrogen atom, Y¹⁴ represents a fluorine atom, a chlorine atom, or OCF₃, Q¹⁴ represents a single bond, —COO—, or —CF₂O—, and m¹⁴ is 0 or 1.

The types of compound capable of being combined are not limited, and in consideration of solubility at a low temperature, a transition temperature, electrical reliability, and birefringence, a compound is suitably combined with respect to each embodiment. For example, in an embodiment of the present invention, one type is used. In another embodiment of the present invention, two types are used. In still another embodiment of the present invention, three types are used. In still another embodiment of the present invention, four types are used. In still another embodiment of the present invention, five types are used. In still another embodiment of the present invention, six or more types are used.

The content of the compound represented by General Formula (XIV) is suitably adjusted in consideration of characteristics such as solubility at a low temperature, a transition temperature, electrical reliability, and birefringence.

For example, the content of the compound represented by General Formula (XIV) is 3% to 40% by mass in an embodiment of the present invention, 7% to 40% by mass in another embodiment, 8% to 40% by mass in still another embodiment, 11% to 40% by mass in still another embodiment, 12% to 40% by mass in still another embodiment, 16% to 40% by mass instill another embodiment, 18% to 40% by mass in still another embodiment, 19% to 40% by mass in still another embodiment, 22% to 40% by mass in still another embodiment, and 25% to 40% by mass in still another embodiment, with respect to the total mass of the liquid crystal composition of the present invention.

For example, the content of the compound represented by General Formula (XIV) is 3% to 35% by mass in an embodiment of the present invention, 3% to 30% by mass in still another embodiment, 3% to 25% by mass in still another embodiment, 3% to 20% by mass in still another embodiment, and 3% to 15% by mass in still another embodiment, with respect to the total mass of the liquid crystal composition of the present invention.

In a case where the liquid crystal composition of the present invention is used in a liquid crystal display element having a low driving voltage, it is suitable that the content of the compound represented by General Formula (XIV) is large. In a case where the liquid crystal composition of the present invention is used in a liquid crystal display element having a high response speed, it is suitable that the content of the compound represented by General Formula (XIV) is small.

Furthermore, the compound represented by General Formula (XIV) is preferably the compound represented by General Formula (XIV-1).

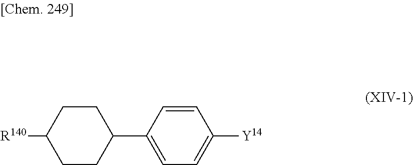

In General Formula (XIV-1), R¹⁴⁰ represents an alkyl group having 1 to 7 carbon atoms, an alkenyl group having 2 to 7 carbon atoms, or an alkoxy group having 1 to 7 carbon atoms, and Y¹⁴ represents a fluorine atom, a chlorine atom, or —OCF₃.

The types of compound capable of being combined are not limited, and in consideration of solubility at a low temperature, a transition temperature, electrical reliability, and birefringence, one to three types are preferably combined.

Furthermore, the compound represented by General Formula (XIV-1) is preferably the compound represented by General Formula (XIV-1-1).

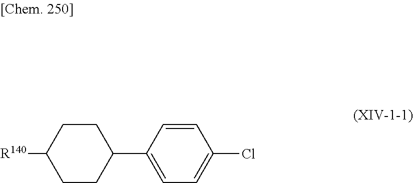

In General Formula (XIV-1-1), R¹⁴⁰ represents an alkyl group having 1 to 7 carbon atoms, an alkenyl group having 2 to 7 carbon atoms, or an alkoxy group having 1 to 7 carbon atoms.

The content of the compound represented by General Formula (XIV-1) is suitably adjusted in consideration of solubility at a low temperature, a transition temperature, and electrical reliability.

For example, the content of the compound represented by General Formula (XIV-1) is 2% by mass to 30% by mass in an embodiment of the present invention, 4% by mass to 30% by mass in another embodiment, 7% by mass to 30% by mass in still another embodiment, 10% by mass to 30% by mass in still another embodiment, and 18% by mass to 30% by mass in still another embodiment, with respect to the total mass of the liquid crystal composition of the present invention.

In addition, for example, the content of the compound represented by General Formula (XIV-1) is 2% by mass to 27% by mass in an embodiment of the present invention, 2% by mass to 24% by mass in another embodiment, and 2% by mass or greater to less than 21% by mass in still another embodiment, with respect to the total mass of the liquid crystal composition of the present invention.

Furthermore, the compound represented by General Formula (XIV-1-1), specifically, is preferably at least one compound selected from the compound group represented by Formulas (51.1) to (51.4), and more preferably contains the compound represented by Formula (51.1).

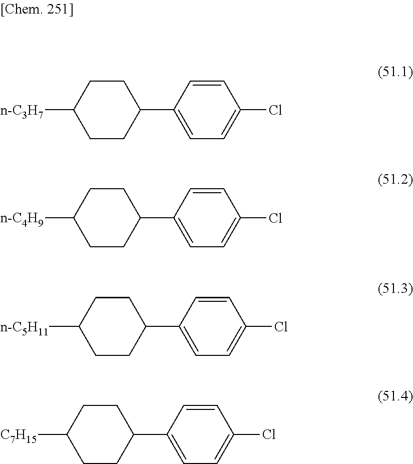

Alternatively/in addition, the compound represented by General Formula (XIV-1) is preferably the compound represented by General Formula (XIV-1-2).

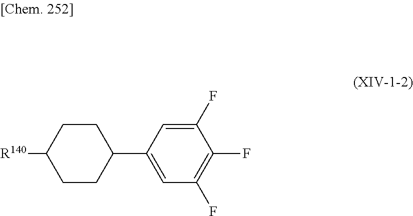

In General Formula (XIV-1-2), R¹⁴⁰ represents an alkyl group having 1 to 7 carbon atoms, an alkenyl group having 2 to 7 carbon atoms, or an alkoxy group having 1 to 7 carbon atoms.

The content of the compound represented by General Formula (XIV-1-2) is preferably 1% by mass to 15% by mass, preferably 3% by mass to 13% by mass, preferably 5% by mass to 11% by mass, and preferably 7% by mass to 9% by mass, with respect to the total mass of the liquid crystal composition of the present invention, in consideration of solubility at a low temperature, a transition temperature, and electrical reliability.

Furthermore, the compound represented by General Formula (XIV-1-2), specifically, is preferably at least one compound selected from the compound group represented by Formulas (52.1) to (52.4), and preferably contains the compound represented by Formula (52.4) among Formulas (52.2) to (52.4).

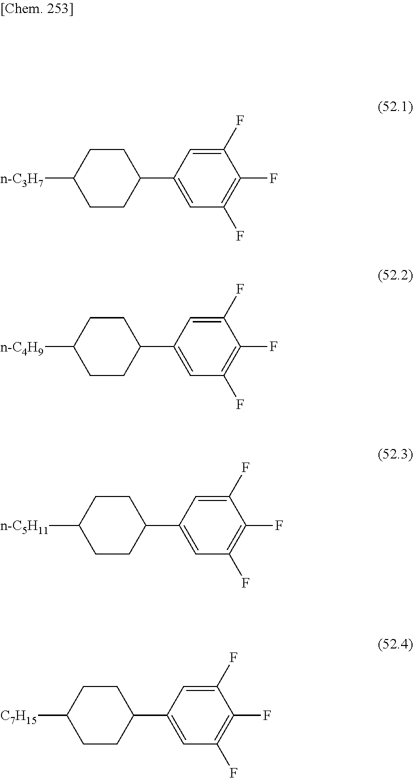

Alternatively/in addition, the compound represented by General Formula (XIV) is preferably the compound represented by General Formula (XIV-2).

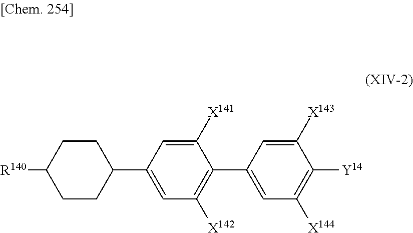

In General Formula (XIV-2), R¹⁴⁰ represents an alkyl group having 1 to 5 carbon atoms, an alkenyl group having 2 to 5 carbon atoms, or an alkoxy group having 1 to 4 carbon atoms, each of X¹⁴¹ to X¹⁴⁴ independently represents a fluorine atom or a hydrogen atom, and Y¹⁴ represents a fluorine atom, a chlorine atom, or —OCF₃.

The types of compound capable of being combined are not limited, and in consideration of solubility at a low temperature, a transition temperature, electrical reliability, and birefringence, a compound is suitably combined with respect to each embodiment. For example, in an embodiment of the present invention, one type is used. In another embodiment of the present invention, two types are used. In still another embodiment of the present invention, three types are used. In still another embodiment of the present invention, four types are used. In still another embodiment of the present invention, five or more types are used.

The content of the compound represented by General Formula (XIV-2) is suitably adjusted in consideration of characteristics such as solubility at a low temperature, a transition temperature, electrical reliability, and birefringence.

For example, the content of the compound represented by General Formula (XIV-2) is 3% to 40% by mass in an embodiment of the present invention, 7% to 40% by mass in another embodiment, 8% to 40% by mass in still another embodiment, 10% to 40% by mass in still another embodiment, 11% to 40% by mass in still another embodiment, 12% to 40% by mass instill another embodiment, and 18% to 40% by mass instill another embodiment, 19% to 40% by mass in still another embodiment, 21% to 40% by mass in still another embodiment, and 22% to 40% by mass in still another embodiment, with respect to the total mass of the liquid crystal composition of the present invention.

In addition, for example, the content of the compound represented by General Formula (XIV-2) is 3% to 35% by mass in an embodiment of the present invention, 3% to 25% by mass in another embodiment, 3% to 20% by mass in still another embodiment, 3% to 15% by mass in still another embodiment, and 3% to 10% by mass in still another embodiment, with respect to the total mass of the liquid crystal composition of the present invention.

In a case where the liquid crystal composition of the present invention is used in a liquid crystal display element having a low driving voltage, it is suitable that the content of the compound represented by General Formula (XIV-2) is large. In a case where the liquid crystal composition of the present invention is used in a liquid crystal display element having a high response speed, it is suitable that the content of the compound represented by General Formula (XIV-2) is small.

Furthermore, the compound represented by General Formula (XIV-2) is preferably the compound represented by General Formula (XIV-2-1).

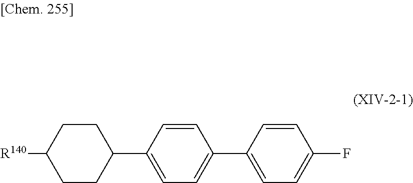

In General Formula (XIV-2-1), R¹⁴⁰ represents an alkyl group having 1 to 5 carbon atoms, an alkenyl group having 2 to 5 carbon atoms, or an alkoxy group having 1 to 4 carbon atoms.

The content of the compound represented by General Formula (XIV-2-1) is preferably 1% by mass to 15% by mass, preferably 3% by mass to 13% by mass, preferably 5% by mass to 11% by mass, and preferably 7% by mass to 9% by mass, with respect to the total mass of the liquid crystal composition of the present invention, in consideration of solubility at a low temperature, a transition temperature, and electrical reliability.

Furthermore, the compound represented by General Formula (XIV-2-1), specifically, is preferably at least one compound selected from the compound group represented by Formulas (53.1) to (53.4), and preferably contains the compound represented by Formula (53.4) among Formulas (53.1) to (53.4).

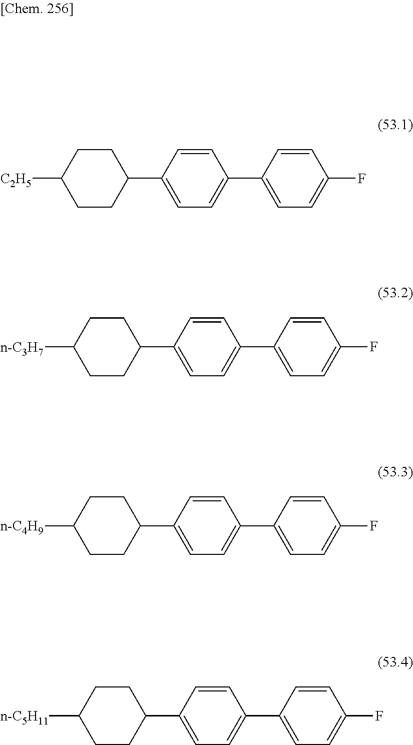

Alternatively/in addition, the compound represented by General Formula (XIV-2) is preferably the compound represented by General Formula (XIV-2-2).

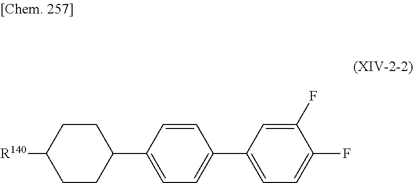

In General Formula (XIV-2-2), R¹⁴ represents an alkyl group having 1 to 5 carbon atoms, an alkenyl group having 2 to 5 carbon atoms, or an alkoxy group having 1 to 4 carbon atoms.

The content of the compound represented by General Formula (XIV-2-2) is preferably 3% by mass to 20% by mass, preferably 5% by mass to 17% by mass, preferably 5% by mass to 15% by mass, and preferably 5% by mass to 9% by mass, with respect to the total mass of the liquid crystal composition of the present invention, in consideration of solubility at a low temperature, a transition temperature, and electrical reliability.

Furthermore, the compound represented by General Formula (XIV-2-2), specifically, is preferably at least one compound selected from the compound group represented by Formulas (54.1) to (54.4), and preferably contains the compound represented by Formulas (54.2) and/or (54.4) among Formulas (54.1) to (54.4).

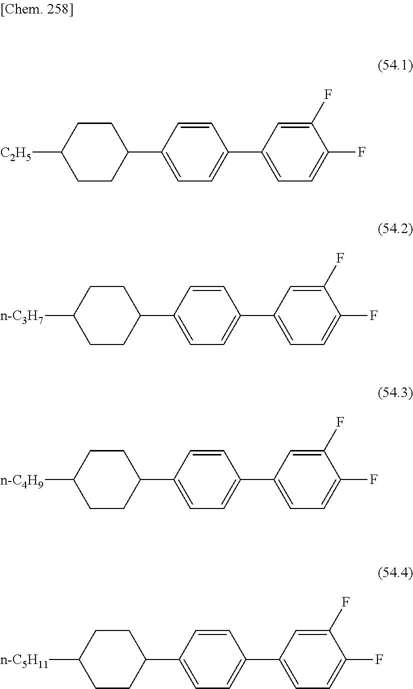

In the liquid crystal composition of the present invention, the content of the compound represented by Formula (54.2) is preferably 5% by mass to 35% by mass, preferably 5% by mass to 25% by mass, preferably 5% by mass to 22% by mass, preferably 6% by mass to 20% by mass, preferably 6% by mass to 15% by mass, and preferably 6% by mass to 9% by mass, with respect to the total mass of the liquid crystal composition of the present invention.

Alternatively/in addition, the compound represented by General Formula (XIV-2) is preferably the compound represented by General Formula (XIV-2-3).

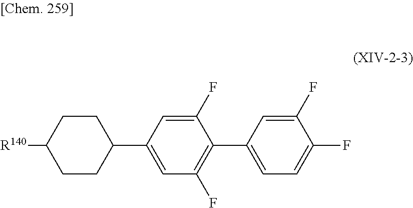

In General Formula (XIV-2-3), R¹⁴⁰ represents an alkyl group having 1 to 5 carbon atoms, an alkenyl group having 2 to 5 carbon atoms, or an alkoxy group having 1 to 4 carbon atoms.

The content of the compound represented by General Formula (XIV-2-3) is preferably 5% by mass to 30% by mass, preferably 9% by mass to 27% by mass, preferably 12% by mass to 24% by mass, and preferably 12% by mass to 20% by mass, with respect to the total mass of the liquid crystal composition of the present invention, in consideration of solubility at a low temperature, a transition temperature, and electrical reliability.

Furthermore, the compound represented by General Formula (XIV-2-3), specifically, is preferably at least one compound selected from the compound group represented by Formulas (55.1) to (55.4), and preferably contains the compound represented by Formulas (55.2) and/or (55.4) among Formulas (55.1) to (55.4).

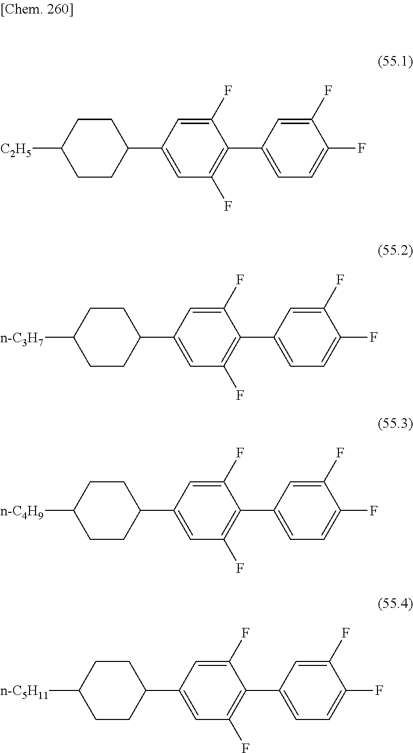

Alternatively/in addition, the compound represented by General Formula (XIV-2) is preferably the compound represented by General Formula (XIV-2-4).

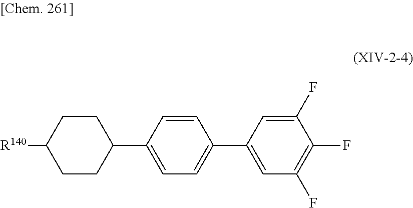

In General Formula (XIV-2-4), R¹⁴⁰ represents an alkyl group having 1 to 5 carbon atoms, an alkenyl group having 2 to 5 carbon atoms, or an alkoxy group having 1 to 4 carbon atoms.

The types of compound capable of being combined are not limited, and in consideration of solubility at a low temperature, a transition temperature, electrical reliability, and birefringence, a compound is suitably combined with respect to each embodiment. For example, in an embodiment of the present invention, one type is used. In another embodiment of the present invention, two types are used. In still another embodiment of the present invention, three or more types are used.

The content of the compound represented by General Formula (XIV-2-4) is suitably adjusted with respect to each embodiment in consideration of characteristics such as solubility at a low temperature, a transition temperature, electrical reliability, and birefringence.

For example, the content of the compound represented by General Formula (XIV-2-4) is 1% by mass to 20% by mass in an embodiment of the present invention, 1% by mass to 15% by mass in another embodiment, 1% by mass to 10% by mass in still another embodiment, 1% by mass to 9% by mass in still another embodiment, 1% by mass to 3% by mass in still another embodiment, and 6% by mass to 9% by mass in still another embodiment, with respect to the total mass of the liquid crystal composition of the present invention.

In a case where the liquid crystal composition of the present invention is used in a liquid crystal display element having a low driving voltage, it is suitable that the content of the compound represented by General Formula (XIV-2-4) is large. In a case where the liquid crystal composition of the present invention is used in a liquid crystal display element having a high response speed, it is suitable that the content of the compound represented by General Formula (XIV-2-4) is small.

Furthermore, the compound represented by General Formula (XIV-2-4), specifically, is preferably at least one compound selected from the compound group represented by Formulas (56.1) to (56.4), and preferably contains the compound represented by Formulas (56.1), (56.2), and/or (56.4) among Formulas (56.1) to (56.4).

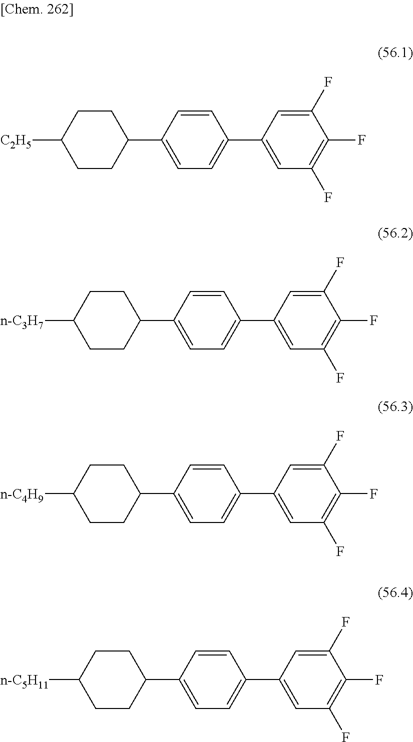

Alternatively/in addition, the compound represented by General Formula (XIV-2) is preferably the compound represented by General Formula (XIV-2-5).

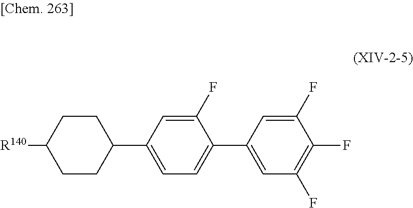

In General Formula (XIV-2-5), R¹⁴⁰ represents an alkyl group having 1 to 5 carbon atoms, an alkenyl group having 2 to 5 carbon atoms, or an alkoxy group having 1 to 4 carbon atoms.

The content of the compound represented by General Formula (XIV-2-5) is preferably 5% by mass to 25% by mass, preferably 10% by mass to 22% by mass, preferably 13% by mass to 18% by mass, and preferably 13% by mass to 15% by mass, with respect to the total mass of the liquid crystal composition of the present invention, in consideration of solubility at a low temperature, a transition temperature, and electrical reliability.

Furthermore, the compound represented by General Formula (XIV-2-5), specifically, is at least one compound selected from the compound group represented by Formulas (57.1) to (57.4), and preferably contains the compound represented by Formula (57.1) among Formulas (57.1) to (57.4).

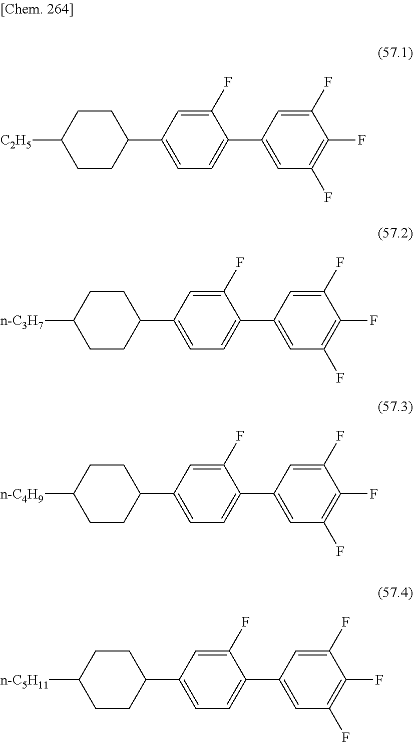

Alternatively/in addition, the compound represented by General Formula (XIV-2) is preferably the compound represented by General Formula (XIV-2-6).

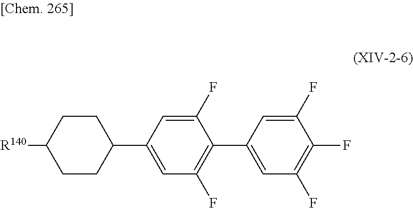

In General Formula (XIV-2-6), R¹⁴⁰ represents an alkyl group having 1 to 5 carbon atoms, an alkenyl group having 2 to 5 carbon atoms, or an alkoxy group having 1 to 4 carbon atoms.

The content of the compound represented by General Formula (XIV-2-6) is preferably 5% by mass to 25% by mass, preferably 10% by mass to 22% by mass, preferably 15% by mass to 20% by mass, and preferably 15% by mass to 17% by mass, with respect to the total mass of the liquid crystal composition of the present invention, in consideration of solubility at a low temperature, a transition temperature, and electrical reliability.

Furthermore, the compound represented by General Formula (XIV-2-6), specifically, is preferably at least one compound selected from the compound group represented by Formulas (58.1) to (58.4), and preferably contains the compound represented by Formula (58.2) among Formulas (58.1) to (58.4).

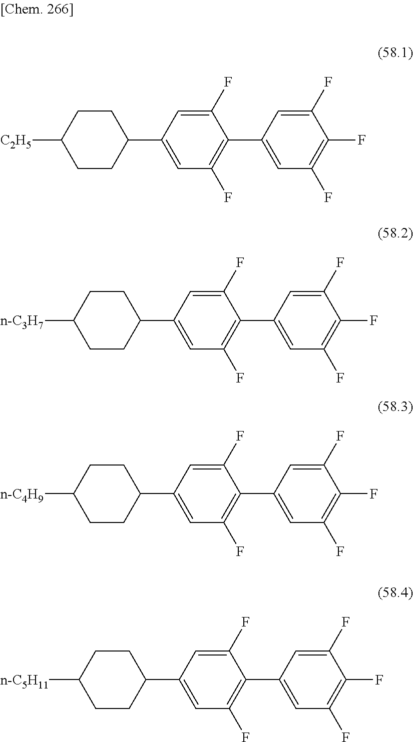

Alternatively/in addition, the compound represented by General Formula (XIV) is preferably the compound represented by General Formula (XIV-3).

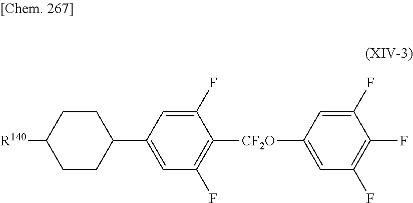

In General Formula (XIV-3), R¹⁴⁰ represents an alkyl group having 1 to 5 carbon atoms, an alkenyl group having 2 to 5 carbon atoms, or an alkoxy group having 1 to 4 carbon atoms.

The types of compound capable of being combined are not particularly limited, and a compound is suitably combined and used depending on the desired performance such as solubility at a low temperature, a transition temperature, electrical reliability, and birefringence. The type of compound used, for example, is one type in an embodiment of the present invention. Alternatively, in another embodiment of the present invention, two or more types are used.

The content of the compound represented by General Formula (XIV-3) is preferably 2.5% by mass to 25% by mass, preferably 3% by mass to 15% by mass, and preferably 3% by mass to 10% by mass, with respect to the total mass of the liquid crystal composition of the present invention, in consideration of solubility at a low temperature, a transition temperature, electrical reliability, and birefringence.

Furthermore, the compound represented by General Formula (XIV-3), specifically, is preferably at least one compound selected from the compound group represented by Formulas (61.1) to (61.4), and more preferably the compound represented by Formulas (61.1) and/or (61.2).

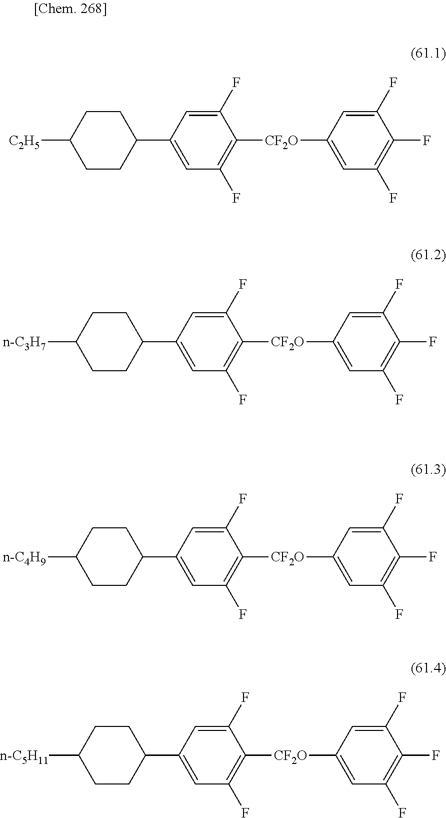

Alternatively/in addition, the compound represented by General Formula (M) is preferably the compound represented by General Formula (XV).

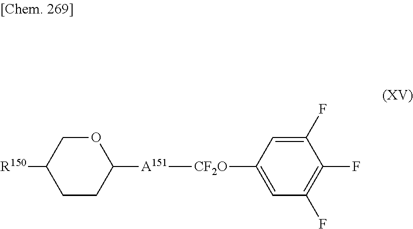

In General Formula (XV), R¹⁵⁰ represents an alkyl group having 1 to 5 carbon atoms, an alkenyl group having 2 to 5 carbon atoms, or an alkoxy group having 1 to 4 carbon atoms, and A′5′ represents a 1,4-cyclohexylene group, a 1,4-phenylene group, or any one of groups represented by the following formulas, and here, a hydrogen atom of the 1,4-phenylene group may be substituted with a fluorine atom.

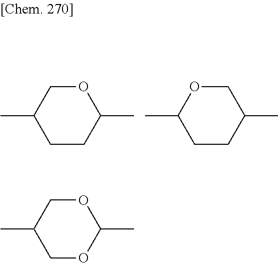

The types of compound capable of being combined are not particularly limited, and in consideration of solubility at a low temperature, a transition temperature, electrical reliability, and birefringence, a compound is suitably combined. For example, in an embodiment of the present invention, one type is used. In addition, in another embodiment of the present invention, two types are used. In still another embodiment, three types are used. In still another embodiment, four types are used. In addition, instill another embodiment, five or more types are used.

The content of the compound represented by General Formula (XV) is suitably adjusted with respect to each embodiment in consideration of characteristics such as solubility at a low temperature, a transition temperature, electrical reliability, and birefringence. For example, the content of the compound represented by General Formula (XV) is 0.5% to 30% by mass in an embodiment of the present invention, 1% to 30% by mass in another embodiment, 3% to 30% by mass in still another embodiment, 6% to 30% by mass in still another embodiment, 9% to 30% by mass in still another embodiment, 11% to 30% by mass in still another embodiment, and 12% to 30% by mass in still another embodiment, 18% to 30% by mass in still another embodiment, 19% to 30% by mass in still another embodiment, 23% to 30% by mass in still another embodiment, and 25% to 30% by mass instill another embodiment, with respect to the total mass of the liquid crystal composition of the present invention.

In addition, for example, the content of the compound represented by General Formula (XV) is 0.5% to 25% by mass in an embodiment of the present invention, 0.5% to 20% by mass in another embodiment, 0.5% to 13% by mass in still another embodiment, 0.5% to 9% by mass in still another embodiment, and 1% to 6% by mass in still another embodiment, with respect to the total mass of the liquid crystal composition of the present invention.

The compound represented by General Formula (XV) used in the liquid crystal composition of the present invention is preferably the compound represented by General Formula (XV-1).

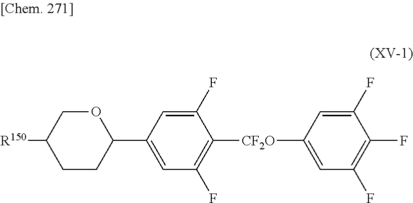

In General Formula (XV-1), R¹⁵⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XV-1) is suitably adjusted in consideration of characteristics such as solubility at a low temperature, a transition temperature, electrical reliability, and birefringence.

For example, the content of the compound represented by General Formula (XV-1) is 1% to 25% by mass in an embodiment of the present invention, 1% to 20% by mass in another embodiment, 1% to 10% by mass in still another embodiment, 3% to 10% by mass in still another embodiment, 4% to 7% by mass in still another embodiment, 1% to 5% by mass in still another embodiment, and 5% to 10% by mass in still another embodiment, with respect to the total mass of the liquid crystal composition of the present invention.

Furthermore, the compound represented by General Formula (XV-1) used in the liquid crystal composition of the present invention, specifically, is preferably at least one compound selected from the compound group represented by Formulas (59.1) to (59.4), and more preferably contains the compound represented by Formula (59.2) among Formulas (59.1) to (59.4).

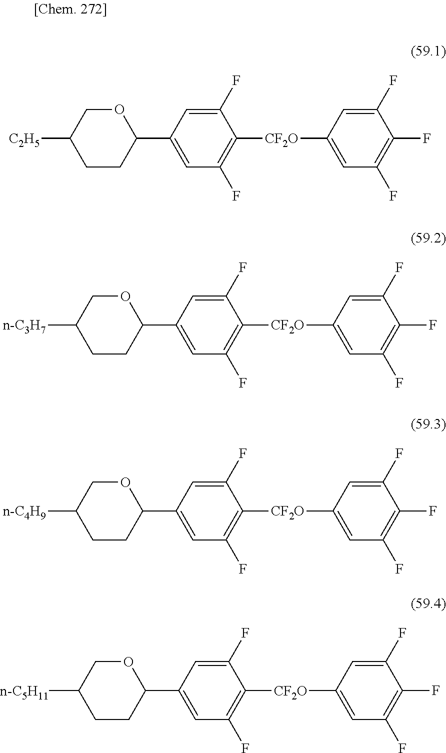

Alternatively/in addition, the compound represented by General Formula (XV) is preferably the compound represented by General Formula (XV-2).

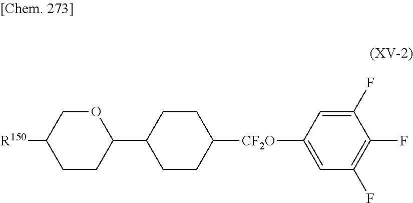

In General Formula (XV-2), R¹⁵⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XV-2) is suitably adjusted in consideration of characteristics such as solubility at a low temperature, a transition temperature, electrical reliability, and birefringence.

For example, the content of the compound represented by General Formula (XV-2) is preferably 0.5% by mass to 20% by mass, preferably 1% by mass to 15% by mass, preferably 1% by mass to 10% by mass, and preferably 1% by mass to 4% by mass, with respect to the total mass of the liquid crystal composition of the present invention, in consideration of solubility at a low temperature, a transition temperature, electrical reliability, and birefringence.

Furthermore, the compound represented by General Formula (XV-2) used in the liquid crystal composition of the present invention, specifically, is preferably at least one compound selected from the compound group represented by Formulas (60.1) to (60.4), and more preferably contains the compound represented by Formula (60.2) among Formulas (60.1) to (60.4).

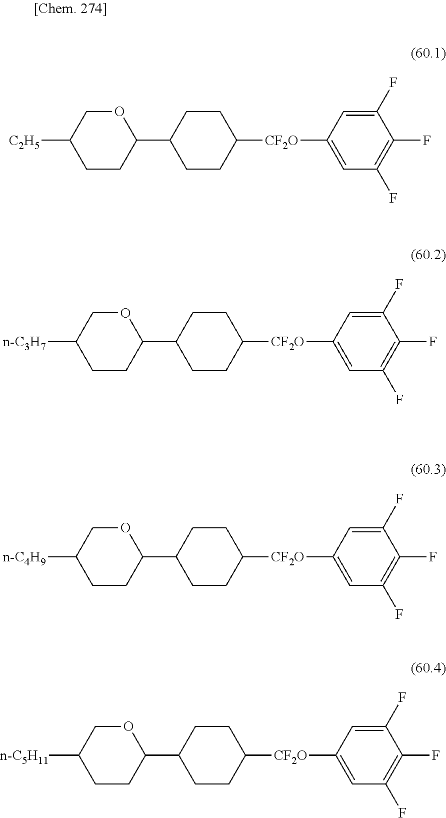

Alternatively/in addition, the compound represented by General Formula (XV) is preferably the compound represented by General Formula (XV-3).

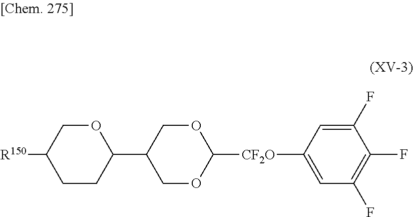

In General Formula (XV-3), R¹⁵⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XV-3) is suitably adjusted in consideration of characteristics such as solubility at a low temperature, a transition temperature, electrical reliability, and birefringence.

For example, the content of the compound represented by General Formula (XV-3) is preferably 0.5% by mass to 20% by mass, preferably 1% by mass to 15% by mass, preferably 1% by mass to 10% by mass, and preferably 1% by mass to 5% by mass, with respect to the total mass of the liquid crystal composition of the present invention, in consideration of solubility at a low temperature, a transition temperature, electrical reliability, and birefringence.

Furthermore, the compound represented by General Formula (XV-3) used in the liquid crystal composition of the present invention, specifically, is preferably at least one compound selected from the compound group represented by Formulas (64.1) to (64.4), and more preferably contains the compound represented by Formula (64.1) or (64.2) among Formulas (64.1) to (64.4).

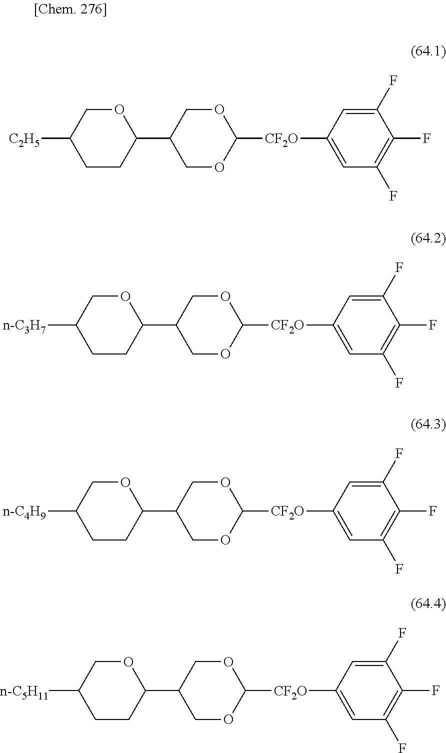

Alternatively/in addition, the compound represented by General Formula (M) is preferably the compound represented by General Formula (XV′).

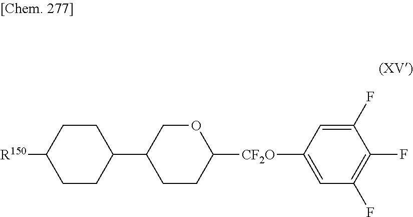

In General Formula (XV′), R¹⁵⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XV′) is suitably adjusted in consideration of characteristics such as solubility at a low temperature, a transition temperature, electrical reliability, and birefringence.

For example, the content of the compound represented by General Formula (XV′) is preferably 0.5% by mass to 20% by mass, preferably 1% by mass to 15% by mass, preferably 1% by mass to 10% by mass, and preferably 1% by mass to 4% by mass, with respect to the total mass of the liquid crystal composition of the present invention, in consideration of solubility at a low temperature, a transition temperature, electrical reliability, and birefringence.

Furthermore, the compound represented by General Formula (XV′) used in the liquid crystal composition of the present invention, specifically, is preferably at least one compound selected from the compound group represented by Formulas (65.1) to (65.4), and more preferably contains the compound represented by Formula (65.2) among Formulas (65.1) to (65.4).

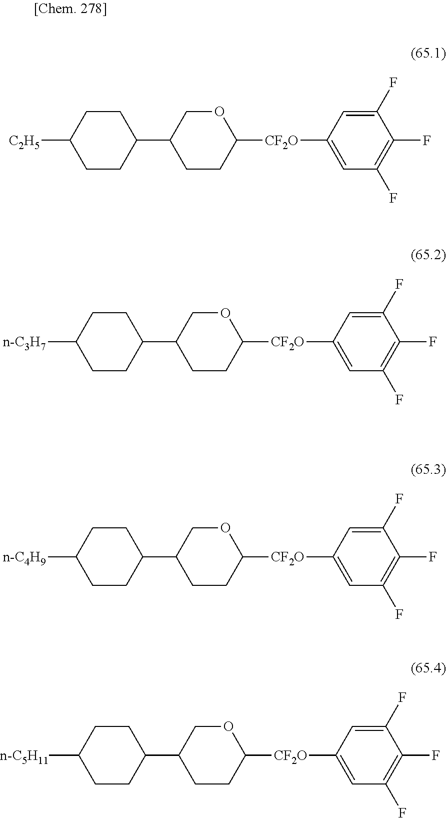

Alternatively/in addition, the compound represented by General Formula (M) is preferably the compound represented by General Formula (XVI).

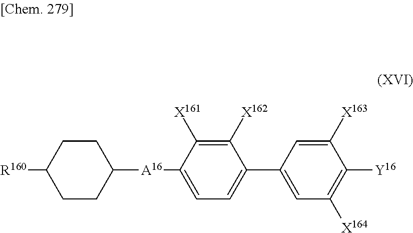

In General Formula (XVI), R¹⁶⁰ represents an alkyl group having 1 to 5 carbon atoms, an alkenyl group having 2 to 5 carbon atoms, or an alkoxy group having 1 to 4 carbon atoms, each of X¹⁶¹ to X¹⁶⁴ independently represents a fluorine atom or a hydrogen atom, Y¹⁶ represents a fluorine atom, a chlorine atom, or —OCF₃, represents a 1,4-phenylene group or a 1,4-cyclohexylene group, and a hydrogen atom of the 1,4-phenylene group may be substituted with a fluorine atom.

The compounds capable of being combined are not particularly limited, and in consideration of solubility at a low temperature, a transition temperature, electrical reliability, and birefringence, a compound is suitably combined. For example, in an embodiment of the present invention, one type is used. In another embodiment of the present invention, two types are used. In still another embodiment, three types are used. In still another embodiment, four types are used. In addition, in still another embodiment, five or more types are used.

The content of the compound represented by General Formula (XVI) is suitably adjusted with respect to each embodiment in consideration of characteristics such as solubility at a low temperature, a transition temperature, electrical reliability, and birefringence. For example, the content of the compound represented by General Formula (XVI) is 1% to 30% by mass in an embodiment of the present invention, 3% to 25% by mass in another embodiment, 6% to 23% by mass in still another embodiment, 9% to 23% by mass in still another embodiment, 12% to 23% by mass in still another embodiment, 15% to 23% by mass in still another embodiment, and 19% to 23% by mass in still another embodiment, with respect to the total mass of the liquid crystal composition of the present invention.

The compound represented by General Formula (XVI) used in the liquid crystal composition of the present invention is preferably the compound represented by General Formula (XVI-1).

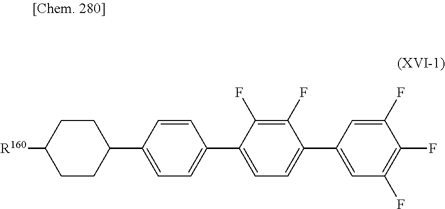

In General Formula (XVI-1), R¹⁶⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XVI-1) is suitably adjusted in consideration of characteristics such as solubility at a low temperature, a transition temperature, electrical reliability, and birefringence.

For example, the content of the compound represented by General Formula (XVI-1) is 1% to 20% by mass in an embodiment of the present invention, 1% to 10% by mass in another embodiment, 3% to 10% by mass in still another embodiment, and 3% to 9% by mass in still another embodiment, with respect to the total mass of the liquid crystal composition of the present invention.

Furthermore, the compound represented by General Formula (XVI-1) used in the liquid crystal composition of the present invention, specifically, is preferably at least one compound selected from the compound group represented by Formulas (62.1) to (62.4), and more preferably contains the compound represented by Formula (62.2) among Formulas (62.1) to (62.4).

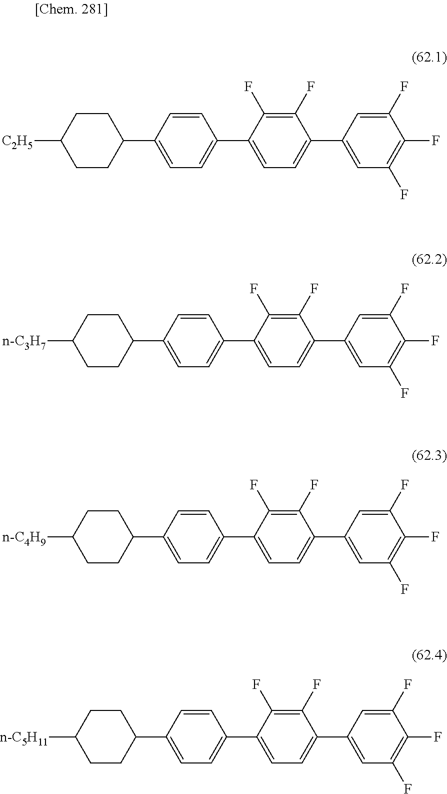

Alternatively/in addition, the compound represented by General Formula (XVI) is preferably the compound represented by General Formula (XVI-2).

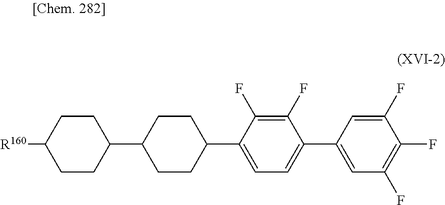

In General Formula (XVI-2), R¹⁶⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XV-2) is suitably adjusted in consideration of characteristics such as solubility at a low temperature, a transition temperature, electrical reliability, and birefringence.

For example, the content of the compound represented by General Formula (XV-2) is preferably 0.5% by mass to 20% by mass, preferably 1% by mass to 15% by mass, preferably 1% by mass to 10% by mass, and preferably 1% by mass to 4% by mass, with respect to the total mass of the liquid crystal composition of the present invention, in consideration of solubility at a low temperature, a transition temperature, electrical reliability, and birefringence.

Furthermore, the compound represented by General Formula (XVI-2) used in the liquid crystal composition of the present invention, specifically, is preferably at least one compound selected from the compound group represented by Formulas (63.1) to (63.4), and more preferably contains the compound represented by Formula (63.2) among Formulas (63.1) to (63.4).

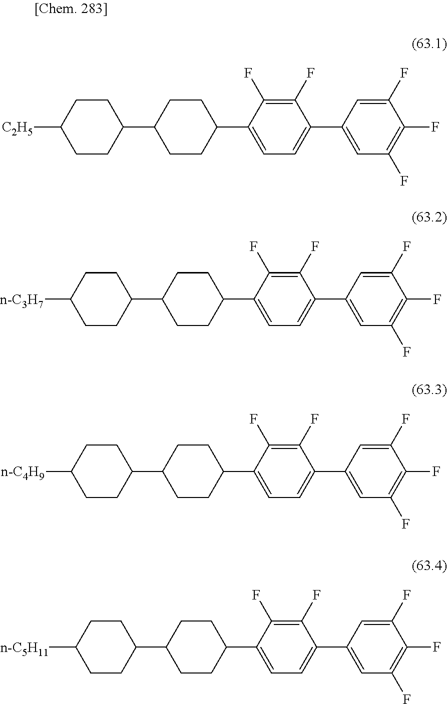

Alternatively/in addition, the compound represented by General Formula (X) is preferably the compound represented by General Formula (XVII).

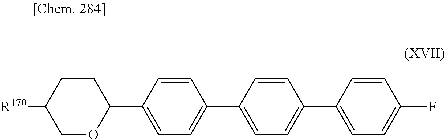

In General Formula (XVII), R¹⁷⁰ represents an alkyl group having 1 to 5 carbon atoms, an alkenyl group having 2 to 5 carbon atoms, or an alkoxy group having 1 to 4 carbon atoms.

The compounds capable of being combined are not particularly limited, and in consideration of solubility at a low temperature, a transition temperature, electrical reliability, and birefringence, one type or two or more types are preferably combined.

The content of the compound represented by General Formula (XVII) is suitably adjusted in consideration of characteristics such as solubility at a low temperature, a transition temperature, electrical reliability, and birefringence.

For example, the content of the compound represented by General Formula (XVII) is preferably 1% by mass to 20% by mass, preferably 1% by mass to 15% by mass, preferably 1% by mass to 10% by mass, and preferably 1% by mass to 5% by mass, with respect to the total mass of the liquid crystal composition of the present invention, in consideration of solubility at a low temperature, a transition temperature, electrical reliability, and birefringence.

Furthermore, the compound represented by General Formula (XVII) used in the liquid crystal composition of the present invention, specifically, is preferably at least one compound selected from the compound group represented by Formulas (66.1) to (66.4), and more preferably contains the compound represented by Formula (66.2) among Formulas (66.1) to (66.4).

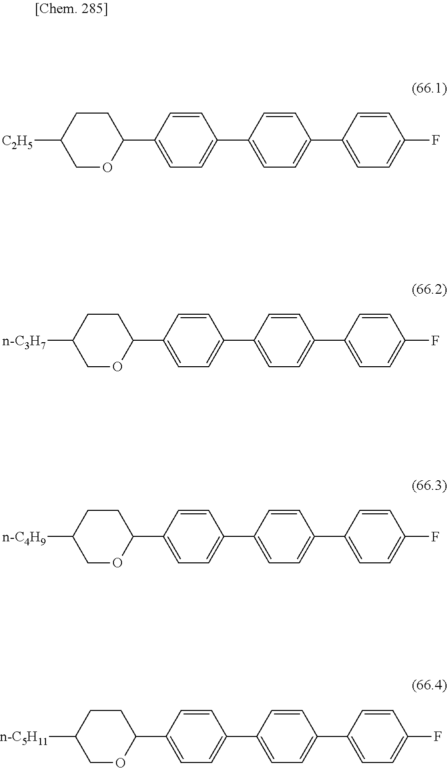

The liquid crystal composition of the present invention preferably does not contain a compound having a structure in which oxygen atoms are bonded to each other such as a peroxide structure (—CO—CO—) in a molecule.

In a case where the reliability and the long-term storage stability of the liquid crystal composition matter, the content of a compound having a carbonyl group is preferably 5% by mass or less, more preferably 3% by mass or less, and still more preferably 1% by mass or less, with respect to the total mass of the composition, and the compound having a carbonyl group is most preferably substantially not contained.

In a case where the stability with respect to UV irradiation matters, the content of a compound substituted with a chlorine atom is preferably 15% by mass or less, more preferably 10% by mass or less, and still more preferably 5% by mass or less, with respect to the total mass of the composition, and the compound substituted with a chlorine atom is most preferably substantially not contained.

The content of a compound in which all the ring structures in the molecule are 6-membered rings is preferably increased, and the content of the compound in which all the ring structures in the molecule are 6-membered rings is preferably 80% by mass or greater, more preferably 90% by mass or greater, and still more preferably 95% by mass or greater, with respect to the total mass of the composition, and it is most preferable that the liquid crystal composition is substantially constituted with only the compound in which all the ring structures in the molecule are 6-membered rings.

In order to suppress the deterioration due to oxidation of the liquid crystal composition, the content of a compound having a cyclohexenylene group as a ring structure is preferably decreased, and the content of the compound having a cyclohexenylene group is preferably 10% by mass or less and more preferably 5% by mass or less, with respect to the total mass of the composition, and the compound having a cyclohexenylene group is still more preferably substantially not contained.

In a case where the improvement of viscosity and Tni matters, the content of a compound having a 2-methylbenzene-1,4-diyl group in which a hydrogen atom may be substituted with halogen in the molecule is preferably decreased, and the content of the compound having a 2-methylbenzene-1,4-diyl group in the molecule is preferably 10% by mass or less and more preferably 5% by mass or less, with respect to the total mass of the composition, and the compound having a 2-methylbenzene-1,4-diyl group is still more preferably substantially not contained.

In a case where the compound contained in the composition of a first embodiment of the present invention has an alkenyl group as a side chain, when the alkenyl group is bonded to cyclohexane, the number of carbon atoms in the alkenyl group is preferably 2 to 5, when the alkenyl group is bonded to benzene, the number of carbon atoms in the alkenyl group is preferably 4 or 5, and it is preferable that the unsaturated bond of the alkenyl group and benzene are not directly bonded.

In the liquid crystal composition of the present invention, in order to manufacture a liquid crystal display element of a PS mode, a horizontal electric field type PSA mode, or a horizontal electric field type PSVA mode, a polymerizable compound can be contained. As the polymerizable compound capable of being used, a photopolymerizable monomer of which polymerization proceeds by energy rays such as light is exemplified, and as the structure, a polymerizable compound having a liquid crystal skeleton in which a plurality of 6-membered rings is connected such as biphenyl derivatives or terphenyl derivatives is exemplified. In addition, specifically, the bifunctional monomer represented by General Formula (XX) is preferable.

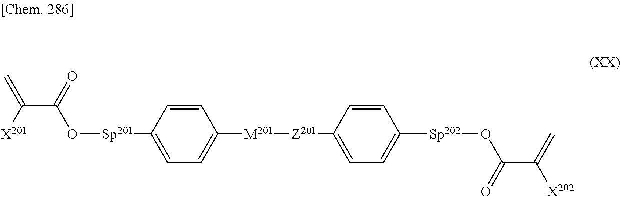

In General Formula (XX), each of X²⁰¹ and X²⁰² independently represents a hydrogen atom or a methyl group, each of Sp²⁰¹ and Sp²⁰² independently represents a single bond, an alkylene group having 1 to 8 carbon atoms or —O—(CH₂)ₛ— (in the formula, s represents an integer of 2 to 7, and an oxygen atom is bonded to an aromatic ring),

Z²⁰¹ represents —OCH₂—, —CH₂O—, —COO—, —OCO—, —CF₂O—, —OCF₂—, —CH₂CH₂—, —CF₂CF₂, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, each of Y¹ and Y² independently represents a fluorine atom or a hydrogen atom), or a single bond,

M²⁰¹ represents a 1,4-phenylene group, a trans-1,4-cyclohexylene group, or a single bond, and any hydrogen atom in all the 1,4-phenylene groups in the formula may be substituted with a fluorine atom.

Both diacrylate derivatives in which both X²⁰¹ and X²⁰² represent hydrogen atoms or dimethacrylate derivatives in which both X²⁰¹ and X²⁰² have methyl groups are preferable, and compounds in which one of X²⁰¹ and X²⁰² represents a hydrogen atom and the other represents a methyl group are also preferable. In the polymerization rate of these compounds, diacrylate derivatives are the fastest, dimethacrylate derivatives are slow, and asymmetric compounds are therebetween. It is possible to use a preferable embodiment according to the application thereof. In a PSA display element, dimethacrylate derivatives are particularly preferable.

Each of Sp²⁰¹ and Sp²⁰² independently represents a single bond, an alkylene group having 1 to 8 carbon atoms, or —O—(CH₂)ₛ—, and in a PSA display element, at least one of Sp²⁰¹ and Sp²⁰² is preferably a single bond, and compounds in which both Sp²⁰¹ and Sp²⁰² represent single bonds, or an embodiment in which one of Sp²⁰¹ and Sp²⁰² represents a single bond and the other represents an alkylene group having 1 to 8 carbon atoms or —O—(CH₂)ₛ— are preferable. In this case, an alkyl group having 1 to 4 carbon atoms is preferable, and s is preferably 1 to 4.

Z²⁰¹ is preferably —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, and particularly preferably a single bond.

M²⁰¹ represents a 1,4-phenylene group in which any hydrogen atom may be substituted with a fluorine atom, a trans-1,4-cyclohexylene group, or a single bond, and a 1,4-phenylene group or a single bond is preferable. In a case where M²⁰¹ represents a ring structure other than a single bond, Z²⁰¹ is preferably a linking group other than a single bond, and in a case where M²⁰¹ is a single bond, Z²⁰¹ is preferably a single bond.

From these points of view, in General Formula (XX), as the ring structures between Sp²⁰¹ and Sp²⁰², specifically, the structures described below are preferable.

In a case where M²⁰¹ represents a single bond, and the ring structure is formed of two rings in General Formula (XX), the ring structure preferably represents the following Formulas (XXa-1) to (XXa-5), more preferably represents Formulas (XXa-1) to (XXa-3), and particularly preferably represents Formula (XXa-1).

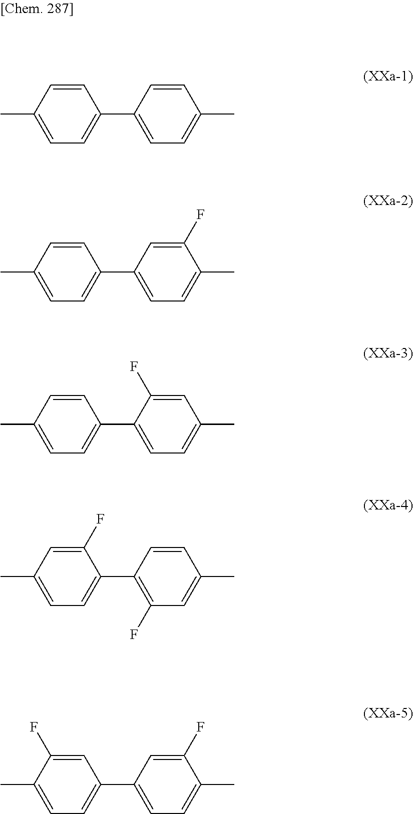

In Formulas (XXa-1) to (XXa-5), both ends are bonded to sp²⁰¹ or Sp²⁰²

Since, in polymerizable compounds including these skeletons, a force for restricting the alignment after polymerization is optimal to a PSA type liquid crystal display element and a good alignment state is obtained, display unevenness is suppressed, or not generated at all.

From the above, the polymerizable monomer is preferably at least one compound selected from the compound group represented by General Formulas (XX-1) to (XX-4), and more preferably the compound represented by General Formula (XX-2) among General Formulas (XX-1) to (XX-4).

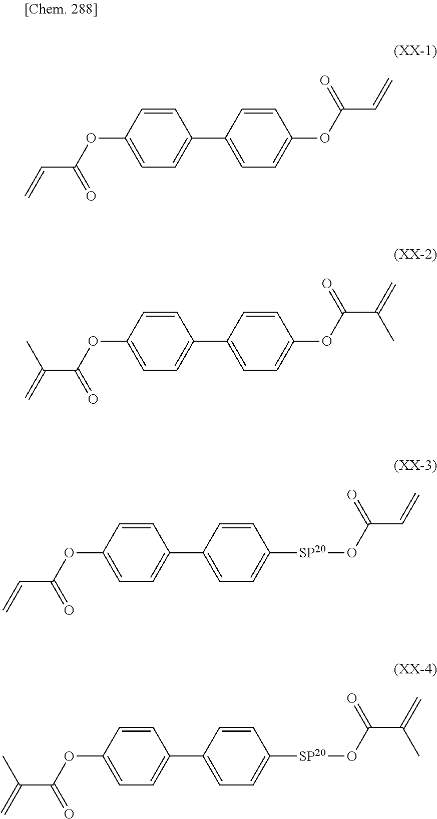

In General Formulas (XX-3) and (XX-4), Sp²⁰ represents an alkylene group having 2 to 5 carbon atoms.

In the case of adding a monomer to the liquid crystal composition of the present invention, polymerization proceeds even when the polymerization initiator is not present; however, the polymerization initiator may be contained in order to promote the polymerization. Examples of the polymerization initiator include benzoin ethers, benzophenones, acetophenones, benzyl ketals, and acyl phosphine oxides.

The liquid crystal composition of the present invention can further contain the compound represented by General Formula (Q).

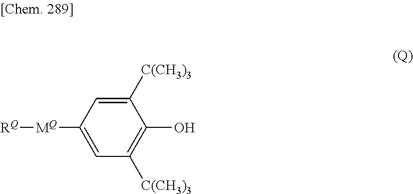

In General Formula (Q), R^{Q} represents a linear alkyl group or a branched alkyl group having 1 to 22 carbon atoms, one or two or more CH₂ groups in the alkyl group may be substituted with —O—, —CH═CH—, —CO—, —OCO—, —COO—, —C≡C—, —CF₂O—, or —OCF₂—, such that an oxygen atom does not become directly adjacent, and M^{Q} represents a trans-1,4-cyclohexylene group, a 1,4-phenylene group, or a single bond.

R^{Q} represents a linear alkyl group or a branched alkyl group having 1 to 22 carbon atoms, one or two or more CH₂ groups in the alkyl group may be substituted with —O—, —CH═CH—, —CO—, —OCO—, —COO—, —C≡C—, —CF₂O—, or —OCF₂—, such that an oxygen atom does not become directly adjacent, and a linear alkyl group having 1 to 20 carbon atoms, a linear alkoxy group, a linear alkyl group in which one CH₂ group has been substituted with —OCO— or —COO—, a branched alkyl group, a branched alkoxy group, or a branched alkyl group in which one CH₂ group has been substituted with —OCO— or —COO— is preferable, and a linear alkyl group having 1 to 10 carbon atoms, a linear alkyl group in which one CH₂ group has been substituted with —OCO— or —COO—, a branched alkyl group, a branched alkoxy group, or a branched alkyl group in which one CH₂ group has been substituted with —OCO— or —COO— is more preferable.

M^{Q} represents a trans-1,4-cyclohexylene group, a 1,4-phenylene group, or a single bond, and a trans-1,4-cyclohexylene group or a 1,4-phenylene group is preferable.

The compound represented by General Formula (Q) is preferably at least one compound selected from the compound group represented by the following General Formulas (Q-a) to (Q-d), and more preferably the compound represented by General Formulas (Q-c) and/or (Q-d).

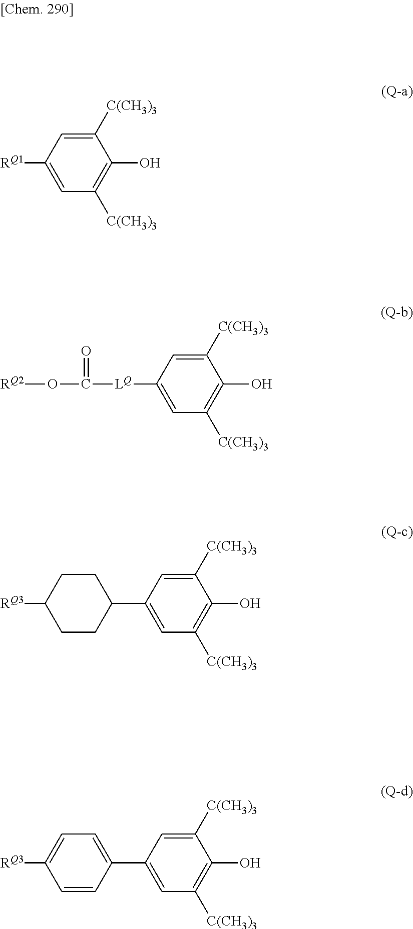

In the above formulas, R^{Q1} is preferably a linear alkyl group or a branched alkyl group having 1 to 10 carbon atoms, R^{Q2} is preferably a linear alkyl group or a branched alkyl group having 1 to 20 carbon atoms, R^{Q3} is preferably a linear alkyl group, a branched alkyl group, a linear alkoxy group, or a branched alkoxy group, having 1 to 8 carbon atoms, and L^{Q} is preferably a linear alkylene group or a branched alkylene group, having 1 to 8 carbon atoms.

In the liquid crystal composition of the present invention, one type or two types of compounds represented by General Formula (Q) are preferably contained, one to five types thereof are more preferably contained, and the content thereof is preferably 0.001% by mass to 1% by mass, preferably 0.001% by mass to 0.1% by mass, and preferably 0.001% by mass to 0.05% by mass, with respect to the total mass of the liquid crystal composition of the present invention.

<Liquid Crystal Display Element>

The polymerizable compound-containing liquid crystal composition of the present invention has a liquid crystal alignment capability by polymerizing a polymerizable compound included therein using ultraviolet ray irradiation, and is used in the liquid crystal display element which controls the light transmission amount using birefringence of the liquid crystal composition. The composition is useful for the liquid crystal display element such as an ECB-LCD, a VA-LCD, a FFS-LCD, or an AM-LCD (active matrix liquid crystal display element), a TN (nematic liquid crystal display element), an STN-LCD (super twisted nematic liquid crystal display element), an OCB-LCD, and an IPS-LCD (in-plane switching liquid crystal display element), is particularly useful for the AM-LCD, and can be used for a transmissive or reflective liquid crystal display element.

As two substrates of the liquid crystal cell used in the liquid crystal display element, glass or a transparent material having flexibility such as plastic can be used, and one substrate may be an opaque material such as silicon. For example, a transparent substrate having a transparent electrode layer can be obtained by sputtering indium tin oxide (ITO) onto a transparent substrate such as a glass plate.

For example, a color filter can be produced by a pigment dispersion method, a printing method, an electrodeposition method, or a staining method. A method for producing the color filter by the pigment dispersion method is described as an example; a curable coloring composition for a color filter is coated onto the transparent substrate, a patterning process is performed, and heating or light irradiation is performed for curing. By performing the step on each of red, green, and blue, it is possible to produce a pixel portion for the color filter. In addition, a pixel electrode in which an active element such as a TFT or a thin-film diode is provided may be installed on the substrate.

The above-described substrate is disposed such that the transparent electrode layer becomes the inner side. At that time, the space between substrates may be adjusted through a spacer. At this time, the thickness of the obtained light adjusting layer is preferably adjusted to be in a range of 1 μm to 100 μm. The thickness is more preferably in the range of 1.5 μm to 10 μm, and in a case where a polarizing plate is used, the product of the refractive index anisotropy Δn of the liquid crystal and the cell thickness d is preferably adjusted such that the contrast is maximum. Moreover, in a case where there are two polarizing plates, a polarization axis of each polarizing plate can be adjusted such that a viewing angle and a contrast are good. In addition, a phase difference film for widening the viewing angle can also be used. For example, as the spacer, a post spacer consisting of glass particles, plastic particles, alumina particles, photoresist material, and the like is exemplified. Thereafter, a sealing agent such as an epoxy-based thermosetting composition is screen-printed onto the substrate in the form provided with the liquid crystal injection port, and the substrates are bonded to each other and are heated, whereby the sealing agent is thermally cured.

As a method of sandwiching the polymerizable compound-containing liquid crystal composition between two substrates, a general vacuum injection method or an ODE method can be used. In the vacuum injection method, dropping marks are less likely to be generated, but there is a problem in that injection marks may remain. In the present invention, the liquid crystal composition can be more suitably used for the display element which is manufactured using the ODE method. In the liquid crystal display element manufacturing step by the ODE method, a sealing agent of an epoxy-based photo-heat combination curable type is drawn in a closed loop bank shape on any one of substrates, a back plane or a front plane, using a dispenser, and after dropping a predetermined amount of the liquid crystal composition in a degassed state therein, the front plane and the back plane are joined, whereby a liquid crystal display element can be manufactured. Since dropping of the liquid crystal composition in the ODE step can be stably performed, the liquid crystal composition of the present invention can be suitably used.

As a method for polymerizing polymerizable compounds, since a moderate polymerization rate is desirable in order to obtain a good alignment capability of liquid crystal, a method in which polymerization is performed by radiating active energy rays such as an ultraviolet rays or electron beams singly or sequentially or in combination thereof is preferable. In a case where ultraviolet rays are used, a polarized light source may be used, and a non-polarized light source may be used. In addition, in a case where polymerization is performed in a state where the polymerizable compound-containing liquid crystal composition is sandwiched between two substrates, at least the substrate of the irradiation surface side necessarily has appropriate transparency with respect to active energy rays. In addition, a method in which after polymerizing only a specific portion using a mask during light irradiation, the alignment state of the unpolymerized portion is changed by changing conditions such as an electric field, a magnetic field or temperature, and further active energy rays are applied to perform polymerization may be used. In particular, when ultraviolet ray exposure is performed, ultraviolet ray exposure is preferably performed while applying an AC electric field to the polymerizable compound-containing liquid crystal composition. The AC electric field to be applied is preferably an alternating current having a frequency in a range of 10 Hz to 10 kHz, more preferably in a range of 60 Hz to 10 kHz, and voltage is selected according to a desired pretilt angle of the liquid crystal display element. In other words, the pretilt angle of the liquid crystal display element can be controlled by an applied voltage. In the liquid crystal display element of a horizontal electric field type MVA mode, the pretilt angle is preferably controlled to be in a range of 80° to 89.9° from the viewpoint of alignment stability and contrast.

The temperature at the time of the irradiation is preferably in the temperature range in which liquid crystal state of the liquid crystal composition of the present invention is maintained. The polymerization is preferably performed at a temperature around room temperature, that is, typically, at a temperature in a range of 15° C. to 35° C. As the lamp for generating ultraviolet rays, a metal halide lamp, a high pressure mercury lamp, an ultrahigh pressure mercury lamp can be used. In addition, as the wavelength of ultraviolet rays to be applied, ultraviolet rays in a wavelength range which is not an absorption wavelength range of the liquid crystal composition are preferably applied, and if necessary, ultraviolet rays are preferably cut before use. The intensity of ultraviolet rays applied is preferably in a range of 0.1 mW/cm² to 100 W/cm², and more preferably in a range of 2 mW/cm² to 50 W/cm². The amount of energy of ultraviolet rays applied can be suitably adjusted, and is preferably in a range of 10 mJ/cm² to 500 J/cm², and more preferably in the range of 100 mJ/cm² to 200 J/cm². When ultraviolet ray is applied, the intensity may be changed. The application time of ultraviolet rays is suitably selected according to the intensity of ultraviolet rays applied, and is preferably in a range of 10 seconds to 3,600 seconds, and more preferably in a range of 10 seconds to 600 seconds.

The liquid crystal display element using the liquid crystal composition of the present invention is useful one which satisfies both high speed response and suppression of display defects, and in particular, is useful for the liquid crystal display element for driving active matrix, and can be applied to a liquid crystal display element for a VA mode, a PSVA mode, a PSA mode, an IPS (in-plane switching) mode, an FSS (fringe field switching) mode, or an ECB mode.

Hereinafter, the preferred embodiments of the liquid crystal display according to the present invention will be described in detail with reference to the drawings.

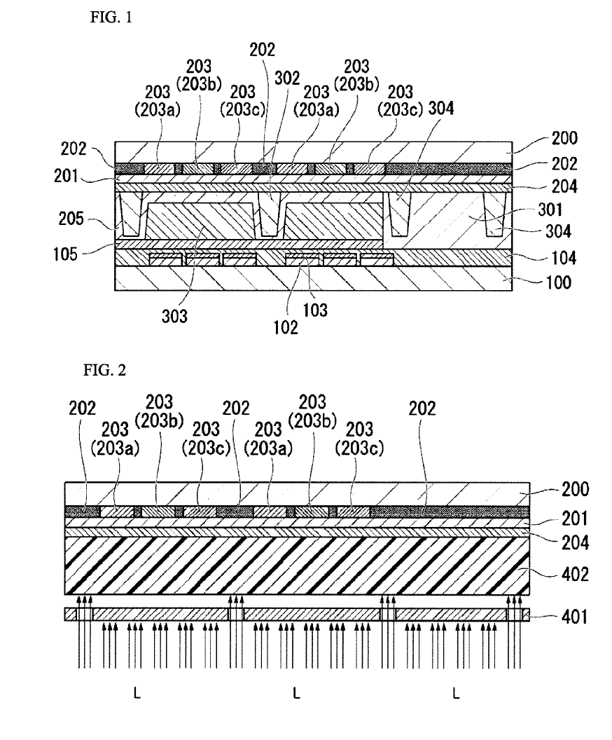

FIG. 1 is a sectional view showing a liquid crystal display element having two substrates facing each other, a seal material provided between the substrates, and a liquid crystal sealed in the sealing region surrounded by the seal material.

In particular, a specific embodiment of the liquid crystal display element having a back plane in which a TFT layer 102 and a pixel electrode 103 are provided on a first substrate 100, and a passivation film 104 and a first alignment film 105 are provided thereon, a front plane in which a black matrix 202, a color filter 203, a planarization film (overcoat layer) 201, and a transparent electrode 204 are provided on a second substrate 200, and a second alignment film 205 is provided thereon, and which is disposed to face the back plane, a seal material 301 provided between the substrates, and a liquid crystal layer 303 sealed in a sealing region surrounded by the seal material, and provided with projections (post spacers) 302 and 304 on the substrate surface with which the seal material 301 comes into contact is shown.

The material of the first substrate or the second substrate is not particularly limited as long as the material is substantially transparent, and glass, ceramics, plastics, and the like can be used. As the plastic substrate, cellulose, cellulose derivatives such as triacetyl cellulose, and diacetyl cellulose, polycycloolefin derivatives, polyesters such as polyethylene terephthalate and polyethylene naphthalate, polyolefins such as polypropylene and polyethylene, polycarbonate, polyvinyl alcohol, polyvinyl chloride, polyvinylidene chloride, polyamide, polyimide, polyimideamide, polystyrene, polyacrylate, polymethyl methacrylate, polyether sulfone, polyarylate, and inorganic-organic composite materials such as a glass fiber-epoxy resin, and a glass fiber-acrylic resin can be used.

Moreover, when a plastic substrate is used, a barrier film is preferably provided. The function of the barrier film is to reduce moisture permeability of the plastic substrate, and to improve the reliability of the electrical characteristics of the liquid crystal display element. As the barrier film, which is not particularly limited as long as the transparency is high and the water vapor permeability is low, respectively, a thin film formed by a vapor deposition or sputtering, chemical vapor deposition method (CVD method) using an inorganic material such as silicon oxide is generally used.

In the present invention, the material of the first substrate or the second substrate may be the same, or different, and it is not particularly limited. If a glass substrate is used, a liquid crystal display element having excellent heat resistance and dimensional stability can be produced, and therefore the glass substrate is preferably used. If a plastic substrate is used, the plastic substrate is suitable for manufacturing by a roll-to-roll method, and reducing weight or obtaining flexibility, and therefore the plastic substrate is preferably used. When the purpose is to impart flatness and heat resistance, it is possible to obtain excellent results by combining the plastic substrate and the glass substrate.

Moreover, in the examples described below, a substrate is used as the material of the first substrate 100 or the second substrate 200.

In the back plane, the TFT layer 102 and the pixel electrode 103 are provided on the first substrate 100. These are manufactured by a general array process. The back plane is obtained by providing the passivation film 104 and the first alignment film 105 thereon.

The passivation film 104 (also referred to as inorganic protective film) is a film to protect the TFT layer, and in general, nitride film (SiNx), oxide film (SiOx), or the like is formed by the chemical vapor deposition (CVD) technique or the like.

In addition, the first alignment film 105 is a film having a function of aligning the liquid crystal, and generally, a polymeric material such as polyimide is used in many cases. As a coating solution, an alignment agent solution consisting of a polymeric material and a solvent is used. Since the alignment film has the possibility of inhibiting the adhesive force with a seal material, the alignment film is pattern-coated in the sealing region. In coating, a printing method such as a flexographic printing method or a liquid droplet discharge method such as an ink-jet is used. After the solvent of the coated alignment agent solution is evaporated by temporary drying, the coated alignment agent solution is cross-linked and cured by baking. Thereafter, the alignment processing is performed in order to elicit the aligning function.

The alignment processing is performed by a general rubbing method. By rubbing the polymer film formed as described above in one direction using a rubbing cloth made of fibers such as rayon, a liquid crystal alignment capability is generated.

In addition, a photo-alignment method can also be used. The photo-alignment method is a method of generating the alignment capability by applying polarized light on the alignment film including an organic material having photosensitivity, and generation of scratches and dust on the substrate by the rubbing method does not occur. As the organic material in the photo-alignment method, a material containing a dichroic dye is exemplified. As the dichroic dye, a dye having a group generating a photoreaction which is the origin of the liquid crystal alignment capability (hereinafter, referred to as photo-alignment group), such as a reaction for alignment induction of molecules or an isomerization reaction by Weigert's effect due to photodichroism (example: azobenzene group), a dimerization reaction (example: cinnamoyl group), a photo-crosslinking reaction (example: benzophenone group), or a photodegradation reaction (example: polyimide group) can be used. After the solvent of the coated alignment agent solution is evaporated by temporary drying, it is possible to obtain an alignment film having an alignment capability in an arbitrary direction by applying light (polarized light) having an arbitrary polarization.

The front plane is provided with the black matrix 202, the color filter 203, the planarization film 201, the transparent electrode 204, and the second alignment film 205 on the second substrate 200.

For example, the black matrix 202 is produced by the pigment dispersion method. In particular, a color resin liquid in which a black colorant for forming a black matrix is homogeneously dispersed is coated on the second substrate 200 provided with a barrier film 201 to form a colored layer. Subsequently, the coloration layer is baked to cure. A photoresist is coated on this, and the resultant product is pre-baked. After the photoresist is exposed through a mask pattern, development is performed to pattern the coloration layer. After this, the photoresist layer is peeled off, and the coloration layer is baked to complete the black matrix 202.

Alternatively, a photoresist type pigment dispersion may be used. In this case, the photoresist type pigment dispersion is coated, the resultant product is pre-baked and exposed through a mask pattern, and development is performed to pattern the coloration layer. After this, the photoresist layer is peeled off, and the coloration layer is baked to complete the black matrix 202.

The color filter 203 is produced by the pigment dispersion method, the electrodeposition method, the printing method, the staining method or the like. The pigment dispersion method is described as an example; a color resin liquid in which a pigment (for example, red) is homogeneously dispersed is coated on the second substrate 200, the resultant product is baked to cure, the photoresist is coated on this, and the resultant product is pre-baked. After the photoresist is exposed through a mask pattern, development is performed, and thus patterning is performed. After this, the photoresist layer is peeled off, and baking is performed again to complete the (red) color filter 203. There is no particular limitation to the order of colors which are produced. In the same manner, a green color filter 203 and a blue color filter 203 are formed.

The transparent electrode 204 is provided on the color filter 203 (the overcoat layer (201) is provided on the color filter 203 for surface planarization, if necessary). The transparent electrode 204 preferably has high transmittance, and low electric resistance. The transparent electrode 204 is manufactured by forming an oxide film such as ITO by a sputtering method or the like.

In addition, in order to protect the transparent electrode 204, a passivation film may also be provided on the transparent electrode 204.

The second alignment film 205 is the same as the first alignment film 105 described above.

A specific aspect of the back plane and the front plane used in the present invention has been described above, however, in the present application, the back plane and the front plane are not limited to the specific aspect, and modifications thereof may be made according to the desired liquid crystal display element without restriction.

A shape of the post spacer is not particularly limited, and the horizontal cross-section thereof can be various shapes such as a circular shape and a polygonal shape including a quadrangular shape and the like. In consideration of a misalignment margin during a process, the horizontal cross-section is particularly preferably a circular shape or a regular polygonal shape. In addition, the shape of the projection is preferably a truncated cone shape or a truncated pyramid shape.

The material of the post spacer is not particularly limited as long as it is a material which is not dissolved in a seal material, an organic solvent used in the seal material, or the liquid crystal, and in terms of processing and weight reduction, a synthetic resin (curable resin) is preferable. On the other hand, by a method by photolithography or a droplet discharge method, the projection can be provided on a surface with which the seal material on a first substrate comes into contact. For this reason, a photocurable resin which is suitable for the method by photolithography or the droplet discharge method is preferably used.

As an example, a case where the post spacer is obtained by the photolithography method will be described. FIG. 2 is a diagram of an exposure processing step using a pattern for producing a post spacer to be formed on a black matrix as a photomask pattern.

A resin solution (not including colorant) for forming the post spacer is coated on the transparent electrode 204 of the front plane. Subsequently, the resin layer 402 is baked to cure. A photoresist is coated on this, and the resultant product is pre-baked. After the photoresist is exposed through a mask pattern 401, development is performed to pattern the resin layer. After this, the photoresist layer is peeled off, and the resin layer is baked to complete the post spacer (302 and 304 in FIG. 1).

The formation position of the post spacer can be determined at a desired position by the mask pattern. Therefore, it is possible to simultaneously make both the inside of the sealing region and the outside of the sealing region (seal material coated portion) of the liquid crystal display element. In addition, the post spacer is preferably formed so as to be positioned on the black matrix to prevent quality degradation of the sealing region. The post spacer produced by the photolithography method as described above may be referred to as a column spacer or a photospacer.

As the material of the spacer, a negative type water soluble resin such as a PVA-Stilbazo photosensitive resin, and a mixture of a polyfunctional acryl-based monomer, acrylic acid copolymer, a triazole-based initiator, and the like are used. Alternatively, a color resin in which a colorant is dispersed in a polyimide resin may also be used. In the present invention, it is possible to obtain a spacer formed of a known material according to compatibility with the liquid crystal to be used and the seal material, without any particular limitation.

In this manner, after providing the post spacer on a surface which is the sealing region on the front plane, the seal material (301 in FIG. 1) is coated on the surface with which the seal material of the back plane comes into contact.

The material of the seal material is not particularly limited, and a curable resin composition in which a polymerization initiator is added to an epoxy-based or acryl-based photocurable, a thermosetting, or a photo-heat combination curable resin is used. In addition, fillers formed of an inorganic substance or an organic substance may be added in order to control moisture permeability, elastic modulus, viscosity, and the like. The shape of these fillers, which is not particularly limited, is spherical, fibrous, or amorphous. Furthermore, a spherical gap material having a monodisperse diameter or fibrous gap material is mixed in order to favorably control a cell gap, or a fibrous material that is likely to be entangled with a projection on the substrate may be mixed in order to further enhance adhesive force with the substrate. The desirable diameter of the fibrous material used at this time is, approximately, ⅕ to 1/10 or less of the cell gap, and the length of the fibrous material is desirably shorter than the seal coating width.

In addition, the material of the fibrous material is not particularly limited as long as a predetermined shape is obtained, and cellulose, synthetic fibers such as polyamide, and polyester, or inorganic materials such as glass and carbon can be suitably selected as the material.

As the method of coating the seal material, a printing method and a dispensing method are exemplified, and the dispensing method in which a small amount of the seal material is used is desirable. The coating position of the seal material is generally on the black matrix such that the sealing region is not adversely affected. As the seal material coating shape, a closed loop shape is used in order to form a liquid crystal dropping region of a next step (such that a liquid crystal is not leaked).

A liquid crystal is dropped to the closed loop shape (sealing region) of the front plane coated with the seal material. In general, a dispenser is used. The amount of liquid crystal to be dropped is basically the same amount of the volume obtained by multiplying a height of the post spacer and a seal coating area in order to match the amount of liquid crystal to be dropped to the liquid crystal cell volume. However, in order to optimize a liquid crystal leakage and display characteristics in the cell bonding step, the amount of liquid crystal to be dropped may be suitably adjusted, or the liquid crystal dropping position may be dispersed.

Next, the back plane is bonded to the front plane on which the seal material is coated and a liquid crystal is dropped. Specifically, the front plane and the back plane are adsorbed to a stage having a mechanism for absorbing the substrate such as an electrostatic chuck, and disposed at a position (distance) where the second alignment film of the front plane and the first alignment film of the back plane face each other and the seal material and the other substrate do not come into contact. In this state, the inside of the system is decompressed. After decompression ends, while checking the bonding position of the front plane and the back plane, the positions of both substrates are adjusted (alignment operation). After adjustment of the bonding position ends, the substrates are caused to approach each other to a position where the seal material on the front plane and the back plane come into contact with each other. In this state, an inert gas is filled into the inside of the system, and the decompression of the inside of the system is slowly released and the pressure is returned to atmospheric pressure. At this time, the front plane and the back plane are compressed by atmospheric pressure, and the cell gap is formed at a height position of the post spacer. In this state, ultraviolet rays are applied to the seal material to cure the seal material, whereby a liquid crystal cell is formed. Thereafter, if necessary, a heating step is added to promote curing of the seal material. In order to enhance the adhesive force or improve the reliability of electrical characteristics of the sealing material, a heating step is added in many cases.

### EXAMPLES

Hereinafter, the present invention will be described in more detail with Examples, however, the present invention is not limited to the examples. In addition, “% by mass” in the compositions of the following examples and the comparative examples means “% by mass”.

In Examples, the measured characteristics are as follows.

Tni: nematic phase-isotropic liquid phase transition temperature (° C.)

Δn: refractive index anisotropy at 298 K (another name: birefringence)

Δ∈: dielectric anisotropy at 298 K

η: viscosity (mPa·s) at 293 K

γ₁: rotational viscosity (mPa·s) at 298 K

VHR: voltage holding ratio (% by mass) at 333 K under the conditions of a frequency of 60 Hz and an applied voltage of 5 V

VHR after heat resistance test: after holding a TEG (Test Element Group), in which a liquid crystal composition sample was enclosed, for evaluating electrooptical characteristics in a thermostat at 130° C. for one hour, measurement was performed under the same conditions as those in the VHR measurement method described above.

Burn-in:

the evaluation of the burn-in on a liquid crystal display element was performed as follows; a predetermined fixed pattern was displayed in the display area for an arbitrary test time, then uniform full screen display was performed, and the test time until the afterimage of the fixed pattern on the uniform full screen display reached an unacceptable afterimage level was measured.

1) Here, the test time indicates the display time of the fixed pattern, and shows that as the time becomes longer, generation of an afterimage is suppressed, and performance is high.

2) The unacceptable afterimage level is a level at which an afterimage to be rejected in the acceptance judgment is observed.

Dropping mark: by visually inspecting the dropping marks which come up to the surface whitely in a case where full screen black display was performed, the evaluation of the dropping marks on a liquid crystal display device was performed on a scale of five stages described below.

5: dropping marks were not present (excellent)
4: dropping marks were very slightly present; however it was at an acceptable level (good).
3: dropping marks were slightly present, and it was at a borderline level in an acceptance judgment (conditionally acceptable)
2: dropping marks were present, and it was at an unacceptable level (unacceptable).
1: dropping marks were present, and it was at a very poor level (severe).

Process Compatibility:

in ODE process, dropping the liquid crystal by 75 pL at one time was performed using a constant volume metering pump, the mass of the liquid crystal dropped by each 100 times of dropping when dropping was performed by 100 times like “0 to 100 times, 101 to 200 times, 201 to 300 times, . . . ” was measured, and the number of dropping times when the variation in mass reached a magnitude incapable of being adapted to the ODE process was evaluated.

It could be said that as the number of dropping times was greater, dropping could be stably performed over a long period of time, and process compatibility was high.

Solubility at a Low Temperature:

in the evaluation of solubility at a low temperature, after preparing a liquid crystal composition, 1.5 g of the liquid crystal composition was weighed and placed in a sample bottle of 3 mL, the following operation state, that is, the temperature change having one cycle of “−20° C. (maintained for 1 hour)→heating (0.2° C./min)→0° C. (maintained for 1 hour)→heating (0.2° C./min)→20° C. (maintained for 1 hour)→cooling (−0.2° C./min) 0° C. (maintained for 1 hour) cooling (−0.2° C./min)→−20° C.” was continuously given thereto in a temperature controlled test chamber, the generation of precipitates from the liquid crystal composition was visually observed, and the test time when precipitates were observed was measured.

As the test time is longer, a liquid crystal phase was stably maintained over a long period of time, and the solubility at low temperatures was good.

Volatility/Manufacturing Device Contamination:

volatility evaluation of a liquid crystal material was performed by observing the operating state of a vacuum agitation defoaming mixer using a stroboscope and by visually observing foaming of the liquid crystal material.

Specifically, 0.8 kg of the liquid crystal composition was put into a dedicated container of a vacuum agitation defoaming mixer having a capacity of 2.0 L, the vacuum agitation defoaming mixer was operated under the conditions of degassing of 4 kPa, an revolution speed of 18 S⁻¹, and a rotation speed 9 S⁻¹, and the time until foaming began was measured.

As the time until foaming began was longer, volatilization was less likely to occur, and the manufacturing device was less likely to be contaminated, and thus, the performance is increased.

### Examples 1 and 2 and Comparative Example 1

Compositions shown in Table 1 were prepared using the following compounds, and an IPS liquid crystal display device having the structure shown in FIGS. 1 and 2 was manufactured. Evaluation results of the obtained compositions and liquid crystal display devices are shown in Table 2.

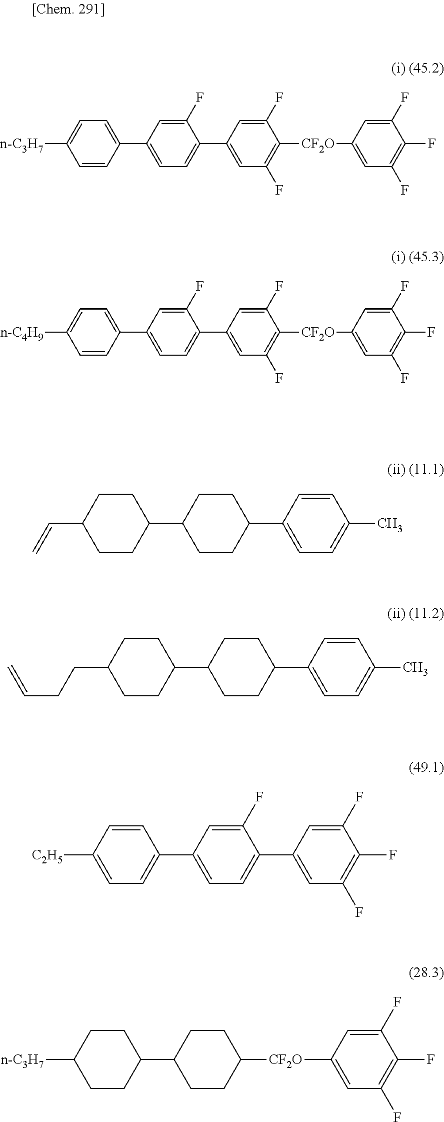

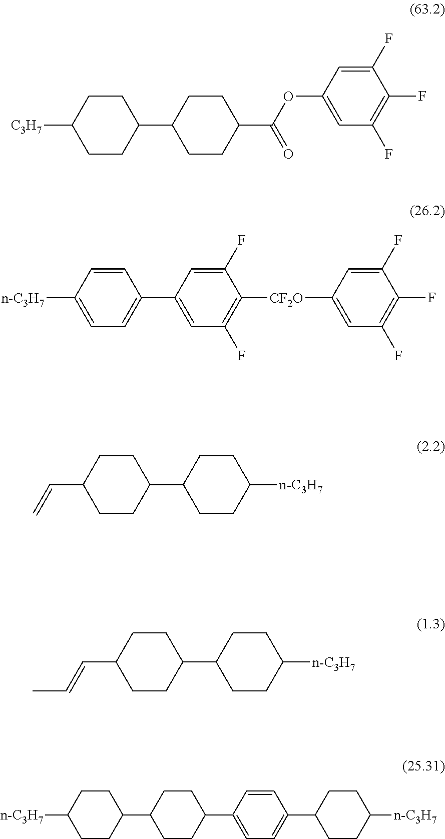

TABLE 1

| | Ratio (%) | | |
|---|---|---|---|
| | Comparative | | |
| Formula | Example 1 | Example 1 | Example 2 |
| (i)45.2 | | 5 | 6 |
| (i)45.3 | | | 1 |
| (ii)11.1 | 5 | 5 | 5 |
| (ii)11.2 | 12 | 6 | 6 |
| 49.1 | 10 | 10 | 10 |
| 28.3 | 2 | 2 | 2 |
| 63.2 | 13 | 13 | 13 |
| 26.2 | 23 | 18 | 16 |
| 2.2 | 22.5 | 22.5 | 28.5 |
| 1.3 | 10 | 16 | 10 |
| 25.31 | 2.5 | 2.5 | 2.5 |

TABLE 2

| | Comparative | | |
|---|---|---|---|
| | Example 1 | Example 1 | Example 2 |
| Tni/° C. | 75.8 | 75.3 | 75.1 |
| Δn | 0.102 | 0.102 | 0.101 |
| Δε | 10.1 | 10.1 | 10.3 |
| η/mPa · s | 17 | 15 | 15 |
| γ₁/mPa · s | 75 | 80 | 82 |
| Initial voltage holding ratio | 98.9 | 99.3 | 99.7 |
| (%) | | | |
| Voltage holding ratio (%) after | 97.6 | 98.2 | 99.0 |
| heat resistance test | | | |
| Burn-in evaluation (h) | 80 | 320 | 615 |
| Dropping mark evaluation | 2 | 3 | 4 |
| Manufacturing device | 180 | 180 | 165 |
| contamination evaluation (s) | | | |
| Process compatibility | 165 | 650 | 1100 |
| evaluation (×100 times) | | | |
| Evaluation of solubility at a | 110 | 600 | 570 |
| low temperature (h) | | | |

The compositions prepared in Examples 1 and 2 were significantly excellent in solubility at a low temperature, also excellent in the dropping mark evaluation, and in the compositions, burn-in was suppressed, compared to the composition prepared in Comparative Example 1.

### Examples 3 to 5

Compositions shown in Table 3 were prepared using the following compounds, and an IPS liquid crystal display device having the structure shown in FIGS. 1 and 2 was manufactured. Evaluation results of the obtained compositions and liquid crystal display devices are shown in Table 4.

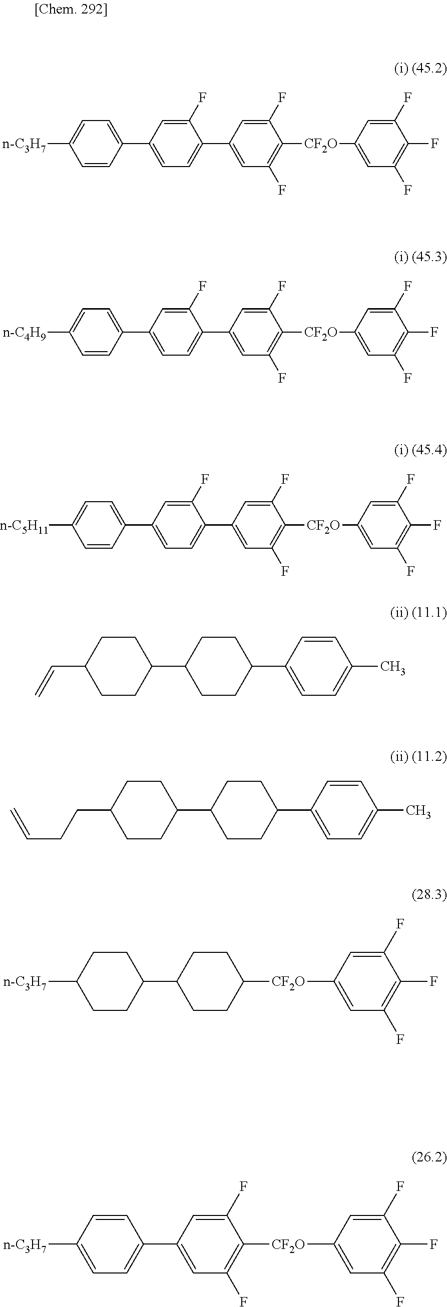

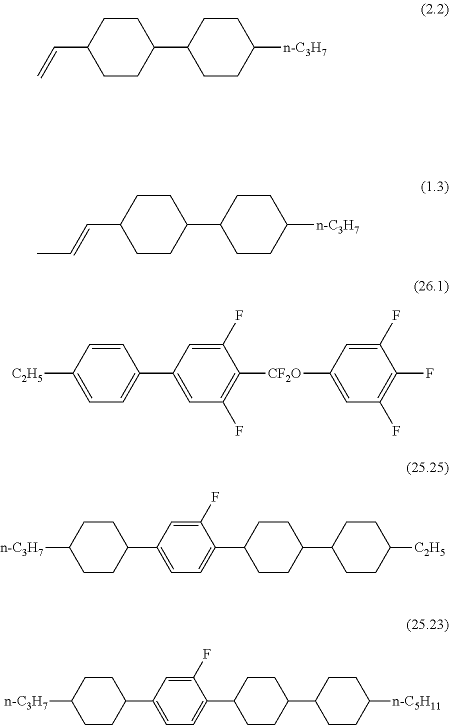

TABLE 3

| | Ratio (%) | | |
|---|---|---|---|
| Formula | Example 3 | Example 4 | Example 5 |
| (i)45.2 | 2 | 7 | 7 |
| (i)45.3 | 7 | 4 | |
| (i)45.4 | 4 | | |
| (ii)11.1 | | 5 | |
| (ii)11.2 | | | 10 |
| 28.3 | 14 | 14 | 15 |
| 26.2 | 16 | 18 | 17 |
| 2.2 | 27 | 27 | 27 |
| 1.3 | 10 | 5 | |
| 26.1 | | | 4 |
| 25.25 | 8 | 8 | 8 |
| 25.23 | 12 | 12 | 12 |

TABLE 4

| | Example 3 | Example 4 | Example 5 |
|---|---|---|---|
| T_{NI}/° C. | 103.5 | 103.8 | 104.4 |
| Δn | 0.099 | 0.099 | 0.098 |
| Δε | 7.8 | 7.9 | 7.9 |
| η/mPa · s | 20 | 20 | 21 |
| γ₁/mPa · s | 112 | 107 | 107 |
| Initial voltage holding ratio | 99.1 | 99.4 | 99.6 |
| (%) | | | |
| Voltage holding ratio (%) | 97.9 | 98.5 | 98.9 |
| after heat resistance test | | | |
| Burn-in evaluation (h) | 90 | 250 | 340 |
| Dropping mark evaluation | 2 | 4 | 5 |
| Manufacturing device | 110 | 135 | 160 |
| contamination evaluation (s) | | | |
| Process compatibility | 170 | 390 | 1050 |
| evaluation (×100 times) | | | |
| Solubility evaluation at a | 100 | 240 | 600 |
| low temperature (h) | | | |

### Examples 6 to 9

Compositions shown in Table 5 were prepared using the following compounds, and an IPS liquid crystal display device having the structure shown in FIGS. 1 and 2 was manufactured. Evaluation results of the obtained compositions and liquid crystal display devices are shown in Table 6.

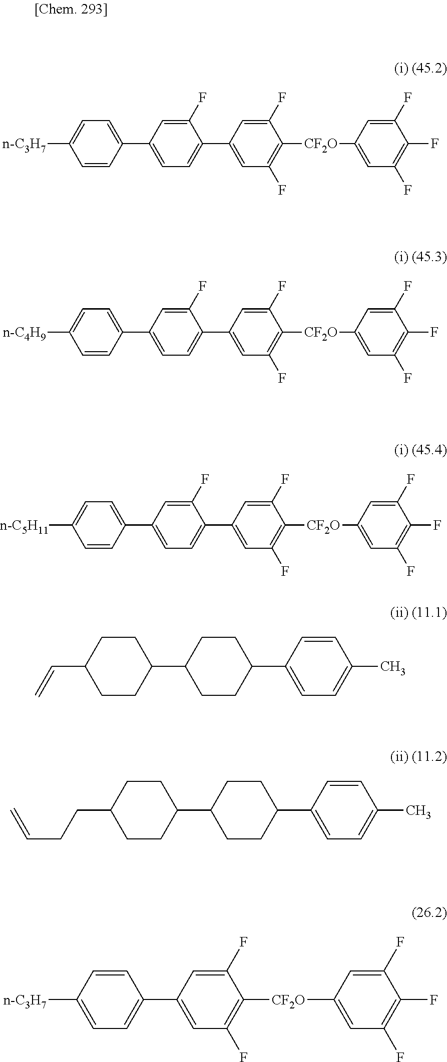

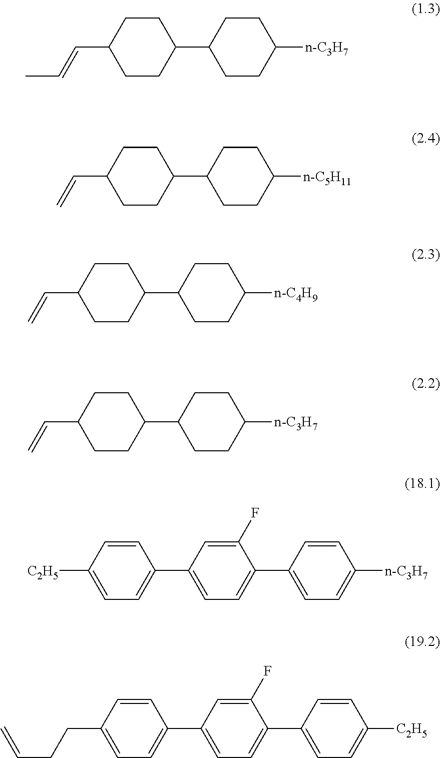

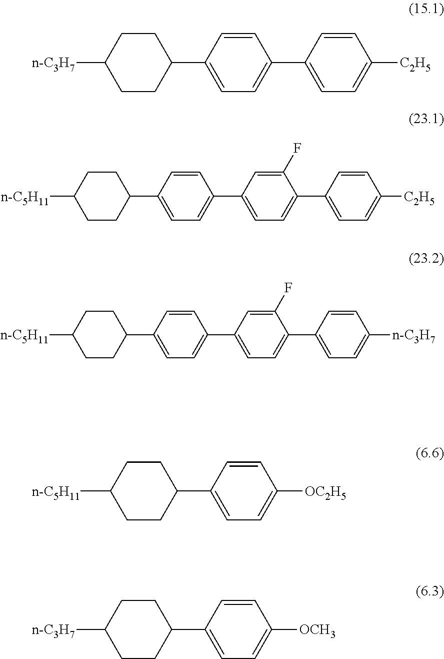

TABLE 5

Ratio (%)

| Formula | Example 6 | Example 7 | Example 8 | Example 9 |
|---|---|---|---|---|
| (i)45.2 | 2 | 3 | 5 | 5 |
| (i)45.3 | 5 | 5 | 3 | 3 |
| (i)45.4 | 3 | 2 | 2 | 2 |
| (ii)11.1 | 15 | 15 | 13 | 11 |
| (ii)11.2 | 11 | 11 | 13 | 15 |
| 26.2 | 8 | 8 | 8 | 8 |
| 1.3 | 11 | 11 | 11 | 11 |
| 2.4 | 12 | | 12 | |
| 2.3 | 15 | 15 | | |
| 2.2 | | 12 | 15 | 27 |
| 18.1 | 3 | | | |
| 19.2 | | | 3 | 3 |
| 15.1 | | 3 | | |
| 23.1 | 5 | 5 | 5 | 5 |
| 23.2 | 5 | 5 | 5 | 5 |
| 6.6 | 5 | 5 | | |
| 6.3 | | | 5 | 5 |

TABLE 6

| | Example 6 | Example 7 | Example 8 | Example 9 |
|---|---|---|---|---|
| Tni/° C. | 104.9 | 105.6 | 106.7 | 105.5 |
| Δn | 0.121 | 0.117 | 0.119 | 0.116 |
| Δε | 5.5 | 5.5 | 5.6 | 5.8 |
| η/mPa · s | 16 | 14 | 13 | 11 |
| γ₁/mPa · s | 90 | 75 | 78 | 66 |
| Initial voltage holding | 99.4 | 99.4 | 99.6 | 99.4 |
| ratio (%) | | | | |
| Voltage holding ratio (%) | 98.8 | 98.8 | 98.9 | 98.8 |
| after heat resistance test | | | | |
| Burn-in evaluation (h) | 525.0 | 530.0 | 530.0 | 500.0 |
| Dropping mark | 5 | 4 | 4 | 3 |
| evaluation | | | | |
| Manufacturing device | 250 | 220 | 190 | 180 |
| contamination evaluation | | | | |
| (s) | | | | |
| Process compatibility | 880 | 780 | 680 | 575 |
| evaluation (×100 times) | | | | |
| Solubility evaluation at a | 610 | 415 | 435 | 250 |
| low temperature (h) | | | | |

### Examples 10 to 13

Compositions shown in Table 7 were prepared using the following compounds, and an IPS liquid crystal display device having the structure shown in FIGS. 1 and 2 was manufactured. Evaluation results of the obtained compositions and liquid crystal display devices are shown in Table 8.

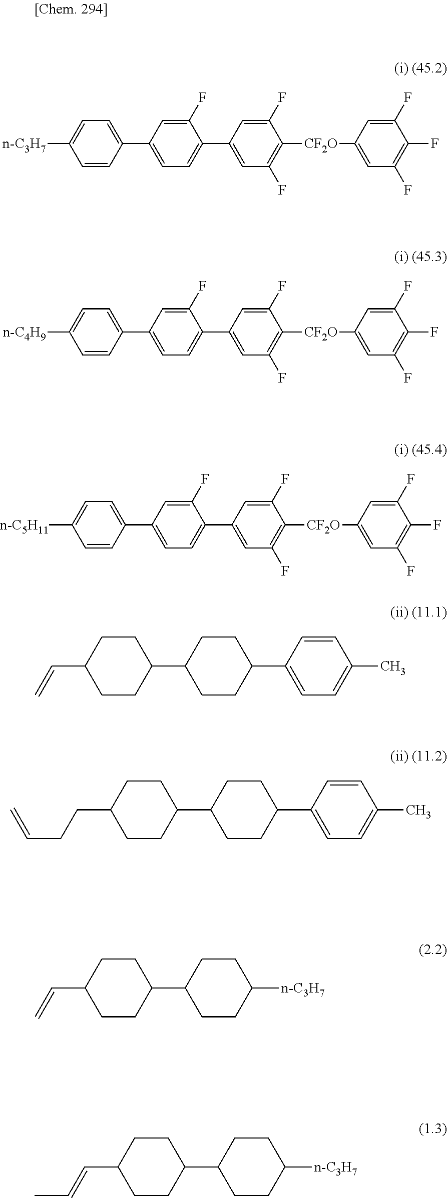

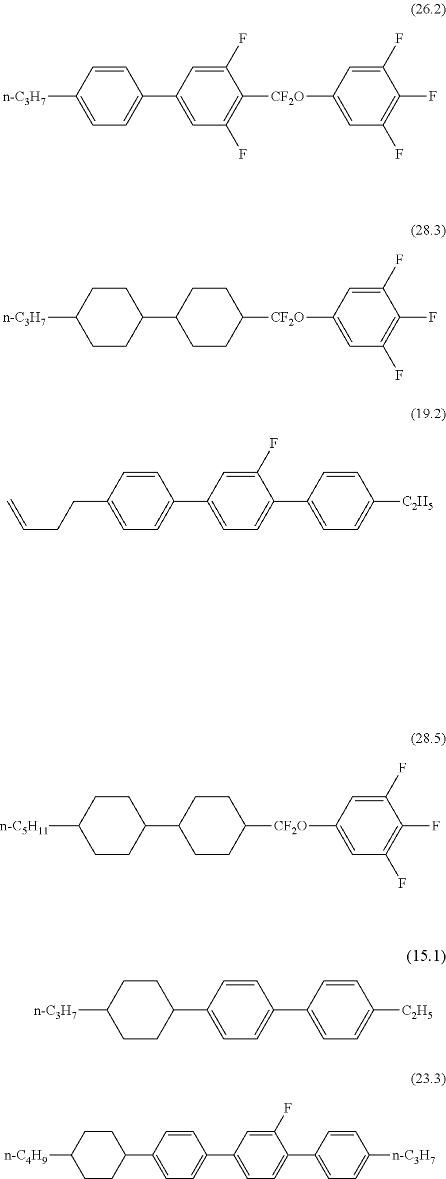

TABLE 7

Ratio (% by mass)

| | Example | Example | Example | Example |
|---|---|---|---|---|
| Formula | 10 | 11 | 12 | 13 |
| (i)45.2 | 2 | 4 | 6 | 6 |
| (i)45.3 | 7 | 6 | 5 | 5 |
| (i)45.4 | 7 | 6 | 5 | 5 |
| (ii)11.1 | | | 6 | 6 |
| (ii)11.2 | 9 | 10 | | |
| 2.2 | 38 | 35 | 40 | 50 |
| 1.3 | 14 | 8 | 11 | |
| 26.2 | 8 | 7 | 6 | 6 |
| 28.3 | 15 | 16 | 11 | 11 |
| 19.2 | | 4 | | |
| 28.5 | | | 5 | 5 |
| 15.1 | | 4 | | 6 |
| 23.3 | | | 5 | |

TABLE 8

| | Example | Example | Example | Example |
|---|---|---|---|---|
| | 10 | 11 | 12 | 13 |
| Tni/° C. | 81.1 | 88.9 | 88.5 | 80.1 |
| Δn | 0.099 | 0.112 | 0.105 | 0.101 |
| Δε | 8.0 | 8.3 | 7.4 | 7.3 |
| η/mPa · s | 13 | 16 | 14 | 12 |
| γ₁/mPa · s | 48 | 60 | 52 | 45 |
| Initial voltage holding | 99.4 | 99.4 | 99.6 | 99.4 |
| ratio (%) | | | | |
| Voltage holding ratio (%) | 98.8 | 98.5 | 98.4 | 98.0 |
| after heat resistance test | | | | |
| Burn-in evaluation (h) | 600 | 400 | 450 | 300 |
| Dropping mark | 5 | 5 | 4 | 4 |
| evaluation | | | | |
| Manufacturing device | 200 | 200 | 175 | 120 |
| contamination evaluation | | | | |
| (s) | | | | |
| Process compatibility | 960 | 850 | 820 | 480 |
| evaluation (×100 times) | | | | |
| Solubility evaluation at a | 610 | 600 | 550 | 360 |
| low temperature (h) | | | | |

### Examples 14 to 17

Compositions shown in Table 9 were prepared using the following compounds, and an IPS liquid crystal display device having the structure shown in FIGS. 1 and 2 was manufactured. Evaluation results of the obtained compositions and liquid crystal display devices are shown in Table 10.

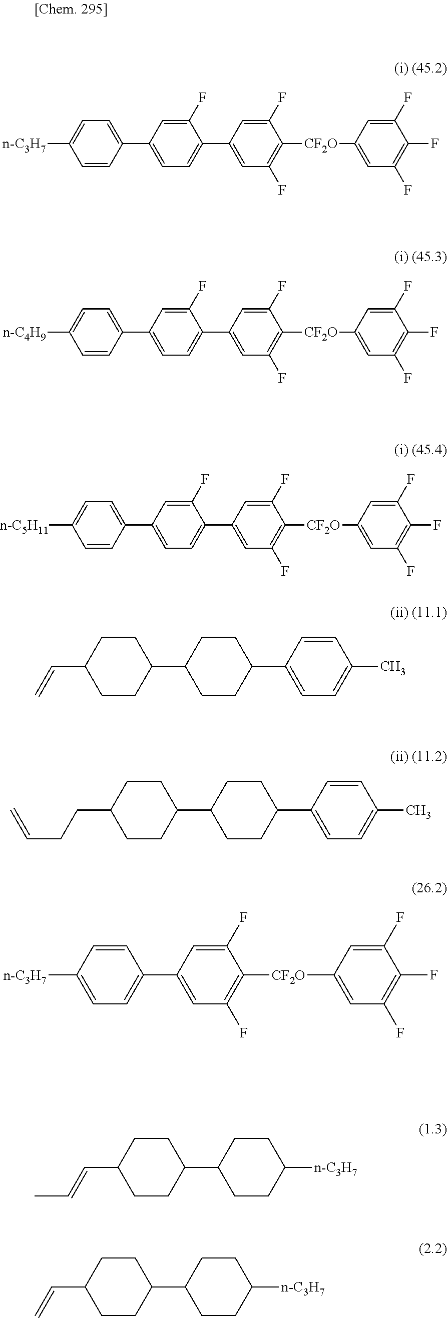

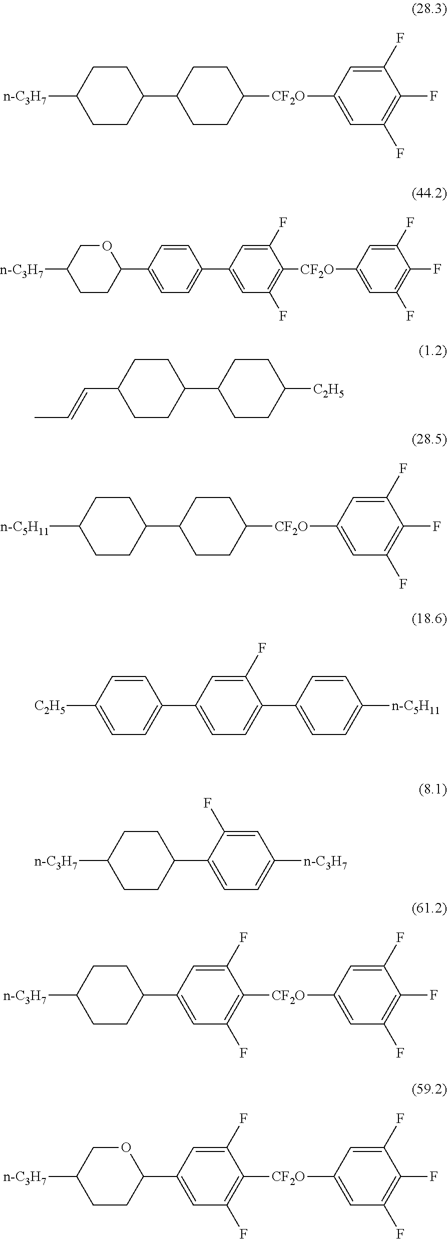

TABLE 9

Ratio (% by mass)

| | Example | Example | Example | Example |
|---|---|---|---|---|
| Formula | 14 | 15 | 16 | 17 |
| (i)45.2 | 2 | 6 | | 10 |
| (i)45.3 | 8 | 4 | 10 | 6 |
| (i)45.4 | 10 | 8 | 4 | 2 |
| (ii)11.1 | | 10 | 5 | |
| (ii)11.2 | 10 | | 5 | 8 |
| 26.2 | 2 | | 2 | |
| 1.3 | 12 | 10 | 14 | 8 |
| 2.2 | 38 | 30 | 36 | 42 |
| 28.3 | 8 | 5 | 3 | 10 |
| 44.2 | | 4 | 6 | 2 |
| 1.2 | | 10 | | |
| 28.5 | | 3 | 5 | |
| 18.6 | | | | 2 |
| 8.1 | 1 | 1 | 1 | 1 |
| 61.2 | 4 | 4 | 4 | 4 |
| 59.2 | 5 | 5 | 5 | 5 |

TABLE 10

| | Example | Example | Example | Example |
|---|---|---|---|---|
| | 14 | 15 | 16 | 17 |
| Tni/° C. | 87.5 | 89.4 | 90.4 | 86.6 |
| Δn | 0.109 | 0.108 | 0.108 | 0.106 |
| Δε | 11.4 | 10.6 | 10.7 | 11.5 |
| η/mPa · s | 17 | 16 | 16 | 15 |
| γ₁/mPa · s | 95 | 89 | 91 | 95 |
| Initial VHR (%) | 99.5 | 99.3 | 99.4 | 99.5 |
| VHR (%) after heat | 98.6 | 98.1 | 98.3 | 98.5 |
| resistance test | | | | |
| Burn-in evaluation (h) | 400 | 300 | 310 | 400 |
| Dropping mark | 5 | 4 | 4 | 5 |
| evaluation | | | | |
| Manufacturing device | 190 | 200 | 190 | 160 |
| contamination | | | | |
| evaluation (s) | | | | |
| Process compatibility | 1000 | 710 | 850 | 990 |
| evaluation (×100 times) | | | | |
| Solubility evaluation at a | 620 | 450 | 460 | 550 |
| low temperature (h) | | | | |

### Examples 18 to 21

Compositions shown in Table 11 were prepared using the following compounds, and an IPS liquid crystal display device having the structure shown in FIGS. 1 and 2 was manufactured. Evaluation results of the obtained compositions and liquid crystal display devices are shown in Table 12.

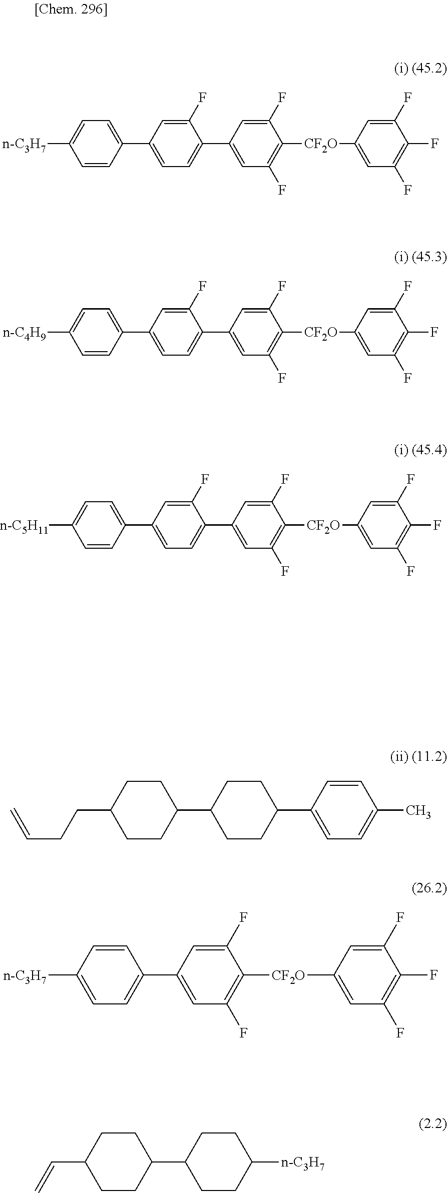

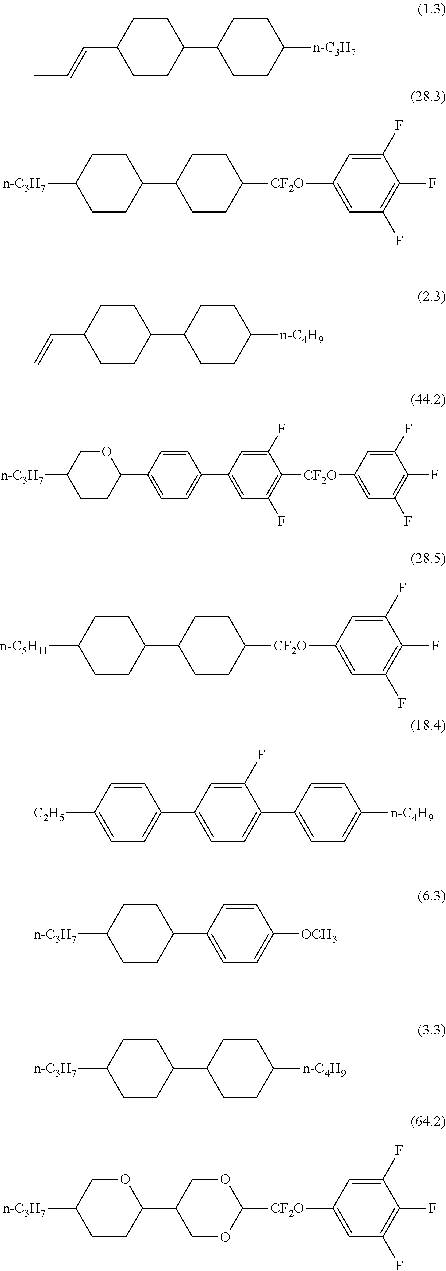

TABLE 11

Ratio (% by mass)

| | Example | Example | Example | Example |
|---|---|---|---|---|
| Formula | 18 | 19 | 20 | 21 |
| (i)45.2 | 4 | 9 | 11 | 3 |
| (i)45.3 | 8 | 6 | 4 | 9 |
| (i)45.4 | 10 | 7 | 5 | 8 |
| (ii)11.2 | 12 | 10 | 8 | 6 |
| 26.2 | 2 | 2 | 2 | 2 |
| 2.2 | 32 | 22 | 18 | 15 |
| 1.3 | 14 | 10 | 18 | 8 |
| 28.3 | 17 | 7 | 18 | 10 |
| 2.3 | | 12 | 8 | |
| 44.2 | | | | 2 |
| 28.5 | | 10 | 2 | 7 |
| 18.4 | | 4 | 2 | 6 |
| 6.3 | | | 4 | |
| 3.3 | | | | 23 |
| 64.2 | 1 | 1 | | 1 |

TABLE 12

| | Example | Example | Example | Example |
|---|---|---|---|---|
| | 18 | 19 | 20 | 21 |
| Tni/° C. | 91.2 | 87.8 | 85.2 | 92.7 |
| Δn | 0.108 | 0.115 | 0.108 | 0.113 |
| Δε | 10.3 | 10.1 | 9.9 | 9.8 |
| η/mPa · s | 19 | 24 | 18 | 25 |
| γ₁/mPa · s | 98 | 107 | 99 | 118 |
| Initial VHR (%) | 99.5 | 99.3 | 99.4 | 99.5 |
| VHR (%) after heat | 98.5 | 97.9 | 98.2 | 98.5 |
| resistance test | | | | |
| Burn-in evaluation (h) | 600 | 500 | 500 | 600 |
| Dropping mark | 5 | 3 | 4 | 5 |
| evaluation | | | | |
| Manufacturing device | 200 | 210 | 220 | 210 |
| contamination | | | | |
| evaluation (s) | | | | |
| Process compatibility | 1190 | 850 | 880 | 460 |
| evaluation (×100 times) | | | | |
| Solubility evaluation at a | 700 | 690 | 540 | 150 |
| low temperature (h) | | | | |

### Examples 22 to 25

Compositions shown in Table 13 were prepared using the following compounds, and an IPS liquid crystal display device having the structure shown in FIGS. 1 and 2 was manufactured. Evaluation results of the obtained compositions and liquid crystal display devices are shown in Table 14.

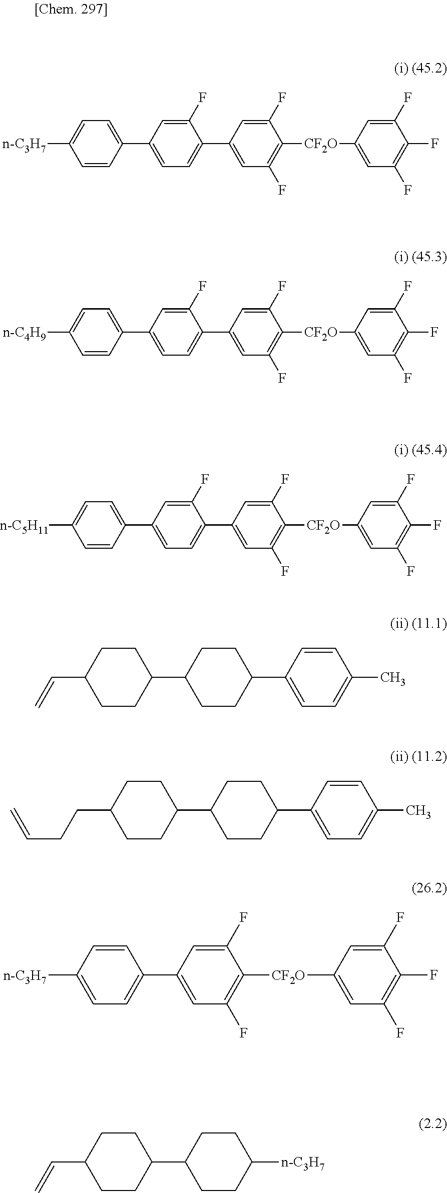

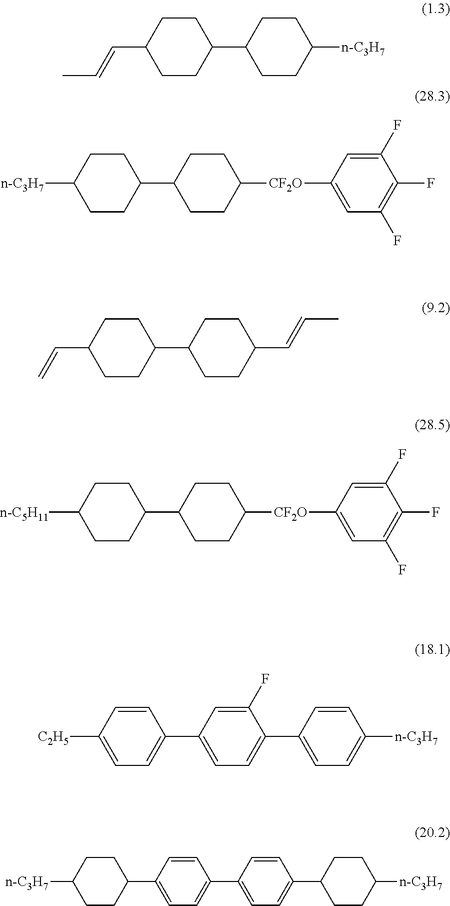

TABLE 13

Ratio (% by mass)

| | Example | Example | Example | Example |
|---|---|---|---|---|
| Formula | 22 | 23 | 24 | 25 |
| (i)45.2 | 2 | 4 | 5 | 6 |
| (i)45.3 | 8 | 5 | 9 | 2 |
| (i)45.4 | 8 | 9 | 4 | 10 |
| (ii)11.1 | | 5 | 5 | 9 |
| (ii)11.2 | 15 | 10 | 7 | 4 |
| 26.2 | 7 | 7 | 9 | 6 |
| 2.2 | 37 | 40 | 33 | 47 |
| 1.3 | 13 | 7 | 9 | 3 |
| 28.3 | 10 | 5 | 8 | 11 |
| 9.2 | | | 9 | |
| 28.5 | | 5 | | |
| 18.1 | | 3 | 2 | |
| 20.2 | | | | 2 |

TABLE 14

| | Example | Example | Example | Example |
|---|---|---|---|---|
| | 22 | 23 | 24 | 25 |
| Tni/° C. | 81.7 | 80.0 | 73.2 | 80.6 |
| Δn | 0.100 | 0.104 | 0.103 | 0.098 |
| Δε | 8.5 | 8.4 | 8.9 | 8.2 |
| η/mPa · s | 15 | 16 | 15 | 14 |
| γ₁/mPa · s | 77 | 77 | 73 | 71 |
| Initial VHR (%) | 99.6 | 99.5 | 99.5 | 99.5 |
| VHR (%) after heat | 98.5 | 98.2 | 98.2 | 98.2 |
| resistance test | | | | |
| Burn-in evaluation (h) | 580 | 540 | 545 | 550 |
| Dropping mark | 5 | 4 | 4 | 4 |
| evaluation | | | | |
| Manufacturing device | 200 | 170 | 200 | 150 |
| contamination | | | | |
| evaluation (s) | | | | |
| Process compatibility | 995 | 745 | 750 | 490 |
| evaluation (×100 times) | | | | |
| Solubility evaluation at a | 620 | 590 | 585 | 500 |
| low temperature (h) | | | | |

### Examples 26 to 29

Compositions shown in Table 15 were prepared using the following compounds, and an IPS liquid crystal display device having the structure shown in FIGS. 1 and 2 was manufactured. Evaluation results of the obtained compositions and liquid crystal display devices are shown in Table 16.

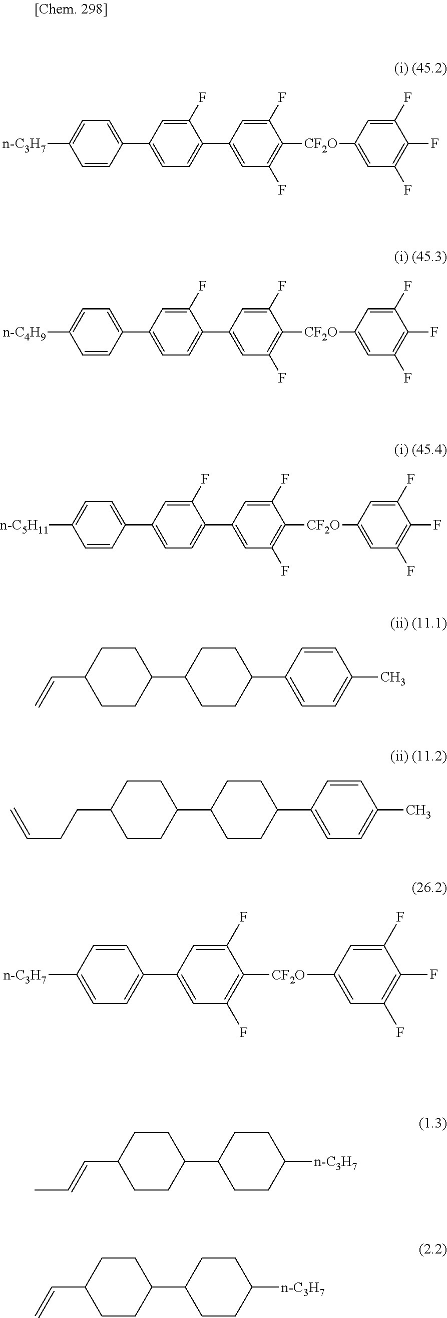

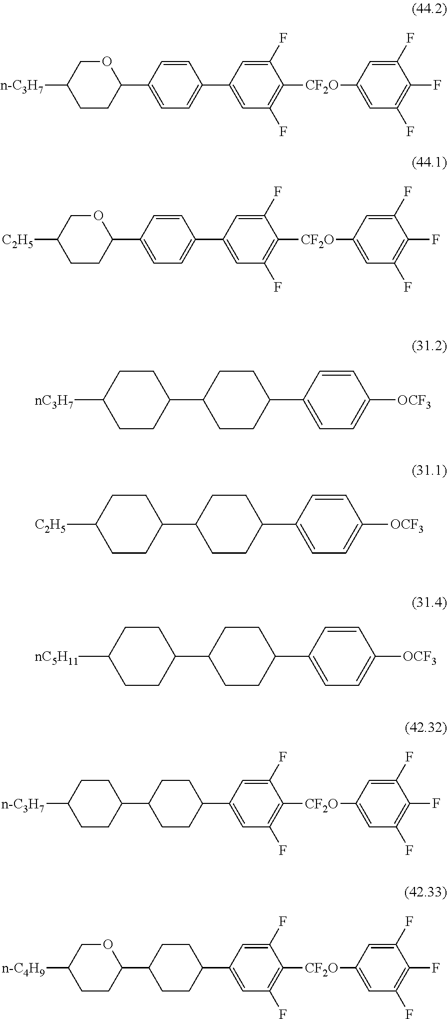

TABLE 15

Ratio (% by mass)

| | Example | Example | Example | Example |
|---|---|---|---|---|
| Formula | 26 | 27 | 28 | 29 |
| (i)45.2 | 3 | 4 | 5 | 6 |
| (i)45.3 | 7 | 6 | 4 | 2 |
| (i)45.4 | 3 | 3 | 4 | 5 |
| (ii)11.1 | 7 | 13 | 13 | 13 |
| (ii)11.2 | | | 8 | 8 |
| 26.2 | 2 | 2 | 2 | 2 |
| 1.3 | 13 | 13 | 13 | 13 |
| 2.2 | 36 | 30 | 25 | 25 |
| 44.2 | 7 | 5 | 3 | 3 |
| 44.1 | 5 | 7 | 6 | 6 |
| 31.2 | 6 | 6 | 3 | |
| 31.1 | | | 3 | 6 |
| 31.4 | 3 | 3 | 3 | 3 |
| 42.32 | 4 | 4 | 4 | 4 |
| 42.33 | 4 | 4 | 4 | 4 |

TABLE 16

| | Example | Example | Example | Example |
|---|---|---|---|---|
| | 26 | 27 | 28 | 29 |
| Tni/° C. | 92.8 | 98.2 | 104.7 | 104.0 |
| Δn | 0.109 | 0.113 | 0.115 | 0.115 |
| Δε | 12.0 | 11.7 | 9.8 | 9.3 |
| η/mPa · s | 17 | 19 | 19 | 19 |
| γ₁/mPa · s | 96 | 110 | 114 | 120 |
| Initial VHR (%) | 99.3 | 99.2 | 99.4 | 99.5 |
| VHR (%) after heat | 98.0 | 97.9 | 98.2 | 98.2 |
| resistance test | | | | |
| Burn-in evaluation (h) | 425 | 400 | 430 | 450 |
| Dropping mark | 5 | 5 | 4 | 4 |
| evaluation | | | | |
| Manufacturing device | 180 | 185 | 190 | 190 |
| contamination | | | | |
| evaluation (s) | | | | |
| Process compatibility | 965 | 840 | 770 | 750 |
| evaluation (×100 times) | | | | |
| Solubility evaluation at a | 580 | 590 | 580 | 490 |
| low temperature (h) | | | | |

### Examples 30 to 33

Compositions shown in Table 17 were prepared using the following compounds, and an IPS liquid crystal display device having the structure shown in FIGS. 1 and 2 was manufactured. Evaluation results of the obtained compositions and liquid crystal display devices are shown in Table 18.

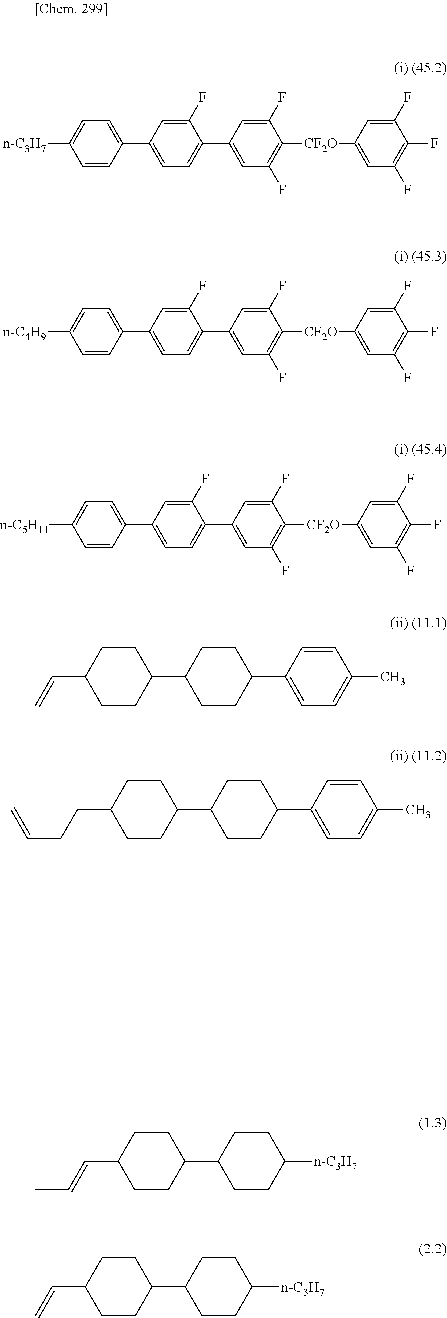

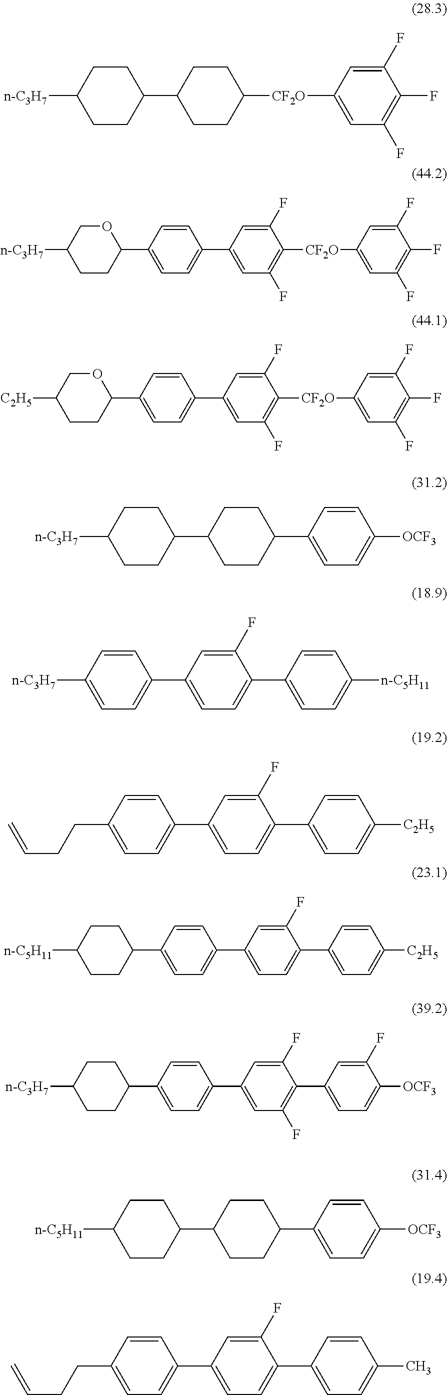

TABLE 17

Ratio (% by mass)

| | Example | Example | Example | Example |
|---|---|---|---|---|
| Formula | 30 | 31 | 32 | 33 |
| (i)45.2 | 2 | 3 | 5 | |
| (i)45.3 | 3 | 2 | | 4 |
| (i)45.4 | | | | 6 |
| (ii)11.1 | 12 | 7 | 9 | 13 |
| (ii)11.2 | 4 | 8 | 6 | 5 |
| 1.3 | 10 | 12 | 7 | 16 |
| 2.2 | 37 | 36 | 41 | 27 |
| 28.3 | 2 | 5 | 4 | 5 |
| 44.2 | 4 | 3 | 5 | 2 |
| 44.1 | 4 | 2 | 1 | 3 |
| 31.2 | 8 | 5 | 10 | 4 |
| 18.9 | | 8 | 8 | |
| 19.2 | | 4 | | |
| 23.1 | | | 4 | |
| 39.2 | | 3 | | |
| 31.4 | 2 | 2 | | 5 |
| 19.4 | 12 | | | 10 |

TABLE 18

| | Example | Example | Example | Example |
|---|---|---|---|---|
| | 30 | 31 | 32 | 33 |
| Tni/° C. | 95.1 | 95.3 | 97.7 | 99.3 |
| Δn | 0.106 | 0.102 | 0.099 | 0.110 |
| Δε | 4.7 | 4.7 | 4.5 | 5.3 |
| η/mPa · s | 14 | 13 | 13 | 17 |
| γ₁/mPa · s | 60 | 66 | 59 | 78 |
| Initial VHR (%) | 99.5 | 99.5 | 99.5 | 99.5 |
| VHR (%) after heat | 98.6 | 98.4 | 98.2 | 97.9 |
| resistance test | | | | |
| Burn-in evaluation (h) | 650 | 600 | 550 | 450 |
| Dropping mark | 5 | 5 | 4 | 4 |
| evaluation | | | | |
| Manufacturing device | 200 | 200 | 175 | 200 |
| contamination | | | | |
| evaluation (s) | | | | |
| Process compatibility | 1204 | 875 | 950 | 700 |
| evaluation (×100 times) | | | | |
| Solubility evaluation at a | 610 | 590 | 550 | 475 |
| low temperature (h) | | | | |

### Examples 34 to 37

Compositions shown in Table 19 were prepared using the following compounds, and an IPS liquid crystal display device having the structure shown in FIGS. 1 and 2 was manufactured. Evaluation results of the obtained compositions and liquid crystal display devices are shown in Table 20.

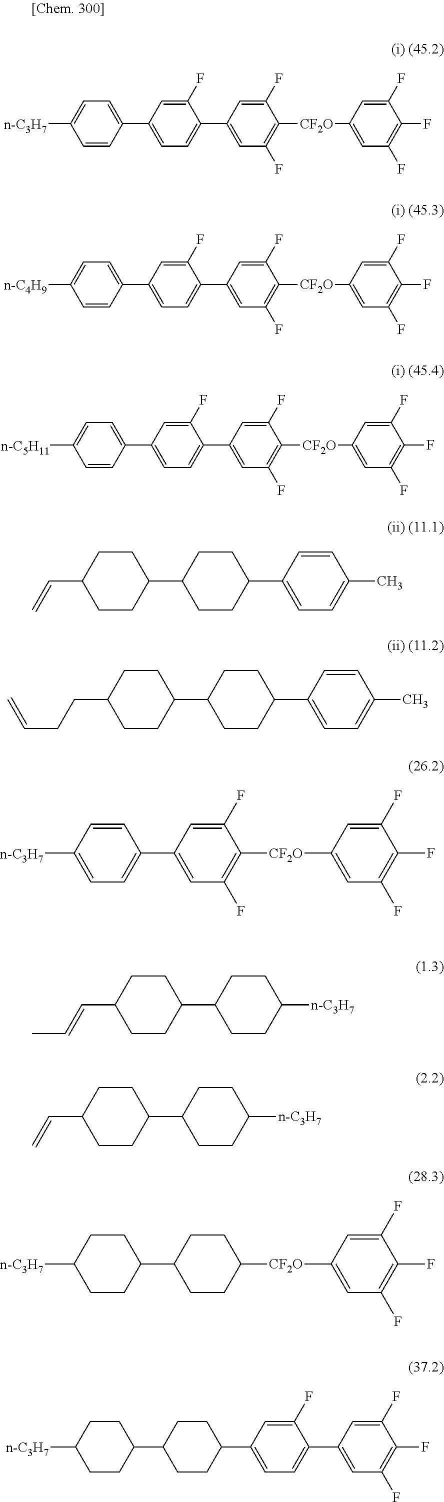

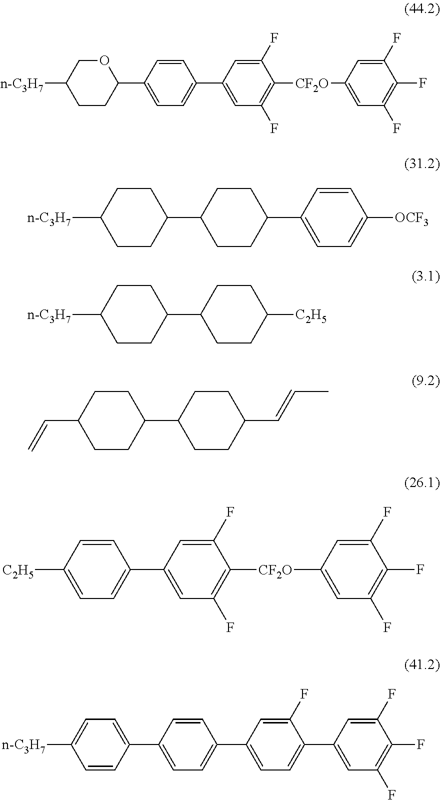

TABLE 19

Ratio (% by mass)

| | Example | Example | Example | Example |
|---|---|---|---|---|
| Formula | 34 | 35 | 36 | 37 |
| (i)45.2 | | | | 8 |
| (i)45.3 | 7 | 9 | 4 | 2 |
| (i)45.4 | 3 | 3 | 6 | |
| (ii)11.1 | | 10 | 6 | |
| (ii)11.2 | 12 | 2 | 6 | 13 |
| 26.2 | 7 | 4 | 10 | 9 |
| 1.3 | 16 | 12 | 10 | |
| 2.2 | 29 | 24 | 35 | 20 |
| 28.3 | 7 | 5 | 10 | 8 |
| 37.2 | 2 | | 1 | 3 |
| 44.2 | 6 | 8 | 3 | 5 |
| 31.2 | 11 | 9 | 8 | 10 |
| 3.1 | | 9 | | 10 |
| 9.2 | | | | 6 |
| 26.1 | | 3 | | 6 |
| 41.2 | | 2 | 1 | |

TABLE 20

| | Example | Example | Example | Example |
|---|---|---|---|---|
| | 34 | 35 | 36 | 37 |
| Tni/° C. | 91.3 | 83.1 | 81.8 | 74.3 |
| Δn | 0.100 | 0.103 | 0.098 | 0.098 |
| Δε | 8.9 | 9.5 | 9.0 | 12.5 |
| η/mPa · s | 16 | 17 | 14 | 18 |
| γ₁/mPa · s | 91 | 108 | 78 | 74 |
| Initial VHR (%) | 99.6 | 99.5 | 99.5 | 99.5 |
| VHR (%) after heat | 98.7 | 98.4 | 98.5 | 98.4 |
| resistance test | | | | |
| Burn-in evaluation (h) | 600 | 500 | 500 | 550 |
| Dropping mark | 5 | 4 | 4 | 5 |
| evaluation | | | | |
| Manufacturing device | 210 | 200 | 185 | 200 |
| contamination | | | | |
| evaluation (s) | | | | |
| Process compatibility | 999 | 750 | 750 | 750 |
| evaluation (×100 times) | | | | |
| Solubility evaluation at a | 575 | 480 | 460 | 535 |
| low temperature (h) | | | | |

### Examples 38 to 41

Compositions shown in Table 21 were prepared using the following compounds, and an IPS liquid crystal display device having the structure shown in FIGS. 1 and 2 was manufactured. Evaluation results of the obtained compositions and liquid crystal display devices are shown in Table 22.

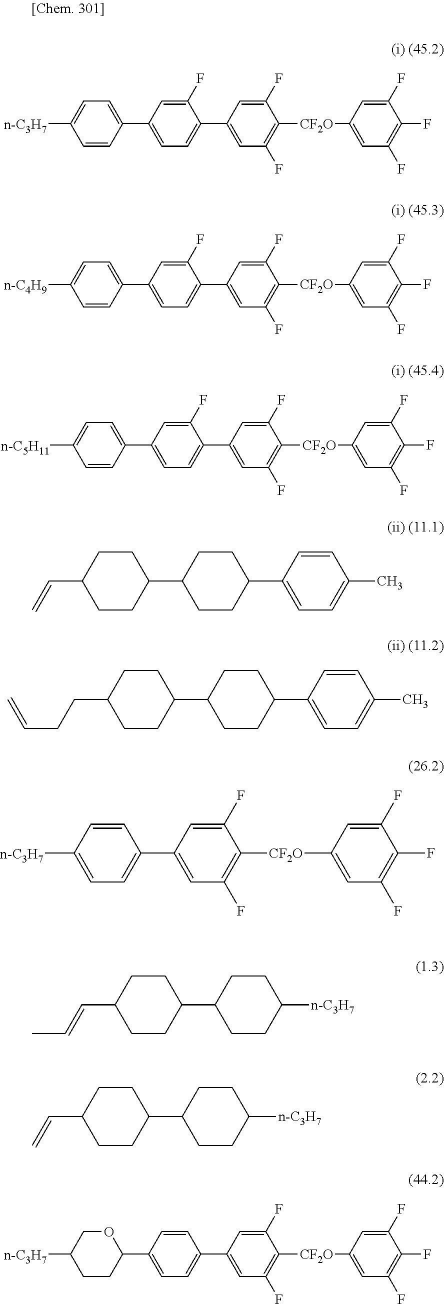

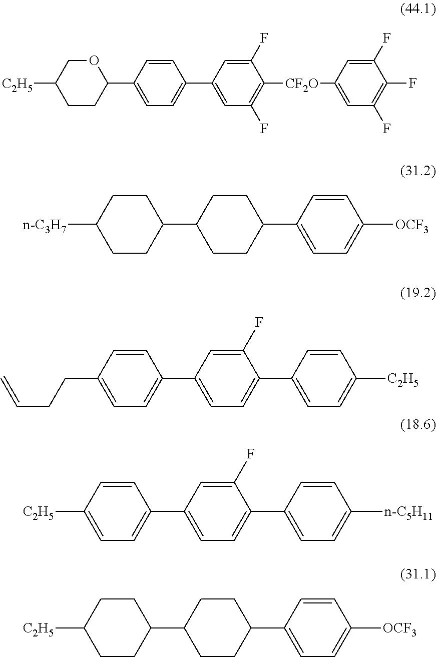

TABLE 21

Ratio (% by mass)

| | Example | Example | Example | Example |
|---|---|---|---|---|
| Formula | 38 | 39 | 40 | 41 |
| (i)45.2 | | 7 | 7 | |
| (i)45.3 | 8 | 8 | | 8 |
| (i)45.4 | 7 | | 8 | 7 |
| (ii)11.1 | | 8 | 8 | 9 |
| (ii)11.2 | 16 | 8 | 8 | |
| 26.2 | 4 | 4 | 4 | 4 |
| 1.3 | 13 | 12 | 11 | 13 |
| 2.2 | 34 | 35 | 36 | 34 |
| 44.2 | 7 | 6 | 5 | 7 |
| 44.1 | 4 | 5 | 6 | 4 |
| 31.2 | 6 | | 6 | |
| 19.2 | 1 | 1 | | |
| 18.6 | | | 1 | 8 |
| 31.1 | | 6 | | 6 |

TABLE 22

| | Example | Example | Example | Example |
|---|---|---|---|---|
| | 38 | 39 | 40 | 41 |
| Tni/° C. | 91.8 | 87.4 | 88.1 | 84.0 |
| Δn | 0.109 | 0.106 | 0.107 | 0.116 |
| Δε | 10.3 | 9.38 | 10.02 | 9.20 |
| η/mPa · s | 19 | 16.7 | 17.3 | 20.6 |
| γ₁/mPa · s | 99 | 101 | 94 | 112 |
| Initial VHR (%) | 99.6 | 99.5 | 99.5 | 99.5 |
| VHR (%) after heat | 98.6 | 99.3 | 99.2 | 99.2 |
| resistance test | | | | |
| Burn-in evaluation (h) | 600 | 580 | 570 | 570 |
| Dropping mark | 5 | 5 | 4 | 4 |
| evaluation | | | | |
| Manufacturing device | 210 | 205 | 200 | 210 |
| contamination | | | | |
| evaluation (s) | | | | |
| Process compatibility | 1010 | 980 | 950 | 1000 |
| evaluation (×100 times) | | | | |
| Solubility evaluation at a | 610 | 600 | 600 | 610 |
| low temperature (h) | | | | |

### Examples 42 to 45

Compositions shown in Table 23 were prepared using the following compounds, and an IPS liquid crystal display device having the structure shown in FIGS. 1 and 2 was manufactured. Evaluation results of the obtained compositions and liquid crystal display devices are shown in Table 24.

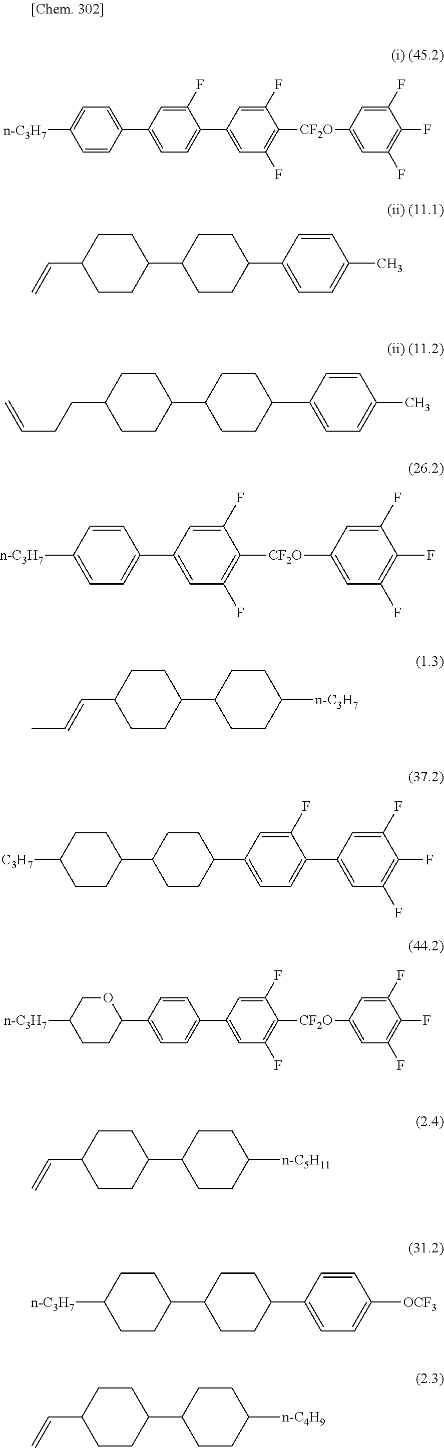

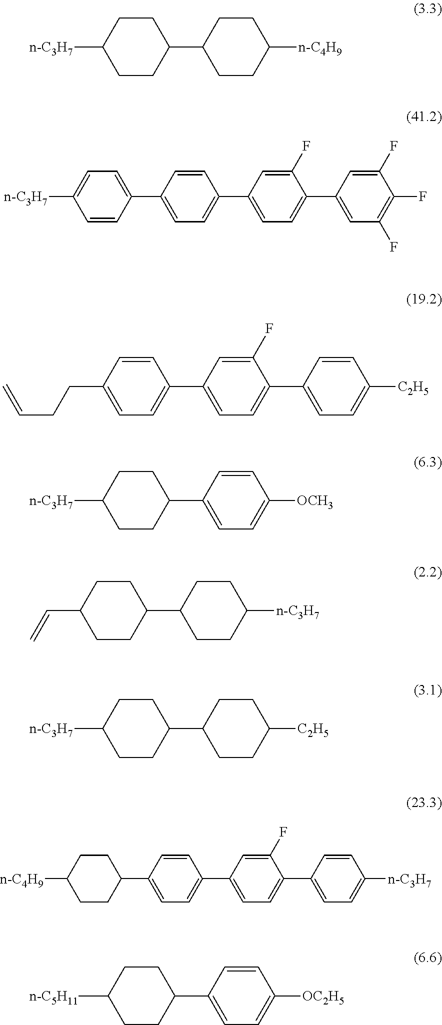

TABLE 23

Ratio (% by mass)

| | Example | Example | Example | Example |
|---|---|---|---|---|
| Formula | 42 | 43 | 44 | 45 |
| (i)45.2 | 5 | 5 | 5 | 5 |
| (ii)11.1 | 17 | 17 | 13 | 13 |
| (ii)11.2 | 9 | 9 | 13 | 13 |
| 26.2 | 9 | 9 | 9 | 9 |
| 1.3 | 8 | 8 | 8 | 13 |
| 37.2 | 7 | 7 | 6 | 6 |
| 44.2 | 4 | 4 | 4 | 4 |
| 2.4 | 10 | 10 | | |
| 31.2 | 3 | 3 | 3 | 3 |
| 2.3 | 11 | | 11 | |
| 3.3 | 4 | 4 | 4 | |
| 41.2 | 1 | 1 | 2 | 2 |
| 19.2 | 1 | 1 | 1 | 2 |
| 6.3 | 11 | 10 | | 6 |
| 2.2 | | 11 | 9 | 15 |
| 3.1 | | | | 4 |
| 23.3 | | 1 | 1 | |
| 6.6 | | | 11 | 5 |

TABLE 24

| | Example | Example | Example | Example |
|---|---|---|---|---|
| | 42 | 43 | 44 | 45 |
| Tni/° C. | 89.9 | 93.3 | 94.8 | 92.8 |
| Δn | 0.105 | 0.106 | 0.111 | 0.109 |
| Δε | 6.7 | 6.7 | 7.2 | 7.1 |
| η/mPa · s | 14 | 13 | 18 | 14 |
| γ₁/mPa · s | 70 | 66 | 70 | 62 |
| Initial voltage holding | 99.5 | 99.5 | 99.4 | 99.4] |
| ratio (%) | | | | |
| Voltage holding ratio (%) | 98.5 | 98.5 | 98.4 | 98.5 |
| after heat resistance test | | | | |
| Burn-in evaluation (h) | 580 | 550 | 540 | 540 |
| Dropping mark | 5 | 5 | 4 | 5 |
| evaluation | | | | |
| Manufacturing device | 220 | 210 | 210 | 220 |
| contamination evaluation | | | | |
| (s) | | | | |
| Process compatibility | 1000 | 890 | 900 | 990 |
| evaluation (×100 times) | | | | |
| Solubility evaluation at a | 600 | 570 | 560 | 590 |
| low temperature (h) | | | | |

### Examples 46 to 49

Compositions shown in Table 25 were prepared using the following compounds, and an IPS liquid crystal display device having the structure shown in FIGS. 1 and 2 was manufactured. Evaluation results of the obtained compositions and liquid crystal display devices are shown in Table 26.

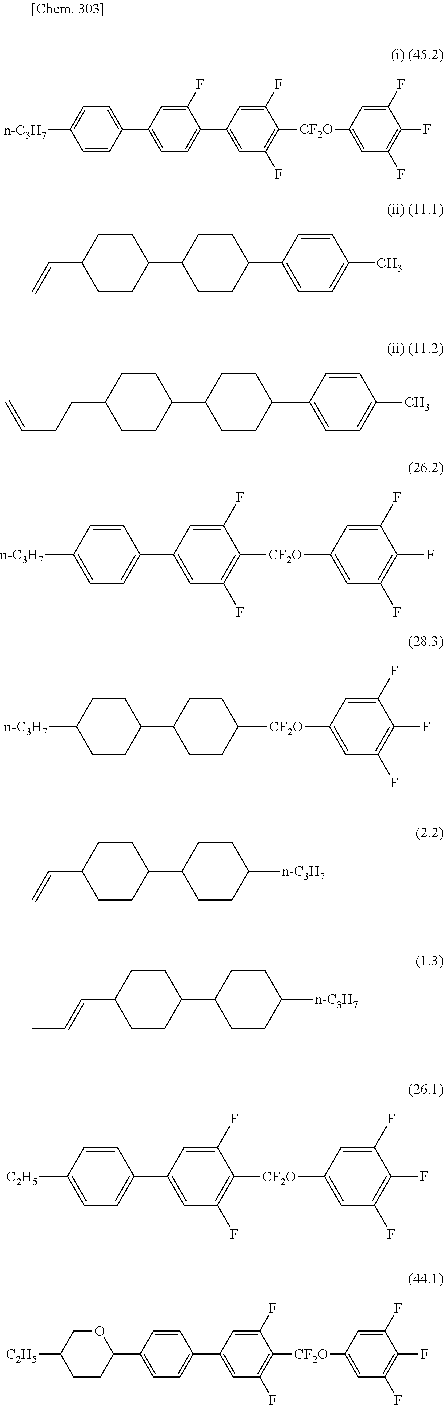

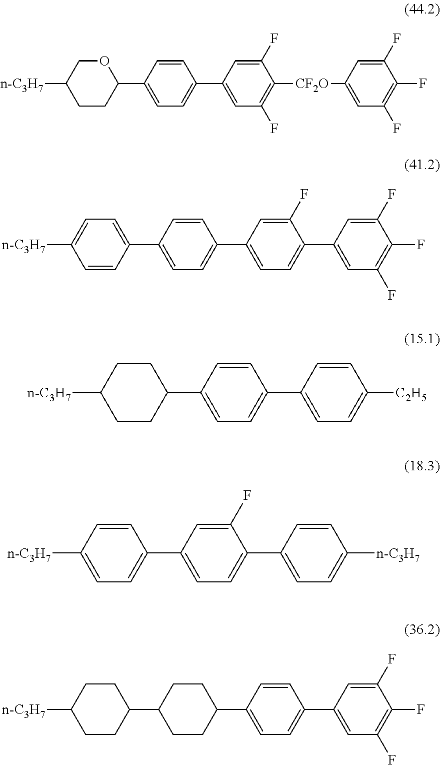

TABLE 25

Ratio (% by mass)

| | Example | Example | Example | Example |
|---|---|---|---|---|
| Formula | 46 | 47 | 48 | 49 |
| (i)45.2 | 2 | 2 | 12 | 8 |
| (ii)11.1 | 16 | | 14 | |
| (ii)11.2 | 14 | 5 | 10 | 17 |
| 26.2 | 12 | 14 | 11 | 9 |
| 28.3 | 7 | 8 | | 6 |
| 2.2 | 28 | 38 | 28 | 15 |
| 1.3 | 9 | 9 | 15 | 22 |
| 26.1 | 2 | | | |
| 44.1 | 3 | 3 | 2 | 5 |
| 44.2 | 6 | 5 | 7 | 4 |
| 41.2 | 1 | 1 | | |
| 15.1 | | 10 | | 7 |
| 18.3 | | 5 | | 6 |
| 36.2 | | | 1 | 1 |

TABLE 26

| | Example | Example | Example | Example |
|---|---|---|---|---|
| | 46 | 47 | 48 | 49 |
| Tni/° C. | 90.0 | 77.9 | 88.0 | 98.8 |
| Δn | 0.105 | 0.109 | 0.111 | 0.121 |
| Δε | 7.0 | 7.6 | 8.2 | 8.0 |
| η/mPa · s | 17 | 14 | 21 | 23 |
| γ₁/mPa · s | 60 | 52 | 84 | 104 |
| Initial voltage holding | 99.6 | 99.5 | 99.5 | 99.6 |
| ratio (%) | | | | |
| Voltage holding ratio (%) | 98.7 | 98.5 | 98.4 | 98.6 |
| after heat resistance test | | | | |
| Burn-in evaluation (h) | 610 | 580 | 570 | 600 |
| Dropping mark | 5 | 4 | 4 | 5 |
| evaluation | | | | |
| Manufacturing device | 210 | 180 | 210 | 210 |
| contamination evaluation | | | | |
| (s) | | | | |
| Process compatibility | 1040 | 985 | 965 | 1000 |
| evaluation (×100 times) | | | | |
| Solubility evaluation at a | 650 | 600 | 500 | 420 |
| low temperature (h) | | | | |

### Examples 50 to 53

Compositions shown in Table 27 were prepared using the following compounds, and an IPS liquid crystal display device having the structure shown in FIGS. 1 and 2 was manufactured. Evaluation results of the obtained compositions and liquid crystal display devices are shown in Table 28.

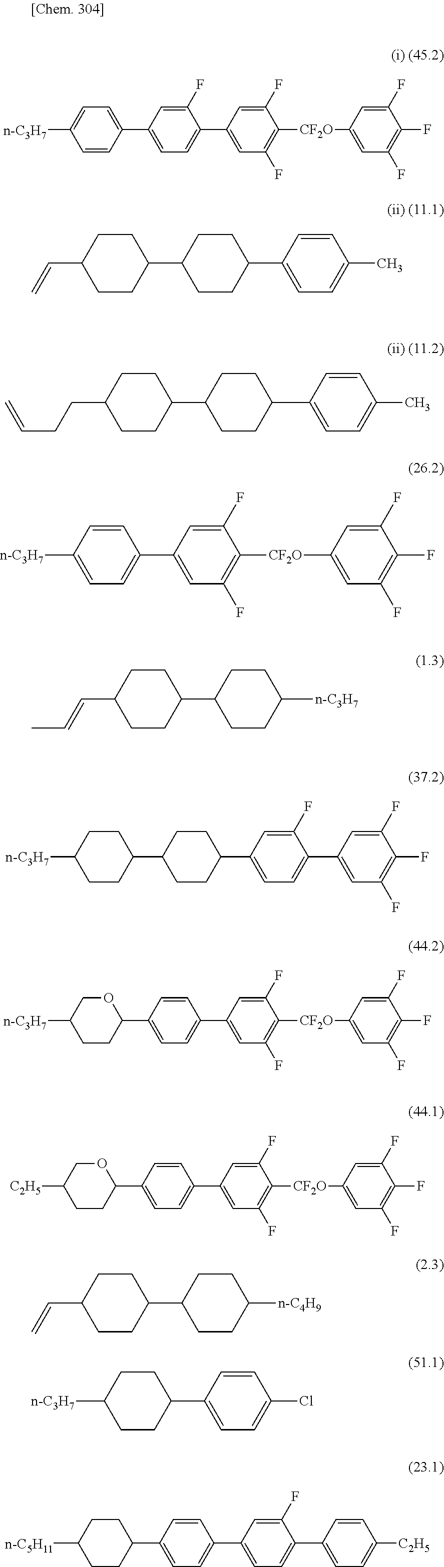

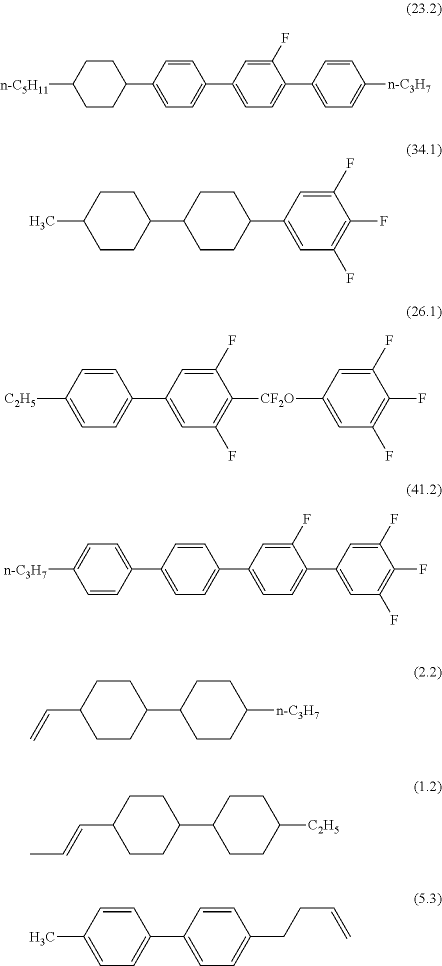

TABLE 27

Ratio (% by mass)

| | Example | Example | Example | Example |
|---|---|---|---|---|
| Formula | 50 | 51 | 52 | 53 |
| (i)45.2 | 4 | 4 | 4 | 4 |
| (ii)11.1 | 14 | 14 | 13 | 10 |
| (ii)11.2 | 13 | 13 | 14 | 13 |
| 26.2 | 14 | 7 | 9 | 14 |
| 1.3 | 8 | 8 | | 12 |
| 37.2 | 2 | 1 | 2 | 2 |
| 44.2 | 6 | 6 | 6 | 6 |
| 44.1 | 4 | 4 | 4 | 4 |
| 2.3 | 16 | | 16 | |
| 51.1 | 8 | 8 | 8 | |
| 23.1 | 3 | 3 | 3 | |
| 23.2 | 3 | 3 | 3 | 6 |
| 34.1 | | | | 8 |
| 26.1 | | 7 | 5 | |
| 41.2 | | 1 | | |
| 2.2 | | 16 | | 16 |
| 1.2 | | | 8 | |
| 5.3 | 5 | 5 | 5 | 5 |

TABLE 28

| | Example | Example | Example | Example |
|---|---|---|---|---|
| | 50 | 51 | 52 | 53 |
| Tni/° C. | 102.8 | 101.6 | 99.0 | 104.8 |
| Δn | 0.123 | 0.124 | 0.121 | 0.118 |
| Δε | 9.8 | 10.1 | 9.9 | 11.2 |
| η/mPa · s | 17 | 15 | 15 | 16 |
| γ₁/mPa · s | 96 | 87 | 84 | 84 |
| Initial voltage holding | 99.4 | 99.6 | 99.6 | 99.4 |
| ratio (%) | | | | |
| Voltage holding ratio (%) | 98.8 | 98.9 | 98.9 | 98.8 |
| after heat resistance test | | | | |
| Burn-in evaluation (h) | 630 | 550 | 620 | 600 |
| Dropping mark | 5 | 4 | 5 | 5 |
| evaluation | | | | |
| Manufacturing device | 210 | 175 | 200 | 200 |
| contamination evaluation | | | | |
| (s) | | | | |
| Process compatibility | 1000 | 860 | 1001 | 1050 |
| evaluation (×100 times) | | | | |
| Solubility evaluation at a | 600 | 550 | 610 | 625 |
| low temperature (h) | | | | |

### Examples 54 to 57

Compositions shown in Table 29 were prepared using the following compounds, and an IPS liquid crystal display device having the structure shown in FIGS. 1 and 2 was manufactured. Evaluation results of the obtained compositions and liquid crystal display devices are shown in Table 30.

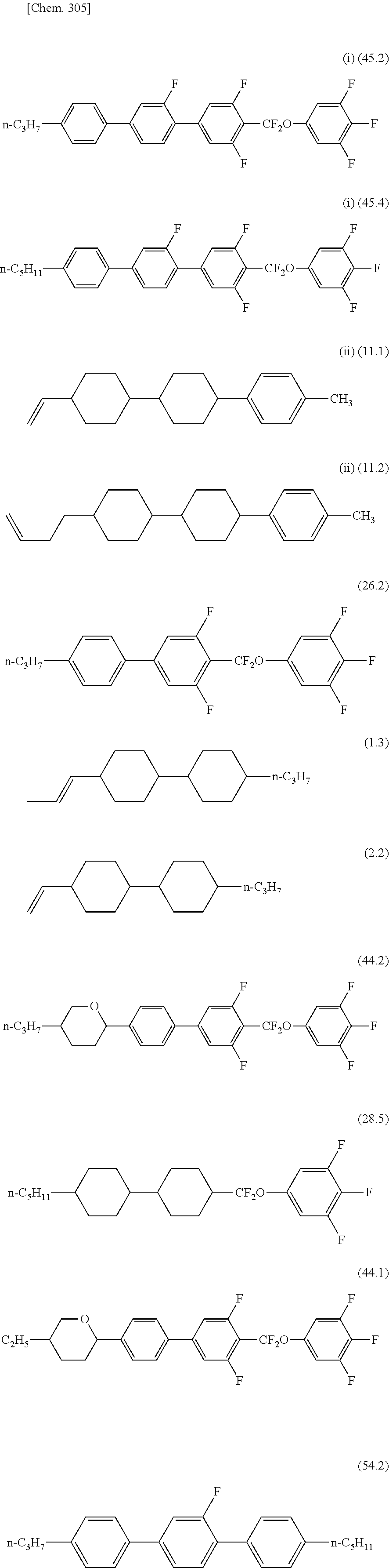

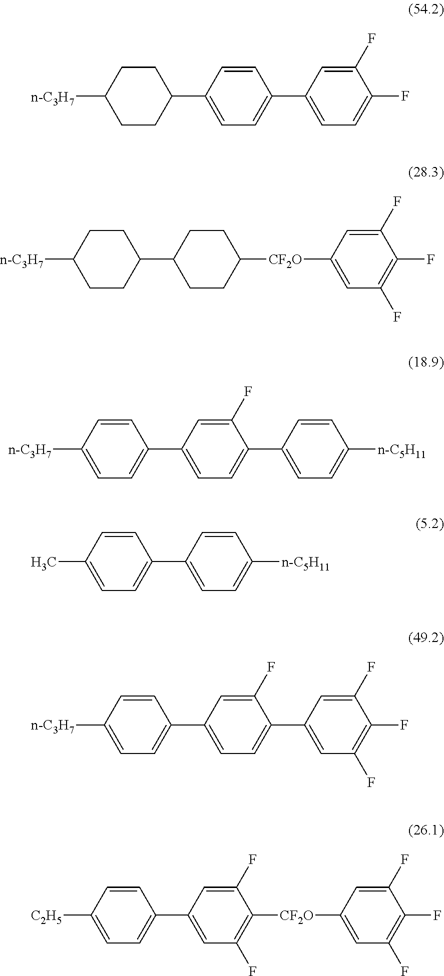

TABLE 29

Ratio (% by mass)

| | Example | Example | Example | Example |
|---|---|---|---|---|
| Formula | 54 | 55 | 56 | 57 |
| (i)45.2 | 5 | | 5 | |
| (i)45.4 | | 5 | | 5 |
| (ii)11.1 | 16 | 8 | 10 | 16 |
| (ii)11.2 | 8 | 8 | 14 | 8 |
| 26.2 | 12 | 6 | 12 | 6 |
| 1.3 | 7 | 7 | | 12 |
| 2.2 | 25 | 25 | 25 | 20 |
| 44.2 | 5 | 5 | 8 | 5 |
| 28.5 | 4 | 4 | 4 | 4 |
| 44.1 | 3 | 3 | | 3 |
| 54.2 | 5 | 5 | 5 | |
| 28.3 | 10 | 10 | 10 | 10 |
| 18.9 | | 8 | | |
| 5.2 | | | 7 | |
| 49.2 | | | | 5 |
| 26.1 | | 6 | | 6 |

TABLE 30

| | Example | Example | Example | Example |
|---|---|---|---|---|
| | 54 | 55 | 56 | 57 |
| Tni/° C. | 85.3 | 81.6 | 79.6 | 79.8 |
| Δn | 0.105 | 0.115 | 0.111 | 0.107 |
| Δε | 9.3 | 9.7 | 9.8 | 9.8 |
| η/mPa · s | 16 | 20 | 18 | 18 |
| γ₁/mPa · s | 87 | 99 | 95 | 108 |
| Initial voltage holding | 99.5 | 99.5 | 99.5 | 99.5 |
| ratio (%) | | | | |
| Voltage holding ratio (%) | 98.6 | 98.4 | 98.2 | 98.1 |
| after heat resistance test | | | | |
| Burn-in evaluation (h) | 630 | 580 | 450 | 440 |
| Dropping mark | 5 | 4 | 4 | 4 |
| evaluation | | | | |
| Manufacturing device | 220 | 200 | 180 | 175 |
| contamination evaluation | | | | |
| (s) | | | | |
| Process compatibility | 1020 | 990 | 860 | 850 |
| evaluation (×100 times) | | | | |
| Solubility evaluation at a | 660 | 600 | 480 | 460 |
| low temperature (h) | | | | |

### Examples 58 to 61

Compositions shown in Table 31 were prepared using the following compounds, and an IPS liquid crystal display device having the structure shown in FIGS. 1 and 2 was manufactured. Evaluation results of the obtained compositions and liquid crystal display devices are shown in Table 32.

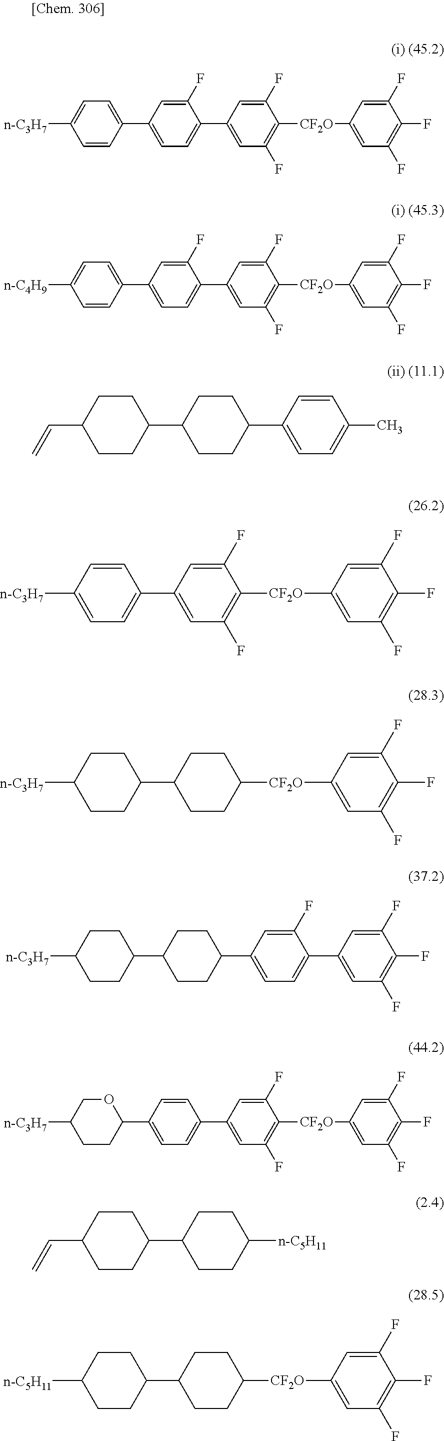

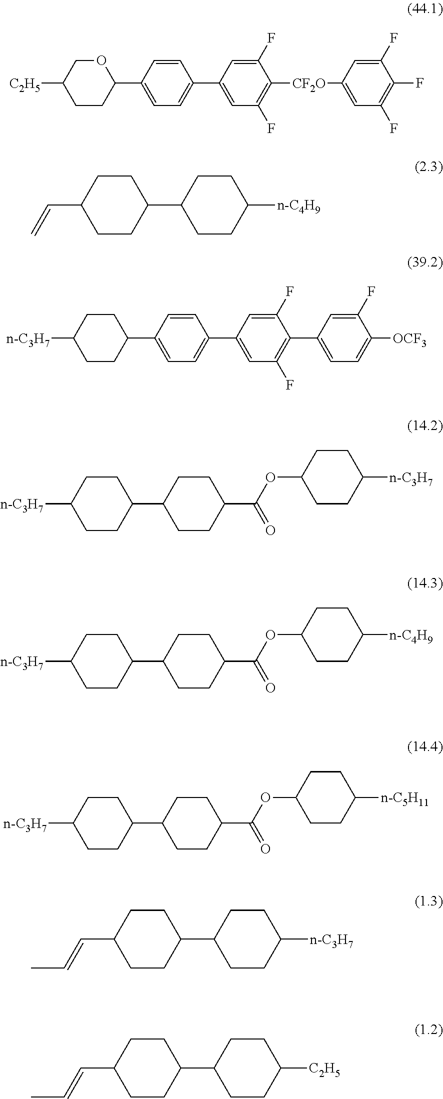

TABLE 31

Ratio (% by mass)

| | Example | Example | Example | Example |
|---|---|---|---|---|
| Formula | 58 | 59 | 60 | 61 |
| (i)45.2 | 7 | 7 | 7 | |
| (i)45.3 | | | | 7 |
| (ii)11.1 | 8 | 8 | 8 | 8 |
| 26.2 | 15 | 15 | 14 | 13 |
| 28.3 | 7 | 7 | 8 | 7 |
| 37.2 | 3 | 3 | 3 | 3 |
| 44.2 | 8 | 8 | 8 | 8 |
| 2.4 | 6 | 6 | 6 | |
| 28.5 | 8 | 8 | 8 | 8 |
| 44.1 | 7 | 7 | 7 | 8 |
| 2.3 | 22 | | 10 | 22 |
| 39.2 | 6 | 6 | 6 | 6 |
| 14.2 | 3 | | | 3 |
| 14.3 | | 3 | | |
| 14.4 | | | 3 | |
| 1.3 | | | 12 | |
| 1.2 | | 22 | | 6 |

TABLE 32

| | Example | Example | Example | Example |
|---|---|---|---|---|
| | 58 | 59 | 60 | 61 |
| Tni/° C. | 94.8 | 100.3 | 102.5 | 97.8 |
| Δn | 0.121 | 0.121 | 0.124 | 0.120 |
| Δε | 17.1 | 16.8 | 16.4 | 16.5 |
| η/mPa · s | 35 | 29 | 35 | 34 |
| γ₁/mPa · s | 190 | 128 | 199 | 177 |
| Initial voltage holding | 99.2 | 99.1 | 99.0 | 99.1 |
| ratio (%) | | | | |
| Voltage holding ratio (%) | 98.0 | 97.9 | 97.9 | 97.9 |
| after heat resistance test | | | | |
| Burn-in evaluation (h) | 355 | 256 | 279 | 310 |
| Dropping mark | 5 | 4 | 5 | 4 |
| evaluation | | | | |
| Manufacturing device | 240 | 235 | 220 | 223 |
| contamination evaluation | | | | |
| (s) | | | | |
| Process compatibility | 856 | 810 | 750 | 900 |
| evaluation (×100 times) | | | | |
| Solubility evaluation at a | 580 | 550 | 520 | 580 |
| low temperature (h) | | | | |

### Examples 62 to 65

Compositions shown in Table 33 were prepared using the following compounds, and an IPS liquid crystal display device having the structure shown in FIGS. 1 and 2 was manufactured. Evaluation results of the obtained compositions and liquid crystal display devices are shown in Table 34.

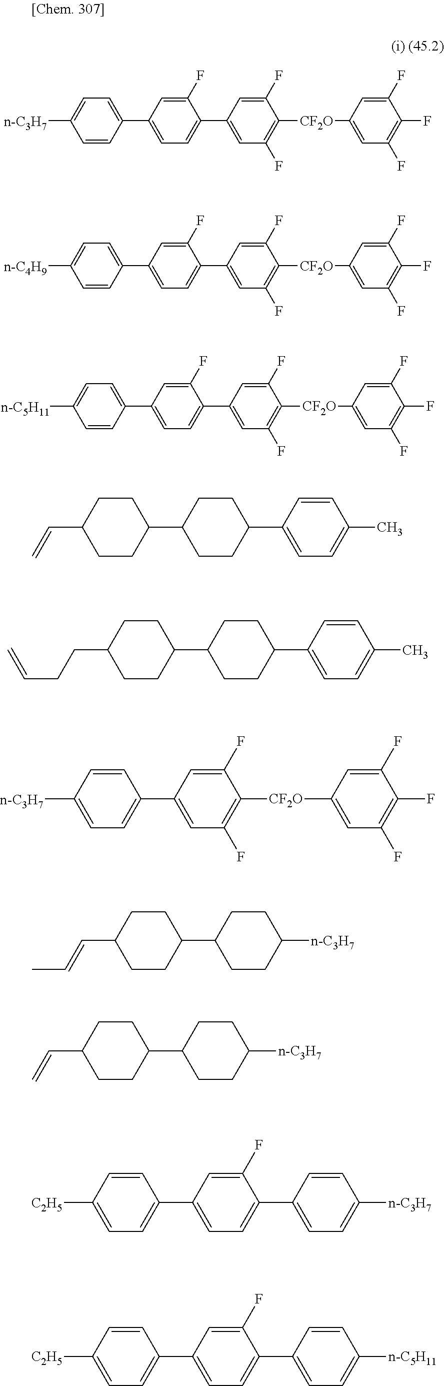

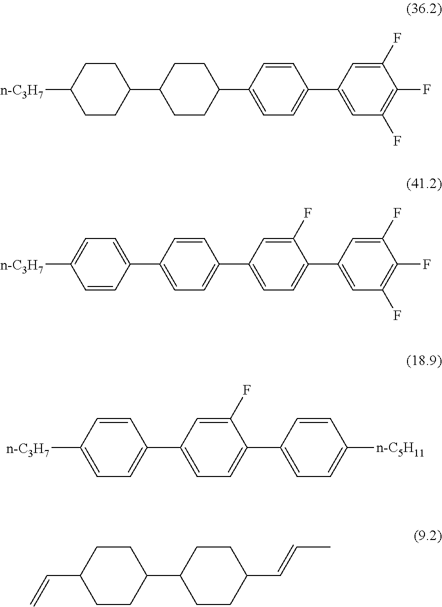

TABLE 33

Ratio (% by mass)

| | Example | Example | Example | Example |
|---|---|---|---|---|
| Formula | 62 | 63 | 64 | 65 |
| (i)45.2 | | | 4 | |
| (i)45.3 | 4 | 4 | | |
| (i)45.4 | | | | 4 |
| (ii)11.1 | 11 | 11 | | 6 |
| (ii)11.2 | | | 11 | 5 |
| 26.2 | 9 | 9 | 9 | 9 |
| 1.3 | 7 | 7 | 4 | |
| 2.2 | 41 | 35 | 44 | 44 |
| 18.1 | 11 | 11 | 11 | 7 |
| 18.6 | 11 | | 11 | 7 |
| 36.2 | 6 | 6 | | |
| 41.2 | | | 6 | 6 |
| 18.9 | | 11 | | 8 |
| 9.2 | | 6 | | 4 |

TABLE 34

| | Example | Example | Example | Example |
|---|---|---|---|---|
| | 62 | 63 | 64 | 65 |
| Tni/° C. | 80.8 | 82.7 | 73.6 | 74.0 |
| Δn | 0.116 | 0.119 | 0.120 | 0.123 |
| Δε | 4.3 | 4.3 | 5.1 | 4.8 |
| η/mPa · s | 12 | 13 | 13 | 14 |
| γ₁/mPa · s | 45 | 48 | 48 | 48 |
| Initial voltage holding | 99.4 | 99.4 | 99.6 | 99.4 |
| ratio (%) | | | | |
| Voltage holding ratio (%) | 98.8 | 98.2 | 98.5 | 98.5 |
| after heat resistance test | | | | |
| Burn-in evaluation (h) | 600 | 300 | 450 | 450 |
| Dropping mark | 5 | 3 | 4 | 4 |
| evaluation | | | | |
| Manufacturing device | 180 | 180 | 150 | 150 |
| contamination evaluation | | | | |
| (s) | | | | |
| Process compatibility | 1010 | 860 | 850 | 1000 |
| evaluation (×100 times) | | | | |
| Solubility evaluation at a | 610 | 480 | 560 | 580 |
| low temperature (h) | | | | |

### Examples 66 to 69

Compositions shown in Table 35 were prepared using the following compounds, and an IPS liquid crystal display device having the structure shown in FIGS. 1 and 2 was manufactured. Evaluation results of the obtained compositions and liquid crystal display devices are shown in Table 36.

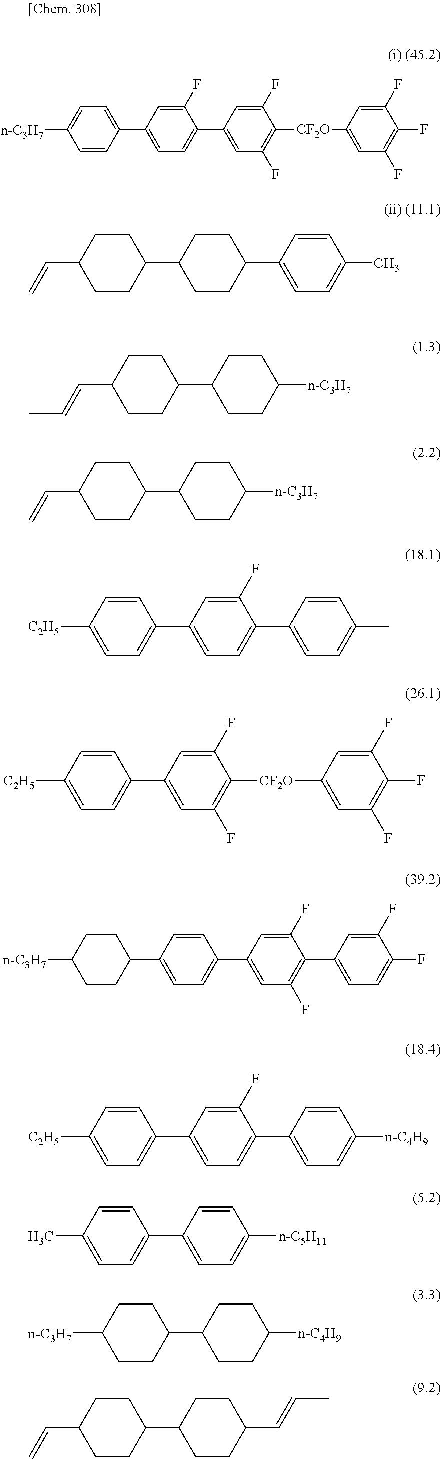

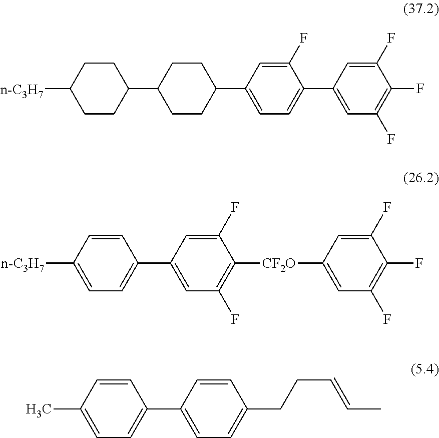

TABLE 35

Ratio (% by mass)

| | Example | Example | Example | Example |
|---|---|---|---|---|
| Formula | 66 | 67 | 68 | 69 |
| (i)45.2 | 5 | 5 | 5 | 5 |
| (ii)11.1 | 8 | 8 | 8 | 8 |
| 1.3 | 15 | 14 | 10 | 10 |
| 2.2 | 34 | 35 | 30 | 30 |
| 18.1 | 8 | 8 | 8 | 8 |
| 26.1 | 5 | | | 5 |
| 39.2 | 5 | | | |
| 18.4 | 10 | 10 | 10 | 10 |
| 5.2 | 10 | 5 | 5 | 5 |
| 3.3 | | | 5 | 5 |
| 9.2 | | | 4 | 4 |
| 37.2 | | 5 | 5 | 5 |
| 26.2 | | 5 | 5 | |
| 5.4 | | 5 | 5 | 5 |

TABLE 36

| | Example | Example | Example | Example |
|---|---|---|---|---|
| | 66 | 67 | 68 | 69 |
| Tni/° C. | 75.3 | 80.1 | 79.9 | 78.1 |
| Δn | 0.121 | 0.120 | 0.120 | 0.120 |
| Δε | 3.9 | 3.9 | 3.8 | 3.8 |
| η/mPa · s | 12 | 11 | 12 | 11 |
| γ₁/mPa · s | 41 | 39 | 40 | 41 |
| Initial voltage holding | 99.4 | 99.4 | 99.6 | 99.4 |
| ratio (%) | | | | |
| Voltage holding ratio (%) | 98.8 | 98.8 | 98.9 | 98.8 |
| after heat resistance test | | | | |
| Burn-in evaluation (h) | 625 | 450 | 450 | 575 |
| Dropping mark | 5 | 3 | 4 | 5 |
| evaluation | | | | |
| Manufacturing device | 200 | 175 | 180 | 195 |
| contamination evaluation | | | | |
| (s) | | | | |
| Process compatibility | 1100 | 775 | 800 | 990 |
| evaluation (×100 times) | | | | |
| Solubility evaluation at a | 620 | 490 | 550 | 610 |
| low temperature (h) | | | | |

### Examples 70 to 73

Compositions shown in Table 35 were prepared using the following compounds, and an IPS liquid crystal display device having the structure shown in FIGS. 1 and 2 was manufactured. Evaluation results of the obtained compositions and liquid crystal display devices are shown in Table 36.

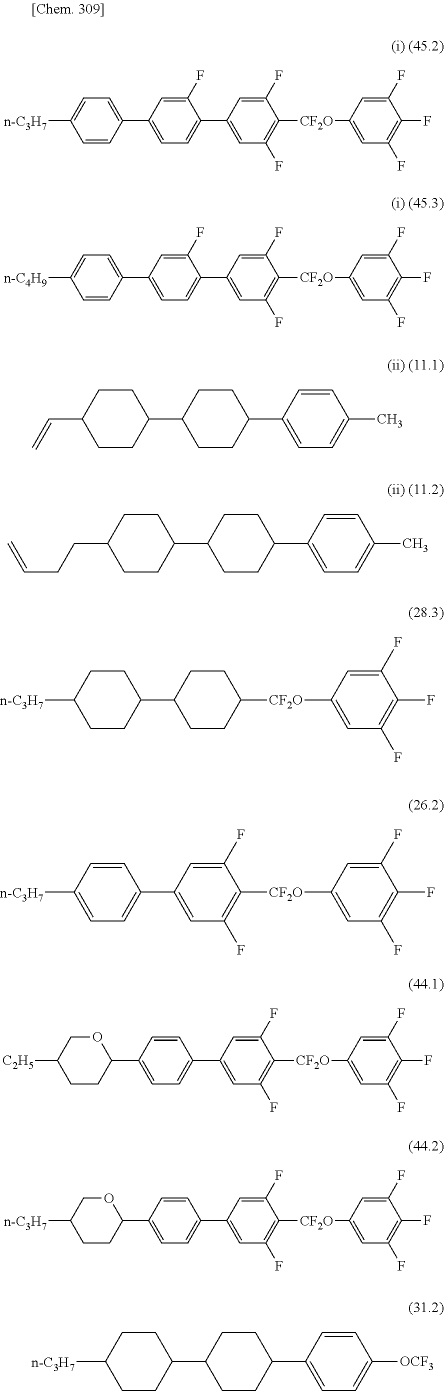

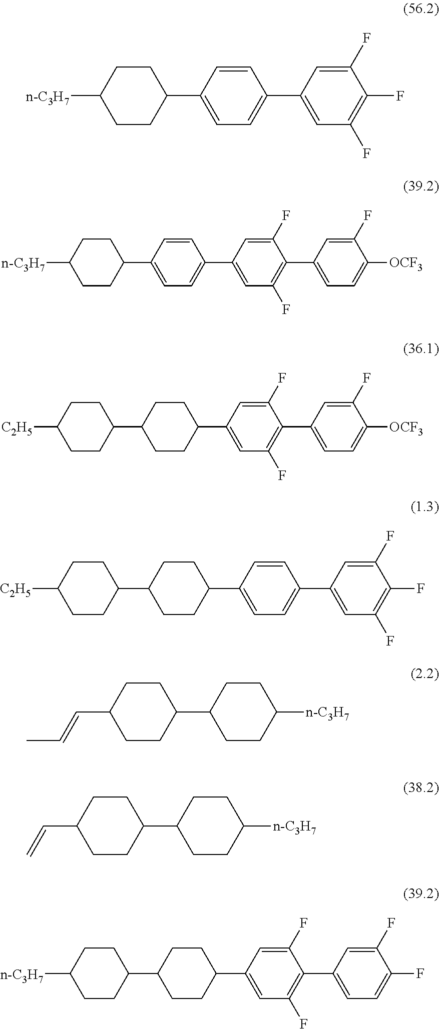

TABLE 37

Ratio (% by mass)

| | Example | Example | Example | Example |
|---|---|---|---|---|
| Formula | 70 | 71 | 72 | 73 |
| (i)45.2 | 4 | | | 5 |
| (i)45.3 | | 5 | 4 | |
| (ii)11.1 | 5 | 5 | 5 | 2 |
| (ii)11.2 | | 8 | 2 | 4 |
| 28.3 | 2 | 3 | 2 | |
| 26.2 | 8 | 6 | 8 | 10 |
| 44.1 | 4 | 3 | 4 | 3 |
| 44.2 | 4 | 3 | 4 | 5 |
| 31.2 | 6 | 7 | | |
| 56.2 | | | 6 | 5 |
| 39.2 | 6 | 7 | 3 | 4 |
| 36.1 | | | 3 | 4 |
| 1.3 | 17 | 10 | 11 | 12 |
| 2.2 | 39 | 37 | 43 | 40 |
| 38.2 | 5 | 6 | 5 | 6 |

TABLE 38

| | Example | Example | Example | Example |
|---|---|---|---|---|
| | 70 | 71 | 72 | 73 |
| Tni/° C. | 85.3 | 95.1 | 82.1 | 81.5 |
| Δn | 0.099 | 0.102 | 0.100 | 0.103 |
| Δε | 8.5 | 8.1 | 8.9 | 10.1 |
| η/mPa · s | 15 | 17 | 14 | 15 |
| γ₁/mPa · s | 83 | 92 | 90 | 95 |
| Initial voltage holding | 99.6 | 99.5 | 99.5 | 99.2 |
| ratio (%) | | | | |
| Voltage holding ratio (%) | 98.6 | 98.3 | 98.1 | 98.0 |
| after heat resistance test | | | | |
| Burn-in evaluation (h) | 625 | 590 | 540 | 530 |
| Dropping mark | 5 | 4 | 4 | 4 |
| evaluation | | | | |
| Manufacturing device | 210 | 190 | 170 | 165 |
| contamination evaluation | | | | |
| (s) | | | | |
| Process compatibility | 1050 | 990 | 840 | 760 |
| evaluation (×100 times) | | | | |
| Solubility evaluation at a | 640 | 550 | 460 | 450 |
| low temperature (h) | | | | |

In the liquid crystal composition having positive dielectric anisotropy of the present invention, the solubility at a low temperature is good, and changes in the specific resistance and the voltage holding ratio due to heat and light are extremely small, and therefore, practicability of the product is high, and the liquid crystal display element including the composition can achieve high speed response performance. In addition, since dropping of the liquid crystal composition can be stably continued in the liquid crystal display element manufacturing step, display defects due to the step can be suppressed, the liquid crystal display element can be manufactured with a high yield, and therefore the liquid crystal composition is very useful.

### INDUSTRIAL APPLICABILITY

In the liquid crystal composition having positive dielectric anisotropy of the present invention, the solubility at a low temperature is good, and changes in the specific resistance and the voltage holding ratio due to heat and light are extremely small, and therefore, practicability of the product is high, and the liquid crystal display element including the composition can achieve high speed response performance. In addition, since dropping of the liquid crystal composition can be stably continued in the liquid crystal display element manufacturing step, display defects due to the step can be suppressed, the liquid crystal display element can be manufactured with a high yield, and therefore the liquid crystal composition is very useful.

### REFERENCE SIGNS LIST

100 FIRST SUBSTRATE
102 TFT LAYER
103 PIXEL ELECTRODE
104 PASSIVATION LAYER
105 FIRST ALIGNMENT FILM
200 SECOND SUBSTRATE
201 PLANARIZATION FILM
202 BLACK MATRIX
203 COLOR FILTER
204 TRANSPARENT ELECTRODE
205 SECOND ALIGNMENT FILM
301 SEAL MATERIAL
302 PROJECTION (POST SPACER)
303 LIQUID CRYSTAL LAYER
304 PROJECTION (POST SPACER)
401 MASK PATTERN
402 RESIN LAYER

1. A liquid crystal composition, comprising:
at least one compound represented by General Formula (i); and
at least one compound represented by General Formula (ii), 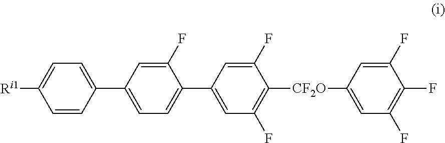
wherein Rⁱ¹ represents an alkyl group having 2 to 5 carbon atoms, and 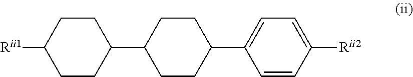
Rⁱⁱ¹ represents an alkenyl group having 2 to 5 carbon atoms, and Rⁱⁱ² represents an alkyl group having 1 to 5 carbon atoms or an alkoxy group having 1 to 4 carbon atoms.

2. The liquid crystal composition according to claim 1, comprising:
at least one compound represented by General Formula (L),
R^{L1}—B^{L1}-L^{L1}-B^{L2}-(L^{L2}-B^{L3})_{OL}—R^{L2} (L)
wherein each of R^{L1} and R^{L2} independently represents an alkyl group having 1 to 8 carbon atoms, each of one —CH₂— group or two or more non-adjacent —CH₂— groups in the alkyl group may be independently substituted with —CH═CH—, —O—, —CO—, —COO—, or —OCO—,
OL represents 0, 1, 2, or 3,
each of B^{L1}, B^{L2}, and B^{L3} independently represents a group selected from the group consisting of
(a) a 1,4-cyclohexylene group (one —CH₂— group or two or more non-adjacent —CH₂— groups present in the group may be substituted with —O—) and
(b) a 1,4-phenylene group (one —CH═ group or two or more non-adjacent —CH═ groups present in the group may be substituted with —N═), each of the groups (a) and (b) may be independently substituted with a cyano group, a fluorine atom, or a chlorine atom,
each of L^{L1} and L^{L2} independently represents a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or
in a case where a plurality of L^{L2}'s are present since OL is 2 or 3, L^{L2}'s may be the same as or different from each other, and in a case where a plurality of B^{L3}'s are present since OL is 2 or 3, B^{L3}'s may be the same as or different from each other, provided that a compound selected from the group represented by General Formula (ii) is excluded.

3. The liquid crystal composition according to claim 1, comprising:
at least one compound represented by General Formula (M), 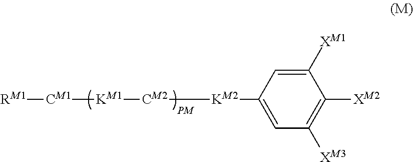
wherein R^{M1} represents an alkyl group having 1 to 8 carbon atoms, each of one —CH₂— group or two or more non-adjacent —CH₂— groups in the alkyl group may be independently substituted with —CH═CH—, —O—, —CO—, —COO—, or —OCO—,
PM represents 0, 1, 2, 3, or 4,
each of C^{M1} and C^{M2} independently represents a group selected from the group consisting of
(d) a 1,4-cyclohexylene group (one —CH₂— group or two or more non-adjacent —CH₂— groups present in the group may be substituted with —O— or —S—) and
(e) a 1,4-phenylene group (one —CH═ group or two or more non-adjacent —CH═ groups present in the group may be substituted with —N═), each of the groups (d) and (e) may be independently substituted with a cyano group, a fluorine atom, or a chlorine atom,
each of K^{M1} and K^{M2} independently represents a single bond, —CH₂CH₂—, —(CH₂)₄—, —OCH₂—, —CH₂O—, —OCF₂—, —CF₂O—, —COO—, —OCO—, or
in a case where a plurality of K^{M1}'s are present since PM is 2, 3, or 4, K^{M1}'s may be the same as or different from each other, and in a case where a plurality of C^{M2}'s are present since PM is 2, 3, or 4, C^{M2}'s may be the same as or different from each other,
each of X^{M1} and X^{M3} independently represents a hydrogen atom, a chlorine atom, or a fluorine atom, and
X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group, provided that a compound represented by General Formula (i) is excluded.

4. The liquid crystal composition according to claim 3, comprising:
at least one compound represented by General Formula (IX-2-2) as the compound represented by General Formula (M), 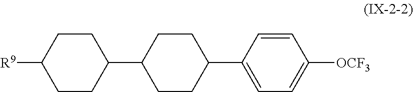
wherein R⁹ represents an alkyl group having 1 to 5 carbon atoms or an alkenyl group having 2 to 5 carbon atoms.

5. The liquid crystal composition according to claim 4, comprising:
a compound represented by Formula (31.2) and/or Formula (31.4) as the compound represented by General Formula (IX-2-2):

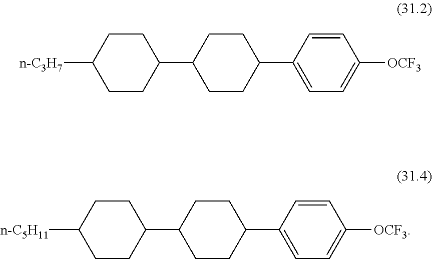

6. The liquid crystal composition according to claim 3, comprising:
at least one compound represented by General Formula (X-1-2) as the compound represented by General Formula (M), 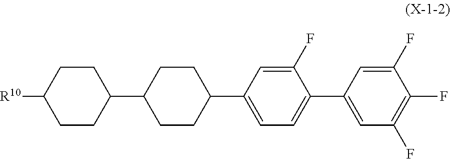
wherein R¹⁰ represents an alkyl group having 1 to 5 carbon atoms, an alkenyl group having 2 to 5 carbon atoms, or an alkoxy group having 1 to 4 carbon atoms.

7. The liquid crystal composition according to claim 6, comprising:
at least one compound represented by Formula (37.2) as the compound represented by General Formula (X-1-2):

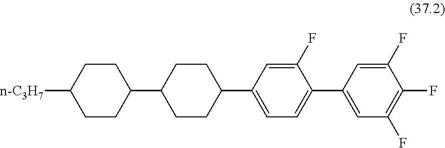

8. The liquid crystal composition according to claim 3, comprising:
at least one compound represented by General Formula (X-2-1) as the compound represented by General Formula (M), 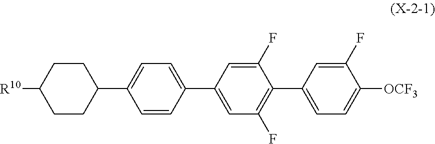
wherein R¹⁰ represents an alkyl group having 1 to 5 carbon atoms, an alkenyl group having 2 to 5 carbon atoms, or an alkoxy group having 1 to 4 carbon atoms.

9. The liquid crystal composition according to claim 8, further comprising:
at least one compound represented by Formula (39.2) as the compound represented by General Formula (X-2-1):

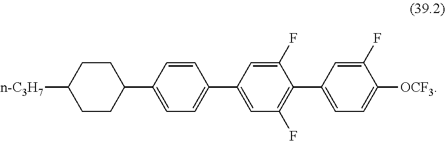

10. The liquid crystal composition according to claim 2, comprising:
at least one compound represented by General Formula (IV-2) as General Formula (L), 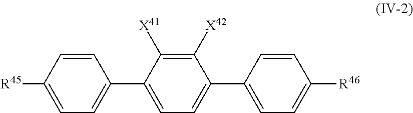
wherein each of R⁴⁵ and R⁴⁶ independently represents an alkyl group having 1 to 5 carbon atoms or an alkenyl group having 2 to 5 carbon atoms, provided that at least one thereof represents an alkenyl group having 2 to 5 carbon atoms, and each of X⁴¹ and X⁴² independently represents a hydrogen atom or a fluorine atom.

11. The liquid crystal composition according to claim 10, comprising:
at least one compound represented by Formula (19.1), (19.2), (19.3), or (19.4) as the compound represented by General Formula (IV-2):

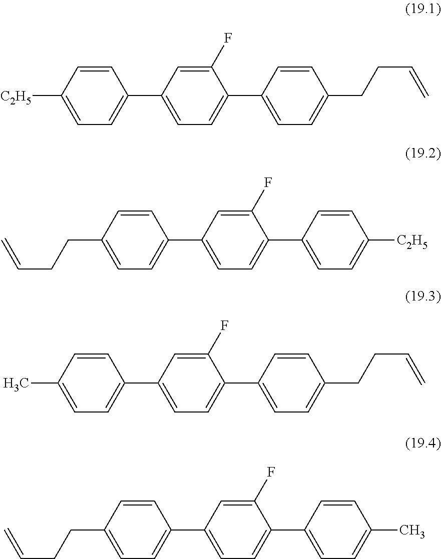

12. The liquid crystal composition according to claim 3, comprising:
at least one compound represented by General Formula (XI-1) as General Formula (M), 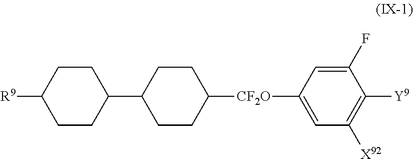
wherein R⁹ represents an alkyl group having 1 to 5 carbon atoms, an alkenyl group having 2 to 5 carbon atoms, or an alkoxy having 1 to 4 carbon atoms, X⁹² represents a hydrogen atom or a fluorine atom, and Y⁹ represents a fluorine atom or —OCF₃.

13. The liquid crystal composition according to claim 12, comprising:
a compound represented by Formula (28.5) as the compound represented by General Formula (XI-1):

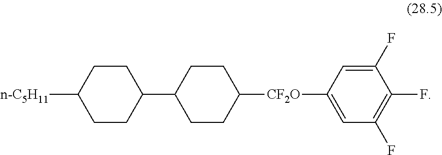

14. The liquid crystal composition according to claim 12, comprising:
15% by mass or greater of a compound represented by Formula (28.3) as the compound represented by General Formula (XI-1):

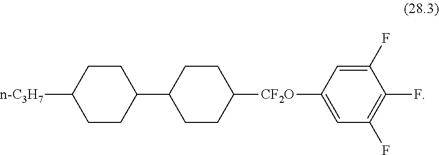

15. The liquid crystal composition according to claim 2, comprising:
at least one compound represented by General Formula (I-5) as General Formula (L), 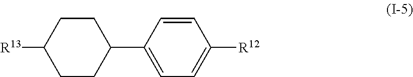
wherein R¹³ represents an alkyl group having 1 to 5 carbon atoms, an alkenyl group having 2 to 5 carbon atoms, or an alkoxy group having 1 to 4 carbon atoms, and R¹² represents an alkyl group having 1 to 5 carbon atoms, an alkenyl group having 2 to 5 carbon atoms, or an alkoxy group having 1 to 4 carbon atoms.

16. The liquid crystal composition according to claim 15, comprising:
a compound represented by Formula (6.3) and/or (6.6) as the compound represented by General Formula (1-5):

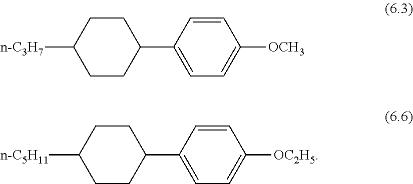

17. The liquid crystal composition according to claim 2, comprising:
at least one compound represented by General Formula (I-7) as General Formula (L), 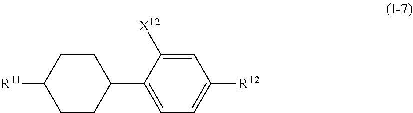
wherein R¹¹ represents an alkyl group having 1 to 5 carbon atoms, an alkenyl group having 2 to 5 carbon atoms, or an alkoxy group having 1 to 4 carbon atoms, R¹² represents an alkyl group having 1 to 5 carbon atoms, an alkenyl group having 2 to 5 carbon atoms, or an alkoxy group having 1 to 4 carbon atoms, and X¹² represents a fluorine atom or a chlorine atom.

18. The liquid crystal composition according to claim 17, comprising:
a compound represented by Formula (8.1) as the compound represented by General Formula (I-7):

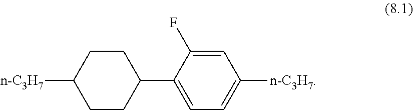

19. The liquid crystal composition according to claim 2, comprising:
at least one compound represented by General Formula (I-4) as General Formula (L), 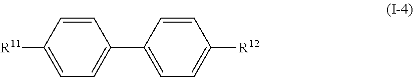
wherein each of R¹¹ and R¹² independently represents an alkyl group having 1 to 5 carbon atoms, an alkenyl group having 2 to 5 carbon atoms, or an alkoxy group having 1 to 4 carbon atoms.

20. The liquid crystal composition according to claim 19, comprising:
a compound represented by Formula (5.2) and/or Formula (5.3) as the compound represented by General Formula (I-4):

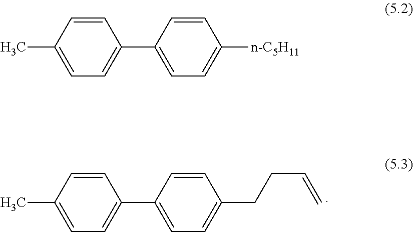

21. The liquid crystal composition according to claim 3, comprising:
at least one compound represented by General Formula (XIV-2-2) as General Formula (M), 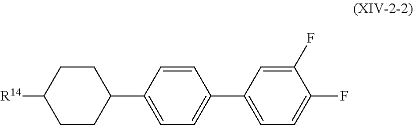
wherein R¹⁴ represents an alkyl group having 1 to 5 carbon atoms, an alkenyl group having 2 to 5 carbon atoms, or an alkoxy group having 1 to 4 carbon atoms.

22. The liquid crystal composition according to claim 21, comprising:
a compound represented by Formula (54.2) as the compound represented by General Formula (XIV-2-2):

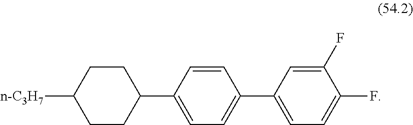

23. The liquid crystal composition according to claim 22, comprising:
0.5% by mass or greater and less than 5% by mass of a compound represented by Formula (54.1) as the compound represented by General Formula (XIV-2-2):

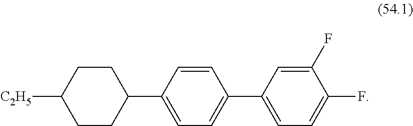

24. The liquid crystal composition according to claim 3, comprising:
at least one compound represented by General Formula (X-1-3) as General Formula (M), 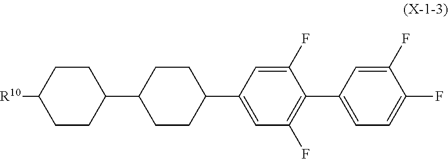
wherein R¹⁰ represents an alkyl group having 1 to 5 carbon atoms, an alkenyl group having 2 to 5 carbon atoms, or an alkoxy group having 1 to 4 carbon atoms.

25. The liquid crystal composition according to claim 24, comprising:
a compound represented by Formula (38.2) as the compound represented by General Formula (X-1-3):

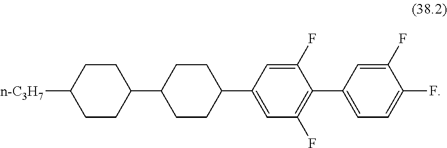

26. The liquid crystal composition according to claim 2, comprising:
14% by mass or greater of at least one compound represented by General Formula (I-1-1) as General Formula (L), 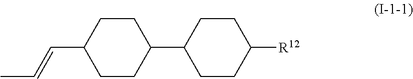
wherein R¹² each independently represents an alkyl group having 1 to 5 carbon atoms, an alkenyl group having 2 to 5 carbon atoms, or an alkoxy group having 1 to 4 carbon atoms.

27. The liquid crystal composition according to claim 26, comprising:
14% by mass or greater of a compound represented by Formula (1.3) as the compound represented by General Formula (I-1-1):

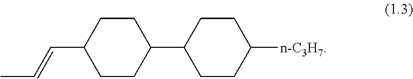

28. The liquid crystal composition according to claim 2, comprising:
9% by mass or greater of at least one compound represented by General Formula (II-2) as General Formula (L), 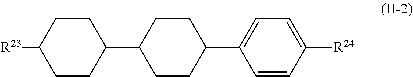
wherein R²³ represents an alkenyl group having 2 to 5 carbon atoms, and R²⁴ represents an alkyl group having 1 to 5 carbon atoms or an alkoxy group having 1 to 4 carbon atoms.

29. The liquid crystal composition according to claim 28, comprising:
9% by mass or greater of a compound represented by Formula (11.2) as the compound represented by General Formula (II-2):

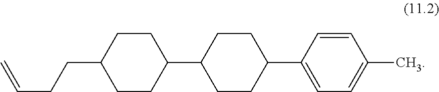

30. The liquid crystal composition according to claim 2, comprising:
9% by mass or greater of at least one compound represented by General Formula (I-1-2) as General Formula (L), 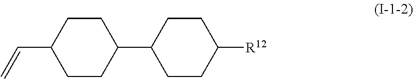
wherein R¹² represents an alkyl group having 1 to 5 carbon atoms, an alkenyl group having 2 to 5 carbon atoms, or an alkoxy group having 2 to 5 carbon atoms.

31. The liquid crystal composition according to claim 30, comprising:
9% by mass or greater of a compound represented by Formula (2.4) as the compound represented by General Formula (I-1-2):

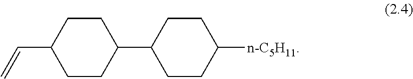

32. The liquid crystal composition according to claim 3, comprising:
0.5% by mass or greater and less than 2% by mass of at least one compound represented by General Formula (X-3-1) as General Formula (M), 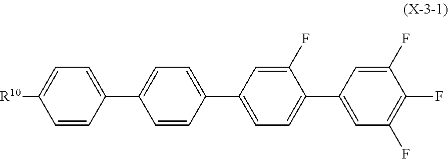
wherein R¹⁰ represents an alkyl group having 1 to 5 carbon atoms, an alkenyl group having 2 to 5 carbon atoms, or an alkoxy group having 1 to 4 carbon atoms.

33. The liquid crystal composition according to claim 32, comprising:
0.5% by mass or greater and less than 2% by mass of a compound represented by Formula (41.2) as the compound represented by General Formula (X-3-1):

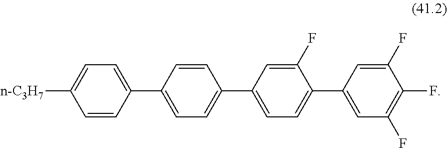

34. The liquid crystal composition according to claim 3, comprising:
0.5% by mass or greater and less than 5% by mass of at least one compound represented by General Formula (VIII-1) as General Formula (M), 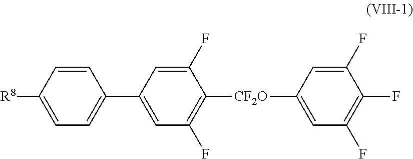
wherein R⁸ represents an alkyl group having 1 to 5 carbon atoms, an alkenyl group having 2 to 5 carbon atoms, or an alkoxy group having 1 to 4 carbon atoms.

35. The liquid crystal composition according to claim 34, comprising:
0.5% by mass or greater and less than 5% by mass of a compound represented by Formula (26.1) as the compound represented by General Formula (VIII-1):

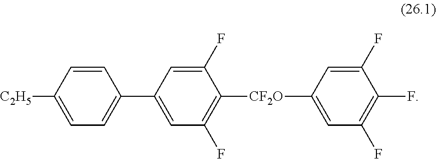

36. The liquid crystal composition according to claim 2, comprising:
7% by mass or greater of at least one compound represented by General Formula (IV-1) as General Formula (L), 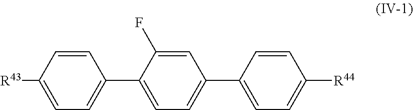
wherein each of R⁴³ and R⁴⁴ independently represents an alkyl group having 1 to 5 carbon atoms.

37. The liquid crystal composition according to claim 36, comprising:
7% by mass or greater of a compound represented by Formula (18.4) and/or Formula (18.5) as the compound represented by General Formula (IV-1):

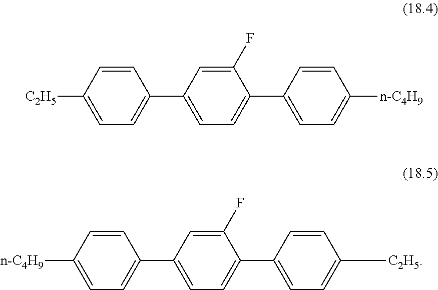

38. The liquid crystal composition according to claim 36, comprising:
9% by mass or greater of a compound represented by Formula (18.6) and/or Formula (18.7) as the compound represented by General Formula (IV-1):

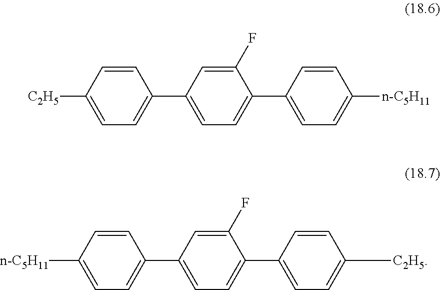

39. A liquid crystal display element for driving active matrix using the liquid crystal composition according to claim 1.

40. The liquid crystal display element for driving active matrix according to claim 39, of which an operation mode is an IPS system.

41. The liquid crystal display element for driving active matrix according to claim 39, of which the operation mode is a VA-IPS system.

42. The liquid crystal display element for driving active matrix according to claim 39, of which the operation mode is an FFS system.

43. The liquid crystal display element for driving active matrix according to claim 39, of which the operation mode is an ECB system.

44. The liquid crystal display element for driving active matrix according to claim 39, of which the operation mode is an OCB system.

45. The liquid crystal display element for driving active matrix according to claim 39, of which the operation mode is a VA system.

46. A liquid crystal display using the liquid crystal display element for active matrix according to claim 39.
